(19) United States
(12) Patent Application Publication
(10) Pub. No.: US 2009/0319802 A1
(43) Pub. Date: Dec. 24, 2009

(54) Key Genaration In An Integrated Circuit

(75) Inventor: Simon Robert Walmsley, Balmain (AU)

Correspondence Address: SILVERBROOK RESEARCH PTY LTD, 393 DARLING STREET, BALMAIN, 2041, AU

(73) Assignee: Silverbrook Research Pty Ltd

(21) Appl. No.: 12/510,912

(22) Filed: Jul. 28, 2009

Related U.S. Application Data
(63) Continuation-in-part of application No. 10/727,158, filed on Dec. 2, 2003.

(30) Foreign Application Priority Data
Dec. 2, 2002 (AU) 2002953134
Dec. 2, 2002 (AU) 2002953135

(51) Int. Cl. G06F 21/00; H04L 9/14

(52) U.S. Cl. 713/189; 380/44

(57) ABSTRACT

A method of manufacturing a series of integrated circuits having related functionality, the method including the steps of: (a) determining an identifier; (b) permanently storing the identifier on one of the integrated circuits; (c) repeating steps (a) and (b) for each integrated circuit in the series; and wherein the identifiers for the series are determined in such a way that knowing the identifier of one of the integrated circuits does not improve the ability of an attacker to determine the identifier of any of the other integrated circuits.

### CROSS REFERENCE TO RELATED APPLICATIONS

The present application is a Continuation-in-Part Application of U.S. application Ser. No. 10/727,158 filed on Dec. 2, 2003, the content of which is incorporated herein by cross-reference.

### FIELD OF INVENTION

The present invention relates to securing a series of integrated circuits against certain forms of security attacks.

The invention has primarily been developed for use in a printer controller chip to authenticate communications between, for example, the printer controller and other peripheral devices such as ink cartridges. However, it will be appreciated that the invention can be applied to integrated circuits in other fields in which analogous problems are faced.

### BACKGROUND OF INVENTION

Manufacturers of systems that require consumables (such as a laser printer that requires toner cartridges) have struggled with the problem of authenticating consumables, to varying levels of success. Most have resorted to specialized packaging that involves a patent. However this does not stop home refill operations or clone manufacture in countries with weak industrial property protection. The prevention of copying is important to prevent poorly manufactured substitute consumables from damaging the base system. For example, poorly filtered ink may clog print nozzles in an ink jet printer, causing the consumer to blame the system manufacturer and not admit the use of non-authorized consumables.

It may also be desirable to monitor and update a record related to resource usage. Authenticating ink quality can be a major issue, since the attributes of inks used by a given printhead can be quite specific. Use of incorrect ink can result in anything from misfiring or poor performance to damage or destruction of the printhead. It would therefore be desirable to provide a system that enables authentication of the correct ink being used, as well as providing various support systems secure enabling refilling of ink cartridges.

In a system that prevents unauthorized programs from being loaded onto or run on an integrated circuit, it can be laborious to allow developers of software to access the circuits during software development. Enabling access to integrated circuits of a particular type requires authenticating software with a relatively high-level key. Distributing the key for use by developers is inherently unsafe, since a single leak of the key outside the organization could endanger security of all chips that use a related key to authorize programs. Having a small number of people with high-security clearance available to authenticate programs for testing can be inconvenient, particularly in the case where frequent incremental changes in programs during development require testing. It would be desirable to provide a mechanism for allowing access to one or more integrated circuits without risking the security of other integrated circuits in a series of such integrated circuits.

In symmetric key security, a message, denoted by M, is plaintext. The process of transforming M into ciphertext C, where the substance of M is hidden, is called encryption. The process of transforming C back into M is called decryption. Referring to the encryption function as E, and the decryption function as D, we have the following identities:
E[M]=C
D[C]=M

Therefore the following identity is true:
D[E[M]]=M

A symmetric encryption algorithm is one where:
the encryption function E relies on key K₁,
the decryption function D relies on key K₂,
K₂ can be derived from K₁, and
K₁ can be derived from K₂.

In most symmetric algorithms, K₁ equals K₂. However, even if K₁ does not equal K₂, given that one key can be derived from the other, a single key K can suffice for the mathematical definition. Thus:
E_{K}[M]=C
D_{K}[C]=M

The security of these algorithms rests very much in the key K. Knowledge of K allows anyone to encrypt or decrypt. Consequently K must remain a secret for the duration of the value of M. For example, M may be a wartime message “My current position is grid position 123-456”. Once the war is over the value of M is greatly reduced, and if K is made public, the knowledge of the combat unit's position may be of no relevance whatsoever. The security of the particular symmetric algorithm is a function of two things: the strength of the algorithm and the length of the key.

An asymmetric encryption algorithm is one where:
the encryption function E relies on key K₁,
the decryption function D relies on key K₂,
K₂ cannot be derived from K₁ in a reasonable amount of time, and
K₁ cannot be derived from K₂ in a reasonable amount of time.

Thus:
E_{K1}[M]=C
D_{K2}[C]=M

These algorithms are also called public-key because one key K₁ can be made public. Thus anyone can encrypt a message (using K₁) but only the person with the corresponding decryption key (K₂) can decrypt and thus read the message.

In most cases, the following identity also holds:
E_{K2}[M]=C
D_{K1}[C]=M

This identity is very important because it implies that anyone with the public key K₁ can see M and know that it came from the owner of K₂. No-one else could have generated C because to do so would imply knowledge of K₂. This gives rise to a different application, unrelated to encryption—digital signatures.

A number of public key cryptographic algorithms exist. Most are impractical to implement, and many generate a very large C for a given M or require enormous keys. Still others, while secure, are far too slow to be practical for several years. Because of this, many public key systems are hybrid—a public key mechanism is used to transmit a symmetric session key, and then the session key is used for the actual messages.

All of the algorithms have a problem in terms of key selection. A random number is simply not secure enough. The two large primes p and q must be chosen carefully—there are certain weak combinations that can be factored more easily (some of the weak keys can be tested for). But nonetheless, key selection is not a simple matter of randomly selecting 1024 bits for example. Consequently the key selection process must also be secure.

Symmetric and asymmetric schemes both suffer from a difficulty in allowing establishment of multiple relationships between one entity and a two or more others, without the need to provide multiple sets of keys. For example, if a main entity wants to establish secure communications with two or more additional entities, it will need to maintain a different key for each of the additional entities. For practical reasons, it is desirable to avoid generating and storing large numbers of keys. To reduce key numbers, two or more of the entities may use the same key to communicate with the main entity. However, this means that the main entity cannot be sure which of the entities it is communicating with. Similarly, messages from the main entity to one of the entities can be decrypted by any of the other entities with the same key. It would be desirable if a mechanism could be provided to allow secure communication between a main entity and one or more other entities that overcomes at least some of the shortcomings of prior art.

In a system where a first entity is capable of secure communication of some form, it may be desirable to establish a relationship with another entity without providing the other entity with any information related the first entity's security features. Typically, the security features might include a key or a cryptographic function. It would be desirable to provide a mechanism for enabling secure communications between a first and second entity when they do not share the requisite secret function, key or other relationship to enable them to establish trust.

A number of other aspects, features, preferences and embodiments are disclosed in the Detailed Description of the Preferred Embodiment below.

### SUMMARY OF THE INVENTION

In accordance with an aspect of the present invention, there is provided a method of providing integrated circuits with keys for use in secure communication, the method including the steps of:
determining a unique identifier for each integrated circuit in the series;
permanently storing the identifiers in the respective integrated circuits by selectively blowing fuses;
in each integrated circuit, mapping the identifier into a key;
wherein the key of one of the integrated circuits is designated as a base key, and the key of at least one other integrated circuit is derived from the base key by applying a one-way function to the base key.

Other aspects are also disclosed.

### BRIEF DESCRIPTION OF THE DRAWINGS

Preferred and other embodiments of the invention will now be described, by way of example only, with reference to the accompanying drawings, in which:

FIG. 1 illustrates a single printer controller (hereinafter “SoPEC”) A4 simplex printer system

FIG. 2 shows a block diagram of the SoPEC

FIG. 3 shows a LSS master system-level interface

FIG. 4 shows relationship between datasets

FIG. 5 shows development of operating system code

FIG. 6 shows a validation hierarchy

FIG. 7 shows protocol for directly verifying reads from ChipR

FIG. 8 shows a protocol for signature translation protocol

FIG. 9 shows a protocol for a direct authenticated write

FIG. 10 shows an alternative protocol for a direct authenticated write

FIG. 11 shows a protocol for basic update of permissions

FIG. 12 shows a protocol for a multiple-key update

FIG. 13 shows a protocol for a single-key authenticated read

FIG. 14 shows a protocol for a single-key authenticated write

FIG. 15 shows a protocol for a single-key update of permissions

FIG. 16 shows a protocol for a single-key update

FIG. 17 shows a protocol for a multiple-key single-M authenticated read

FIG. 18 shows a protocol for a multiple-key authenticated write

FIG. 19 shows a protocol for a multiple-key update of permissions

FIG. 20 shows a protocol for a multiple-key update

FIG. 21 shows a protocol for a multiple-key multiple-M authenticated read

FIG. 22 shows a protocol for a multiple-key authenticated write

FIG. 23 shows a protocol for a multiple-key update of permissions

FIG. 24 shows a protocol for a multiple-key update

FIG. 25 shows 160-bit maximal period LFSR

FIG. 26 shows an output signature generation data format for Read

FIG. 27 shows an input signature verification data format for Test

FIG. 28 shows an output signature generation data format for Translate

FIG. 29 shows an input signature verification data format for WriteAuth

FIG. 30 shows input signature data format for ReplaceKey

FIG. 31 shows a key replacement map

FIG. 32 shows a key replacement map after K₁ is replaced

FIG. 33 shows a key replacement process

FIG. 34 shows an output signature data format for GetProgramKey

FIG. 35 shows transfer and rollback process

FIG. 36 shows an upgrade flow

FIG. 37 shows authorised ink refill paths in the printing system

FIG. 38 shows an input signature verification data format for XferAmount

FIG. 39 shows equivalent signature generation between 4 QA Devices A, B, C and D

### DETAILED DESCRIPTION OF PREFERRED AND OTHER EMBODIMENTS

Print System Overview

A SoPEC (Small office home office Print Engine Controller) ASIC (Application Specific Integrated Circuit) is suitable for use in, for example, SoHo printer products. Every SoPEC based printer architecture will generally contain:
One or more SoPEC devices.
One or more bi-lithic printheads (printhead constructed from 2 printhead Integrated Circuits (ICs)).
Two or more Low Speed Serial interface (LSS) busses.
Two or more Quality Assurance (QA) chips.
Universal Serial Bus (USB) 1.1 connection to host or Inter SoPEC Interface (ISI) connection to Bridge Chip (A device with a high speed interface (such as USB2.0, Ethernet or IEEE1394) and one or more ISI interfaces. The ISI-Bridge would be the ISIMaster for each of the ISI buses it interfaces to).
ISI bus connection between SoPECs (when multiple SoPECs are used).

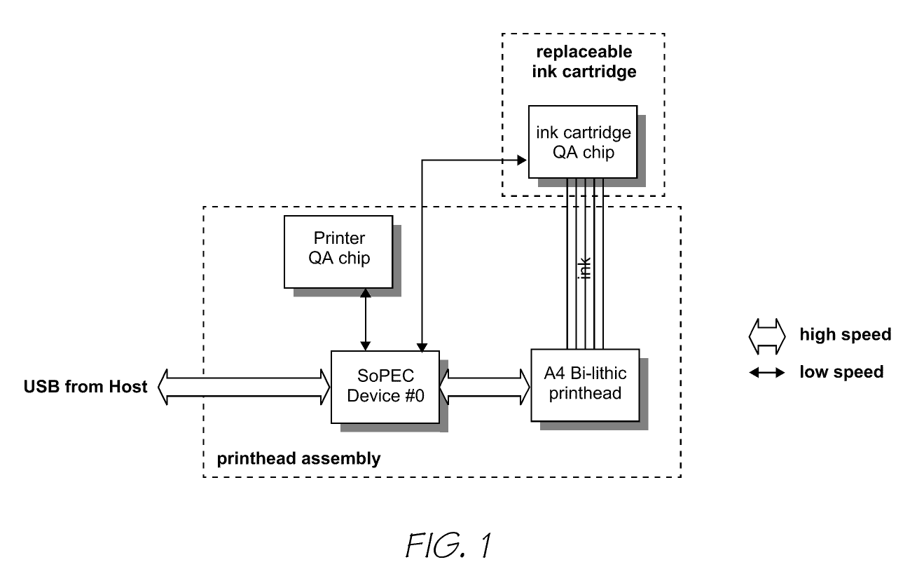

Several possible SoPEC based system architectures exist. FIG. 1 illustrates a single SoPEC device used to control two printhead ICs. The SoPEC receives compressed data through the USB from the host. The compressed data is processed and transferred to the printhead.

The SoPEC device contains several system on a chip (SoC) components, as well as the print engine pipeline control application specific logic.

Print Engine Pipeline (PEP) Logic

The PEP reads compressed page store data from embedded memory, optionally decompresses the data and formats it for sending to the printhead. The print engine pipeline functionality includes expanding the page image, dithering the contone layer, compositing the black layer over the contone layer, compensation for dead nozzles in the printhead, and sending the resultant image to the bi-lithic printhead.

Embedded CPU

SoPEC contains an embedded Central Processing Unit (CPU) for general purpose system configuration and management. The CPU performs page and band header processing, motor control and sensor monitoring (via a General Purpose Input Output (GPIO)) and other system control functions. The CPU can perform buffer management or report buffer status to the host. The CPU can optionally run vendor application specific code for general print control such as paper ready monitoring and LED status update.

Embedded Memory Buffer

A 2.5 Mbyte embedded memory buffer is integrated onto the SoPEC device, of which approximately 2 Mbytes are available for compressed page store data. A compressed page is divided into one or more bands, with a number of bands stored in memory. As a band of the page is consumed by the PEP for printing a new band can be downloaded. The new band may be for the current page or the next page.

Using banding it is possible to begin printing a page before the complete compressed page is downloaded, but care must be taken to ensure that data is always available for printing or a buffer underrun may occur.

Embedded USB 1.1 Device

The embedded USB 1.1 device accepts compressed page data and control commands from the host PC, and facilitates the data transfer to either embedded memory or to another SoPEC device in multi-SoPEC systems.

Bi-Lithic Printhead

The printhead is constructed by abutting 2 printhead ICs together. The printhead ICs can vary in size from 2 inches to 8 inches, so to produce an A4 printhead several combinations are possible. For example two printhead ICs of 7 inches and 3 inches could be used to create a A4 printhead (the notation is 7:3). Similarly 6 and 4 combination (6:4), or 5:5 combination. For an A3 printhead it can be constructed from 8:6 or a 7:7 printhead IC combination. For photographic printing smaller printheads can be constructed.

LSS Interface Bus

Each SoPEC device has 2 LSS system buses for communication with QA devices for system authentication and ink usage accounting. The number of QA devices per bus and their position in the system is unrestricted with the exception that PRINTER_QA and INK_QA devices should be on separate LSS busses.

QA Devices

Each SoPEC system can have several QA devices. Normally each printing SoPEC will have an associated PRINTER_QA. Ink cartridges will contain an INK_QA chip. PRINTER_QA and INK_QA devices should be on separate LSS busses. All QA chips in the system are physically identical with flash memory contents defining PRINTER_QA from INK_QA chip.

ISI Interface

The Inter-SoPEC Interface (ISI) provides a communication channel between SoPECs in a multi-SoPEC system. A ISIMaster is the only device allowed to initiate communication on an Inter SoPEC Interface (ISI) bus, and can be a SoPEC device or an ISI-Bridge chip depending on the printer configuration. Both compressed data and control commands are transferred via the interface. The ISIMaster interfaces with the host.

ISI-Bridge Chip

A device, other than a SoPEC with a USB connection, which provides print data to a number of slave SoPECs. A bridge chip will typically have a high bandwidth connection, such as USB2.0, Ethernet or IEEE1394, to a host and may have an attached external Dynamic Random Access Memory (DRAM) for compressed page storage. A bridge chip would have one or more ISI interfaces. The use of multiple ISI buses would allow the construction of independent print systems within the one printer. The ISI-Bridge would be the ISIMaster for each of the ISI buses it interfaces to.

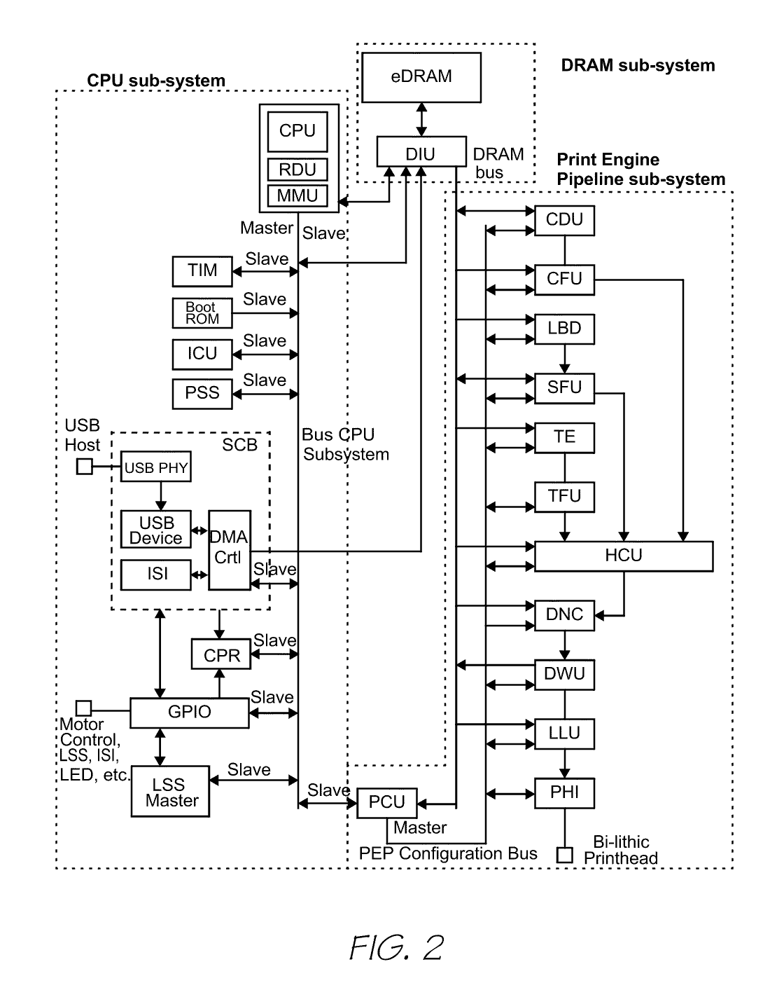

FIG. 2 shows a block diagram of the SoPEC. The SoPEC device consists of 3 distinct subsystems namely:
CPU Subsystem
DRAM Subsystem
Print Engine Pipeline (PEP) Subsystem

The CPU subsystem controls and configures all aspects of the other subsystems. It provides general support for interfacing and synchronising the external printer with the internal print engine. It also controls the low speed communication to the QA chips. The CPU subsystem contains various peripherals to aid the CPU, such as GPIO (includes motor control), interrupt controller, LSS Master and general timers. The Serial Communications Block (SCB) on the CPU subsystem provides a full speed USB1.1 interface to the host as well as an Inter SoPEC Interface (ISI) to other SoPEC devices.

The DRAM subsystem accepts requests from the CPU, Serial Communications Block (SCB) and blocks within the PEP subsystem. The DRAM subsystem (in particular the DRAM Interface Unit (DIU)) arbitrates the various requests and determines which request should win access to the DRAM. The DIU arbitrates based on configured parameters, to allow sufficient access to DRAM for all requesters. The DIU also hides the implementation specifics of the DRAM such as page size, number of banks, refresh rates etc.

The Print Engine Pipeline (PEP) subsystem accepts compressed pages from DRAM and renders them to bi-level dots for a given print line destined for a printhead interface that communicates directly with up to 2 segments of a bi-lithic printhead.

A first stage of the page expansion pipeline is a Contone Decoder Unit (CDU), a Lossless Bi-level Decoder (LBD) and a Tag Encoder (TE). The CDU expands a JPEG-compressed contone (typically CMYK) layer, the LBD expands a compressed bi-level layer (typically K), and the TE encodes Netpage tags for later rendering (typically in IR or K ink). The output from the first stage is a set of buffers: a Contone FIFO Unit (CFU), a Spot FIFO Unit (SFU), and a Tag FIFO Unit (TFU). The CFU and SFU buffers are implemented in DRAM.

A second stage is a Halftoner compositor unit (HCU), which dithers the contone layer, and composites position tags and a bi-level spot0 layer over a resulting bi-level dithered layer. A number of options exist for the way in which compositing occurs. Up to 6 channels of bi-level data are produced from this stage. Note that not all 6 channels may be present on the printhead. For example, the printhead may be CMY only, with K pushed into the CMY channels and IR ignored. Alternatively, the position tags may be printed in K if IR ink is not available (or for testing purposes).

A third stage is a Dead Nozzle Compensator (DNC) which compensates for dead nozzles in the printhead by color redundancy and error diffusing dead nozzle data into surrounding dots.

The resultant bi-level 6 channel dot-data (typically CMYK-IRF) is buffered and written out to a set of line buffers stored in DRAM via a Dotline Writer Unit (DWU).

Finally, the dot-data is loaded back from DRAM, and passed to the printhead interface via a dot FIFO. The dot FIFO accepts data from a Line Loader Unit (LLU) at the system clock rate (pclk), while the PrintHead Interface (PHI) removes data from the FIFO and sends it to the printhead at a rate of ⅔ times the system clock rate.

Table 1 provides a summary of the various units within the SoPEC.

TABLE 1
Units within SoPEC

| | Unit | | |
|---|---|---|---|
| Subsystem | Acronym | Unit Name | Description |
| DRAM | DIU | DRAM interface | Provides the interface for DRAM read |
| | | unit | and write access for the various SoPEC |
| | | | units, CPU and the SCB block. The DIU |
| | | | provides arbitration between competing |
| | | | units controls DRAM access. |
| | DRAM | Embedded DRAM | 20 Mbits of embedded DRAM, |
| CPU | CPU | Central | CPU for system configuration and |
| | | Processing Unit | control |
| | MMU | Memory | Limits access to certain memory |
| | | Management Unit | address areas in CPU user mode |
| | RDU | Real-time Debug | Facilitates the observation of the |
| | | Unit | contents of most of the CPU |
| | | | addressable registers in SoPEC in |
| | | | addition to some pseudo-registers in |
| | | | realtime. |
| | TIM | General Timer | Contains watchdog and general system |
| | | | timers |
| | LSS | Low Speed Serial | Low level controller for interfacing with |
| | | Interfaces | the QA chips |
| | GPIO | General Purpose | General IO controller, with built-in |
| | | IOs | Motor control unit, LED pulse units and |
| | | | de-glitch circuitry |
| | ROM | Boot ROM | 16 KBytes of System Boot ROM code |
| | ICU | Interrupt Controller | General Purpose interrupt controller |
| | | Unit | with configurable priority, and masking. |
| | CPR | Clock, Power and | Central Unit for controlling and |
| | | Reset block | generating the system clocks and |
| | | | resets and powerdown mechanisms |
| | PSS | Power Save | Storage retained while system is |
| | | Storage | powered down |
| | USB | Universal Serial | USB device controller for interfacing |
| | | Bus Device | with the host USB. |
| | ISI | Inter-SoPEC | ISI controller for data and control |
| | | Interface | communication with other SoPEC's in a |
| | | | multi-SoPEC system |
| | SCB | Serial | Contains both the USB and ISI blocks. |
| | | Communication | |
| | | Block | |
| Print | PCU | PEP controller | Provides external CPU with the means |
| Engine | | | to read and write PEP Unit registers, |
| Pipeline | | | and read and write DRAM in single 32- |
| (PEP) | | | bit chunks. |
| | CDU | Contone decoder | Expands JPEG compressed contone |
| | | unit | layer and writes decompressed |
| | | | contone to DRAM |
| | CFU | Contone FIFO Unit | Provides line buffering between CDU |
| | | | and HCU |
| | LBD | Lossless Bi-level | Expands compressed bi-level layer. |
| | | Decoder | |
| | SFU | Spot FIFO Unit | Provides line buffering between LBD |
| | | | and HCU |
| | TE | Tag encoder | Encodes tag data into line of tag dots. |
| | TFU | Tag FIFO Unit | Provides tag data storage between TE |
| | | | and HCU |
| | HCU | Halftoner | Dithers contone layer and composites |
| | | compositor unit | the bi-level spot 0 and position tag dots. |
| | DNC | Dead Nozzle | Compensates for dead nozzles by color |
| | | Compensator | redundancy and error diffusing dead |
| | | | nozzle data into surrounding dots. |
| | DWU | Dotline Writer Unit | Writes out the 6 channels of dot data |
| | | | for a given printline to the line store |
| | | | DRAM |
| | LLU | Line Loader Unit | Reads the expanded page image from |
| | | | line store, formatting the data |
| | | | appropriately for the bi-lithic printhead. |
| | PHI | PrintHead | Is responsible for sending dot data to |
| | | Interface | the bi-lithic printheads and for providing |
| | | | line synchronization between multiple |
| | | | SoPECs. Also provides test interface to |
| | | | printhead such as temperature |
| | | | monitoring and Dead Nozzle |
| | | | Identification. |

Normal operation in a single SoPEC system with a USB host connection is next described. SoPEC operation is broken up into a number of sections. Buffer management in a SoPEC system is normally performed by the host.

Powerup

Powerup describes SoPEC initialisation following an external reset or a watchdog timer system reset.

A typical powerup sequence is:
1) Execute reset sequence for complete SoPEC.
2) CPU boot from ROM.
3) Basic configuration of CPU peripherals, SCB and DIU. DRAM initialisation. USB Wakeup.
4) Download and authentication of program.
5) Execution of program from DRAM.
6) Retrieve operating parameters from PRINTER_QA and authenticate operating parameters.
7) Download and authenticate any further datasets.

USB Wakeup

The CPU can put different sections of SoPEC into sleep mode by writing to registers in the CPR block. Normally the CPU sub-system and the DRAM will be put in sleep mode but the SCB and power-safe storage (PSS) will still be enabled.

Wakeup describes SoPEC recovery from sleep mode with the SCB and power-safe storage (PSS) still enabled. In a single SoPEC system, wakeup can be initiated following a USB reset from the SCB.

A typical USB wakeup sequence is:
1 ) Execute reset sequence for sections of SoPEC in sleep mode.
2) CPU boot from ROM, if CPU-subsystem was in sleep mode.
3) Basic configuration of CPU peripherals and DIU, and DRAM initialisation, if required.
4) Download and authentication of program using results in Power-Safe Storage (PSS).
5) Execution of program from DRAM.
6) Retrieve operating parameters from PRINTER_QA and authenticate operating parameters.
7) Download and authenticate using results in PSS of any further datasets (programs).

Print Initialization

This sequence is typically performed at the start of a print job following powerup or wakeup:
1 ) Check amount of ink remaining via QA chips.
2) Download static data e.g. dither matrices, dead nozzle tables from host to DRAM.
3) Check printhead temperature, if required, and configure printhead with firing pulse profile etc. accordingly.
4) Initiate printhead pre-heat sequence, if required.

Typically during page printing ink usage is communicated to the QA chips.
1 ) Calculate ink printed (from PHI).
2) Decrement ink remaining (via QA chips).
3) Check amount of ink remaining (via QA chips). This operation may be better performed while the page is being printed rather than at the end of the page.

Security operation of the SoPEC system is now described. Communication between SoPEC and the QA chips (i.e. INK_QA and PRINTER_QA) takes place on at least a per power cycle and per page basis. Communication with the QA chips has three principal purposes: validating the presence of genuine QA chips (i.e the printer is using approved consumables), validation of the amount of ink remaining in the cartridge and authenticating the operating parameters for the printer. After each page has been printed, SoPEC is expected to communicate the number of dots fired per ink plane to the QA chipset. SoPEC may also initiate decoy communications with the QA chips from time to time. When validating ink consumption SoPEC is expected to principally act as a conduit between the PRINTER_QA and INK_QA chips and to take certain actions (basically enable or disable printing and report status to host PC) based on the result. The communication channels are insecure but all traffic is signed to guarantee authenticity. The INK_QA and PRINTER_QA chips are identical in their virgin state. They only become a INK_QA or PRINTER_QA after their FlashROM has been programmed.

Authentication of downloaded code in a single SoPEC system follows the following process:
1) SoPEC identification by activity on USB end-points 2-4 indicates it is the ISIMaster (unless the SoPEC CPU has explicitly disabled this function).
2) The program is downloaded to the embedded DRAM.
3) The CPU calculates a SHA-1 hash digest of the downloaded program.
4) The ResetSrc register in the CPR block is read to determine whether or not a power-on reset occurred.
5) If a power-on reset occurred the signature of the downloaded code (which needs to be in a known location such as the first or last N bytes of the downloaded code) is decrypted using the Silverbrook public boot0key stored in ROM. This decrypted signature is the expected SHA-1 hash of the accompanying program. The encryption algorithm is likely to be a public key algorithm such as RSA. If a power-on reset did not occur then the expected SHA-1 hash is retrieved from the PSS and the compute intensive decryption is not required.
6) The calculated and expected hash values are compared and if they match then the programs authenticity has been verified.
7) If the hash values do not match then the host PC is notified of the failure and the SoPEC will await a new program download.
8) If the hash values match then the CPU starts executing the downloaded program.
9) If, as is very likely, the downloaded program wishes to download subsequent programs (such as OEM code) it is responsible for ensuring the authenticity of everything it downloads. The downloaded program may contain public keys that are used to authenticate subsequent downloads, thus forming a hierarchy of authentication. The SoPEC ROM does not control these authentications—it is solely concerned with verifying that the first program downloaded has come from a trusted source.
10) At some subsequent point OEM code starts executing. The Silverbrook supervisor code acts as an O/S to the OEM user mode code. The OEM code must access most SoPEC functionality via system calls to the Silverbrook code.
11) The OEM code is expected to perform some simple ‘turn on the lights’ tasks after which the host PC is informed that the printer is ready to print and the Start Printing use case comes into play.

The SoPEC IC will be used in a range of printers with different capabilities (e.g. A3/A4 printing, printing speed, resolution etc.). It is expected that some printers will also have a software upgrade capability which would allow a user to purchase a license that enables an upgrade in their printer's capabilities (such as print speed). To facilitate this it must be possible to securely store the operating parameters in the PRINTER_QA chip, to securely communicate these parameters to the SoPEC and to securely reprogram the parameters in the event of an upgrade. Note that each printing SoPEC (as opposed to a SoPEC that is only used for the storage of data) will have its own PRINTER_QA chip (or at least access to a PRINTER_QA that contains the SoPEC's SoPEC_id_key).

Process:
1) Program code is downloaded and authenticated.
2) The program code has a function to create the SoPEC_id_key from the unique SoPEC_id that was programmed when the SoPEC was manufactured.
3) The SoPEC retrieves the signed operating parameters from its PRINTER_QA chip. The PRINTER_QA chip uses the SoPEC_id_key (which is stored as part of the pairing process executed during printhead assembly manufacture & test) to sign the operating parameters which are appended with a random number to thwart replay attacks.
4) The SoPEC checks the signature of the operating parameters using its SoPEC_id_key. If this signature authentication process is successful then the operating parameters are considered valid and the overall boot process continues. If not the error is reported to the host PC.
5) Operating parameters may also be set or upgraded using a second key, the PrintEngineLicense_key, which is stored on the PRINTER_QA and used to authenticate the change in operating parameters.

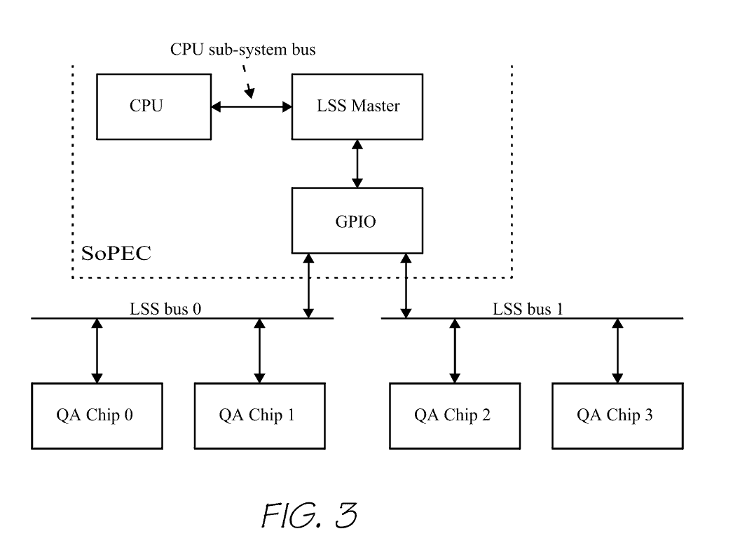

The Low Speed Serial Interface (LSS) provides a mechanism for the internal SoPEC CPU to communicate with external QA chips via two independent LSS buses. The LSS communicates through the GPIO block to the QA chips. The LSS Master system-level interface is illustrated in FIG. 3. Note that multiple QA chips are allowed on each LSS bus.

The ROM block interfaces to the CPU bus and contains the SoPEC boot code. The ROM block consists of the CPU bus interface, the ROM macro and a ChipID macro.

The current ROM size is 16 KBytes implemented as a 4096×32 macro. Access to the ROM is not cached because the CPU enjoys fast (no more than one cycle slower than a cache access), unarbitrated access to the ROM.

Each SoPEC device has a unique ChipID which is set by blowing fuses at manufacture. IBM's 300 mm ECID macro and a custom 112-bit ECID macro are used to implement the ChipID offering 224-bits of laser fuses. The ECID macros allows all 224 bits to be read out in parallel and the ROM block will make all 224 bits available in the FuseChipID[N] registers which are readable by the CPU in supervisor mode only. There are two boot scenarios for the SoPEC device namely after power-on and after being awoken from sleep mode. When the device is in sleep mode it is hoped that power will actually be removed from the DRAM, CPU and most other peripherals and so the program code will need to be freshly downloaded each time the device wakes up from sleep mode. In order to reduce the wakeup boot time (and hence the perceived print latency) certain data items are stored in the PSS block. These data items include the SHA-1 hash digest expected for the program(s) to be downloaded, the master/slave SoPEC id and some configuration parameters. All of these data items are stored in the PSS by the CPU prior to entering sleep mode. The SHA-1 value stored in the PSS is calculated by the CPU by decrypting the signature of the downloaded program using the appropriate public key stored in ROM. This compute intensive decryption only needs to take place once as part of the power-on boot sequence—subsequent wakeup boot sequences will simply use the resulting SHA-1 digest stored in the PSS. Note that the digest only needs to be stored in the PSS before entering sleep mode and the PSS can be used for temporary storage of any data at all other times. The CPU is in supervisor mode for the entire boot sequence.

The boot code places no restrictions on the activity of any programs downloaded and authenticated by it other than those imposed by the configuration of the MMU i.e. the principal function of the boot code is to authenticate that any programs downloaded by it are from a trusted source. It is the responsibility of the downloaded program to ensure that any code it downloads is also authenticated and that the system remains secure.

QA Chip Terminology
For authenticated reads, ChipR is the QA Chip being read from, and ChipT is the QA Chip that identifies whether the data read from ChipR can be trusted. ChipR and ChipT are referred to as Untrusted QA Device and Trusted QA Device respectively.
For replacement of keys, ChipP is the QA Chip being programmed with the new key, and ChipF is the factory QA Chip that generates the message to program the new key. ChipF is referred to as the Key Programmer QA Device.
For upgrades of data in memory vectors, ChipU is the QA Chip being upgraded, and ChipS is the QA Chip that signs the upgrade value. ChipS is referred to as the Value Upgrader QA Device and Parameter Upgrader QA Device.

Any given physical QA Chip will contain functionality that allows it to operate as an entity in some number of these protocols.

Therefore, wherever the terms ChipR, ChipT, ChipP, ChipF, ChipU and ChipS are used in this document, they are referring to logical entities involved in an authentication protocol.

Physical QA Chips are referred to by their location. For example, each ink cartridge may contain a QA Chip referred to as an INK_QA, with all INK_QA chips being on the same physical bus. In the same way, the QA Chip inside the printer is referred to as PRINTER_QA, and will be on a separate bus to the INK_QA chips.

The functional security requirements for the preferred embodiment are:
Code of QA chip owner or licensee co-existing safely with code of authorized OEMs
Chip owner/licensee operating parameters authentication
Parameters authentication for authorized OEMs
Ink usage authentication

Each of these is outlined below.

QA Manufacturer/owner code and OEM program code co-existing safely SoPEC includes a CPU that must run both manufacturer/owner program code and OEM program code. The execution model envisaged for SoPEC is one where Manufacturer/owner program code forms an operating system (O/S), providing services such as controlling the print engine pipeline, interfaces to communications channels etc. The OEM program code must run in a form of user mode, protected from harming the Manufacturer/owner program code. The OEM program code is permitted to obtain services by calling functions in the O/S, and the O/S may also call OEM code at specific times. For example, the OEM program code may request that the O/S call an OEM interrupt service routine when a particular GPIO pin is activated.

In addition, it may be required for the OEM code to directly call functions in Manufacturer/owner code with the same permissions as the OEM code. For example, the Manufacturer/owner code may provide SHA1 as a service, and the OEM could call the SHA1 function, but execute that function with OEM permissions and not Silverbook permissions.

A basic requirement then, for SoPEC, is a form of protection management, whereby Manufacturer/owner and OEM program code can co-exist without the OEM program code damaging operations or services provided by the Manufacturer/owner O/S. Since services rely on SoPEC peripherals (such as USB2 Host, LSS Master, Timers etc) access to these peripherals should also be restricted to Manufacturer/owner program code only.

Manufacturer/Owner Operating Parameters Authentication

A particular OEM will be licensed to run a Print Engine with a particular set of operating parameters (such as print speed or quality). The OEM and/or end-user can upgrade the operating license for a fee and thereby obtain an upgraded set of operating parameters.

Neither the OEM nor end-user should be able to upgrade the operating parameters without paying the appropriate fee to upgrade the license. Similarly, neither the OEM nor end-user should be able to bypass the authentication mechanism via any program code on SoPEC. This implies that OEMs and end-users must not be able to tamper with or replace Manufacturer/owner program code or data, nor be able to call unauthorized functions within Manufacturer/owner program code.

However, the OEM must be capable of assembly-line testing the Print Engine at the upgraded status before selling the Print Engine to the end-user.

OEM Operating Parameters Authentication

The OEM may provide operating parameters to the end-user independent of the Manufacturer/owner operating parameters. For example, the OEM may want to sell a franking machine.

The end-user should not be able to upgrade the operating parameters without paying the appropriate fee to the OEM. Similarly, the end-user should not be able to bypass the authentication mechanism via any program code on SoPEC. This implies that end-users must not be able to tamper with or replace OEM program code or data, as well as not be able to tamper with the PEP blocks or service-related peripherals.

Cannot Trust the Comms Channel to the QA Chip in the Printer (PRINTER_QA)

If the printer operating parameters are stored in the non-volatile memory of the Print Engine's on-board PRINTER_QA chip, both Manufacturer/owner and OEM program code cannot rely on the communication channel being secure. It is possible for an attacker to eavesdrop on communications to the PRINTER_QA chip, replace the PRINTER_QA chip and/or subvert the communications channel. It is also possible for this to be true during manufacture of the circuit board containing the SoPEC and the PRINTER_QA chip.

Cannot Trust the Comms Channel to the QA Chip in the Ink Cartridges (INK_QA)

The amount of ink remaining for a given ink cartridge is stored in the non-volatile memory of that ink cartridge's INK_QA chip. Both Manufacturer/owner and OEM program code cannot rely on the communication channel to the INK_QA being secure. It is possible for an attacker to eavesdrop on communications to the INK_QA chip, to replace the INK_QA chip and/or to subvert the communications channel. It is also possible for this to be true during manufacture of the consumable containing the INK_QA chip.

Each SoPEC has a Unique ID

Each SoPEC contains a unique SoPEC_id of minimum size 64-bits. This SoPEC_id is used to form a symmetric key unique to each SoPEC: SoPEC_id_key. On SoPEC we make use of an additional 112-bit Electronic Chip Id (ECID) macro that has been programmed with a random number on a per-chip basis. Thus SoPEC_id is the 112-bit macro, and the SoPEC_id_key is a 160-bit result obtained by SHA1(SoPEC_id).

The verification of operating parameters and ink usage depends on SoPEC_id being difficult to determine. Difficult to determine means that someone should not be able to determine the id via software, or by viewing the communications between chips on the board.

It is important to note that in the proposed solution, compromise of the SoPEC_id leads only to compromise of the operating parameters and ink usage on this particular SoPEC. It does not compromise any other SoPEC or all inks or operating parameters in general.

It is ideal that the SoPEC_id be random, although this is unlikely to occur on standard manufacture processes for ASICs. If the id is within a small range however, it will be able to be broken by brute force. This is why 32-bits is not sufficient protection.

SoPEC contains a CPU with direct hardware support for user and supervisor modes. Manufacturer/owner (operating system) program code will run in supervisor mode, and all OEM program code will run in user mode.

Memory Management Unit

SoPEC contains a Memory Management Unit (MMU) that limits access to regions of DRAM by defining read, write and execute access permissions for supervisor and user mode. Program code running in user mode is subject to user mode permission settings, and program code running in supervisor mode is subject to supervisor mode settings.

A setting of 1 for a permission bit means that type of access (e.g. read, write, execute) is permitted. A setting of 0 for a read permission bit means that that type of access is not permitted.

At reset and whenever SoPEC wakes up, the settings for all the permission bits are 1 for all supervisor mode accesses, and 0 for all user mode accesses. This means that supervisor mode program code must explicitly set user mode access to be permitted on a section of DRAM.

Access permission to all the non-valid address space should be trapped, regardless of user or supervisor mode, and regardless of the access being read, execute, or write.

Access permission to all of the valid non-DRAM address space (for example the PEP blocks) is supervisor read/write access only (no supervisor execute access, and user mode has no access at all) with the exception that certain GPIO and Timer registers can also be accessed by user code. These registers will require bitwise access permissions. Each peripheral block will determine how the access is restricted. With respect to the DRAM and PEP subsystems of SoPEC, typically we would set user read/write/execute mode permissions to be 1/1/0 only in the region of memory that is used for OEM program data, 1/0/1 for regions of OEM program code, and 0/0/0 elsewhere (including the trap table). By contrast we would typically set supervisor mode read/write/execute permissions for this memory to be 1/1/0 (to avoid accidentally executing user code in supervisor mode).

The SoPEC_id parameter should only be accessible in supervisor mode, and should only be stored and manipulated in a region of memory that has no user mode access.

Unique ID is not Cached

The unique SoPEC_id needs to be available to supervisor code and not available to user code. This is taken care of by the MMU.

However the SoPEC_id must also not be accessable via the CPU's data cache or register windows. For example, if the user were to cause an interrupt to occur at a particular point in the program execution when the SoPEC_id was being manipulated, it must not be possible for the user program code to turn caching off and then access the SoPEC_id inside the data cache. This would bypass any MMU security.

The same must be true of register windows. It must not be possible for user mode program code to read or modify register settings in a supervisor program's register windows.

This means that at the least, the SoPEC_id itself must not be cacheable. Likewise, any processed form of the SoPEC_id such as the SoPEC_id_key (e.g. read into registers or calculated expected results from a QA_Chip) should not be accessable by user program code.

Specific Entry Points in O/S

Given that user mode program code cannot even call functions in supervisor code space, the question arises as how OEM programs can access functions, or request services. Use of a command dispatcher allows the O/S to provide services that filter access—e.g. a generalised print function will set PEP registers appropriately and ensure QA Chip ink updates occur.

Boot Procedure

Basic Premise

The intention is to load the Manufacturer/owner and OEM program code into SoPEC's RAM, where it can be subsequently executed. The basic SoPEC therefore, must be capable of downloading program code. However SoPEC must be able to guarantee that only authorized Manufacturer/owner boot programs can be loaded, otherwise anyone could modify the O/S to do anything, and then load that—thereby bypassing the licensed operating parameters.

We perform authentication of program code and data using asymmetric (public-key) digital signatures and without using a QA Chip.

Assuming we have already downloaded some data and a 160-bit signature into eDRAM, the boot loader needs to perform the following tasks:
perform SHA-1 on the downloaded data to calculate a digest localDigest
perform asymmetric decryption on the downloaded signature (160-bits) using an asymmetric public key to obtain authorizedDigest
If authorizedDigest is the PKCS#1 form of localDigest, then the downloaded data is authorized (the signature must have been signed with the asymmetric private key) and control can then be passed to the downloaded data

Asymmetric decryption is used instead of symmetric decryption because the decrypting key must be held in SoPEC's ROM. If symmetric private keys are used, the ROM can be probed and the security is compromised.

The procedure requires the following data item:
boot0key=an n-bit asymmetric public key

The procedure also requires the following two functions:
SHA-1=a function that performs SHA-1 on a range of memory and returns a 160-bit digest
decrypt=a function that performs asymmetric decryption of a message using the passed-in key
   PKCS#1 form of localDigest is 2048-bits formatted as follows: bits 2047-2040=0x00, bits 2039-2032=0x01, bits 2031-288=0xFF . . . 0xFF, bits 287-160=0x003021300906052B0E03021A05000414, bits 159-0=localDigest.

Assuming that all of these are available (e.g. in the boot ROM), boot loader 0 can be defined as in the following pseudocode:

```
    bootloader0(data, sig)
      localDigest ← SHA-1(data)
      authorizedDigest ← decrypt(sig, boot0key)
      expectedDigest  =  0x00|0x01|0xFF..0xFF|
        0x003021300906052B0E03021A05000414  |localDigest)
// “|” = concat
      If (authorizedDigest == expectedDigest)
      jump to program code at data-start address// will never return
      Else
      // program code is unauthorized
      EndIf
```

The length of the key will depend on the asymmetric algorithm chosen.

In the case of RSA, a 2048-bit key is required to match the 160-bit symmetric-key security of the QA Chip. In the case of ECDSA, a key length of 132 bits is likely to suffice. RSA is convenient because the patent (U.S. Pat. No. 4,405,829) expired in September 2000.

There is no advantage to storing multiple keys in SoPEC and having the external message choose which key to validate against, because a compromise of any key allows the external user to always select that key.

There is also no particular advantage to having the boot mechanism select the key (e.g. one for USB-based booting and one for external ROM booting) a compromise of the external ROM booting key is enough to compromise all the SoPEC systems.

However, there are advantages in having multiple keys present in the boot ROM and having a wire-bonding option on the pads select which of the keys is to be used. Ideally, the pads would be connected within the package, and the selection is not available via external means once the die has been packaged. This means we can have different keys for different application areas (e.g. different uses of the chip), and if any particular SoPEC key is compromised, the die could be kept constant and only the bonding changed. Note that in the worst case of all keys being compromised, it may be economically feasible to change the boot0key value in SoPEC's ROM, since this is only a single mask change, and would be easy to verify and characterize.

Therefore the entire security of SoPEC is based on keeping the asymmetric private key paired to boot0key secure. The entire security of SoPEC is also based on keeping the program that signs (i.e. authorizes) datasets using the asymmetric private key paired to boot0key secure.

It may therefore be reasonable to have multiple signatures (and hence multiple signature programs) to reduce the chance of a single point of weakness by a rogue employee. Note that the authentication time increases linearly with the number of signatures, and requires a 2048-bit public key in ROM for each signature.

Hierarchies of Authentication

Given that test programs, evaluation programs, and Manufacturer/owner O/S code needs to be written and tested, and OEM program code etc. also needs to be tested, it is not secure to have a single authentication of a monolithic dataset combining Manufacturer/owner O/S, non-O/S, and OEM program code—we certainly don't want OEMs signing Manufacturer/owner program code, and Manufacturer/owner shouldn't have to be involved with the signing of OEM program code.

Therefore we require differing levels of authentication and therefore a number of keys, although the procedure for authentication is identical to the first—a section of program code contains the key and procedure for authenticating the next.

This method allows for any hierarchy of authentication, based on a root key of boot0key. For example, assume that we have the following entities:
QACo, Manufacturer/owner's QA/key company. Knows private version of boot0key, and owner of security concerns.
SoPECCo, Manufacturer/owner's SoPEC hardware/software company. Supplies SoPEC ASICs and SoPEC O/S printing software to a ComCo.
ComCo, a company that assembles Print Engines from SoPECs, Memjet printheads etc, customizing the Print Engine for a given OEM according to a license
OEM, a company that uses a Print Engine to create a printer product to sell to the end-users. The OEM would supply the motor control logic, user interface, and casing.

The levels of authentication hierarchy are as follows:
QACo writes the boot ROM, agenerates dataset1, consisting of a boot loader program that loads and validates dataset2 and QACo's asymmetric public boot1key. QACo signs dataset0 with the asymmetric private boot0key.
SoPECCo generates dataset1, consisting of the print engine security kernel O/S (which incorporates the security-based features of the print engine functionality) and the ComCo's asymmetric public key. Upon a special “formal release” request from SoPECCo, QACo signs dataset0 with QACo's asymmetric private boot0key key. The print engine program code expects to see an operating parameter block signed by the ComCo's asymmetric private key. Note that this is a special “formal release” request to by SoPECCo.
The ComCo generates dataSet3, consisting of dataset1 plus dataset2, where dataset2 is an operating parameter block for a given OEM's print engine licence (according to the print engine license arrangement) signed with the ComCo's asymmetric private key. The operating parameter block (dataset2) would contain valid print speed ranges, a PrintEngineLicenseld, and the OEM's asymmetric public key. The ComCo can generate as many of these operating parameter blocks for any number of Print Engine Licenses, but cannot write or sign any supervisor O/S program code.
The OEM would generate dataset5, consisting of dataset3 plus dataset4, where dataset4 is the OEM program code signed with the OEM's asymmetric private key. The OEM can produce as many versions of dataset5 as it likes (e.g. for testing purposes or for updates to drivers etc) and need not involve Manufacturer/owner, QACo, or ComCo in any way.

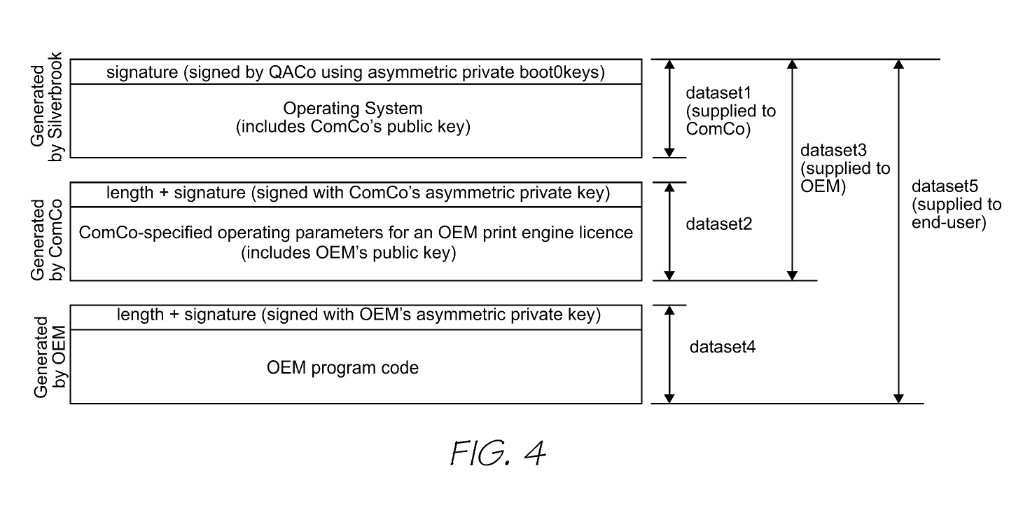

The relationship is shown in FIG. 4.

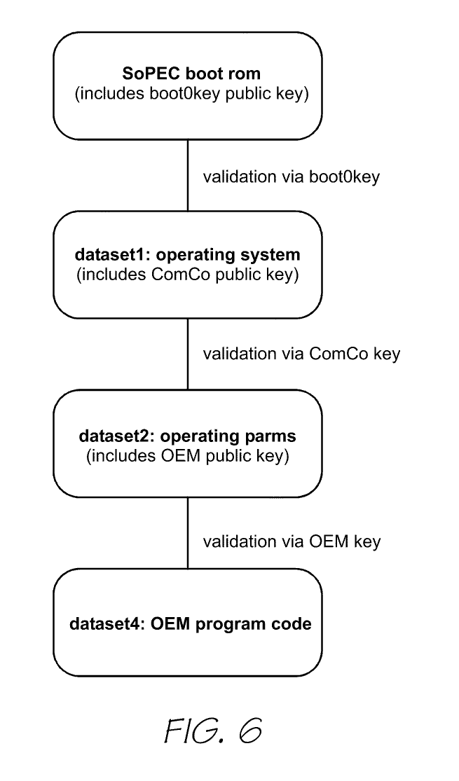

When the end-user uses dataset5, SoPEC itself validates dataset1 via the boot0key mechanism. Once dataset1 is executing, it validates dataset2, and uses dataset2 data to validate dataset4. The validation hierarchy is shown in FIG. 6.

If a key is compromised, it compromises all subsequent authorizations down the hierarchy. In the example from above (and as illustrated in FIG. 6) if the OEM's asymmetric private key is compromised, then O/S program code is not compromised since it is above OEM program code in the authentication hierarchy. However if the ComCo's asymmetric private key is compromised, then the OEM program code is also compromised. A compromise of boot0key compromises everything up to SoPEC itself, and would require a mask ROM change in SoPEC to fix.

It is worthwhile repeating that in any hierarchy the security of the entire hierarchy is based on keeping the asymmetric private key paired to boot0key secure. It is also a requirement that the program that signs (i.e. authorizes) datasets using the asymmetric private key paired to boot0key secure.

Developing Program Code at Manufacturer/Owner

The hierarchical boot procedure gives a hierarchy of protection in a final shipped product. It is also desirable to use a hierarchy of protection during software development within Manufacturer/owner.

For a program to be downloaded and run on SoPEC during development, it needs to be signed. In addition, we don't want to have to sign each and every Manufacturer/owner development code with the boot0key, as it creates the possibility of any developmental (including buggy or rogue) application being run on any SoPEC.

Therefore QACo needs to generate/create a special intermediate boot loader, signed with boot0key, that performs the exact same tasks as the normal boot loader, except that it checks the SoPECid to see if it is a specific SoPECid (or set of SoPECids). If the SoPEC_id is in the valid set, then the developmental boot loader validates dataset2 by means of its length and a SHA-1 digest of the developmental code, and not by a further digital signature. The QACo can give this boot loader to the software development team within Manufacturer/owner. The software team can now write and run any program code, and load the program code using the development boot loader. There is no requirement for the subsequent software program (i.e. the developmental program code) to be signed with any key since the programs can only be run on the particular SoPECs.

If the developmental boot loader (and/or signature generator) were compromised, or any of the developmental programs were compromised, the worst situation is that an attacker could run programs on that particular set of SoPECs, and on no others.

This should greatly reduce the possibility of erroneous programs signed with boot0key being available to an attacker (only official releases are signed by boot0key), and therefore reduces the possibility of a Manufacturer/owner employee intentionally or inadvertently creating a back door for attackers.

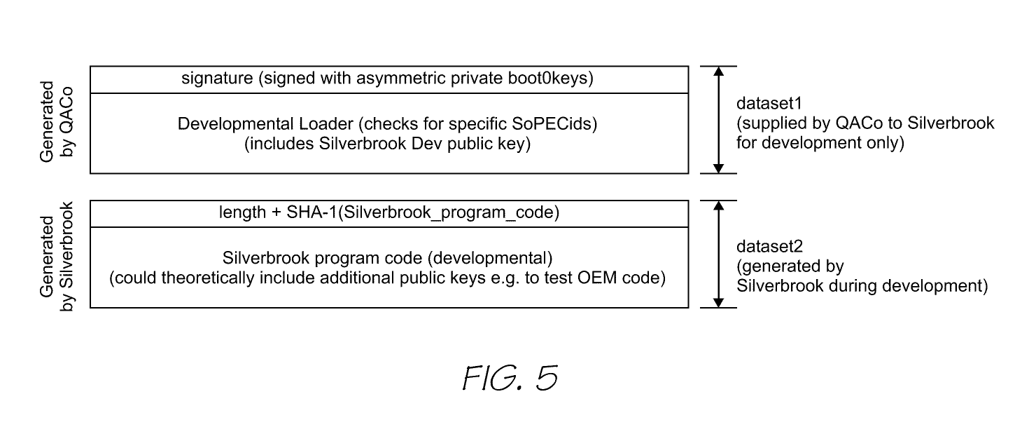

The relationship is shown below in FIG. 5.

Theoretically the same kind of hierarchy could also be used to allow OEMs to be assured that their program code will only work on specific SoPECs, but this is unlikely to be necessary, and is probably undesirable.

Date-Limited Loaders

It is possible that errors in supervisor program code (e.g. the operating system) could allow attackers to subvert the program in SoPEC and gain supervisor control.

To reduce the impact of this kind of attack, it is possible to allocate some bits of the SoPEC_id to form some kind of date. The granularity of the date could be as simple as a single bit that says the date is obtained from the regular IBM ECID, or it could be 6 bits that give 10 years worth of 3-month units.

The first step of the program loaded by boot loader 0 could check the SoPEC_id date, and run or refuse to run appropriately. The Manufacturer/owner driver or OS could therefore be limited to run on SoPECs that are manufactured up until a particular date.

This means that the OEM would require a new version of the OS for SoPECs after a particular date, but the new driver could be made to work on all previous versions of SoPEC.

The function simply requires a form of date, whose granularity for working can be determined by agreement with the OEM.

For example, suppose that SoPECs are supplied with 3-month granularity in their date components. Manufacturer/owner could ship a version of the OS that works for any SoPEC of the date (i.e. on any chip), or for all SoPECs manufactured during the year etc. The driver issued the next year could work with all SoPECs up until that years etc. In this way the drivers for a chip will be backwards compatible, but will be deliberately not forwards-compatible. It allows the downloading of a new driver with no problems, but it protects against bugs in one years's driver OS from being used against future SoPECs.

Note that the phasing in of a new OS doesn't have to be at the same time as the hardware. For example, the new OS can come in 3 months before the hardware that it supports. However once the new SoPECs are being delivered, the OEM must not ship the older driver with the newer SoPECs, for the old driver will not work on the newer SoPECs. Basically once the OEM has received the new driver, they should use that driver for all SoPEC systems from that point on (old SoPECs will work with the new driver).

This date-limiting feature would most likely be using a field in the ComCo specified operating parameters, so it allows the SoPEC to use date-checking in addition to additional QA Chip related parameter checking (such as the OEM's PrintEngineLicenseld etc).

A variant on this theme is a date-window, where a start-date and end-date are specified (as relating to SoPEC manufacture, not date of use).

Authenticating Operating Parameters

Operating parameters need to be considered in terms of Manufacturer/owner operating parameters and OEM operating parameters. Both sets of operating parameters are stored on the PRINTER_QA chip (physically located inside the printer). This allows the printer to maintain parameters regardless of being moved to different computers, or a loss/replacement of host O/S drivers etc.

On PRINTER_QA, memory vector M₀ contains the upgradable operating parameters, and memory vectors M₁₊ contains any constant (non-upgradable) operating parameters.

Considering only Manufacturer/owner operating parameters for the moment, there are actually two problems:
a. setting and storing the Manufacturer/owner operating parameters, which should be authorized only by Manufacturer/owner
b. reading the parameters into SoPEC, which is an issue of SoPEC authenticating the data on the PRINTER_QA chip since we don't trust PRINTER_QA.

The PRINTER_QA chip therefore contains the following symmetric keys:
K₀=PrintEngineLicense_key. This key is constant for all SoPECs supplied for a given print engine license agreement between an OEM and a Manufacturer/owner ComCo. K₀ has write permissions to the Manufacturer/owner upgradeable region of M₀ on PRINTER_QA.
K₁=SoPEC_id_key. This key is unique for each SoPEC, and is known only to the SoPEC and PRINTER_QA. K₁ does not have write permissions for anything.

K₀ is used to solve problem (a). It is only used to authenticate the actual upgrades of the operating parameters. Upgrades are performed using the standard upgrade protocol, with PRINTER_QA acting as the ChipU, and the external upgrader acting as the ChipS.

K₁ is used by SoPEC to solve problem (b). It is used to authenticate reads of data (i.e. the operating parameters) from PRINTER_QA. The procedure follows the standard authenticated read protocol, with PRINTER_QA acting as ChipR, and the embedded supervisor software on SoPEC acting as ChipT. Authenticated read protocol requires the use of a 160-bit nonce, which is a pseudo-random number. This creates the problem of introducing pseudo-randomness into SoPEC that is not readily determinable by OEM programs, especially given that SoPEC boots into a known state. One possibility is to use the same random number generator as in the QA Chip (a 160-bit maximal-lengthed linear feedback shift register) with the seed taken from the value in the WatchDogTimer register in SoPEC's timer unit when the first page arrives.

Note that the procedure for verifying reads of data from PRINTER_QA does not rely on Manufacturer/owner's key K₀. This means that precisely the same mechanism can be used to read and authenticate the OEM data also stored in PRINTER_QA. Of course this must be done by Manufacturer/owner supervisor code so that SoPEC_id_key is not revealed.

If the OEM also requires upgradable parameters, we can add an extra key to PRINTER_QA, where that key is an OEM_key and has write permissions to the OEM part of M₀.

In this way, K₁ never needs to be known by anyone except the SoPEC and PRINTER_QA.

Each printing SoPEC in a multi-SoPEC system need access to a PRINTER_QA chip that contains the appropriate SoPEC_id_key to validate ink useage and operating parameters. This can be accomplished by a separate PRINTER_QA for each SoPEC, or by adding extra keys (multiple SoPEC_id_keys) to a single PRINTER_QA.

However, if ink usage is not being validated (e.g. if print speed were the only Manufacturer/owner upgradable parameter) then not all SoPECs require access to a PRINTER_QA chip that contains the appropriate SoPEC_id_key. Assuming that OEM program code controls the physical motor speed (different motors per OEM), then the PHI within the first (or only) front-page SoPEC can be programmed to accept (or generate) line sync pulses no faster than a particular rate. If line syncs arrived faster than the particular rate, the PHI would simply print at the slower rate. If the motor speed was hacked to be fast, the print image will appear stretched.

Floating Operating Parameters and Dongles

Manufacturer/owner operating parameters include such items as print speed, print quality etc. and are tied to a license provided to an OEM. These parameters are under Manufacturer/owner control. The licensed Manufacturer/owner operating parameters are typically stored in the PRINTER_QA.

However there are situations when it is desirable to have a floating upgrade to a license, for use on a printer of the user's choice. For example, OEMs may sell a speed-increase license upgrade that can be plugged into the printer of the user's choice. This form of upgrade can be considered a floating upgrade in that it upgrades whichever printer it is currently plugged into. This dongle is referred to as ADDITIONAL_PRINTER_QA. The software checks for the existence of an ADDITIONAL_PRINTER_QA, and if present the operating parameters are chosen from the values stored on both QA chips.

The basic problem of authenticating the additional operating parameters boils down to the problem that we don't trust ADDITIONAL_PRINTER_QA. Therefore we need a system whereby a given SoPEC can perform an authenticated read of the data in ADDITIONAL_PRINTER_QA.

We should not write the SoPEC_id_key to a key in the ADDITIONAL_PRINTER_QA because:
then it will be tied specifically to that SoPEC, and the primary intention of the ADDITIONAL_PRINTER_QA is that it be floatable;
the ink cartridge would then not work in another printer since the other printer would not know the old SoPEC_id_key (knowledge of the old key is required in order to change the old key to a new one).
updating keys is not power-safe (i.e. if at the user's site, power is removed mid-update, the ADDITIONAL_PRINTER_QA could be rendered useless)

The proposed solution is to let ADDITIONAL_PRINTER_QA have two keys:
K₀=FloatingPrintEngineLicense_key. This key has the same function as the PrintEngineLicense_key in the PRINTER_QA in that K₀ has write permissions to the Manufacturer/owner upgradeable region of M₀ on ADDITIONAL_PRINTER_QA.
K₁=UseExtParmsLicense_key. This key is constant for all of the ADDITIONAL_PRINTER_QAs for a given license agreement between an OEM and a Manufacturer/owner ComCo (this is not the same key as PrintEngineLicense_key which is stored as K₀ in PRINTER_QA). K₁ has no write permissions to anything.

K₀ is used to allow writes to the various fields containing operating parameters in the ADDITIONAL_PRINTER_QA. These writes/upgrades are performed using the standard upgrade protocol, with ADDITIONAL_PRINTER_QA acting as the ChipU, and the external upgrader acting as the ChipS. The upgrader (ChipS) also needs to check the appropriate licensing parameters such as OEM_Id for validity.

K₁ is used to allow SoPEC to authenticate reads of the ink remaining and any other ink data. This is accomplished by having the same UseExtParmsLicense_key within PRINTER_QA (e.g. in K₂), also with no write permissions. i.e:
PRINTER_QA.K₂=UseExtParmsLicense_key. This key is constant for all of the PRINTER_QAs for a given license agreement between an OEM and a Manufacturer/owner ComCo. K₂ has no write permissions to anything.

This means there are two shared keys, with PRINTER_QA sharing both, and thereby acting as a bridge between INK_QA and SoPEC.
UseExtParmsLicense_key is shared between PRINTER_QA and ADDITIONAL_PRINTER_QA
SoPEC_id_key is shared between SoPEC and PRINTER_QA

All SoPEC has to do is do an authenticated read from ADDITIONAL_PRINTER_QA, pass the data/signature to PRINTER_QA, let PRINTER_QA validate the data/signature, and get PRINTER_QA to produce a similar signature based on the shared SoPEC_id_key. It can do so using a Translate function. SoPEC can then compare PRINTER_QA's signature with its own calculated signature (i.e. implement a Test function in software on SoPEC), and if the signatures match, the data from ADDITIONAL_PRINTER_QA must be valid, and can therefore be trusted. Once the data from ADDITIONAL_PRINTER_QA is known to be trusted, the various operating parameters such as OEM_Id can be checked for validity.

The actual steps of read authentication as performed by SoPEC are:

R_{PRINTER} ← PRINTER_QA.random( )
R_{DONGLE},M_{DONGLE},SIG_{DONGLE} ← DONGLE_QA.read(K1, R_{PRINTER})
R_{SOPEC} ← random( )
R_{PRINTER}, SIG_{PRINTER} ← PRINTER_QA.translate(K2, R_{DONGLE},
M_{DONGLE}, SIG_{DONGLE}, K1, R_{SOPEC})
SIG_{SOPEC} ← HMAC_SHA_1(SoPEC_id_key, M_{DONGLE} | R_{PRINTER} |
R_{SOPEC})
If (SIG_{PRINTER} = SIG_{SOPEC})

// various parms inside M_{DONGLE} (data read from

ADDITIONAL_PRINTER_QA) is valid
Else

// the data read from ADDITIONAL_PRINTER_QA is not valid and

cannot be trusted
EndIf

Dongles Tied to a Given SoPEC

Floating dongles i.e. dongles that can be used on any SoPEC, are described above. Sometimes it is desirable to tie a dongle to a specific SoPEC.

Tying a QA_CHIP to be used only on a specific SoPEC can be easily accomplished by writing the PRINTER_QA's chipId (unique serial number) into an appropriate M₀ field on the ADDITIONAL_PRINTER_QA. The system software can detect the match and function appropriately. If there is no match, the software can ignore the data read from the ADDITIONAL_PRINTER_QA.

Although it is also possible to store the SoPEC_id_key in one of the keys within the dongle, this must be done in an environment where power will not be removed partway through the key update process (if power is removed during the key update there is a possibility that the dongle QA Chip may be rendered unusable, although this can be checked for after the power failure).

OEM Assembly-Line Test

Although an OEM should only be able to sell the licensed operating parameters for a given Print Engine, they must be able to assembly-line test or service/test the Print Engine with a different set of operating parameters e.g. a maximally upgraded Print Engine.

Several different mechanisms can be employed to allow OEMs to test the upgraded capabilities of the Print Engine. At present it is unclear exactly what kind of assembly-line tests would be performed.

The simplest solution is to use an ADDITIONAL_PRINTER_QA. The ADDITIONAL_PRINTER_QA would contain the operating parameters that maximally upgrade the printer as long as the dongle is connected to the SoPEC. The exact connection may be directly electrical (e.g. via the standard QA Chip connections) or may be over the USB connection to the printer test host depending on the nature of the test.

In the testing environment, the ADDITIONAL_PRINTER_QA also requires a numberOfImpressions field inside M₀, which is writeable by K₀. Before the SoPEC prints a page at the higher speed, it decrements the numberOfImpressions counter, performs an authenticated read to ensure the count was decremented, and then prints the page. In this way, the total number of pages that can be printed at high speed is reduced in the event of someone stealing the ADDITIONAL_PRINTER_QA device. It also means that multiple test machines can make use of the same ADDITIONAL_PRINTER_QA.

Use of a PrintEngineLicense id

Manufacturer/owner O/S program code contains the OEM's asymmetric public key to ensure that the subsequent OEM program code is authentic—i.e. from the OEM. However given that SoPEC only contains a single root key, it is theoretically possible for different OEM's applications to be run identically physical Print Engines i.e. printer driver for OEM₁ run on an identically physical Print Engine from OEM₂.

To guard against this, the Manufacturer/owner O/S program code contains a PrintEngineLicense_id code (e.g. 16 bits) that matches the same named value stored as a fixed operating parameter in the PRINTER_QA (i.e. in M₁₊). As with all other operating parameters, the value of PrintEngineLicense_id is stored in PRINTER_QA (and any ADDITIONAL_PRINTER_QA devices) at the same time as the other various PRINTER_QA customizations are being applied, before being shipped to the OEM site.

In this way, the OEMs can be sure of differentiating themselves through software functionality.

Authentication of Ink

The Manufacturer/owner O/S performs ink authentication during prints. Ink usage authentication makes use of counters in SoPEC that keep an accurate record of the exact number of dots printed for each ink.

The ink amount remaining in a given cartridge is stored in that cartridge's INK_QA chip. Other data stored on the INK_QA chip includes ink color, viscosity, Memjet firing pulse profile information, as well as licensing parameters such as OEM_Id, inkType, InkUsageLicense_Id, etc. This information is typically constant, and is therefore likely to be stored in M₁₊ within INK_QA.

Just as the Print Engine operating parameters are validated by means of PRINTER_QA, a given Print Engine license may only be permitted to function with specifically licensed ink. Therefore the software on SoPEC could contain a valid set of ink types, colors, OEM_Ids, InkUsageLicense_Ids etc. for subsequent matching against the data in the INK_QA.

SoPEC must be able to authenticate reads from the INK_QA, both in terms of ink parameters as well as ink remaining.

To authenticate ink a number of steps must be taken:
restrict access to dot counts
authenticate ink usage and ink parameters via INK_QA and PRINTER_QA
broadcast ink dot usage to all SoPECs in a multi-SoPEC system

Restrict Access to Dot Counts

Since the dot counts are accessed via the PHI in the PEP section of SoPEC, access to these registers (and more generally all PEP registers) must be only available from supervisor mode, and not by OEM code (running in user mode). Otherwise it might be possible for OEM program code to clear dot counts before authentication has occurred.

Authenticate Ink Usage and Ink Parameters via INK_QA and PRINTER_QA

The basic problem of authentication of ink remaining and other ink data boils down to the problem that we don't trust INK_QA. Therefore how can a SoPEC know the initial value of ink (or the ink parameters), and how can a SoPEC know that after a write to the INK_QA, the count has been correctly decremented.

Taking the first issue, which is determining the initial ink count or the ink parameters, we need a system whereby a given SoPEC can perform an authenticated read of the data in INK_QA.

We cannot write the SoPEC_id_key to the INK_QA for two reasons:
updating keys is not power-safe (i.e. if power is removed mid-update, the INK_QA could be rendered useless)
the ink cartridge would then not work in another printer since the other printer would not know the old SoPEC_id_key (knowledge of the old key is required in order to change the old key to a new one).

The proposed solution is to let INK_QA have two keys:
K₀=SupplyInkLicense_key. This key is constant for all ink cartridges for a given ink supply agreement between an OEM and a Manufacturer/owner ComCo (this is not the same key as PrintEngineLicense_key which is stored as K₀ in PRINTER_QA). K₀ has write permissions to the ink remaining regions of M₀ on INK_QA.
K₁=UseInkLicense_key. This key is constant for all ink cartridges for a given ink usage agreement between an OEM and a Manufacturer/owner ComCo (this is not the same key as PrintEngineLicense_key which is stored as K₀ in PRINTER_QA). K₁ has no write permissions to anything.

K₀ is used to authenticate the actual upgrades of the amount of ink remaining (e.g. to fill and refill the amount of ink). Upgrades are performed using the standard upgrade protocol, with INK_QA acting as the ChipU, and the external upgrader acting as the ChipS. The fill and refill upgrader (ChipS) also needs to check the appropriate ink licensing parameters such as OEM_Id, InkType and InkUsageLicense_Id for validity.

K₁ is used to allow SoPEC to authenticate reads of the ink remaining and any other ink data. This is accomplished by having the same UseInkLicense_key within PRINTER_QA (e.g. in K₂ or K₃), also with no write permissions.

This means there are two shared keys, with PRINTER_QA sharing both, and thereby acting as a bridge between INK_QA and SoPEC.
UseInkLicense_key is shared between INK_QA and PRINTER_QA
SoPEC_id_key is shared between SoPEC and PRINTER_QA

All SoPEC has to do is do an authenticated read [6] from INK_QA, pass the data/signature to PRINTER_QA, let PRINTER_QA validate the data/signature and get PRINTER_QA to produce a similar signature based on the shared SoPEC_id_key (i.e. the Translate function). SoPEC can then compare PRINTER_QA's signature with its own calculated signature (i.e. implement a Test function in software on the SoPEC), and if the signatures match, the data from INK_QA must be valid, and can therefore be trusted.

Once the data from INK_QA is known to be trusted, the amount of ink remaining can be checked, and the other ink licensing parameters such as OEM_Id, InkType, InkUsageLicense_Id can be checked for validity.

The actual steps of read authentication as performed by SoPEC are:

```
R_{PRINTER} ← PRINTER_QA.random( )
R_{INK}, M_{INK}, SIG_{INK} ← INK_QA.read(K1, R_{PRINTER}) //
read  with  key1:
UseInkLicense_key
R_{SOPEC} ← random( )
R_{PRINTER}, SIG_{PRINTER} ← PRINTER_QA.translate(K2, R_{INK},
M_{INK}, SIG_{INK}, K1, R_{SOPEC})
SIG_{SOPEC} ← HMAC_SHA_1(SoPEC_id_key,
M_{INK} | R_{PRINTER} | R_{SOPEC})
If (SIG_{PRINTER} = SIG_{SOPEC})
  // M_{INK} (data read from INK_QA) is valid
  // M_{INK} could be ink parameters, such as InkUsageLicense_Id, or ink
remaining
  If (M_{INK}.inkRemaining = expectedInkRemaining)
    // all is ok
  Else
    // the ink value is not what we wrote, so don't print anything anymore
  EndIf
Else
  // the data read from INK_QA is not valid and cannot be trusted
EndIf
```

Strictly speaking, we don't need a nonce (R_{SOPEC}) all the time because M_{A} (containing the ink remaining) should be decrementing between authentications. However we do need one to retrieve the initial amount of ink and the other ink parameters (at power up). This is why taking a random number from the WatchDogTimer at the receipt of the first page is acceptable.

In summary, the SoPEC performs the non-authenticated write of ink remaining to the INK_QA chip, and then performs an authenticated read of the data via the PRINTER_QA as per the pseudocode above. If the value is authenticated, and the INK_QA ink-remaining value matches the expected value, the count was correctly decremented and the printing can continue.

Broadcast Ink Dot Usage to all SoPECs in a Multi-SoPEC System

In a multi-SoPEC system, each SoPEC attached to a printhead must broadcast its ink usage to all the SoPECs. In this way, each SoPEC will have its own version of the expected ink usage.

In the case of a man-in-the-middle attack, at worst the count in a given SoPEC is only its own count (i.e. all broadcasts are turned into 0 ink usage by the man-in-the-middle). We would also require the broadcast amount to be treated as an unsigned integer to prevent negative amounts from being substituted.

A single SoPEC performs the update of ink remaining to the INK_QA chip, and then all SoPECs perform an authenticated read of the data via the appropriate PRINTER_QA (the PRINTER_QA that contains their matching SoPEC_id_key—remember that multiple SoPEC_id_keys can be stored in a single PRINTER_QA). If the value is authenticated, and the INK_QA value matches the expected value, the count was correctly decremented and the printing can continue.

If any of the broadcasts are not received, or have been tampered with, the updated ink counts will not match. The only case this does not cater for is if each SoPEC is tricked (via a USB2 inter-SoPEC-comms man-in-the-middle attack) into a total that is the same, yet not the true total. Apart from the fact that this is not viable for general pages, at worst this is the maximum amount of ink printed by a single SoPEC. We don't care about protecting against this case.

Since a typical maximum is 4 printing SoPECs, it requires at most 4 authenticated reads. This should be completed within 0.5 seconds, well within the 1-2 seconds/page print time.

Example Hierarchy

Adding an extra bootloader step, we can break up the contents of program space into logical sections, as shown in Table 2. Note that the ComCo does not provide any program code, merely operating parameters that are used by the O/S.

TABLE 2
Sections of Program Space

| section | contents | verifies |
|---|---|---|
| 0 | boot loader 0 | section 1 via boot0key |
| (ROM) | SHA-1 function | |
| | asymmetric decrypt | |
| | function boot0key | |
| 1 | boot loader 1 | section 2 via |
| | SoPEC_OS_public_key | SoPEC_OS_public_key |
| 2 | Manufacturer/owner O/S | section 3 via ComCo_public_key |
| | program code | section 4 via OEM_public_key |
| | function to generate | (supplied in section 3) |
| | SoPEC_id_key from | PRINTER_QA data, which |
| | SoPEC_id | includes the |
| | Basic Print Engine | PrintEngineLicense_id, |
| | ComCo_public_key | Manufacturer/owner operating |
| | | parameters, and OEM operating |
| | | parameters (all authenticated via |
| | | SoPEC_id_key) |
| 3 | ComCo license agreement | Is used by section 2 to verify |
| | operating parameter ranges, | section 4 and range of |
| | including | parameters as found in |
| | PrintEngineLicense_id | PRINTER_QA |
| | (gets loaded into supervisor | |
| | mode section of memory) | |
| | OEM_public_key (gets | |
| | loaded into supervisor | |
| | mode section of memory) | |
| | Any ComCo written user- | |
| | mode program code (gets | |
| | loaded into mode mode | |
| | section of memory) | |
| 4 | OEM specific program | OEM operating parameters via |
| | code | calls to Manufacturer/owner O/S |
| | | code |

The verification procedures will be required each time the CPU is woken up, since the RAM is not preserved.

What if the CPU is not fast enough?

Typically, every time the CPU is woken up to print a document it needs to perform:
SHA-1 on all program code and program data
4 sets of asymmetric decryption to load the program code and data
1 HMAC-SHA1 generation per 512-bits of Manufacturer/owner and OEM printer and ink operating parameters

Although the SHA-1 and HMAC process will be fast enough on the embedded CPU (the program code will be executing from ROM), it may be that the asymmetric decryption will be slow. And this becomes more likely with each extra level of authentication. If this is the case (as is likely), hardware acceleration is required.

A cheap form of hardware acceleration takes advantage of the fact that in most cases the same program is loaded each time, with the first time likely to be at power-up. The hardware acceleration is simply data storage for the authorizedDigest which means that the boot procedure now is:

```
slowCPU_bootloader0(data, sig)
  localDigest ← SHA-1(data)
  If (localDigest = previouslyStoredAuthorizedDigest)
  jump to program code at data-start address// will never return
  Else
  authorizedDigest ← decrypt(sig, boot0key)
expectedDigest  =  0x00|0x01|0xFF..0xFF|
    0x003021300906052B0E03021A05000414 |localDigest)
If (authorizedDigest == expectedDigest)
previouslyStoredAuthorizedDigest ← localDigest
  jump to program code at data-start address// will never return
Else
// program code is unauthorized
EndIf
```

This procedure means that a reboot of the same authorized program code will only require SHA-1 processing. At power-up, or if new program code is loaded (e.g. an upgrade of a driver over the internet), then the full authorization via asymmetric decryption takes place. This is because the stored digest will not match at power-up and whenever a new program is loaded.

The question is how much preserved space is required.

Each digest requires 160 bits (20 bytes), and this is constant regardless of the asymmetric encryption scheme or the key length. While it is possible to reduce this number of bits, thereby sacrificing security, the cost is small enough to warrant keeping the full digest.

However each level of boot loader requires its own digest to be preserved. This gives a maximum of 20 bytes per loader. Digests for operating parameters and ink levels may also be preserved in the same way, although these authentications should be fast enough not to require cached storage.

Assuming SoPEC provides for 12 digests (to be generous), this is a total of 240 bytes. These 240 bytes could easily be stored as 60×32-bit registers, or probably more conveniently as a small amount of RAM (eg 0.25-1 Kbyte). Providing something like 1 Kbyte of RAM has the advantage of allowing the CPU to store other useful data, although this is not a requirement.

In general, it is useful for the boot ROM to know whether it is being started up due to power-on reset, GPIO activity, or activity on the USB2. In the former case, it can ignore the previously stored values (either 0 for registers or garbage for RAM). In the latter cases, it can use the previously stored values. Even without this, a startup value of 0 (or garbage) means the digest won't match and therefore the authentication will occur implictly.

Setting up QA Chip Keys

In use, each INK_QA chip needs the following keys:
K₀=SupplyInkLicense_key
K₁=UseInkLicense_key

Each PRINTER_QA chip tied to a specific SoPEC requires the following keys:
K₀=PrintEngineLicense_key
K₁=SoPEC_id_key
K₂=UseExtParmsLicense_key
K₃=UseInkLicense_key

Note that there may be more than one K₁ depending on the number of PRINTER_QA chips and SoPECs in a system. These keys need to be appropriately set up in the QA Chips before they will function correctly together.

Original QA Chips as Received by a ComCo

When original QA Chips are shipped from QACo to a specific ComCo their keys are as follows:
K₀=QACo_ComCo_Key0
K₁=QACo_ComCo_Key1
K₂=QACo_ComCo_Key2
K₃=QACo_ComCo_Key3

All 4 keys are only known to QACo. Note that these keys are different for each QA Chip.

Steps at the ComCo

The ComCo is responsible for making Print Engines out of Memjet printheads, QA Chips, PECs or SoPECs, PCBs etc.

In addition, the ComCo must customize the INK_QA chips and PRINTER_QA chip on-board the print engine before shipping to the OEM.

There are two stages:
replacing the keys in QA Chips with specific keys for the application (i.e. INK_QA and PRINTER_QA)
setting operating parameters as per the license with the OEM

Replacing Keys

The ComCo issues QID hardware by QACo that allows programming of the various keys (except for K₁) in a given QA Chip to the final values, following the standard ChipF/ChipP replace key (indirect version) protocol. The indirect version of the protocol allows each QACo_ComCo_Key to be different for each SoPEC.

In the case of programming of PRINTER_QA's K₁ to be SoPEC_id_key, there is the additional step of transferring an asymmetrically encrypted SoPEC_id_key (by the public-key) along with the nonce (R_{P}) used in the replace key protocol to the device that is functioning as a ChipF. The ChipF must decrypt the SoPEC_id_key so it can generate the standard replace key message for PRINTER_QA (functioning as a ChipP in the ChipF/ChipP protocol). The asymmetric key pair held in the ChipF equivalent should be unique to a ComCo (but still known only by QACo) to prevent damage in the case of a compromise.

Note that the various keys installed in the QA Chips (both INK_QA and PRINTER_QA) are only known to the QACo. The OEM only uses QIDs and QACo supplied ChipFs. The replace key protocol allows the programming to occur without compromising the old or new key.

Setting Operating Parameters

There are two sets of operating parameters stored in PRINTER_QA and INK_QA:
fixed
upgradable

The fixed operating parameters can be written to by means of a non-authenticated writes to M₁₊ via a QID, and permission bits set such that they are ReadOnly.

The upgradable operating parameters can only be written to after the QA Chips have been programmed with the correct keys. Once they contain the correct keys they can be programmed with appropriate operating parameters by means of a QID and an appropriate ChipS (containing matching keys).

Authentication Protocols

The following describes authentication protocols for general authentication applications, but with specific reference to the QA Chip.

The intention is to show the broad form of possible protocols for use in different authentication situations, and can be used as a reference when subsequently defining an implementation specification for a particular application. As mentioned earlier, although the protocols are described in relation to a printing environment, many of them have wider application such as, but not limited to, those described at the end of this specification.

Basic Protocols

This protocol set is a restricted form of a more general case of a multiple key single memory vector protocol. It is a restricted form in that the memory vector M has been optimized for Flash memory utilization:
M is broken into multiple memory vectors (semi-fixed and variable components) for the purposes of optimizing flash memory utilization. Typically M contains some parts that are fixed at some stage of the manufacturing process (eg a batch number, serial number etc.), and once set, are not ever updated. This information does not contain the amount of consumable remaining, and therefore is not read or written to with any great frequency.
We therefore define M₀ to be the M that contains the frequently updated sections, and the remaining Ms to be rarely written to. Authenticated writes only write to M₀, and non-authenticated writes can be directed to a specific Mₙ. This reduces the size of permissions that are stored in the QA Chip (since key-based writes are not required for Ms other than M₀). It also means that M₀ and the remaining Ms can be manipulated in different ways, thereby increasing flash memory longevity.

Each QA Chip contains the following values:
N The maximum number of keys known to the chip.
T The number of vectors M is broken into.
K_{N} Array of N secret keys used for calculating F_{KN}[X] where Kₙ is the nth element of the array.
R Current random number used to ensure time varying messages. Each chip instance must be seeded with a different initial value. Changes for each signature generation.
M_{T} Array of T memory vectors. Only M₀ can be written to with an authorized write, while all Ms can be written to in an unauthorized write. Writes to M₀ are optimized for Flash usage, while updates to any other M₁₊ are expensive with regards to Flash utilization, and are expected to be only performed once per section of Mₙ. M₁ contains T, N and f in ReadOnly form so users of the chip can know these two values.
P_{T+N} T+N element array of access permissions for each part of M. Entries n={0 . . . T−1} hold access permissions for non-authenticated writes to Mₙ (no key required). Entries n={T to T+N−1}hold access permissions for authenticated writes to M₀ for Kₙ. Permission choices for each part of M are Read Only, Read/Write, and Decrement Only.
C 3 constants used for generating signatures. C₁, C₂, and C₃ are constants that pad out a sub-message to a hashing boundary, and all 3 must be different.

Each QA Chip contains the following private function:
S_{Kn}[N,X] Internal function only. Returns S_{Kn}[X], the result of applying a digital signature function S to X based upon the appropriate key Kₙ. The digital signature must be long enough to counter the chances of someone generating a random signature. The length depends on the signature scheme chosen, although the scheme chosen for the QA Chip is HMAC-SHA1, and therefore the length of the signature is 160 bits.

Additional functions are required in certain QA Chips, but these are described as required.

Read Protocols

The set of read protocols describe the means by which a System reads a specific data vector Mₜ from a QA Chip referred to as ChipR.

We assume that the communications link to ChipR (and therefore ChipR itself) is not trusted. If it were trusted, the System could simply read the data and there is no issue. Since the communications link to ChipR is not trusted and ChipR cannot be trusted, the System needs a way of authenticating the data as actually being from a real ChipR. Since the read protocol must be capable of being implemented in physical QA Chips, we cannot use asymmetric cryptography (for example the ChipR signs the data with a private key, and System validates the signature using a public key).

This document describes two read protocols:
direct validation of reads
indirect validation of reads.

Direct Validation of Reads

In a direct validation read protocol we require two QA Chips: ChipR is the QA Chip being read, and ChipT is the QA Chip we entrust to tell us whether or not the data read from ChipR is trustworthy.

The basic idea is that system asks ChipR for data, and ChipR responds with the data and a signature based on a secret key. System then asks ChipT whether the signature supplied by ChipR is correct. If ChipT responds that it is, then System can trust that data just read from ChipR. Every time data is read from ChipR, the validation procedure must be carried out.

Direct validation requires the System to trust the communication line to ChipT. This could be because ChipT is in physical proximity to the System, and both System and ChipT are in a trusted (e.g. Silverbrook secure) environment. However, since we need to validate the read, ChipR by definition must be in a non-trusted environment.

Each QA Chip protects its signature generation or verification mechanism by the use of a nonce.

The protocol requires the following publicly available functions in ChipT:
Random[ ] Returns R (does not advance R).
Test[n, X, Y, Z] Advances R and returns 1 if S_{Kn}[R|X|C₁|Y]=Z. Otherwise returns 0. The time taken to calculate and compare signatures must be independent of data content.

The protocol requires the following publicly available functions in ChipR:
Read[n, t, X] Advances R, and returns R, Mₜ, S_{Kn}[X|R|C₁|Mₜ]. The time taken to calculate the signature must not be based on the contents of X, R, Mₜ, or K. If t is invalid, the function assumes t=0.

To read ChipR's memory Mₜ in a validated way, System performs the following tasks:
a. System calls ChipT's Random function;
b. ChipT returns R_{T} to System;
c. System calls ChipR's Read function, passing in some key number n1, the desired data vector number t, and R_{T} (from b);
d. ChipR updates R_{R}, then calculates and returns R_{R}, M_{Rt}, S_{Kn1}[R_{T}|R_{R}|C₁|M_{Rt];}
e. System calls ChipT's Test function, passing in the key to use for signature verification n2, and the results from d (i.e. R_{R}, M_{Rt}, S_{Kn1}[R_{T}|R_{R}|C₁|M_{Rt}]);
f. System checks response from ChipT. If the response is 1, then the Mₜ read from ChipR is considered to be valid. If 0, then the Mₜ read from ChipR is considered to be invalid.

The choice of n1 and n2 must be such that ChipR's Kₙ₁=ChipT's Kₙ₂.

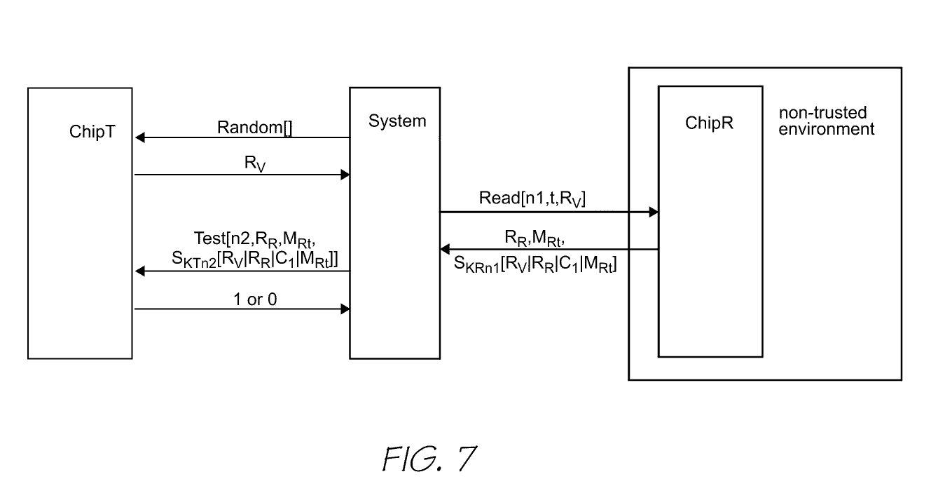

The data flow for this read protocol is shown in FIG. 7.

From the System's perspective, the protocol would take on a form like the following pseudocode:

R_{T} ← ChipT.Random( )
R_{R}, M_{R}, SIG_{R} ← ChipR.Read(keyNumOnChipR,desiredM, R_{T})
ok ← ChipT.Test(keyNumOnChipT, R_{R}, M_{R}, SIG_{R})
If (ok = 1)
// M_{R} is to be trusted
Else
// M_{R} is not to be trusted
EndIf

With regards to security, if an attacker finds out ChipR's Kₙ₁, they can replace the ChipR by a fake ChipR because they can create signatures. Likewise, if an attacker finds out ChipT's Kₙ₂, they can replace the ChipR by a fake ChipR because ChipR's Kₙ₁=ChipT's Kₙ₂. Moreover, they can use the ChipRs on any system that shares the same key.

The only way of restricting exposure due to key reveals is to restrict the number of systems that match ChipR and ChipT. i.e. vary the key as much as possible. The degree to which this can be done will depend on the application. In the case of a PRINTER_QA acting as a ChipT, and an INK_QA acting as a ChipR, the same key must be used on all systems where the particular INK_QA data must be validated.

In all cases, ChipR must contain sufficient information to produce a signature. Knowing (or finding out) this information, whatever form it is in, allows clone ChipRs to be built.

Indirect Validation of Reads

In a direct validation protocol, the System validates the correctness of data read from ChipR by means of a trusted chip ChipT. This is possible because ChipR and ChipT share some secret information.

However, it is possible to extend trust via indirect validation. This is required when we trust ChipT, but ChipT doesn't know how to validate data from ChipR. Instead, ChipT knows how to validate data from ChipI (some intermediate chip) which in turn knows how to validate data from either another ChipI (and so on up a chain) or ChipR. Thus we have a chain of validation.

The means of validation chains is translation of signatures. ChipIₙ translates signatures from higher up the chain (either ChipIₙ₋₁ or from ChipR at the start of the chain) into signatures capable of being passed to the next stage in the chain (either ChipIₙ₊₁ or to ChipT at the end of the chain). A given ChipI can only translate signatures if it knows the key of the previous stage in the chain as well as the key of the next stage in the chain.

The protocol requires the following publicly available functions in ChipI:
Random[ ] Returns R (does not advance R).
Translate[n1, X, Y, Z, n2,A] Returns 1, S_{Kn2}[A|R|C₁|Y] and advances R if Z=S_{Kn1}[R|X|C₁|Y]. Otherwise returns 0, 0. The time taken to calculate and compare signatures must be independent of data content.

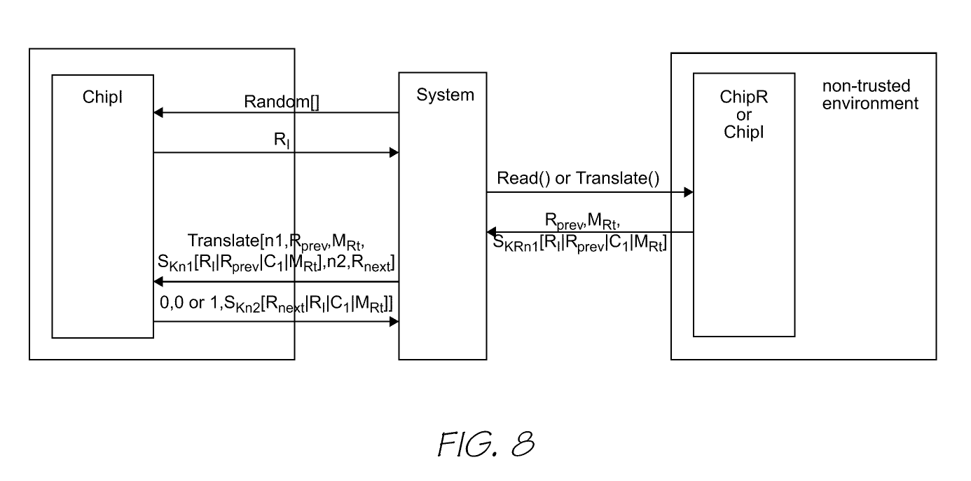

The data flow for this signature translation protocol is shown in FIG. 8:

Note that Rₚᵣₑᵥ is eventually R_{R}, and Rₙₑₓₜ is eventually R_{T}. In the multiple ChipI case, Rₚᵣₑᵥ is the R_{I} of ChipIₙ₋₁ and Rₙₑₓₜ is R_{I} of ChipIₙ₊₁. The Rₚᵣₑᵥ of the first ChipI in the chain is R_{R}, and the Rₙₑₓₜ of the last ChipI in the chain is R_{T}.

Assuming at least 1 ChipT, the System would need to perform the following tasks in order to read ChipR's memory Mₜ in an indirectly validated way:
a. System calls ChipIₙ's Random function;
b. ChipI₀ returns R_{I0} to System;
c. System calls ChipR's Read function, passing in some key number n0, the desired data vector number t, and R_{I0} (from b);
d. ChipR updates R_{R}, then calculates and returns R_{R}, M_{Rt}, S_{Kn0}[R_{In}|R_{R}|C₁|M_{Rt}];
e. System assigns R_{R} to Rₚᵣₑᵥ and S_{Kn0}[R_{In}|R_{R}|C₁|M_{Rt}] to SIGₚᵣₑᵥ
f. System calls the next-chip-in-the-chain's Random function (either ChipIₙ₊₁ or ChipT)
g. The next-chip-in-the-chain will return Rₙₑₓₜ to System
h. System calls ChipIₙ's Translate function, passing in n1ₙ (translation input key number), Rₚᵣₑᵥ, M_{Rt}, SIGₚᵣₑᵥ), n2ₙ (translation output key number) and the results from g (Rₙₑₓₜ);
i. ChipI returns testResult and SIG_{I} to System
j. If testResult=0, then the validation has failed, and the Mₜ read from ChipR is considered to be invalid. Exit with failure.
k. If the next chip in the chain is a ChipI, assign SIG_{I} to SIGₚᵣₑᵥ and go to step f
l. System calls ChipT's Test function, passing in nₜ, Rₚᵣₑᵥ, M_{Rt}, and SIGₚᵣₑᵥ;
m. System calls System checks response from ChipT. If the response is 1, then the Mₜ read from ChipR is considered to be valid. If 0, then the Mₜ read from ChipR is considered to be invalid.

For the Translate function to work, ChipIₙ and ChipIₙ₊₁ must share a key. The choice of n1 and n2 in the protocol described must be such that ChipIₙ's Kₙ₂=ChipIₙ₊₁'s Kₙ₁. Note that Translate is essentially a “Test plus resign” function. From an implementation point of view the first part of Translate is identical to Test.

Note that the use of ChipIs and the translate function merely allows signatures to be transformed. At the end of the translation chain (if present) will be a ChipT requiring the use of a Test function. There can be any number of ChipIs in the chain to ChipT as long as the Translate function is used to map signatures between ChipIₙ and ChipIₙ₊₁ and so on until arrival at the final destination (ChipT).

From the System's perspective, a read protocol using at least 1 ChipI would take on a form like the following pseudocode:

```
Rₙₑₓₜ ← ChipI[0].Random( )
Rₚᵣₑᵥ, M_{R}, SIGₚᵣₑᵥ ← ChipR.Read(keyNumOnChipR,desiredM,
Rₙₑₓₜ)
ok = 1
i = 0
while ((i < iMax) AND ok)
For i ← 0 to iMax
If (i = iMax)
  Rₙₑₓₜ ← ChipT.Random( )
Else
  Rₙₑₓₜ ← ChipI[i+1].Random( )
EndIf
ok, SIGₚᵣₑᵥ ← ChipI[i].Translate(iKey[i], Rₚᵣₑᵥ, M_{R}, SIGₚᵣₑᵥ, oKey[i],
Rₙₑₓₜ)
Rₚᵣₑᵥ = Rₙₑₓₜ
If (ok = 0)
  // M_{R} is not to be trusted
EndIf
EndFor
ok ← ChipT.Test(keyNumOnChipT, Rₚᵣₑᵥ, M_{R}, SIGₚᵣₑᵥ)
If (ok = 1)
// M_{R} is to be trusted
Else
// M_{R} is not to be trusted
EndIf
```

Additional Comments on Reads

Certain implementations will exist where the operating parameters are stored in QA Chips. In this case, the system must read the data from the QA Chip using an appropriate read protocol.

If the connection is trusted (e.g. to a virtual QA Chip in software), a generic Read is sufficient. If the connection is not trusted, it is ideal that the System have a trusted ChipT in the form of software (if possible) or hardware (e.g. a QA Chip on board the same silicon package as the microcontroller and firmware). Whether implemented in software or hardware, the QA Chip should contain an appropriate key that is unique per print engine. Such a key setup would allow reads of print engine parameters and also allow indirect reads of consumables (from a consumable QA Chip).

If the ChipT is physically separate from System (e.g. ChipT is on a board connected to System) System must also occasionally (based on system clock for example) call ChipT's Test function with bad data, expecting a 0 response. This is to reduce the possibility of someone inserting a fake ChipT into the system that always returns 1 for the Test function.

Upgrade Protocols

This set of protocols describe the means by which a System upgrades a specific data vector Mₜ within a QA Chip (ChipU). The data vector may contain information about the functioning of the device (e.g. the current maximum operating speed) or the amount of a consumable remaining.

The updating of Mₜ in ChipU falls into two categories:
non-authenticated writes, where anyone is able to update the data vector
authenticated writes, where only authorized entities are able to upgrades data vectors

Non-Authenticated Writes

This is the most frequent type of write, and takes place between the System/consumable during normal everyday operation for M₀, and during the manufacturing process for M₁₊.

In this kind of write, the System wants to change Mₜ within ChipU subject to P. For example, the System could be decrementing the amount of consumable remaining. Although System does not need to know and of the Ks or even have access to a trusted chip to perform the write, the System must follow a non-authenticated write by an authenticated read if it needs to know that the write was successful.

The protocol requires ChipU to contain the following publicly available function:
Write[t, X] Writes X over those parts of Mₜ subject to Pₜ and the existing value for M. To authenticate a write of M_{new} to ChipA's memory M:
a. System calls ChipU's Write function, passing in M_{new};
b. The authentication procedure for a Read is carried out;
c. If the read succeeds in such a way that M_{new}=M returned in b, the write succeeded. If not, it failed.

Note that if these parameters are transmitted over an error-prone communications line (as opposed to internally or using an additional error-free transport layer), then an additional checksum would be required to prevent the wrong M from being updated or to prevent the correct M from being updated to the wrong value. For example, SHA-1[t,X] should be additionally transferred across the communications line and checked (either by a wrapper function around Write or in a variant of Write that takes a hash as an extra parameter).

This is the most frequent type of write, and takes place between the System/consumable during normal everyday operation for M₀, and during the manufacturing process for M₁₊.

Authenticated Writes

In the QA Chip protocols, M₀ is defined to be the only data vector that can be upgraded in an authenticated way. This decision was made primarily to simplify flash management, although it also helps to reduce the permissions storage requirements.

In this kind of write, System wants to change Chip U's M₀ in an authorized way, without being subject to the permissions that apply during normal operation. For example, a consumable may be at a refilling station and the normally Decrement Only section of M₀ should be updated to include the new valid consumable. In this case, the chip whose M₀ is being updated must authenticate the writes being generated by the external System and in addition, apply the appropriate permission for the key to ensure that only the correct parts of M₀ are updated. Having a different permission for each key is required as when multiple keys are involved, all keys should not necessarily be given open access to M₀. For example, suppose M₀ contains printer speed and a counter of money available for franking. A ChipS that updates printer speed should not be capable of updating the amount of money. Since P_{0 . . . T-1} is used for non-authenticated writes, each Kₙ has a corresponding permission P_{T+n} that determines what can be updated in an authenticated write.

The basic principle of the authenticated write (or upgrade) protocol is that the new value for the Mₜ must be signed before ChipU accepts it. The QA Chip responsible for generating the signature (ChipS) must first validate that the ChipU is valid by reading the old value for Mₜ. Once the old value is seen as valid, a new value can be signed by ChipS and the resultant data plus signature passed to ChipU. Note that both chips distrust each other.

There are two forms of authenticated writes. The first form is when both ChipU and ChipS directly store the same key. The second is when both ChipU and ChipS store different versions of the key and a transforming procedure is used on the stored key to generate the required key—i.e. the key is indirectly stored. The second form is slightly more complicated, and only has value when the ChipS is not readily available to an attacker.

Direct Authenticated Writes

The direct form of the authenticated write protocol is used when the ChipS and ChipU are equally available to an attacker. For example, suppose that ChipU contains a printer's operating speed. Suppose that the speed can be increased by purchasing a ChipS and inserting it into the printer system. In this case, the ChipS and ChipU are equally available to an attacker. This is different from upgrading the printer over the internet where the effective ChipS is in a remote location, and thereby not as readily available to an attacker.

The direct authenticated write protocol requires ChipU to contain the following publicly available functions:
Read[n, t, X] Advances R, and returns R, Mₜ, S_{Kn}[X|R|C₁|Mₜ]. The time taken to calculate the signature must not be based on the contents of X, R, Mₜ, or K.
WriteA[n, X, Y, Z] Advances R, replaces M₀ by Y subject to P_{T+n}, and returns 1 only if S_{Kn}[R|X|C₁|Y]=Z. Otherwise returns 0. The time taken to calculate and compare signatures must be independent of data content. This function is identical to ChipT's Test function except that it additionally writes Y subject to P_{T+n} to its M when the signature matches.

Authenticated writes require that the System has access to a ChipS that is capable of generating appropriate signatures.

In its basic form, ChipS requires the following variables and function:
SignM[n,V,W,X,Y,Z] Advances R, and returns R, S_{Kn}[W|R|C₁|Z] only if Y=S_{Kn}[V|W|C₁|X]. Otherwise returns all 0s. The time taken to calculate and compare signatures must be independent of data content.

To update ChipU's M vector:
a. System calls ChipU's Read function, passing in n1, 0 (desired vector number) and 0 (the random value, but is a don't-care value) as the input parameters;
b. ChipU produces R_{U}, M_{U0}, S_{Kn1}[0|R_{U}|C₁|M_{U0}] and returns these to System;
c. System calls ChipS's SignM function, passing in n2 (the key to be used in ChipS), 0 (the random value as used in a), R_{U}, M_{U0}, S_{Kn1}[0|R_{U}|C₁|M_{U0}], and M_{D} (the desired vector to be written to ChipU);
d. ChipS produces R_{S} and S_{Kn2}[R_{U}|R_{S}|C₁|M_{D}] if the inputs were valid, and 0 for all outputs if the inputs were not valid.
e. If values returned in d are non zero, then ChipU is considered authentic. System can then call ChipU's WriteA function with these values from d.
f. ChipU should return a 1 to indicate success. A 0 should only be returned if the data generated by ChipS is incorrect (e.g. a transmission error).

The choice of n1 and n2 must be such that ChipU's Kₙ₁ =ChipS's Kₙ₂.

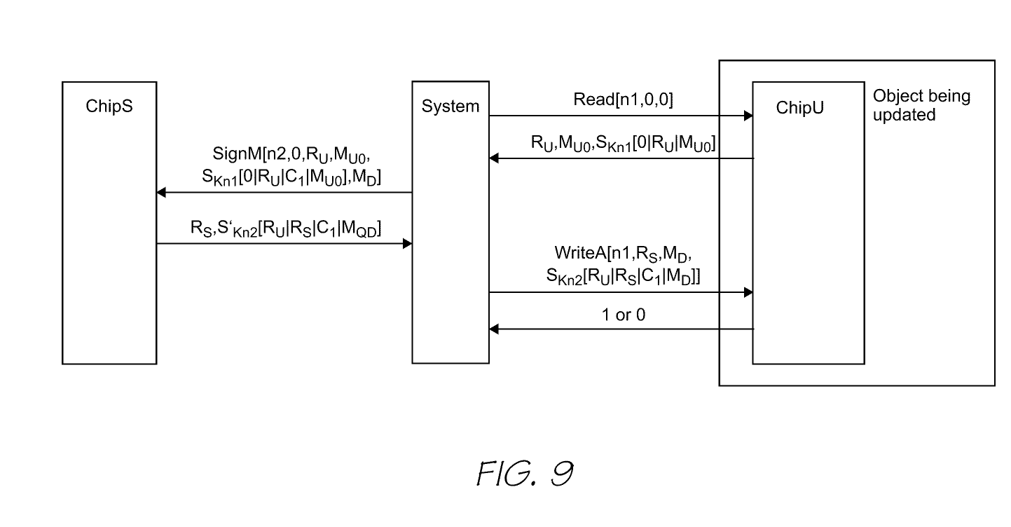

The data flow for authenticated writes is shown in FIG. 9.

Note that this protocol allows ChipS to generate a signature for any desired memory vector MD, and therefore a stolen ChipS has the ability to effectively render the particular keys for those parts of M₀ in ChipU irrelevant.

It is therefore not recommended that the basic form of ChipS be ever implemented except in specifically controlled circumstances.

It is much more secure to limit the powers of ChipS. The following list covers some of the variants of limiting the power of ChipS:
a. the ability to upgrade a limited number of times
b. the ability to upgrade based on a credit value—i.e. the upgrade amount is decremented from the local value, and effectively transferred to the upgraded device
c. the ability to upgrade to a fixed value or from a limited list
d. the ability to upgrade to any value
e. the ability to only upgrade certain data fields within M

In many of these variants, the ability to refresh the ChipS in some way (e.g. with a new count or credit value) would be a useful feature.

In certain cases, the variant is in ChipS, while ChipU remains the same. It may also be desirable to create a ChipU variant, for example only allowing ChipU to only be upgraded a specific number of times.

Variant Example

This section details the variant for the ability to upgrade a memory vector to any value a specific number of times, but the upgrade is only allowed to affect certain fields within the memory vector i.e. a combination of (a), (d), and (e) above.

In this example, ChipS requires the following variables and function:
CountRemaining Part of ChipS's M₀ that contains the number of signatures that ChipS is allowed to generate. Decrements with each successful call to SignM and Sign P. Permissions in ChipS's P_{0 . . . T-1} for this part of M₀ needs to be ReadOnly once ChipS has been setup. Therefore CountRemaining can only be updated by another ChipS that will perform updates to that part of M₀ (assuming ChipS's Ps allows that part of M₀ to be updated).
Q Part of M that contains the write permissions for updating ChipU's M. By adding Q to ChipS we allow different ChipSs that can update different parts of M_{U}. Permissions in ChipS's P_{0 . . . T-1} for this part of M needs to be ReadOnly once ChipS has been setup. Therefore Q can only be updated by another ChipS that will perform updates to that part of M.
SignM[n,V,W,X,Y,Z] Advances R, decrements CountRemaining and returns R, Z_{QX} (Z applied to X with permissions Q), S_{Kn}[W|R|C₁|Z_{QX}] only if Y=S_{Kn}[V|W|C₁|X] and CountRemaining>0. Otherwise returns all 0s. The time taken to calculate and compare signatures must be independent of data content.

To update ChipU's M vector:
a. System calls ChipU's Read function, passing in n1, 0 (desired vector number) and 0 (the random value, but is a don't-care value) as the input parameters;
b. ChipU produces R_{U}, M_{UO}, S_{Kn1}[0|R_{U}|C₁|M_{U0}] and returns these to System;
c. System calls ChipS's SignM function, passing in n2 (the key to be used in ChipS), 0 (as used in a), R_{U}, M_{U0}, S_{Kn1}[0|R_{U}|C₁|M_{U0}], and M_{D} (the desired vector to be written to ChipU);
d. ChipS produces R_{S}, M_{QD} (processed by running M_{D} against M_{U0} using Q) and S_{Kn2}[R_{U}|R_{S}|C₁|M_{QD}] if the inputs were valid, and 0 for all outputs if the inputs were not valid.
e. If values returned in d are non zero, then ChipU is considered authentic. System can then call ChipU's WriteA function with these values from d.
f. ChipU should return a 1 to indicate success. A 0 should only be returned if the data generated by ChipS is incorrect (e.g. a transmission error).

The choice of n1 and n2 must be such that ChipU's Kₙ₁=ChipS's Kₙ₂.

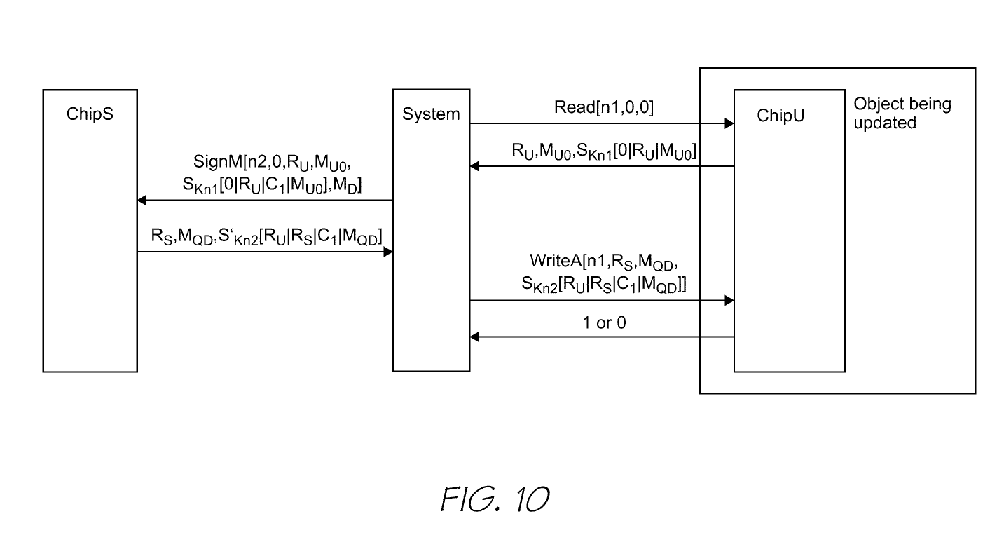

The data flow for this variant of authenticated writes is shown in FIG. 10.

Note that Q in ChipS is part of ChipS's M. This allows a user to set up ChipS with a permission set for upgrades. This should be done to ChipS and that part of M designated by P_{0 . . . T-1} set to ReadOnly before ChipS is programmed with K_{U}. If K_{S} is programmed with K_{U} first, there is a risk of someone obtaining a half-setup ChipS and changing all of M_{U} instead of only the sections specified by Q.

In addition, CountRemaining in ChipS needs to be setup (including making it ReadOnly in P_{S}) before ChipS is programmed with K_{U}. ChipS should therefore be programmed to only perform a limited number of SignM operations (thereby limiting compromise exposure if a ChipS is stolen). Thus ChipS would itself need to be upgraded with a new CountRemaining every so often.

Indirect Authenticated Writes

This section describes an alternative authenticated write protocol when ChipU is more readily available to an attacker and ChipS is less available to an attacker. We can store different keys on ChipU and ChipS, and implement a mapping between them in such a way that if the attacker is able to obtain a key from a given ChipU, they cannot upgrade all ChipUs.

In the general case, this is accomplished by storing key K_{S} on ChipS, and K_{U} and f on ChipU. The relationship is f(K_{S})=K_{U} such that knowledge of K_{U} and f does not make it easy to determine K_{S}. This implies that a one-way function is desirable for f.

In the QA Chip domain, we define f as a number (e.g. 32-bits) such that SHA1(K_{S}|f)=K_{U}. The value of f (random between chips) can be stored in a known location within M₁ as a constant for the life of the QA Chip. It is possible to use the same f for multiple relationships if desired, since f is public and the protection lies in the fact that f varies between QA Chips (preferably in a non-predictable way).

The indirect protocol is the same as the direct protocol with the exception that f is additionally passed in to the SignM function so that ChipS is able to generate the correct key. The System obtains f by performing a Read of M₁. Note that all other functions, including the WriteA function in ChipU, are identical to their direct authentication counterparts.
SignM[f,n,V,W,X,Y,Z] Advances R, and returns R, S_{f(Kn)}[W|R|C₁|Z] only if Y=S_{f(Kn)}[V|W|C₁|X] and CountRemaining>0. Otherwise returns all 0s. The time taken to calculate and compare signatures must be independent of data content.

Before reading ChipU's memory M₀ (the pre-upgrade value), the System must extract f from ChipU by performing the following tasks:
a. System calls ChipU's Read function, passing in (dontCare, 1, dontCare)
b. ChipU returns M₁, from which System can extract f_{U}
c. System stores f_{U} for future use

To update ChipU's M vector, the protocol is identical to that described in the basic authenticated write protocol with the exception of steps c and d:
c. System calls ChipS's SignM function, passing in f_{U}, n2 (the key to be used in ChipS), 0 (as used in a), R_{U}, M_{U0}, S_{Kn1}[0|R_{U}|C₁|M_{U0}], and M_{D} (the desired vector to be written to ChipU);
d. ChipS produces R_{S} and S_{fU(Kn2)}[R_{U}|R_{S}|C₁|M_{D}] if the inputs were valid, and 0 for all outputs if the inputs were not valid.

In addition, the choice of n1 and n2 must be such that ChipU's Kₙ₁=ChipS's f_{U}(Kₙ₂).

Note that f_{U} is obtained from M₁ without validation. This is because there is nothing to be gained by subverting the value of f_{U}, (because then the signatures won't match).

From the System's perspective, the protocol would take on a form like the following pseudocode:

```
dontCare, M_{R}, dontCare ← ChipR.Read(dontCare,1, dontCare)
f_{R} = extract from M_{R}
...
R_{U}, M_{U}, SIG_{U} ← ChipU.Read(keyNumOnChipU,0, 0)
R_{S}, SIG_{S} = ChipS.SignM2(f_{R}, keyNumOnChipS, 0, R_{U}, M_{U}, SIG_{U}, M_{D})
If (R_{S} = SIG_{S} = 0)
  // ChipU and therefore M_{U} is not to be trusted
Else
  // ChipU and therefore M_{U} can be trusted
  ok = ChipU.WriteA(keyNumOnChipU, R_{S}, M_{D}, SIG_{S})
  If (ok)
    // updating of data in ChipU was successful
  Else
    // transmission error during WriteA
  EndIf
EndIf
```

Variant Example
SignM[f,n,V,W,X,Y,Z] Advances R, decrements CountRemaining and returns R, Z_{QX} (Z applied to X with permissions Q), S_{f(Kn)}[W|R|C₁|Z_{QX}] only if Y=S_{f(Kn)}[V|W|C₁|X] and CountRemaining>0. Otherwise returns all 0s. The time taken to calculate and compare signatures must be independent of data content.

Before reading ChipU's memory M₀ (the pre-upgrade value), the System must extract f from ChipU by performing the following tasks:
a. System calls ChipU's Read function, passing in (dontCare, 1, dontCare)
b. ChipU returns M₁, from which System can extract f_{U}
c. System stores f_{U} for future use

To update ChipU's M vector, the protocol is identical to that described in the basic authenticated write protocol with the exception of steps c and d:
c. System calls ChipS's SignM function, passing in f_{U}, n2 (the key to be used in ChipS), 0 (as used in a), R_{U}, M_{U0}, S_{Kn1}[0|R_{U}|C₁|M_{U0}], and M_{D} (the desired vector to be written to ChipU);
d. ChipS produces R_{S}, M_{QD} (processed by running M_{D} against M_{U0} using Q) and S_{fU(Kn2)}[R_{U}|R_{S}|C₁|M_{QD}] if the inputs were valid, and 0 for all outputs if the inputs were not valid.

In addition, the choice of n1 and n2 must be such that ChipU's Kₙ₁=ChipS's f_{U}(Kₙ₂).

Note that f_{U} is obtained from M₁ without validation. This is because there is nothing to be gained by subverting the value of f_{U}, (because then the signatures won't match).

From the System's perspective, the protocol would take on a form like the following pseudocode:

```
dontCare, M_{R}, dontCare ← ChipR.Read(dontCare,1, dontCare)
f_{R} = extract from M_{R}
...
R_{U}, M_{U}, SIG_{U} ← ChipU.Read(keyNumOnChipU,0, 0)
R_{S}, M_{QD}, SIG_{S} = ChipS.SignM2(f_{R}, keyNumOnChipS, 0, R_{U},
M_{U}, SIG_{U}, M_{D})
If (R_{S} = M_{QD} = SIG_{S} = 0)
  // ChipU and therefore M_{U} is not to be trusted
Else
  // ChipU and therefore M_{U} can be trusted
  ok = ChipU.WriteA(keyNumOnChipU, R_{S}, M_{QD}, SIG_{S})
  If (ok)
    // updating of data in ChipU was successful
  Else
    // transmission error during WriteA
  EndIf
EndIf
```

Updating Permissions for Future Writes

In order to reduce exposure to accidental and malicious attacks on P (and certain parts of M), only authorized users are allowed to update P. Writes to P are the same as authorized writes to M, except that they update Pₙ instead of M. Initially (at manufacture), P is set to be Read/Write for all M. As different processes fill up different parts of M, they can be sealed against future change by updating the permissions. Updating a chip's P_{0 . . . T-1} changes permissions for unauthorized writes to Mₙ, and updating P_{T . . . T+N-1} changes permissions for authorized writes with key Kₙ.

Pₙ is only allowed to change to be a more restrictive form of itself. For example, initially all parts of M have permissions of Read/Write. A permission of Read/Write can be updated to Decrement Only or Read Only. A permission of Decrement Only can be updated to become Read Only. A Read Only permission cannot be further restricted.

In this transaction protocol, the System's chip is referred to as ChipS, and the chip being updated is referred to as ChipU. Each chip distrusts the other.

The protocol requires the following publicly available functions in ChipU:
Random[ ] Returns R (does not advance R).
SetPermission[n,p,X,Y,Z] Advances R, and updates Pₚ according to Y and returns 1 followed by the resultant Pₚ only if S_{Kn}[R|X|Y|C₂]=Z. Otherwise returns 0. Pₚ can only become more restricted. Passing in 0 for any permission leaves it unchanged (passing in Y=0 returns the current Pₚ).

Authenticated writes of permissions require that the System has access to a ChipS that is capable of generating appropriate signatures. ChipS requires the following variable:
CountRemaining Part of ChipS's M₀ that contains the number of signatures that ChipS is allowed to generate. Decrements with each successful call to SignM and SignP. Permissions in ChipS's P_{0 . . . T-1} for this part of M₀ needs to be ReadOnly once ChipS has been setup. Therefore CountRemaining can only be updated by another ChipS that will perform updates to that part of M₀ (assuming ChipS's Pₙ allows that part of M₀ to be updated).

In addition, ChipS requires either of the following two SignP functions depending on whether direct or indirect key storage is used:
SignP[n,X,Y] Used when the same key is directly stored in both ChipS and ChipU. Advances R, decrements CountRemaining and returns R and S_{Kn}[X|R|Y|C₂] only if CountRemaining>0. Otherwise returns all 0s. The time taken to calculate and compare signatures must be independent of data content.
SignP[f,n,X,Y] Used when the same key is not directly stored in both ChipS and ChipU. In this case ChipU's Kₙ₁=ChipS's f(Kₙ₂). The function is identical to the direct form of SignP, except that it additionally accepts f and returns S_{f(Kn)}[X|R|Y|C₂] instead of S_{Kn}[X|R|Y|C₂].

Direct form of SignP

When the direct form of SignP is used, ChipU's Pₙ is updated as follows:
a. System calls ChipU's Random function;
b. ChipU returns R_{U} to System;
c. System calls ChipS's SignP function, passing in n2, R_{U} and P_{D} (the desired P to be written to ChipU);
d. ChipS produces R_{S} and S_{Kn2}[R_{U}|R_{S}|P_{D}|C₂] if it is still permitted to produce signatures.
e. If values returned in d are non zero, then System can then call ChipU's SetPermission function with n1, the desired permission entry p, R_{S}, P_{D} and S_{Kn2}[R_{U}|R_{S}|P_{D}|C₂].
f. ChipU verifies the received signature against its own generated signature S_{Kn1}[R_{U}|R_{S}|P_{D}|C₂] and applies P_{D} to Pₙ if the signature matches
g. System checks 1st output parameter. 1=success, 0=failure.

The choice of n1 and n2 must be such that ChipU's Kₙ₁=ChipS's Kₙ₂.

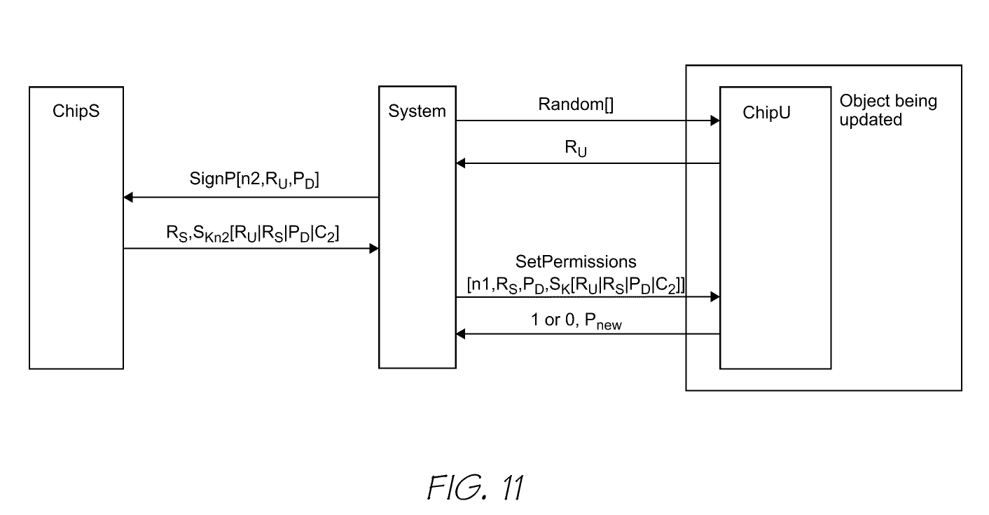

The data flow for basic authenticated writes to permissions is shown in FIG. 11.

Indirect form of SignP

When the indirect form of SignP is used in ChipS, the System must extract f from ChipU (so it knows how to generate the correct key) by performing the following tasks:
a. System calls ChipU's Read function, passing in (dontCare, 1, dontCare)
b. ChipU returns M₁, from which System can extract f_{U}
c. System stores f_{U} for future use

ChipU's Pₙ is updated as follows:
a. System calls ChipU's Random function;
b. ChipU returns R_{U} to System;
c. System calls ChipS's SignP function, passing in f_{U}, n2, R_{U} and P_{D} (the desired P to be written to ChipU);
d. ChipS produces R_{S} and S_{fU(Kn2)}[R_{U}|R_{S}|P_{D}|C₂] if it is still permitted to produce signatures.
e. If values returned in d are non zero, then System can then call ChipU's SetPermission function with n1, the desired permission entry p, R_{S}, P_{D} and S_{fU(Kn2)}[R_{U}|R_{S}|P_{D}|C₂].
f. ChipU verifies the received signature against S_{Kn1}[R_{U}|R_{S}|P_{D}|C₂] and applies P_{D} to Pₙ if the signature matches
g. System checks 1st output parameter. 1=success, 0=failure.

In addition, the choice of n1 and n2 must be such that ChipU's Kₙ₁=ChipS's f_{U}(Kₙ₂).

Protecting Memory Vectors

To protect the appropriate part of Mₙ against unauthorized writes, call SetPermissions[n] for n=0 to T−1. To protect the appropriate part of M₀ against authorized writes with key n, call SetPermissions[T+n] for n=0 to N−1.

Note that only M₀ can be written in an authenticated fashion.

Note that the SetPermission function must be called after the part of M has been set to the desired value.

For example, if adding a serial number to an area of M₁ that is currently ReadWrite so that noone is permitted to update the number again:
the Write function is called to write the serial number to M₁
SetPermission(1) is called for to set that part of M to be ReadOnly for non-authorized writes.

If adding a consumable value to M₀ such that only keys 1-2 can update it, and keys 0, and 3-N cannot:
the Write function is called to write the amount of consumable to M
SetPermission is called for 0 to set that part of M₀ to be DecrementOnly for non-authorized writes. This allows the amount of consumable to decrement.
SetPermission is called for n={T, T+3, T+4 . . . , T+N−1} to set that part of M₀ to be ReadOnly for authorized writes using all but keys 1 and 2. This leaves keys 1 and 2 with ReadWrite permissions to M₀.

It is possible for someone who knows a key to further restrict other keys, but it is not in anyone's interest to do so.

Programming K

In this case, we have a factory chip (ChipF) connected to a System. The System wants to program the key in another chip (ChipP). System wants to avoid passing the new key to ChipP in the clear, and also wants to avoid the possibility of the key-upgrade message being replayed on another ChipP (even if the user doesn't know the key).

The protocol assumes that ChipF and ChipP already share (directly or indirectly) a secret key K_{old}. This key is used to ensure that only a chip that knows K_{old} can set K_{new}.

Although the example shows a ChipF that is only allowed to program a specific number of ChipPs, the key-upgrade protocol can be easily altered (similar to the way the write protocols have variants) to provide other means of limiting the ability to update ChipPs. The protocol requires the following publicly available functions in ChipP:

Random[ ] Returns R (does not advance R). ReplaceKey[n, X, Y, Z] Replaces Kₙ by S_{Kn}[R|X|C₃]\textcircled{+}Y, advances R, and returns 1 only if S_{Kn}[X|Y|C₃]=Z. Otherwise returns 0. The time taken to calculate signatures and compare values must be identical for all inputs.

And the following data and functions in ChipF:
CountRemaining Part of M₀ with contains the number of signatures that ChipF is allowed to generate. Decrements with each successful call to GetProgramKey. Permissions in P for this part of M₀ needs to be ReadOnly once ChipF has been setup. Therefore can only be updated by a ChipS that has authority to perform updates to that part of M₀.

K_{new} The new key to be transferred from ChipF to ChipP. Must not be visible. After manufacture, K_{new} is 0.

SetPartialKey[X] Updates K_{new} to be K_{new}\textcircled{+}X. This function allows K_{new} to be programmed in any number of steps, thereby allowing different people or systems to know different parts of the key (but not the whole K_{new}). K_{new} is stored in ChipF's flash memory.

In addition, ChipF requires either of the following GetProgramKey functions depending on whether direct or indirect key storage is used on the input key and/or output key:
GetProgramKey1[n, X] Direct to direct. Used when the same key (Kₙ) is directly stored in both ChipF and ChipP and we want to store K_{new} in ChipP. Advances R_{F}, decrements CountRemaining, outputs R_{F}, the encrypted key S_{Kn}[X|R_{F}|C₃]\textcircled{+}K_{new} and a signature of the first two outputs plus C₃ if CountRemaining>0. Otherwise outputs 0. The time to calculate the encrypted key & signature must be identical for all inputs.
GetProgramKey2[f, n, X] Direct to indirect. Used when the same key (Kₙ) is directly stored in both ChipF and ChipP but we want to store f_{P}(K_{new}) in ChipP instead of simply K_{new} (i.e. we want to keep the key in ChipP to be different in all ChipPs). In this case ChipP's Kₙ₁=ChipF's f_{P}(Kₙ₂). The function is identical to GetProgramKey1, except that it additionally accepts f_{P}, and returns S_{Kn}[X|R_{F}|C₃]\textcircled{+}f_{P}(K_{new}) instead of S_{Kn}[X|R_{F}|C₃]\textcircled{+}K_{new}. Note that the produced signature is produced using Kₙ since that is what is already stored in ChipP.
GetProgramKey3[f, n, X] Indirect to direct. Used when the same key is not directly stored in both ChipF and ChipP but we want to store K_{new} in ChipP. In this case ChipP's Kₙ₁=ChipF's f_{P}(Kₙ₂). The function is identical to GetProgramKey1, except that it additionally accepts f_{P}, and returns S_{fP(Kn)}[X|R_{F}|C₃]\textcircled{+}K_{new} instead of S_{Kn}[X|R_{F}|C₃]\textcircled{+}K_{new}. The produced signature is produced using f_{P}(Kn) instead of Kₙ since that is what is already stored in ChipP.
GetProgramKey4[f, n, X] Indirect to indirect. Used when the same key is not directly stored in both ChipF and ChipP but we want to store f_{P}(K_{new}) in ChipP instead of simply K_{new} (i.e. we want to keep the key in ChipP to be different in all ChipPs). In this case ChipP's Kₙ₁=ChipF's f_{P}(Kₙ₂). The function is identical to GetProgramKey3, except that it returns S_{fP(Kn)}[X|R_{F}|C₃]\textcircled{+}f_{P}(K_{new}) instead of S_{fP(Kn)}[X|R_{F}|C₃]\textcircled{+}K_{new}. The produced signature is produced using f_{P}(Kₙ) since that is what is already stored in ChipP.

Since there are likely to be few ChipFs, and many ChipPs, the indirect forms of GetProgramKey can be usefully employed.

GetProgramKey1—Direct to Direct

With the “old key=direct, new key=direct” form of GetProgramKey, to update P's key:
a. System calls ChipP's Random function;
b. ChipP returns R_{P} to System;
c. System calls ChipF's GetProgramKey function, passing in n2 (the desired key to use) and the result from b;
d. ChipF updates R_{F}, then calculates and returns R_{F}, S_{Kn2}[R_{P}|R_{F}|C₃]\textcircled{+}K_{new}, and S_{Kn2}[R_{F}|S_{Kn2}[R_{P}|R_{F}|C₃]\textcircled{+}K_{new}|C₃];
e. If the response from d is not 0, System calls ChipP's ReplaceKey function, passing in n1 (the key to use in ChipP) and the response from d;
f. System checks response from ChipP. If the response is 1, then ChipP's Kₙ₁ has been correctly updated to K_{new}. If the response is 0, ChipP's Kₙ₁ has not been updated.

The choice of n1 and n2 must be such that ChipP's Kₙ₁=ChipF's Kₙ₂.

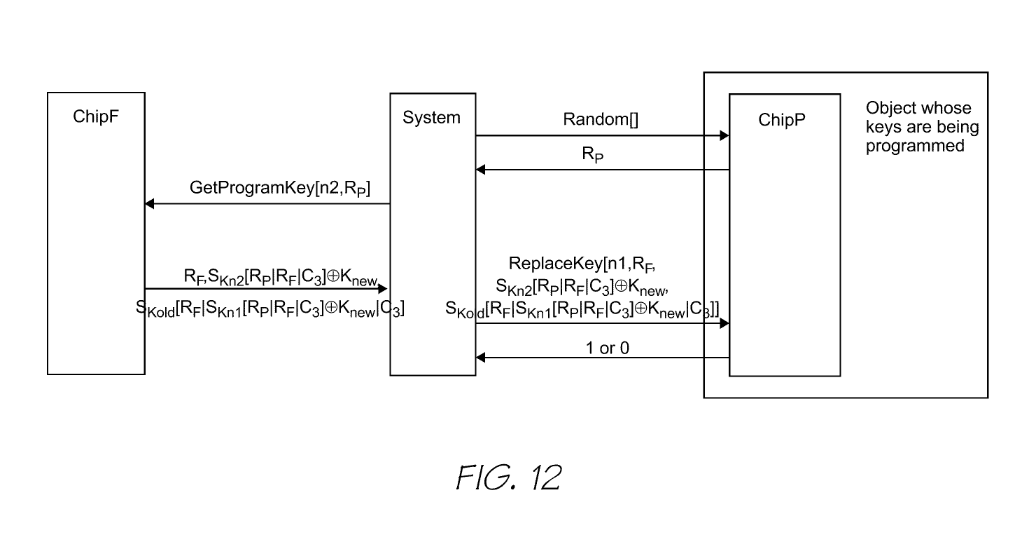

The data flow for key updates is shown in FIG. 12:

Note that K_{new} is never passed in the open. An attacker could send its own R_{P}, but cannot produce S_{Kn2}[R_{P}|R_{F}|C₃] without Kₙ₂. The signature based on K_{new} is sent to ensure that ChipP will be able to determine if either of the first two parameters have been changed en route.

CountRemaining needs to be setup in M_{F0} (including making it ReadOnly in P) before ChipF is programmed with K_{P}. ChipF should therefore be programmed to only perform a limited number of GetProgramKey operations (thereby limiting compromise exposure if a ChipF is stolen). An authorized ChipS can be used to update this counter if necessary.

GetProgramKey2—Direct to Indirect

With the “old key=direct, new key=indirect” form of GetProgramKey, to update P's key, the System must extract f from ChipP (so it can tell ChipF how to generate the correct key) by performing the following tasks:
a. System calls ChipP's Read function, passing in (dontCare, 1, dontCare)
b. ChipP returns M₁, from which System can extract f_{P}
c. System stores f_{P} for future use

ChipP's key is updated as follows:
a. System calls ChipP's Random function;
b. ChipP returns R_{P} to System;
c. System calls ChipF's GetProgramKey function, passing in f_{P}, n2 (the desired key to use) and the result from b;
d. ChipF updates R_{F}, then calculates and returns R_{F}, S_{Kn2}[R_{P}|R_{F|C}₃]\textcircled{+}f_{P}(K_{new}), and S_{Kn2}[R_{F}|S_{Kn2}[R_{P}|R_{F}|C³]\textcircled{+}f_{P}(K_{new})|C₃];
e. If the response from d is not 0, System calls ChipP's ReplaceKey function, passing in n1 (the key to use in ChipP) and the response from d;
f. System checks response from ChipP. If the response is 1, then ChipP's Kₙ₁ has been correctly updated to f_{P}(K_{new}). If the response is 0, ChipP's Kₙ₁ has not been updated.

The choice of n1 and n2 must be such that ChipP's Kₙ₁=ChipF's Kₙ₂.

GetProgramKey3—Indirect to Direct

With the “old key=indirect, new key=direct” form of GetProgramKey, to update P's key, the System must extract f from ChipP (so it can tell ChipF how to generate the correct key) by performing the following tasks:
a. System calls ChipP's Read function, passing in (dontCare, 1, dontCare)
b. ChipP returns M₁, from which System can extract f_{P}
c. System stores f_{P} for future use

ChipP's key is updated as follows:
a. System calls ChipP's Random function;
b. ChipP returns R_{P} to System;
c. System calls ChipF's GetProgramKey function, passing in f_{P}, n2 (the desired key to use) and the result from b;
d. ChipF updates R_{F}, then calculates and returns R_{F}, S_{fP(Kn2)}[R_{P}|R_{F}|C₃]\textcircled{+}K_{new}, and S_{fP(Kn2)}[R_{F}|S_{fP(Kn2)}[R_{P}|R_{F}|C₃]\textcircled{+}K_{new}|C₃];
e. If the response from d is not 0, System calls ChipP's ReplaceKey function, passing in n1 (the key to use in ChipP) and the response from d;
f. System checks response from ChipP. If the response is 1, then ChipP's Kₙ₁ has been correctly updated to K_{new}. If the response is 0, ChipP's Kₙ₁ has not been updated.

The choice of n1 and n2 must be such that ChipP's Kₙ₁=ChipF's f_{P}(Kₙ₂).

GetProgramKey4—Indirect to Indirect

With the “old key=indirect, new key=indirect” form of GetProgramKey, to update P's key, the System must extract f from ChipP (so it can tell ChipF how to generate the correct key) by performing the following tasks:
a. System calls ChipP's Read function, passing in (dontCare, 1, dontCare)
b. ChipP returns M₁, from which System can extract f_{P}
c. System stores f_{P} for future use

ChipP's key is updated as follows:
a. System calls ChipP's Random function;
b. ChipP returns R_{P} to System;
c. System calls ChipF's GetProgramKey function, passing in f_{P}, n2 (the desired key to use) and the result from b;
d. ChipF updates R_{F}, then calculates and returns R_{F}, S_{fP(Kn2)}[R_{P}|R_{F}|C₃]\textcircled{+}f_{P}(K_{new}), and S_{fP(Kn2)}[R_{F}|S_{fP(Kn2)}[R_{P}|R_{F}|C₃]\textcircled{+}f_{P}(K_{new})|C₃];
e. If the response from d is not 0, System calls ChipP's ReplaceKey function, passing in n1 (the key to use in ChipP) and the response from d;
f. System checks response from ChipP. If the response is 1, then ChipP's Kₙ₁ has been correctly updated to f_{P}(K_{new}). If the response is 0, ChipP's Kₙ₁ has not been updated. The choice of n1 and n2 must be such that ChipP's Kₙ₁=ChipF's f_{P}(Kₙ₂).

Chicken and Egg

The Program Key protocol requires both ChipF and ChipP to know K_{old} (either directly or indirectly). Obviously both chips had to be programmed in some way with K_{old}, and thus K_{old} can be thought of as an older K_{new}: K_{old} can be placed in chips if another ChipF knows K_{older}, and so on.

Although this process allows a chain of reprogramming of keys, with each stage secure, at some stage the very first key (K_{first}) must be placed in the chips. K_{first} is in fact programmed with the chip's microcode at the manufacturing test station as the last step in manufacturing test. K_{first} can be a manufacturing batch key, changed for each batch or for each customer etc., and can have as short a life as desired. Compromising K_{first} need not result in a complete compromise of the chain of Ks. This is especially true if K_{first} is indirectly stored in ChipPs (i.e. each ChipP holds an f and f(K_{first}) instead of K_{first} directly). One example is where K_{first} (the key stored in each chip after manufacture/test) is a batch key, and can be different per chip. K_{first} may advance to a ComCo specific K_{second} etc. but still remain indirect. A direct form (e.g. K_{final}) only needs to go in if it is actually required at the end of the programming chain.

Depending on reprogramming requirements, K_{first} can be the same or different for all Kₙ.

Memjet Forms of Protocols

Physical QA Chips are used in Memjet printer systems to store printer operating parameters as well as consumable parameters.

PRINTER_QA

A PRINTER_QA is stored within each print engine to perform two primary tasks:
storage and protection of operating parameters
a means of indirect read validation of other QA Chip data vectors

Each PRINTER_QA contains the following keys:

TABLE 3
Keys in PrinterQA

| Key | Contents | Comments |
|---|---|---|
| 0 | Upgrade Key | Used to upgrade the operating |
| | | parameters. Should be indirect |
| | | form of key (i.e. a different key |
| | | for each PRINTER_QA) so |
| | | that an indirect form of the |
| | | write is required. |
| 1 | Consumable Read Validation | Used to indirectly read the |
| | Key | data from an |
| | | CONSUMABLE_QA chip using |
| | | indirect authenticated read |
| | | protocol. |
| 2 | PrintEngineController Read | When reading data from the |
| | Validation Key | PRINTER_QA, the system can |
| | | either trust the data, or must |
| | | use this key to perform the |
| | | authenticated read protocol. |
| 3-n | (reserved) | Currently unused. |
| | | Could be used to provide a |
| | | means to indirectly read |
| | | additional print engine |
| | | operating parameters ala K1, |
| | | or provide additional Print |
| | | Engine validation ala K2. |

Note that if multiple Print Engine Controllers are used (e.g. a multiple SoPEC system), then multiple PrintEngineController Read Validation Keys are required. These keys can be stored within a single PRINTER_QA (e.g. in K₃ and beyond), or can be stored in separate PRINTER_QAs (for example each SoPEC (or group of SoPECs) has an individual PRINTER_QA).

The functions required in the PRINTER_QA are:
Random, ReplaceKey, to allow key programming & substitution
Read, to allow reads of data
Write, to allow updates of M₁₊ during manufacture
WriteAuth, to provide a means of updating the M₀ data (operating parameters)
SetPermissions, to provide a means of updating write permissions
Test, to provide a means of checking if consumable reads are valid
Translate, to provide a means of indirect reading of consumable data

CONSUMABLE_QA

A CONSUMABLE_QA is stored with each consumable (e.g. ink cartridge) to perform two primary tasks:
storage of consumable related data
protection of consumable amount remaining

Each CONSUMABLE_QA contains the following keys:

TABLE 4
Keys in CONSUMABLE_QA

| Key | Contents | Comments |
|---|---|---|
| 0 | Upgrade Key | Used to upgrade the |
| | | consumable parameters. |
| | | Should be stored as the |
| | | indirect form of the key (i.e. a |
| | | different key for each |
| | | CONSUMABLE_QA) so that |
| | | an indirect form of the write is |
| | | required. |
| 1 | Consumable Read Validation | When reading data from the |
| | Key | CONSUMABLE_QA, the |
| | | system can either trust the |
| | | data, or must use this key to |
| | | perform either the direct or |
| | | indirect authenticated read |
| | | protocol. |
| 2 | (reserved) | Currently unused. |
| 3-n | (reserved) | Currently unused. |

The functions required in the CONSUMABLE_QA are:
Random, ReplaceKey, to allow key programming & substitution
Read, to allow reads of data
Write, to allow updates of M₁₊ during manufacture
WriteAuth, to provide a means of updating the M₀ data (consumable remaining)
SetPermissions, to provide a means of updating write permissions

Authentication of Consumables

QA Chip Terminology

This document refers to QA Chips by their function in particular protocols:
For authenticated reads, ChipA is the QA Chip being authenticated, and ChipT is the QA Chip that is trusted.
For replacement of keys, ChipP is the QA Chip being programmed with the new key, and ChipF is the factory QA Chip that generates the message to program the new key.
For upgrades of data in a QA Chip, ChipU is the QA Chip being upgraded, and ChipS is the QA Chip that signs the upgrade value.

Any given physical QA Chip will contain functionality that allows it to operate as an entity in some number of these protocols.

Therefore, wherever the terms ChipA, ChipT, ChipP, ChipF, ChipU and ChipS are used in this document, they are referring to logical entities involved in an authentication protocol as defined in subsequent sections.

Physical QA Chips are referred to by their location. For example, each ink cartridge may contain a QA Chip referred to as an INK_QA, with all INK_QA chips being on the same physical bus. In the same way, the QA Chip inside a printer is referred to as PRINTER_QA, and will be on a separate bus to the INK_QA chips.

The authentication mechanism is therefore built into an authentication chip that is embedded in the consumable and allows a system to authenticate that consumable securely and easily. Limiting ourselves to the system authenticating consumables (we don't consider the consumable authenticating the system), two levels of protection can be considered:

Presence Only Authentication:
This is where only the presence of an authentication chip is tested. The authentication chip can be removed and used in other consumables as long as be used indefinitely.

Consumable Lifetime Authentication:
This is where not only is the presence of the authentication chip tested for, but also the authentication chip must only last the lifetime of the consumable. For the chip to be re-used it must be completely erased and reprogrammed.

The two levels of protection address different requirements. We are primarily concerned with Consumable Lifetime authentication in order to prevent cloned versions of high volume consumables. In this case, each chip should hold secure state information about the consumable being authenticated. It should be noted that a Consumable Lifetime authentication chip could be used in any situation requiring a Presence Only authentication chip.

Requirements for authentication, data storage integrity and manufacture are considered separately. The following sections summarize requirements of each.

Authentication

The authentication requirements for both Presence Only and Consumable Lifetime authentication are restricted to the case of a system authenticating a consumable. We do not consider bi-directional authentication where the consumable also authenticates the system. For example, it is not necessary for a valid toner cartridge to ensure it is being used in a valid photocopier.

For Presence Only authentication, we must be assured that an authentication chip is physically present. For Consumable Lifetime authentication we also need to be assured that state data actually came from the authentication chip, and that it has not been altered en route. These issues cannot be separated—data that has been altered has a new source, and if the source cannot be determined, the question of alteration cannot be settled.

It is not enough to provide an authentication method that is secret, relying on a home-brew security method that has not been scrutinized by security experts. The primary requirement therefore is to provide authentication by means that have withstood the scrutiny of experts.

The authentication scheme used by the authentication chip should be resistant to defeat by logical means. Logical types of attack are extensive, and attempt to do one of three things:
Bypass the authentication process altogether
Obtain the secret key by force or deduction, so that any question can be answered
Find enough about the nature of the authenticating questions and answers in order to, without the key, give the right answer to each question.

Data Storage Integrity

Although authentication protocols take care of ensuring data integrity in communicated messages, data storage integrity is also required. Two kinds of data must be stored within the authentication chip:
Authentication data, such as secret keys
Consumable state data, such as serial numbers, and media remaining etc.

The access requirements of these two data types differ greatly. The authentication chip therefore requires a storage/access control mechanism that allows for the integrity requirements of each type.

Authentication Data

Authentication data must remain confidential. It needs to be stored in the chip during a manufacturing/programming stage of the chip's life, but from then on must not be permitted to leave the chip. It must be resistant to being read from non-volatile memory. The authentication scheme is responsible for ensuring the key cannot be obtained by deduction, and the manufacturing process is responsible for ensuring that the key cannot be obtained by physical means.

The size of the authentication data memory area must be large enough to hold the necessary keys and secret information as mandated by the authentication protocols.

Consumable State Data

Consumable state data can be divided into the following types. Depending on the application, there will be different numbers of each of these types of data items.
Read Only
ReadWrite
Decrement Only
Read Only data needs to be stored in the chip during a manufacturing/programming stage of the chip's life, but from then on should not be allowed to change. Examples of Read Only data items are consumable batch numbers and serial numbers.
ReadWrite data is changeable state information, for example, the last time the particular consumable was used. ReadWrite data items can be read and written an unlimited number of times during the lifetime of the consumable. They can be used to store any state information about the consumable. The only requirement for this data is that it needs to be kept in non-volatile memory. Since an attacker can obtain access to a system (which can write to ReadWrite data), any attacker can potentially change data fields of this type. This data type should not be used for secret information, and must be considered insecure.
Decrement Only data is used to count down the availability of consumable resources. A photocopier's toner cartridge, for example, may store the amount of toner remaining as a Decrement Only data item. An ink cartridge for a color printer may store the amount of each ink color as a Decrement Only data item, requiring 3 (one for each of Cyan, Magenta, and Yellow), or even as many as 5 or 6 Decrement Only data items. The requirement for this kind of data item is that once programmed with an initial value at the manufacturing/programming stage, it can only reduce in value. Once it reaches the minimum value, it cannot decrement any further. The Decrement Only data item is only required by Consumable Lifetime authentication.

Note that the size of the consumable state data storage required is only for that information required to be authenticated. Information which would be of no use to an attacker, such as ink color-curve characteristics or ink viscosity do not have to be stored in the secure state data memory area of the authentication chip.

Manufacture

Regardless of the authentication scheme used, the circuitry of the authentication part of the chip must be resistant to physical attack. Physical attack comes in four main ways, although the form of the attack can vary:
Bypassing the authentication chip altogether
Physical examination of chip while in operation (destructive and non-destructive)
Physical decomposition of chip
Physical alteration of chip

Authentication

The QA Chip is a programmable device, and can therefore be setup with an application-specific program together with an application-specific set of protocols. This section describes the following sets of protocols:
single key single memory vector
multiple key single memory vector
multiple key multiple memory vector

These protocols refer to the number of valid keys that an QA Chip knows about, and the size of data required to be stored in the chip.

From these protocols it is straightforward to construct protocol sets for the single key multiple memory vector case (of course the multiple memory vector can be considered to be and multiple key single memory vector. Other protocol sets can also be defined as necessary. Of course multiple memory vector can be conveniently

All the protocols rely on a time-variant challenge (i.e. the challenge is different each time), where the response depends on the challenge and the secret. The challenge involves a random number so that any observer will not be able to gather useful information about a subsequent identification.

Single Key Single Memory Vector

Protocol Background

This protocol set is provided for two reasons:
the other protocol sets defined in this document are simply extensions of this one; and
it is useful in its own right

The single key protocol set is useful for applications where only a single key is required. Note that there can be many consumables and systems, but there is only a single key that connects them all. Examples include:
car and keys. A car and the car-key share a single key. There can be multiple sets of car-keys, each effectively cut to the same key. A company could have a set of cars, each with the same key. Any of the car-keys could then be used to drive any of the cars.
printer and ink cartridge. All printers of a certain model use the same ink cartridge, with printer and cartridge sharing only a single key. Note that to introduce a new printer model that accepts the old ink cartridge the new model would need the same key as the old model. See the multiple-key protocols for alternative solutions to this problem.

Requirements of Protocol

Each QA Chip contains the following values:
K The secret key for calculating F_{K}[X]. K must not be stored directly in the QA Chip. Instead, each chip needs to store a random number R_{K} (different for each chip), K\textcircled{+}R_{K}, and [symbol] K\textcircled{+}R_{K}. The stored K\textcircled{+}R_{K} can be XORed with R_{K} to obtain the real K. Although [symbol] K\textcircled{+}R_{K} must be stored to protect against differential attacks, it is not used.
R Current random number used to ensure time varying messages. Each chip instance must be seeded with a different initial value. Changes for each signature generation.
M Memory vector of QA Chip.
P2 element array of access permissions for each part of M. Entry 0 holds access permissions for non-authenticated writes to M (no key required). Entry 1 holds access permissions for authenticated writes to M (key required).

Permission choices for each part of M are Read Only, Read/Write, and Decrement Only.
C 3 constants used for generating signatures. C₁, C₂, and C₃ are constants that pad out a submessage to a hashing boundary, and all 3 must be different.
   Each QA Chip contains the following private function:
S_{K}[X] Internal function only. Returns S_{K}[X], the result of applying a digital signature function S to X based upon key K. The digital signature must be long enough to counter the chances of someone generating a random signature. The length depends on the signature scheme chosen, although the scheme chosen for the QA Chip is HMAC-SHA1, and therefore the length of the signature is 160 bits.

Additional functions are required in certain QA Chips, but these are described as required.

Reads of M

In this case, we have a trusted chip (ChipT) connected to a System. The System wants to authenticate an object that contains a non-trusted chip (ChipA). In effect, the System wants to know that it can securely read a memory vector (M) from ChipA: to be sure that ChipA is valid and that M has not been altered.

The protocol requires the following publicly available function in ChipA:
Read[X] Advances R, and returns R, M, S_{K}[X|R|C₁|M]. The time taken to calculate the signature must not be based on the contents of X, R, M, or K.

The protocol requires the following publicly available functions in ChipT:
Random[ ] Returns R (does not advance R).
Test[X, Y, Z] Advances R and returns 1 if S_{K}[R|X|C₁|Y]=Z. Otherwise returns 0. The time taken to calculate and compare signatures must be independent of data content.

To authenticate ChipA and read ChipA's memory M:
a. System calls ChipT's Random function;
b. ChipT returns R_{T} to System;
c. System calls ChipA's Read function, passing in the result from b;
d. ChipA updates R_{A}, then calculates and returns R_{A}, M_{A}, S_{K}[R_{T}|R_{A}|C₁|M_{A}];
e. System calls ChipT's Test function, passing in R_{A}, M_{A}, S_{K}[R_{T}|R_{A}|C₁|M_{A}];
f. System checks response from ChipT. If the response is 1, then ChipA is considered authentic. If 0, ChipA is considered invalid.

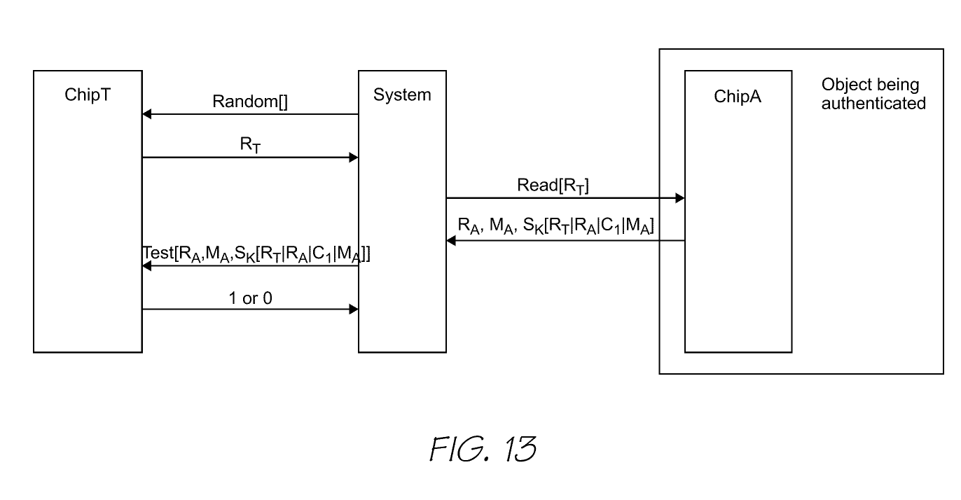

The data flow for read authentication is shown in FIG. 13.

The protocol allows System to simply pass data from one chip to another, with no special processing. The protection relies on ChipT being trusted, even though System does not know K.

When ChipT is physically separate from System (eg is chip on a board connected to System) System must also occassionally (based on system clock for example) call ChipT's Test function with bad data, expecting a 0 response. This is to prevent someone from inserting a fake ChipT into the system that always returns 1 for the Test function.

Writes

In this case, the System wants to update M in some chip referred to as ChipU. This can be non-authenticated (for example, anyone is allowed to count down the amount of consumable remaining), or authenticated (for example, replenishing the amount of consumable remaining).

Non-Authenticated Writes

This is the most frequent type of write, and takes place between the System/consumable during normal everyday operation. In this kind of write, System wants to change M in a way that doesn't require special authorization. For example, the System could be decrementing the amount of consumable remaining. Although System does not need to know K or even have access to a trusted chip, System must follow a non-authenticated write by an authenticated read if it needs to know that the write was successful.

The protocol requires the following publicly available function:

Write[X]Writes X over those parts of M subject to P₀ and the existing value for M.

To authenticate a write of M_{new} to ChipA's memory M:
a. System calls ChipU's Write function, passing in M_{new};
b. The authentication procedure for a Read is carried out;
c. If ChipU is authentic and M_{new}=M returned in b, the write succeeded. If not, it failed.

Authenticated Writes

In this kind of write, System wants to change Chip U's M in an authorized way, without being subject to the permissions that apply during normal operation (P₀). For example, the consumable may be at a refilling station and the normally Decrement Only section of M should be updated to include the new valid consumable. In this case, the chip whose M is being updated must authenticate the writes being generated by the external System and in addition, apply permissions P₁ to ensure that only the correct parts of M are updated.

In this transaction protocol, the System's chip is referred to as ChipS, and the chip being updated is referred to as ChipU. Each chip distrusts the other.

The protocol requires the following publicly available functions in ChipU:
Read[X] Advances R, and returns R, M, S_{K}[X|R|C₁|M]. The time taken to calculate the signature must be identical for all inputs.
WriteA[X, Y, Z] Returns 1, advances R, and replaces M by Y subject to P₁ only if S_{K}[R|X|C₁|Y]=Z. Otherwise returns 0. The time taken to calculate and compare signatures must be independent of data content. This function is identical to ChipT's Test function except that it additionally writes Y over those parts of M subject to P₁ when the signature matches.

Authenticated writes require that the System has access to a ChipS that is capable of generating appropriate signatures. ChipS requires the following variables and function:
CountRemaining Part of M that contains the number of signatures that ChipS is allowed to generate. Decrements with each successful call to SignM and Sign P. Permissions in ChipS's P₀ for this part of M needs to be ReadOnly once ChipS has been setup. Therefore CountRemaining can only be updated by another ChipS that will perform updates to that part of M (assuming ChipS's P₁ allows that part of M to be updated).
Q Part of M that contains the write permissions for updating ChipU's M. By adding Q to ChipS we allow different ChipSs that can update different parts of M_{U}. Permissions in ChipS's P₀ for this part of M needs to be ReadOnly once ChipS has been setup. Therefore Q can only be updated by another ChipS that will perform updates to that part of M.
SignM[V,W,X,Y,Z] Advances R, decrements CountRemaining and returns R, Z_{QX} (Z applied to X with permissions Q), followed by S_{K}[W|R|C₁|Z_{QX}] only if S_{K}[V|W|C₁|X]=Y and CountRemaining>0. Otherwise returns all 0s. The time taken to calculate and compare signatures must be independent of data content.

To update ChipU's M vector:
a. System calls ChipU's Read function, passing in 0 as the input parameter;
b. ChipU produces R_{U}, M_{U}, S_{K}[0|R_{U}|C₁|M_{U}] and returns these to System;
c. System calls ChipS's SignM function, passing in 0 (as used in a), R_{U}, M_{U}, S_{K}[0|R_{U}|C₁|M_{U}], and M_{D} (the desired vector to be written to ChipU);
d. ChipS produces R_{S}, M_{QD} (processed by running M_{D} against M_{U} using Q) and S_{K}[R_{U}|R_{S}|C₁|M_{QD}] if the inputs were valid, and 0 for all outputs if the inputs were not valid.
e. If values returned in d are non zero, then ChipU is considered authentic. System can then call ChipU's WriteA function with these values.
f. ChipU should return a 1 to indicate success. A 0 should only be returned if the data generated by ChipS is incorrect (e.g. a transmission error).

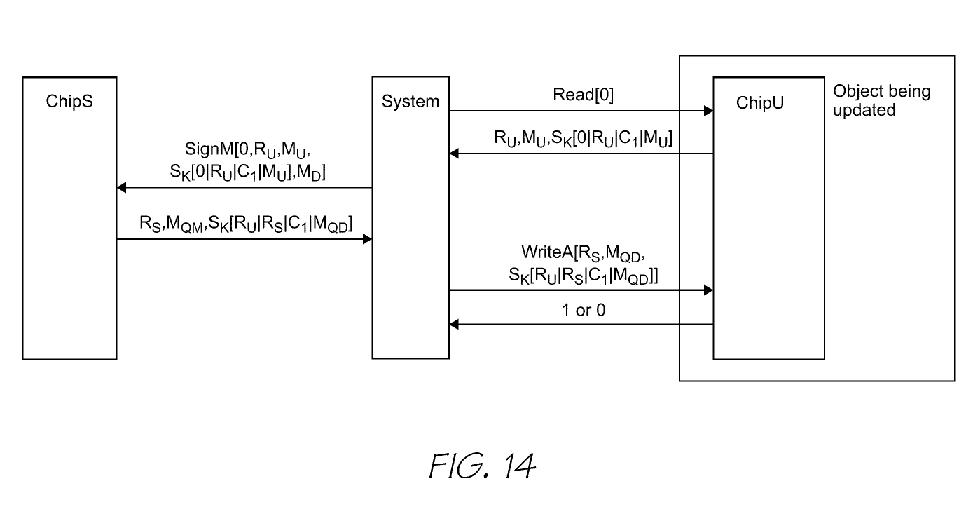

The data flow for authenticated writes is shown in FIG. 14.

Note that Q in ChipS is part of ChipS's M. This allows a user to set up ChipS with a permission set for upgrades. This should be done to ChipS and that part of M designated by P₀ set to ReadOnly before ChipS is programmed with K_{U}. If K_{S} is programmed with K_{U} first, there is a risk of someone obtaining a half-setup ChipS and changing all of M_{U} instead of only the sections specified by Q.

The same is true of CountRemaining. The CountRemaining value needs to be setup (including making it ReadOnly in P₀) before ChipS is programmed with K_{U}. ChipS is therefore programmed to only perform a limited number of SignM operations (thereby limiting compromise exposure if a ChipS is stolen). Thus ChipS would itself need to be upgraded with a new CountRemaining every so often.

Updating Permissions for Future Writes

In order to reduce exposure to accidental and malicious attacks on P and certain parts of M, only authorized users are allowed to update P. Writes to P are the same as authorized writes to M, except that they update Pₙ instead of M. Initially (at manufacture), P is set to be Read/Write for all parts of M. As different processes fill up different parts of M, they can be sealed against future change by updating the permissions. Updating a chip's P₀ changes permissions for unauthorized writes, and updating P₁ changes permissions for authorized writes.

Pₙ is only allowed to change to be a more restrictive form of itself. For example, initially all parts of M have permissions of Read/Write. A permission of Read/Write can be updated to Decrement Only or Read Only. A permission of Decrement Only can be updated to become Read Only. A Read Only permission cannot be further restricted.

In this transaction protocol, the System's chip is referred to as ChipS, and the chip being updated is referred to as ChipU. Each chip distrusts the other.

The protocol requires the following publicly available functions in ChipU:
Random[ ] Returns R (does not advance R).
SetPermission[n,X,Y,Z] Advances R, and updates Pₙ according to Y and returns 1 followed by the resultant Pₙ only if S_{K}[R|X|Y|C₂]=Z. Otherwise returns 0. Pₙ can only become more restricted. Passing in 0 for any permission leaves it unchanged (passing in Y=0 returns the current Pₙ).

Authenticated writes of permissions require that the System has access to a ChipS that is capable of generating appropriate signatures. ChipS requires the following variables and function:
CountRemaining Part of M that contains the number of signatures that ChipS is allowed to generate. Decrements with each successful call to SignM and SignP. Permissions in ChipS's P₀ for this part of M needs to be ReadOnly once ChipS has been setup. Therefore CountRemaining can only be updated by another ChipS that will perform updates to that part of M (assuming ChipS's P₁ allows that part of M to be updated).
SignP[X,Y] Advances R, decrements CountRemaining and returns R and S_{K}[X|R|Y|C₂] only if CountRemaining>0. Otherwise returns all 0s.

The time taken to calculate and compare signatures must be independent of data content.

To update ChipU's Pₙ:
a. System calls ChipU's Random function;
b. ChipU returns R_{U} to System;
c. System calls ChipS's SignP function, passing in R_{U} and P_{D} (the desired P to be written to ChipU);
d. ChipS produces R_{S} and S_{K}[R_{U}|R_{S}|P_{D}|C₂] if it is still permitted to produce signatures.
e. If values returned in d are non zero, then System can then call ChipU's SetPermission function with the desired n, R_{S}, P_{D} and S_{K}[R_{U}|R_{S}|P_{D}|C₂].
f. ChipU verifies the received signature against S_{K}[R_{U}|R_{S}|P_{D}|C₂] and applies P_{D} to Pₙ if the signature matches
g. System checks 1st output parameter. 1=success, 0=failure.

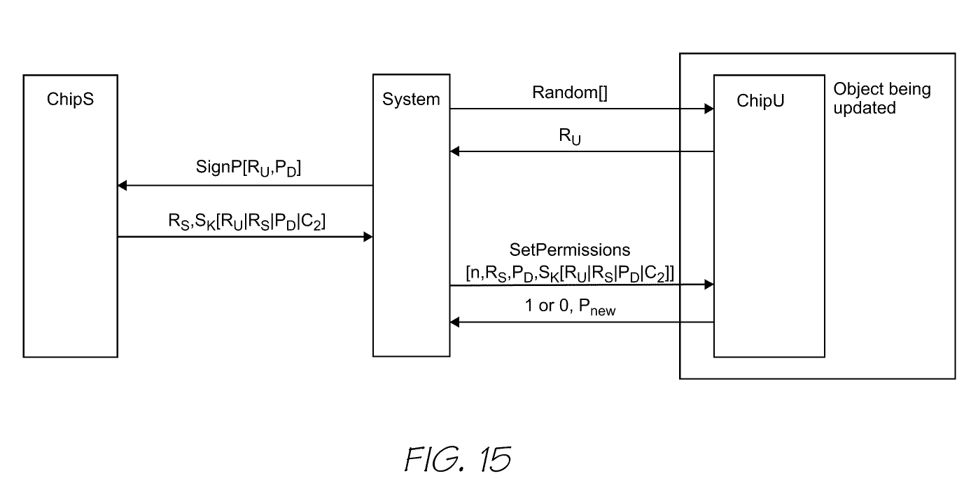

The data flow for authenticated writes to permissions is shown in FIG. 15.

Programming K

In this case, we have a factory chip (ChipF) connected to a System. The System wants to program the key in another chip (ChipP). System wants to avoid passing the new key to ChipP in the clear, and also wants to avoid the possibility of the key-upgrade message being replayed on another ChipP (even if the user doesn't know the key). The protocol assumes that ChipF and ChipP already share a secret key K_{old}. This key is used to ensure that only a chip that knows K_{old} can set K_{new}.

The protocol requires the following publicly available functions in ChipP:
Random[ ] Returns R (does not advance R).
ReplaceKey[X, Y, Z] Replaces K by S_{Kold}[R|X|C₃]\textcircled{+}Y, advances R, and returns 1 only if S_{Kold}[X|Y|C₃]=Z. Otherwise returns 0. The time taken to calculate signatures and compare values must be identical for all inputs.

And the following data and function in ChipF:
CountRemaining Part of M with contains the number of signatures that ChipF is allowed to generate. Decrements with each successful call to GetProgramKey. Permissions in P for this part of M needs to be ReadOnly once ChipF has been setup. Therefore can only be updated by a ChipS that has authority to perform updates to that part of M.
K_{new} The new key to be transferred from ChipF to ChipP. Must not be visible.
SetPartialKey[X,Y] If word X of K_{new} has not yet been set, set word X of K_{new} to Y and return 1. Otherwise return 0. This function allows K_{new} to be programmed in multiple steps, thereby allowing different people or systems to know different parts of the key (but not the whole K_{new}). K_{new} is stored in ChipF's flash memory. Since there is a small number of ChipFs, it is theoretically not necessary to store the inverse of K_{new}, but it is stronger protection to do so.
GetProgramKey[X] Advances R_{F}, decrements CountRemaining, outputs R_{F}, the encrypted key S_{Kold}[X|R_{F}|C₃]\textcircled{+}K_{new} and a signature of the first two outputs plus C₃ if CountRemaining>0. Otherwise outputs 0. The time to calculate the encrypted key & signature must be identical for all inputs.

To update P's key:
a. System calls ChipP's Random function;
b. ChipP returns R_{P} to System;
c. System calls ChipF's GetProgramKey function, passing in the result from b;
d. ChipF updates R_{F}, then calculates and returns R_{F}, S_{Kold}[R_{P}|R_{F}|C₃]\textcircled{+}K_{new}, and S_{Kold}[R_{F}|S_{Kold}[R_{P}|R_{F}|C₃]\textcircled{+}K_{new}|C₃];
e. If the response from d is not 0, System calls ChipP's ReplaceKey function, passing in the response from d;
f. System checks response from ChipP. If the response is 1, then K_{P} has been correctly updated to K_{new}. If the response is 0, K_{P} has not been updated.

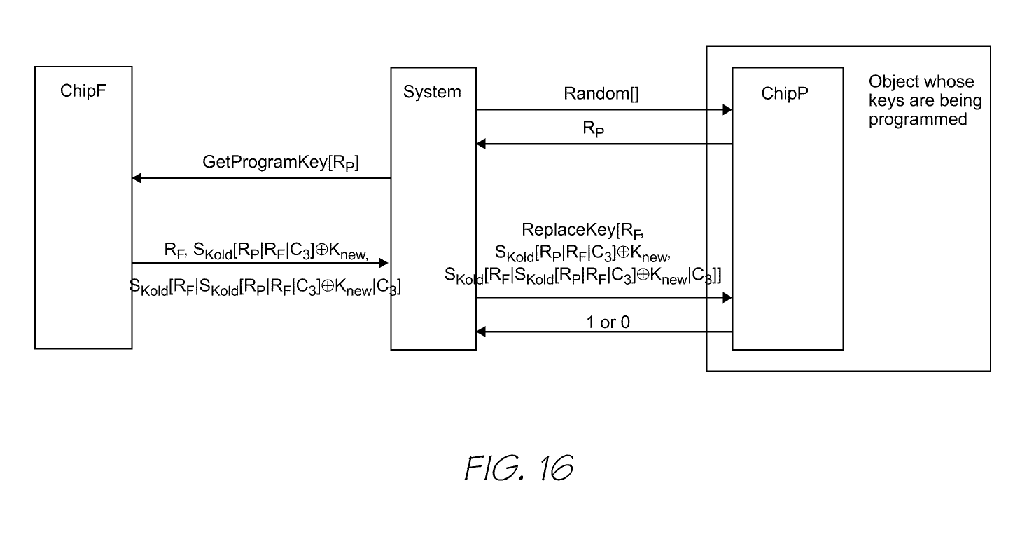

The data flow for key updates is shown in FIG. 16.

Note that K_{new} is never passed in the open. An attacker could send its own R_{P}, but cannot produce S_{Kold}[R_{P}|R_{F}|C₃] without K_{old}. The third parameter, a signature, is sent to ensure that ChipP can determine if either of the first two parameters have been changed en route.

CountRemaining needs to be setup in M_{F} (including making it ReadOnly in P) before ChipF is programmed with K_{P}. ChipF should therefore be programmed to only perform a limited number of GetProgramKey operations (thereby limiting compromise exposure if a ChipF is stolen). An authorized ChipS can be used to update this counter if necessary.

Chicken and Egg

Of course, for the Program Key protocol to work, both ChipF and ChipP must both know K_{old}. Obviously both chips had to be programmed with K_{old}, and thus K_{old} can be thought of as an older K_{new}: K_{old} can be placed in chips if another ChipF knows K_{older}, and so on. Although this process allows a chain of reprogramming of keys, with each stage secure, at some stage the very first key (K_{first}) must be placed in the chips. K_{first} is in fact programmed with the chip's microcode at the manufacturing test station as the last step in manufacturing test. K_{first} can be a manufacturing batch key, changed for each batch or for each customer etc, and can have as short a life as desired. Compromising K_{first} need not result in a complete compromise of the chain of Ks.

Multiple Key Single Memory Vector

Protocol Background

This protocol set is an extension to the single key single memory vector protocol set, and is provided for two reasons:
the multiple key multiple memory vector protocol set defined in this document is simply extensions of this one; and
it is useful in its own right

The multiple key protocol set is typically useful for applications where there are multiple types of systems and consumables, and they need to work with each other in various ways. This is typically in the following situations:
when different systems want to share some consumables, but not others. For example printer models may share some ink cartridges and not share others.
when there are different owners of data in M. Part of the memory vector may be owned by one company (eg the speed of the printer) and another may be owned by another (eg the serial number of the chip). In this case a given key Kₙ needs to be able to write to a given part of M, and other keys Kₙ need to be disallowed from writing to these same areas.

Requirements of Protocol

Each QA Chip contains the following values:
N The maximum number of keys known to the chip.
K_{N} Array of N secret keys used for calculating F_{Kn}[X] where Kₙ is the nth element of the array. Each Kₙ must not be stored directly in the QA Chip . Instead, each chip needs to store a single random number R_{K} (different for each chip), Kₙ\textcircled{+}R_{K}, and [symbol] Kₙ\textcircled{+}R_{K}. The stored Kₙ\textcircled{+}R_{K} can be XORed with R_{K} to obtain the real Kₙ. Although [symbol] Kₙ\textcircled{+}R_{K} must be stored to protect against differential attacks, it is not used.
R Current random number used to ensure time varying messages. Each chip instance must be seeded with a different initial value. Changes for each signature generation.
M Memory vector of QA Chip. A fixed part of M contains N in ReadOnly form so users of the chip can know the number of keys known by the chip.
P N+1 element array of access permissions for each part of M. Entry 0 holds access permissions for non-authenticated writes to M (no key required). Entries 1 to N+1 hold access permissions for authenticated writes to M, one for each K. Permission choices for each part of M are Read Only, Read/Write, and Decrement Only.
C 3 constants used for generating signatures. C₁, C₂, and C₃ are constants that pad out a submessage to a hashing boundary, and all 3 must be different.

Each QA Chip contains the following private function:
S_{Kn}[N,X] Internal function only. Returns S_{Kn}[X], the result of applying a digital signature function S to X based upon the appropriate key Kₙ. The digital signature must be long enough to counter the chances of someone generating a random signature. The length depends on the signature scheme chosen, although the scheme chosen for the QA Chip is HMAC-SHA1, and therefore the length of the signature is 160 bits.

Additional functions are required in certain QA Chips, but these are described as required.

Reads

As with the single key scenario, we have a trusted chip (ChipT) connected to a System. The System wants to authenticate an object that contains a non-trusted chip (ChipA). In effect, the System wants to know that it can securely read a memory vector (M) from ChipA: to be sure that ChipA is valid and that M has not been altered. The protocol requires the following publicly available functions:
Random[ ] Returns R (does not advance R).
Read[n, X]Advances R, and returns R, M, S_{Kn}[X|R|C₁|M]. The time taken to calculate the signature must not be based on the contents of X, R, M, or K.
Test[n,X, Y, Z] Advances R and returns 1 if S_{Kn}[R|X|C₁|Y]=Z. Otherwise returns 0. The time taken to calculate and compare signatures must be independent of data content.

To authenticate ChipA and read ChipA's memory M:
a. System calls ChipT's Random function;
b. ChipT returns R_{T} to System;
c. System calls ChipA's Read function, passing in some key number n1 and the result from b;
d. ChipA updates R_{A}, then calculates and returns R_{A}, M_{A}, S_{KAn1}[R_{T}|R_{A}|C₁|M_{A}];
e. System calls ChipT's Test function, passing in n2, R_{A}, M_{A}, S_{KAn1}[R_{T}|R_{A}|C₁|M_{A}];
f. System checks response from ChipT. If the response is 1, then ChipA is considered authentic. If 0, ChipA is considered invalid.

The choice of n1 and n2 must be such that ChipA's Kₙ₁=ChipT's Kₙ₂.

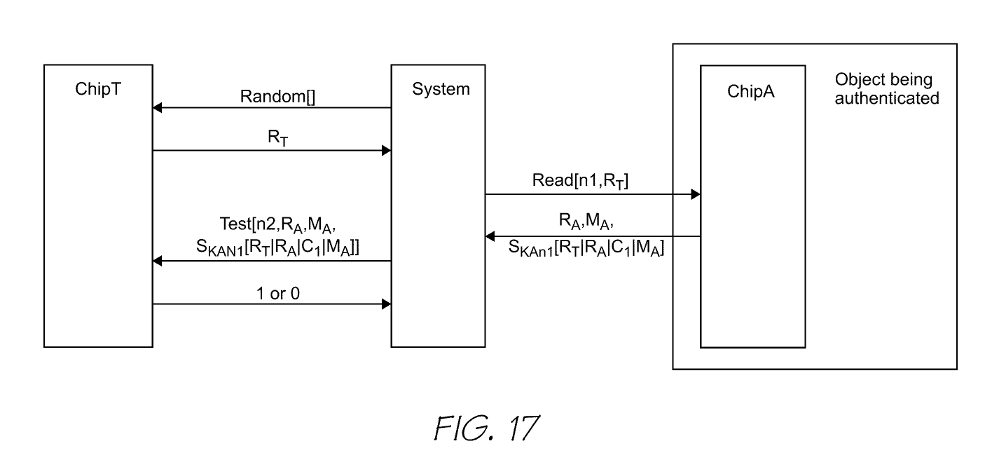

The data flow for read authentication is shown in FIG. 17.

The protocol allows System to simply pass data from one chip to another, with no special processing. The protection relies on ChipT being trusted, even though System does not know K.

When ChipT is physically separate from System (eg is chip on a board connected to System) System must also occassionally (based on system clock for example) call ChipT's Test function with bad data, expecting a 0 response. This is to prevent someone from inserting a fake ChipT into the system that always returns 1 for the Test function.

It is important that n1 is chosen by System. Otherwise ChipA would need to return N_{A} sets of signatures for each read, since ChipA does not know which of the keys will satisfy ChipT. Similarly, system must also choose n2, so it can potentially restrict the number of keys in ChipT that are matched against (otherwise ChipT would have to match against all its keys). This is important in order to restrict how different keys are used. For example, say that ChipT contains 6 keys, keys 0-2 are for various printer-related upgrades, and keys 3-6 are for inks. ChipA contains say 4 keys, one key for each printer model. At power-up, System goes through each of chipA's keys 0-3, trying each out against ChipT's keys 3-6. System doesn't try to match against ChipT's keys 0-2. Otherwise knowledge of a speed-upgrade key could be used to provide ink QA Chip chips. This matching needs to be done only once (eg at power up). Once matching keys are found, System can continue to use those key numbers.

Since System needs to know N_{T} and N_{A}, part of M is used to hold N (eg in Read Only form), and the system can obtain it by calling the Read function, passing in key 0.

Writes

As with the single key scenario, the System wants to update M in ChipU. As before, this can be done in a non-authenticated and authenticated way.

Non-Authenticated Writes

This is the most frequent type of write, and takes place between the System/consumable during normal everyday operation. In this kind of write, System wants to change M subject to P. For example, the System could be decrementing the amount of consumable remaining. Although System does not need to know any of the Ks or even have access to a trusted chip to perform the write, System must follow a non-authenticated write by an authenticated read if it needs to know that the write was successful.

The protocol requires the following publicly available function:
Write[X] Writes X over those parts of M subject to P₀ and the existing value for M.

To authenticate a write of M_{new} to ChipA's memory M:
a. System calls ChipU's Write function, passing in M_{new};
b. The authentication procedure for a Read is carried out;
c. If ChipU is authentic and M_{new}=M returned in b, the write succeeded. If not, it failed.

Authenticated Writes

In this kind of write, System wants to change Chip U's M in an authorized way, without being subject to the permissions that apply during normal operation (P₀). For example, the consumable may be at a refilling station and the normally Decrement Only section of M should be updated to include the new valid consumable. In this case, the chip whose M is being updated must authenticate the writes being generated by the external System and in addition, apply the appropriate permission for the key to ensure that only the correct parts of M are updated. Having a different permission for each key is required as when multiple keys are involved, all keys should not necessarily be given open access to M. For example, suppose M contains printer speed and a counter of money available for franking. A ChipS that updates printer speed should not be capable of updating the amount of money. Since P₀ is used for non-authenticated writes, each Kₙ has a corresponding permission Pₙ₊₁ that determines what can be updated in an authenticated write.

In this transaction protocol, the System's chip is referred to as ChipS, and the chip being updated is referred to as ChipU. Each chip distrusts the other.

The protocol requires the following publicly available functions in ChipU:
Read[n, X] Advances R, and returns R, M, S_{Kn}[X|R|C₁|M]. The time taken to calculate the signature must not be based on the contents of X, R, M, or K.
WriteA[n, X, Y, Z] Advances R, replaces M by Y subject to Pₙ₊₁, and returns 1 only if S_{Kn}[R|X|C₁|Y]=Z. Otherwise returns 0. The time taken to calculate and compare signatures must be independent of data content. This function is identical to ChipT's Test function except that it additionally writes Y subject to Pₙ₊₁ to its M when the signature matches.

Authenticated writes require that the System has access to a ChipS that is capable of generating appropriate signatures. ChipS requires the following variables and function:
CountRemaining Part of M that contains the number of signatures that ChipS is allowed to generate. Decrements with each successful call to SignM and SignP. Permissions in ChipS's P₀ for this part of M needs to be ReadOnly once ChipS has been setup. Therefore CountRemaining can only be updated by another ChipS that will perform updates to that part of M (assuming ChipS's P allows that part of M to be updated).
Q Part of M that contains the write permissions for updating ChipU's M. By adding Q to ChipS we allow different ChipSs that can update different parts of M_{U}. Permissions in ChipS's P₀ for this part of M needs to be ReadOnly once ChipS has been setup. Therefore Q can only be updated by another ChipS that will perform updates to that part of M.
SignM[n,V,W,X,Y,Z] Advances R, decrements CountRemaining and returns R, Z_{QX} (Z applied to X with permissions Q), S_{Kn}[W|R|C₁|Z_{QX}] only if Y=S_{Kn}[V|W|C₁|X] and CountRemaining>0. Otherwise returns all 0s.

The time taken to calculate and compare signatures must be independent of data content.

To update ChipU's M vector:
a. System calls ChipU's Read function, passing in n1 and 0 as the input parameters;
b. ChipU produces R_{U}, M_{U}, S_{Kn1}[0|R_{U}|C₁|M_{U}] and returns these to System;
c. System calls ChipS's SignM function, passing in n2 (the key to be used in ChipS), 0 (as used in a), R_{U}, M_{U}, S_{Kn1}[0|R_{U}|C₁|M_{U}], and M_{D} (the desired vector to be written to ChipU);
d. ChipS produces R_{S}, M_{QD} (processed by running M_{D} against M_{U} using Q) and S_{Kn2}[R_{U}|R_{S}|C₁|M_{QD}] if the inputs were valid, and 0 for all outputs if the inputs were not valid.
e. If values returned in d are non zero, then ChipU is considered authentic. System can then call ChipU's WriteA function with these values from d.
f. ChipU should return a 1 to indicate success. A 0 should only be returned if the data generated by ChipS is incorrect (e.g. a transmission error).

The choice of n1 and n2 must be such that ChipU's Kₙ₁=ChipS's Kₙ₂.

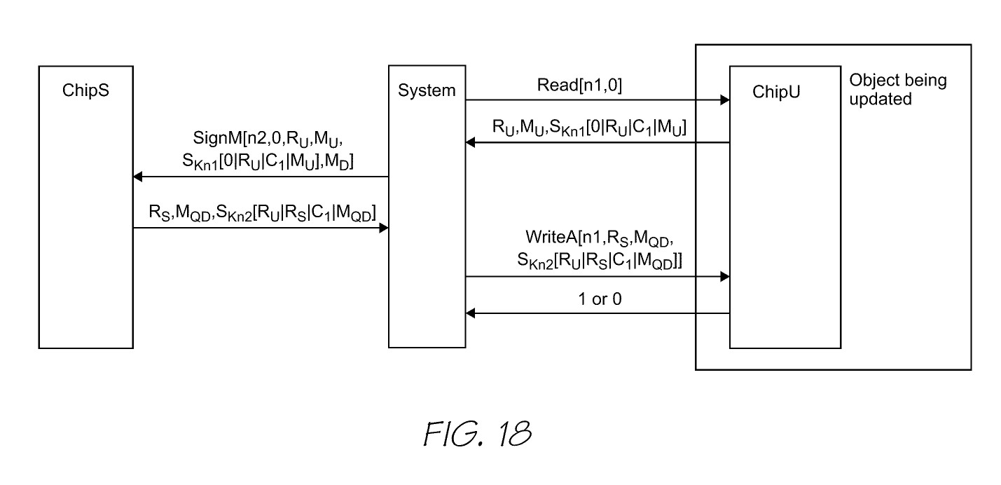

The data flow for authenticated writes is shown in FIG. 18.

Note that Q in ChipS is part of ChipS's M. This allows a user to set up ChipS with a permission set for upgrades. This should be done to ChipS and that part of M designated by P₀ set to ReadOnly before ChipS is programmed with K_{U}. If K_{S} is programmed with K_{U} first, there is a risk of someone obtaining a half-setup ChipS and changing all of M_{U} instead of only the sections specified by Q.

In addition, CountRemaining in ChipS needs to be setup (including making it ReadOnly in P_{S}) before ChipS is programmed with K_{U}. ChipS should therefore be programmed to only perform a limited number of SignM operations (thereby limiting compromise exposure if a ChipS is stolen). Thus ChipS would itself need to be upgraded with a new CountRemaining every so often.

Updating Permissions for Future Writes

In order to reduce exposure to accidental and malicious attacks on P (and certain parts of M), only authorized users are allowed to update P. Writes to P are the same as authorized writes to M, except that they update Pₙ instead of M. Initially (at manufacture), P is set to be Read/Write for all parts of M. As different processes fill up different parts of M, they can be sealed against future change by updating the permissions. Updating a chip's P₀ changes permissions for unauthorized writes, and updating Pₙ₊₁ changes permissions for authorized writes with key Kₙ.

Pₙ is only allowed to change to be a more restrictive form of itself. For example, initially all parts of M have permissions of Read/Write. A permission of Read/Write can be updated to Decrement Only or Read Only. A permission of Decrement Only can be updated to become Read Only. A Read Only permission cannot be further restricted. In this transaction protocol, the System's chip is referred to as ChipS, and the chip being updated is referred to as ChipU. Each chip distrusts the other.

The protocol requires the following publicly available functions in ChipU:
Random[ ] Returns R (does not advance R).
SetPermission[n,p,X,Y,Z] Advances R, and updates Pₚ according to Y and returns 1 followed by the resultant Pₚ only if S_{Kn}[R|X|Y|C₂]=Z. Otherwise returns 0. Pₚ can only become more restricted. Passing in 0 for any permission leaves it unchanged (passing in Y=0 returns the current Pₚ).

Authenticated writes of permissions require that the System has access to a ChipS that is capable of generating appropriate signatures. ChipS requires the following variables and function:
CountRemaining Part of M that contains the number of signatures that ChipS is allowed to generate. Decrements with each successful call to SignM and SignP. Permissions in ChipS's P₀ for this part of M needs to be ReadOnly once ChipS has been setup. Therefore CountRemaining can only be updated by another ChipS that will perform updates to that part of M (assuming ChipS's Pₙ allows that part of M to be updated).
SignP[n,X,Y] Advances R, decrements CountRemaining and returns R and S_{Kn}[X|R|Y|C₂] only if CountRemaining>0. Otherwise returns all 0s. The time taken to calculate and compare signatures must be independent of data content.

To update ChipU's Pₙ:
a. System calls ChipU's Random function;
b. ChipU returns R_{U} to System;
c. System calls ChipS's SignP function, passing in n1, R_{U} and P_{D} (the desired P to be written to ChipU);
d. ChipS produces R_{S} and S_{Kn1}[R_{U}|R_{S}|P_{D}|C₂] if it is still permitted to produce signatures.
e. If values returned in d are non zero, then System can then call ChipU's SetPermission function with n2, the desired permission entry p, R_{S}, P_{D} and S_{Kn1}[R_{U}|R_{S}|P_{D}|C₂].
f. ChipU verifies the received signature against S_{Kn2}[R_{U}|R_{S}|P_{D}|C₂] and applies P_{D} to Pₙ if the signature matches
g. System checks 1st output parameter. 1=success, 0=failure.

The choice of n1 and n2 must be such that ChipU's Kₙ₁=ChipS's Kₙ₂.

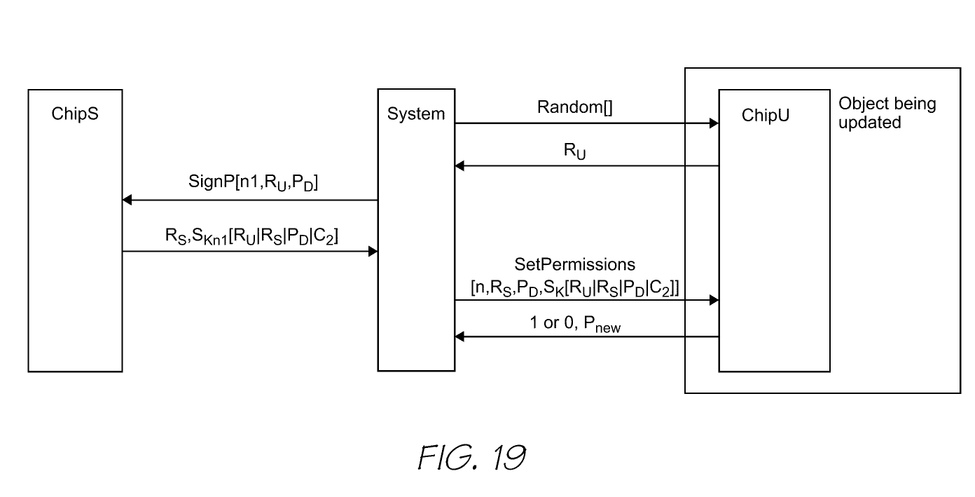

The data flow for authenticated writes to permissions is shown in FIG. 19.

Protecting M in a Multiple Key System

To protect the appropriate part of M, the SetPermission function must be called after the part of M has been set to the desired value.

For example, if adding a serial number to an area of M that is currently ReadWrite so that none is permitted to update the number again:
the Write function is called to write the serial number to M
SetPermission is called for n={1, . . . , N} to set that part of M to be ReadOnly for authorized writes using key n−1.
SetPermission is called for 0 to set that part of M to be ReadOnly for non-authorized writes

For example, adding a consumable value to M such that only keys 1-2 can update it, and keys 0, and 3-N cannot:
the Write function is called to write the amount of consumable to M
SetPermission is called for n={1, 4, 5, . . . , N−1} to set that part of M to be ReadOnly for authorized writes using key n−1. This leaves keys 1 and 2 with ReadWrite permissions.
SetPermission is called for 0 to set that part of M to be DecrementOnly for non-authorized writes. This allows the amount of consumable to decrement.

It is possible for someone who knows a key to further restrict other keys, but it is not in anyone's interest to do so.

K

In this case, we have a factory chip (ChipF) connected to a System. The System wants to program the key in another chip (ChipP). System wants to avoid passing the new key to ChipP in the clear, and also wants to avoid the possibility of the key-upgrade message being replayed on another ChipP (even if the user doesn't know the key).

The protocol is a simple extension of the single key protocol in that it assumes that ChipF and ChipP already share a secret key K_{old}. This key is used to ensure that only a chip that knows K_{old} can set K_{new}.

The protocol requires the following publicly available functions in ChipP:
Random[ ] Returns R (does not advance R).
ReplaceKey[n, X, Y, Z] Replaces Kₙ by S_{Kn}[R|X|C₃]\textcircled{+}Y, advances R, and returns 1 only if S_{Kn}[X|Y|C₃]=Z. Otherwise returns 0. The time taken to calculate signatures and compare values must be identical for all inputs.

And the following data and functions in ChipF:
CountRemaining Part of M with contains the number of signatures that ChipF is allowed to generate. Decrements with each successful call to GetProgramKey. Permissions in P for this part of M needs to be ReadOnly once ChipF has been setup. Therefore can only be updated by a ChipS that has authority to perform updates to that part of M.
K_{new} The new key to be transferred from ChipF to ChipP. Must not be visible.
SetPartialKey[X,Y] If word X of K_{new} has not yet been set, set word X of K_{new} to Y and return 1. Otherwise return 0. This function allows K_{new} to be programmed in multiple steps, thereby allowing different people or systems to know different parts of the key (but not the whole K_{new}). K_{new} is stored in ChipF's flash memory. Since there is a small number of ChipFs, it is theoretically not necessary to store the inverse of K_{new}, but it is stronger protection to do so.
GetProgramKey[n, X] Advances R_{F}, decrements CountRemaining, outputs R_{F}, the encrypted key S_{Kn}[X|R_{F}|C₃]\textcircled{+}K_{new} and a signature of the first two outputs plus C₃ if CountRemaining>0. Otherwise outputs 0. The time to calculate the encrypted key & signature must be identical for all inputs.

To update P's key:
a. System calls ChipP's Random function;
b. ChipP returns R_{P} to System;
c. System calls ChipF's GetProgramKey function, passing in n1 (the desired key to use) and the result from b;
d. ChipF updates R_{F}, then calculates and returns R_{F}, S_{Kn1}[R_{P}|R_{F}|C₃]\textcircled{+}K_{new}, and S_{Kn1}[R_{F}|S_{Kn1}[R_{P}|R_{F}|C₃]\textcircled{+}K_{new}|C₃];
e. If the response from d is not 0, System calls ChipP's ReplaceKey function, passing in n2 (the key to use in ChipP) and the response from d;
f. System checks response from ChipP. If the response is 1, then K_{Pn2} has been correctly updated to K_{new}. If the response is 0, K_{Pn2} has not been updated.

The choice of n1 and n2 must be such that ChipF's Kₙ₁=ChipP's Kₙ₂.

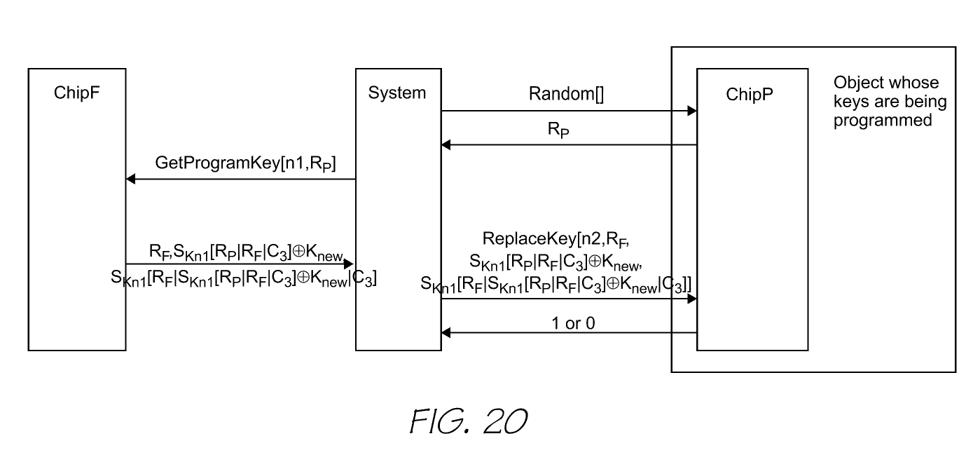

The data flow for key updates is shown in FIG. 20.

Note that K_{new} is never passed in the open. An attacker could send its own R_{P}, but cannot produce S_{Kn1}[R_{P}|R_{F}|C₃] without Kₙ₁. The signature based on K_{new} is sent to ensure that ChipP will be able to determine if either of the first two parameters have been changed en route.

CountRemaining needs to be setup in M_{F} (including making it ReadOnly in P) before ChipF is programmed with K_{P}. ChipF should therefore be programmed to only perform a limited number of GetProgramKey operations (thereby limiting compromise exposure if a ChipF is stolen). An authorized ChipS can be used to update this counter if necessary.

Chicken and Egg

As with the single key protocol, for the Program Key protocol to work, both ChipF and ChipP must both know K_{old}. Obviously both chips had to be programmed with K_{old}, and thus K_{old} can be thought of as an older K_{new}: K_{old} can be placed in chips if another ChipF knows K_{older}, and so on.

Although this process allows a chain of reprogramming of keys, with each stage secure, at some stage the very first key (K_{first}) must be placed in the chips. K_{first} is in fact programmed with the chip's microcode at the manufacturing test station as the last step in manufacturing test. K_{first} can be a manufacturing batch key, changed for each batch or for each customer etc, and can have as short a life as desired. Compromising K_{first} need not result in a complete compromise of the chain of Ks.

Depending on the reprogramming requirements, K_{first} can be the same or different for all Kₙ.

Multiple Keys Multiple Memory Vectors

Protocol Background

This protocol set is a slight restriction of the multiple key single memory vector protocol set, and is the expected protocol. It is a restriction in that M has been optimized for Flash memory utilization.

M is broken into multiple memory vectors (semi-fixed and variable components) for the purposes of optimizing flash memory utilization. Typically M contains some parts that are fixed at some stage of the manufacturing process (eg a batch number, serial number etc), and once set, are not ever updated. This information does not contain the amount of consumable remaining, and therefore is not read or written to with any great frequency.

We therefore define M₀ to be the M that contains the frequently updated sections, and the remaining Ms to be rarely written to. Authenticated writes only write to M₀, and non-authenticated writes can be directed to a specific Mn. This reduces the size of permissions that are stored in the QA Chip (since key-based writes are not required for Ms other than M₀). It also means that M₀ and the remaining Ms can be manipulated in different ways, thereby increasing flash memory longevity.

Requirements of Protocol

Each QA Chip contains the following values:
N The maximum number of keys known to the chip.
T The number of vectors M is broken into.
K_{N} Array of N secret keys used for calculating F_{Kn}[X] where Kₙ is the nth element of the array. Each Kₙ must not be stored directly in the QA Chip . Instead, each chip needs to store a single random number R_{K} (different for each chip), Kₙ\textcircled{+}R_{K}, and [symbol] Kₙ\textcircled{+}R_{K}. The stored Kₙ\textcircled{+}R_{K} can be XORed with R_{K} to obtain the real Kₙ. Although [symbol] Kₙ\textcircled{+}R_{K} must be stored to protect against differential attacks, it is not used.
R Current random number used to ensure time varying messages. Each chip instance must be seeded with a different initial value. Changes for each signature generation.
M_{T} Array of T memory vectors. Only M₀ can be written to with an authorized write, while all Ms can be written to in an unauthorized write. Writes to M₀ are optimized for Flash usage, while updates to any other Mₙ are expensive with regards to Flash utilization, and are expected to be only performed once per section of Mₙ. M₁ contains T and N in ReadOnly form so users of the chip can know these two values.
P_{T+N} T+N element array of access permissions for each part of M. Entries n={0 . . . T−1} hold access permissions for non-authenticated writes to Mₙ (no key required). Entries n={T to T+N−1} hold access permissions for authenticated writes to M₀ for Kₙ.

Permission choices for each part of M are Read Only, Read/Write, and Decrement Only.
C 3 constants used for generating signatures. C₁, C₂, and C₃ are constants that pad out a submessage to a hashing boundary, and all 3 must be different.

Each QA Chip contains the following private function:
S_{Kn}[N,X] Internal function only. Returns S_{Kn}[X], the result of applying a digital signature function S to X based upon the appropriate key Kₙ. The digital signature must be long enough to counter the chances of someone generating a random signature. The length depends on the signature scheme chosen, although the scheme chosen for the QA Chip is HMAC-SHA1, and therefore the length of the signature is 160 bits.

Additional functions are required in certain QA Chips, but these are described as required.

Reads

As with the previous scenarios, we have a trusted chip (ChipT) connected to a System. The System wants to authenticate an object that contains a non-trusted chip (ChipA). In effect, the System wants to know that it can securely read a memory vector (Mₜ) from ChipA: to be sure that ChipA is valid and that M has not been altered.

The protocol requires the following publicly available functions:
Random[ ] Returns R (does not advance R).
Read[n, t, X] Advances R, and returns R, Mₜ, S_{Kn}[X|R|C₁|Mₜ]. The time taken to calculate the signature must not be based on the contents of X, R, Mₜ, or K. If t is invalid, the function assumes t=0.
Test[n,X, Y, Z] Advances R and returns 1 if S_{Kn}[R|X|C₁|Y]=Z. Otherwise returns 0. The time taken to calculate and compare signatures must be independent of data content.

To authenticate ChipA and read ChipA's memory M:
a. System calls ChipT's Random function;
b. ChipT returns R_{T} to System;
c. System calls ChipA's Read function, passing in some key number n1, the desired M number t, and the result from b;
d. ChipA updates R_{A}, then calculates and returns R_{A}, M_{At}, S_{KAn1}[R_{T}|R_{A}|C₁|M_{At}];
e. System calls ChipT's Test function, passing in n2, R_{A}, M_{At}, S_{KAn1}[R_{T}|R_{A}|C₁|M_{At}];
f. System checks response from ChipT. If the response is 1, then ChipA is considered authentic. If 0, ChipA is considered invalid.

The choice of n1 and n2 must be such that ChipA's Kₙ₁=ChipT's Kₙ₂.

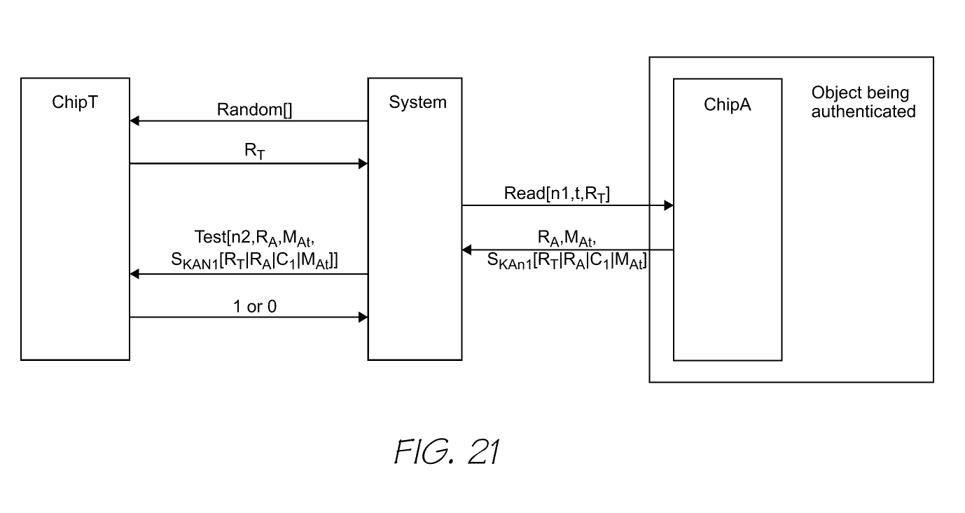

The data flow for read authentication is shown in FIG. 21.

The protocol allows System to simply pass data from one chip to another, with no special processing. The protection relies on ChipT being trusted, even though System does not know K.

When ChipT is physically separate from System (eg is chip on a board connected to System) System must also occasionally (based on system clock for example) call ChipT's Test function with bad data, expecting a 0 response. This is to prevent someone from inserting a fake ChipT into the system that always returns 1 for the Test function.

It is important that n1 is chosen by System. Otherwise ChipA would need to return N_{A} sets of signatures for each read, since ChipA does not know which of the keys will satisfy ChipT. Similarly, system must also choose n2, so it can potentially restrict the number of keys in ChipT that are matched against (otherwise ChipT would have to match against all its keys). This is important in order to restrict how different keys are used. For example, say that ChipT contains 6 keys, keys 0-2 are for various printer-related upgrades, and keys 3-6 are for inks. ChipA contains say 4 keys, one key for each printer model. At power-up, System goes through each of chipA's keys 0-3, trying each out against ChipT's keys 3-6. System doesn't try to match against ChipT's keys 0-2. Otherwise knowledge of a speed-upgrade key could be used to provide ink QA Chip chips. This matching needs to be done only once (eg at power up). Once matching keys are found, System can continue to use those key numbers.

Since System needs to know N_{T}, N_{A}, and T_{A}, part of M₁ is used to hold N (eg in Read Only form), and the system can obtain it by calling the Read function, passing in key 0 and t=1.

Writes

As with the previous scenarios, the System wants to update Mₜ in ChipU. As before, this can be done in a non-authenticated and authenticated way.

Non-Authenticated Writes

This is the most frequent type of write, and takes place between the System/consumable during normal everyday operation for M₀, and during the manufacturing process for Mₜ.

In this kind of write, System wants to change M subject to P. For example, the System could be decrementing the amount of consumable remaining. Although System does not need to know and of the Ks or even have access to a trusted chip to perform the write, System must follow a non-authenticated write by an authenticated read if it needs to know that the write was successful.

The protocol requires the following publicly available function:
Write[t, X] Writes X over those parts of Mₜ subject to Pₜ and the existing value for M.

To authenticate a write of M_{new} to ChipA's memory M:
a. System calls ChipU's Write function, passing in M_{new};
b. The authentication procedure for a Read is carried out;
c. If ChipU is authentic and M_{new}=M returned in b, the write succeeded. If not, it failed.

10.4.2 Authenticated Writes

In the multiple memory vectors protocol, only M₀ can be written to an an authenticated way. This is because only M₀ is considered to have components that need to be upgraded.

In this kind of write, System wants to change Chip U's M₀ in an authorized way, without being subject to the permissions that apply during normal operation. For example, the consumable may be at a refilling station and the normally Decrement Only section of M₀ should be updated to include the new valid consumable. In this case, the chip whose M₀ is being updated must authenticate the writes being generated by the external System and in addition, apply the appropriate permission for the key to ensure that only the correct parts of M₀ are updated. Having a different permission for each key is required as when multiple keys are involved, all keys should not necessarily be given open access to M₀. For example, suppose M₀ contains printer speed and a counter of money available for franking. A ChipS that updates printer speed should not be capable of updating the amount of money. Since P_{0 . . . T-1} is used for non-authenticated writes, each Kₙ has a corresponding permission P_{T+n} that determines what can be updated in an authenticated write.

In this transaction protocol, the System's chip is referred to as ChipS, and the chip being updated is referred to as ChipU. Each chip distrusts the other.

The protocol requires the following publicly available functions in ChipU:
Read[n, t, X] Advances R, and returns R, Mₜ, S_{Kn}[X|R|C₁|Mₜ]. The time taken to calculate the signature must not be based on the contents of X, R, Mₜ, or K.
WriteA[n, X, Y, Z] Advances R, replaces M₀ by Y subject to P_{T+n}, and returns 1 only if S_{Kn}[R|X|C₁|Y]=Z. Otherwise returns 0. The time taken to calculate and compare signatures must be independent of data content. This function is identical to ChipT's Test function except that it additionally writes Y subject to P_{T+n} to its M when the signature matches.

Authenticated writes require that the System has access to a ChipS that is capable of generating appropriate signatures. ChipS requires the following variables and function:
CountRemaining Part of M that contains the number of signatures that ChipS is allowed to generate. Decrements with each successful call to SignM and SignP. Permissions in ChipS's P_{0 . . . T-1} for this part of M needs to be ReadOnly once ChipS has been setup.

Therefore CountRemaining can only be updated by another ChipS that will perform updates to that part of M (assuming ChipS's P allows that part of M to be updated).
Q Part of M that contains the write permissions for updating ChipU's M. By adding Q to ChipS we allow different ChipSs that can update different parts of M_{U}. Permissions in ChipS's P_{0 . . . T-1} for this part of M needs to be ReadOnly once ChipS has been setup. Therefore Q can only be updated by another ChipS that will perform updates to that part of M.
SignM[n,V,W,X,Y,Z] Advances R, decrements CountRemaining and returns R, Z_{QX} (Z applied to X with permissions Q), S_{Kn}[W|R|C₁|Z_{QX}] only if Y=S_{Kn}[V|W|C₁|X] and CountRemaining>0. Otherwise returns all 0s. The time taken to calculate and compare signatures must be independent of data content.

To update ChipU's M vector:
a. System calls ChipU's Read function, passing in n1, 0 and 0 as the input parameters;
b. ChipU produces R_{U}, M_{U0}, S_{Kn1}[0|R_{U}|C₁|M_{U0}] and returns these to System;
c. System calls ChipS's SignM function, passing in n2 (the key to be used in ChipS), 0 (as used in a), R_{U}, M_{U0}, S_{Kn1}[0|R_{U}|C₁|M_{U0}], and M_{D} (the desired vector to be written to ChipU);
d. ChipS produces R_{S}, M_{QD} (processed by running M_{D} against M_{U0} using Q) and S_{Kn2}[R_{U}|R_{S}|C₁|M_{QD}] if the inputs were valid, and 0 for all outputs if the inputs were not valid.
e. If values returned in d are non zero, then ChipU is considered authentic. System can then call ChipU's WriteA function with these values from d.
f. ChipU should return a 1 to indicate success. A 0 should only be returned if the data generated by ChipS is incorrect (e.g. a transmission error).

The choice of n1 and n2 must be such that ChipU's Kₙ₁=ChipS's Kₙ₂.

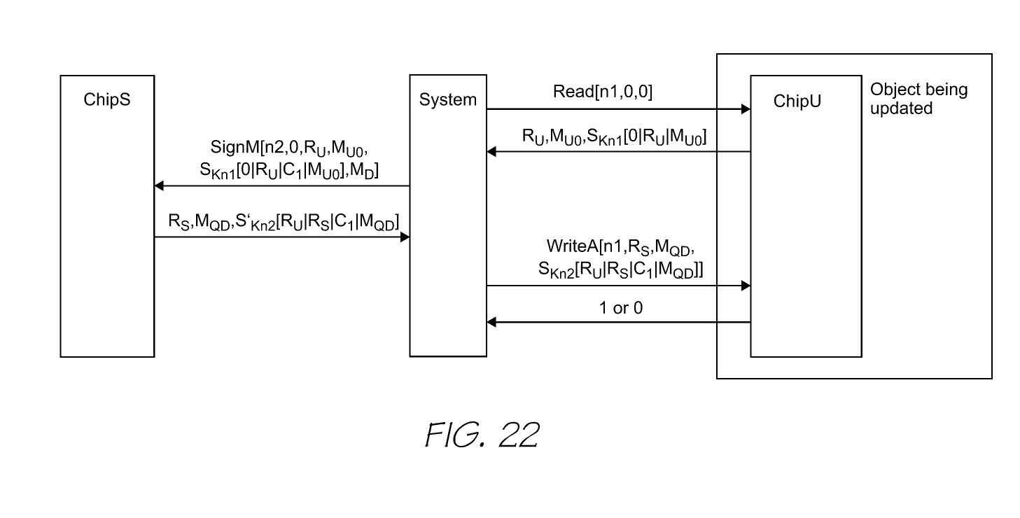

The data flow for authenticated writes is shown in FIG. 22.

Note that Q in ChipS is part of ChipS's M. This allows a user to set up ChipS with a permission set for upgrades. This should be done to ChipS and that part of M designated by P_{0 . . . T-1} set to ReadOnly before ChipS is programmed with K_{U}. If K_{S} is programmed with K_{U} first, there is a risk of someone obtaining a half-setup ChipS and changing all of M_{U} instead of only the sections specified by Q.

In addition, CountRemaining in ChipS needs to be setup (including making it ReadOnly in P_{S}) before ChipS is programmed with K_{U}. ChipS should therefore be programmed to only perform a limited number of SignM operations (thereby limiting compromise exposure if a ChipS is stolen). Thus ChipS would itself need to be upgraded with a new CountRemaining every so often.

Updating Permissions for Future Writes

In order to reduce exposure to accidental and malicious attacks on P (and certain parts of M), only authorized users are allowed to update P. Writes to P are the same as authorized writes to M, except that they update Pₙ instead of M. Initially (at manufacture), P is set to be Read/Write for all M. As different processes fill up different parts of M, they can be sealed against future change by updating the permissions. Updating a chip's P_{0 . . . T-1} changes permissions for unauthorized writes to Mₙ, and updating P_{T . . . T+N-1} changes permissions for authorized writes with key Kₙ.

Pₙ is only allowed to change to be a more restrictive form of itself. For example, initially all parts of M have permissions of Read/Write. A permission of Read/Write can be updated to Decrement Only or Read Only. A permission of Decrement Only can be updated to become Read Only. A Read Only permission cannot be further restricted.

In this transaction protocol, the System's chip is referred to as ChipS, and the chip being updated is referred to as ChipU. Each chip distrusts the other.

The protocol requires the following publicly available functions in ChipU:
Random[ ] Returns R (does not advance R).
SetPermission[n,p,X,Y,Z] Advances R, and updates Pₚ according to Y and returns 1 followed by the resultant Pₚ only if S_{Kn}[R|X|Y|C₂]=Z. Otherwise returns 0. Pₚ can only become more restricted.

Passing in 0 for any permission leaves it unchanged (passing in Y=0 returns the current Pₚ).

Authenticated writes of permissions require that the System has access to a ChipS that is capable of generating appropriate signatures. ChipS requires the following variables and function:
CountRemaining Part of ChipS's M₀ that contains the number of signatures that ChipS is allowed to generate. Decrements with each successful call to SignM and SignP. Permissions in ChipS's P_{0 . . . T-1} for this part of M₀ needs to be ReadOnly once ChipS has been setup. Therefore CountRemaining can only be updated by another ChipS that will perform updates to that part of M₀ (assuming ChipS's Pₙ allows that part of M₀ to be updated).
SignP[n,X,Y] Advances R, decrements CountRemaining and returns R and S_{Kn}[X|R|Y|C₂] only if CountRemaining>0. Otherwise returns all 0s. The time taken to calculate and compare signatures must be independent of data content.

To update ChipU's Pₙ:
a. System calls ChipU's Random function;
b. ChipU returns R_{U} to System;
c. System calls ChipS's SignP function, passing in n1, R_{U} and P_{D} (the desired P to be written to ChipU);
d. ChipS produces R_{S} and S_{Kn1}[R_{U}|R_{S}|P_{D}|C₂] if it is still permitted to produce signatures.
e. If values returned in d are non zero, then System can then call ChipU's SetPermission function with n2, the desired permission entry p, R_{S}, P_{D} and S_{Kn1}[R_{U}|R_{S}|P_{D}|C₂].
f. ChipU verifies the received signature against S_{Kn2}[R_{U}|R_{S}|P_{D}|C₂] and applies P_{D} to Pₙ if the signature matches
g. System checks 1st output parameter. 1=success, 0=failure.

The choice of n1 and n2 must be such that ChipU's Kₙ₁=ChipS's Kₙ₂.

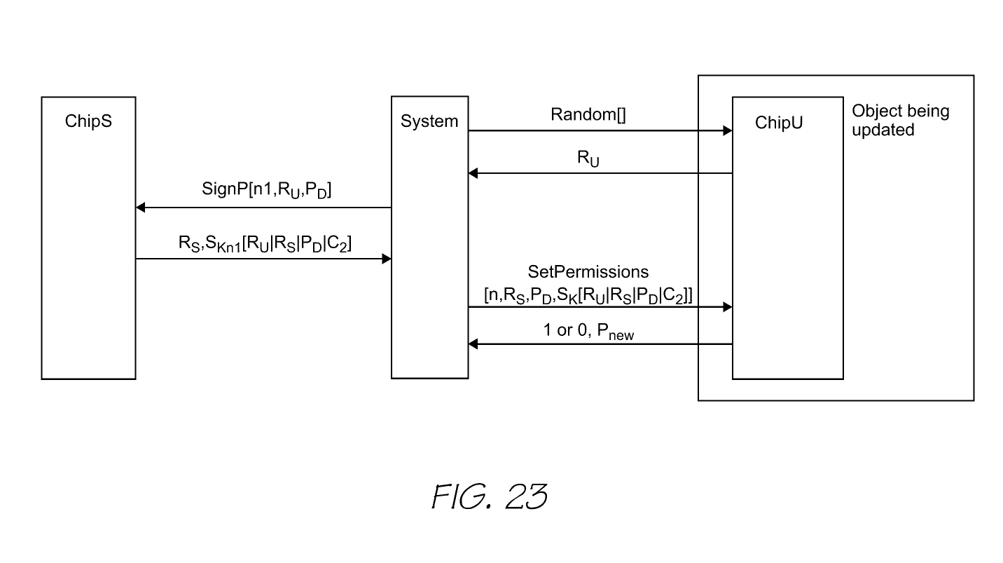

The data flow for authenticated writes to permissions is shown in FIG. 23.

Protecting M in a Multiple Key Multiple M System

To protect the appropriate part of Mn against unauthorized writes, call SetPermissions[n] for n=0 to T−1. To protect the appropriate part of M₀ against authorized writes with key n, call SetPermissions[T+n] for n=0 to N−1.

Note that only M₀ can be written in an authenticated fashion.

Note that the SetPermission function must be called after the part of M has been set to the desired value.

For example, if adding a serial number to an area of M₁ that is currently ReadWrite so that noone is permitted to update the number again:
the Write function is called to write the serial number to M₁
SetPermission(1) is called for to set that part of M to be ReadOnly for non-authorized writes.

If adding a consumable value to M₀ such that only keys 1-2 can update it, and keys 0, and 3-N cannot:
the Write function is called to write the amount of consumable to M
SetPermission is called for 0 to set that part of M₀ to be DecrementOnly for non-authorized writes. This allows the amount of consumable to decrement.
SetPermission is called for n={T, T+3, T+4 . . . , T+N−1} to set that part of M₀ to be ReadOnly for authorized writes using all but keys 1 and 2. This leaves keys 1 and 2 with ReadWrite permissions to M₀.

It is possible for someone who knows a key to further restrict other keys, but it is not in anyone's interest to do so.

Programming K

This section is identical to the multiple key single memory vector. It is repeated here with mention to M₀ instead of M for CountRemaining.

In this case, we have a factory chip (ChipF) connected to a System. The System wants to program the key in another chip (ChipP). System wants to avoid passing the new key to ChipP in the clear, and also wants to avoid the possibility of the key-upgrade message being replayed on another ChipP (even if the user doesn't know the key).

The protocol is a simple extension of the single key protocol in that it assumes that ChipF and ChipP already share a secret key K_{old}. This key is used to ensure that only a chip that knows K_{old} can set K_{new}.

The protocol requires the following publicly available functions in ChipP:
Random[ ] Returns R (does not advance R).
ReplaceKey[n, X, Y, Z] Replaces Kₙ by S_{Kn}[R|X|C₃]\textcircled{+}Y, advances R, and returns 1 only if S_{Kn}[X|Y|C₃]=Z. Otherwise returns 0. The time taken to calculate signatures and compare values must be identical for all inputs.

And the following data and functions in ChipF:
CountRemaining Part of M₀ with contains the number of signatures that ChipF is allowed to generate. Decrements with each successful call to GetProgramKey. Permissions in P for this part of M₀ needs to be ReadOnly once ChipF has been setup. Therefore can only be updated by a ChipS that has authority to perform updates to that part of M₀.
K_{new} The new key to be transferred from ChipF to ChipP. Must not be visible.
SetPartialKey[X,Y] If word X of K_{new} has not yet been set, set word X of K_{new} to Y and return 1. Otherwise return 0. This function allows K_{new} to be programmed in multiple steps, thereby allowing different people or systems to know different parts of the key (but not the whole K_{new}). K_{new} is stored in ChipF's flash memory. Since there is a small number of ChipFs, it is theoretically not necessary to store the inverse of K_{new}, but it is stronger protection to do so.
GetProgramKey[n, X] Advances R_{F}, decrements CountRemaining, outputs R_{F}, the encrypted key S_{Kn}[X|R_{F}|C₃]\textcircled{+}K_{new} and a signature of the first two outputs plus C₃ if CountRemaining>0. Otherwise outputs 0. The time to calculate the encrypted key & signature must be identical for all inputs.

To update P's key:
a. System calls ChipP's Random function;
b. ChipP returns R_{P} to System;
c. System calls ChipF's GetProgramKey function, passing in n1 (the desired key to use) and the result from b;
d. ChipF updates R_{F}, then calculates and returns R_{F}, S_{Kn1}[R_{P}|R_{F}|C₃]\textcircled{+}K_{new}, and S_{Kn1}[R_{F}|S_{Kn1}[R_{P}|R_{F}|C₃]\textcircled{+}K_{new}|C₃];
e. If the response from d is not 0, System calls ChipP's ReplaceKey function, passing in n2 (the key to use in ChipP) and the response from d;
f. System checks response from ChipP. If the response is 1, then K_{Pn2} has been correctly updated to K_{new}. If the response is 0, K_{Pn2} has not been updated.

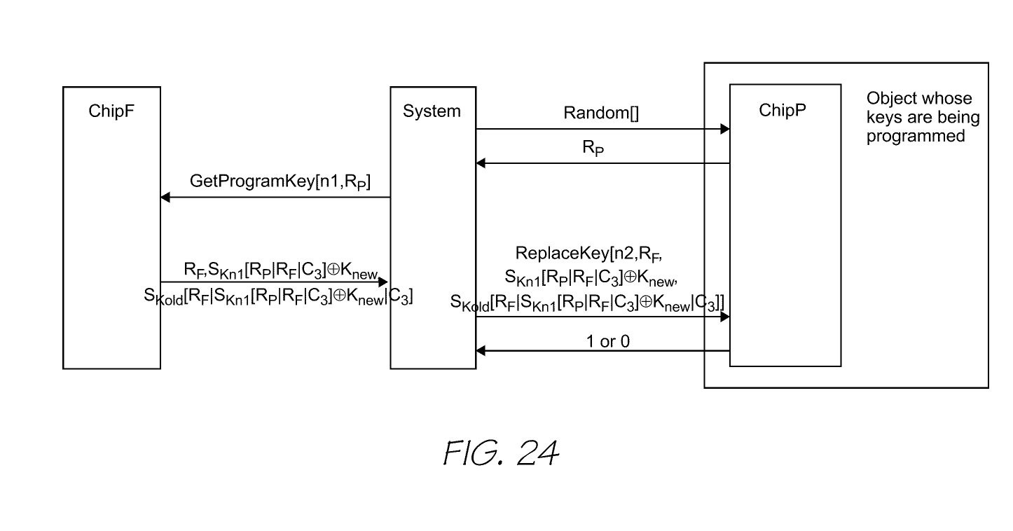

The choice of n1 and n2 must be such that ChipF's Kₙ₁=ChipP's Kₙ₂.
The data flow for key updates is shown in FIG. 24.
Note that K_{new} is never passed in the open. An attacker could send its own R_{P}, but cannot produce S_{Kn1}[R_{P}|R_{F}|C₃] without Kₙ₁. The signature based on K_{new} is sent to ensure that ChipP will be able to determine if either of the first two parameters have been changed en route.

CountRemaining needs to be setup in M_{F0} (including making it ReadOnly in P) before ChipF is programmed with K_{P}. ChipF should therefore be programmed to only perform a limited number of GetProgramKey operations (thereby limiting compromise exposure if a ChipF is stolen). An authorized ChipS can be used to update this counter if necessary.

Chicken and Egg

As with the single key protocol, for the Program Key protocol to work, both ChipF and ChipP must both know K_{old}. Obviously both chips had to be programmed with K_{old}, and thus K_{old} can be thought of as an older K_{new}:K_{old} can be placed in chips if another ChipF knows K_{older}, and so on.

Although this process allows a chain of reprogramming of keys, with each stage secure, at some stage the very first key (K_{first}) must be placed in the chips. K_{first} is in fact programmed with the chip's microcode at the manufacturing test station as the last step in manufacturing test. K_{first} can be a manufacturing batch key, changed for each batch or for each customer etc, and can have as short a life as desired. Compromising K_{first} need not result in a complete compromise of the chain of Ks.

Depending on reprogramming requirements, K_{first} can be the same or different for all Kₙ.

Security Note

Different ChipFs should have different R_{F} values to prevent K_{new} from being determined as follows:

The attacker needs 2 ChipFs, both with the same R_{F} and Kₙ but different values for K_{new}. By knowing K_{new1} the attacker can determine K_{new2}. The size of R_{F} is 2¹⁶⁰, and assuming a lifespan of approximately 2³² Rs, an attacker needs about 2⁶⁰ ChipFs with the same Kₙ to locate the correct chip. Given that there are likely to be only hundreds of ChipFs with the same Kₙ, this is not a likely attack. The attack can be eliminated completely by making C₃ different per chip and transmitting it with the new signature.

Summary of Functions for All Protocols

All protocol sets, whether single key, multiple key, single M or multiple M, all rely on the same set of functions. The function set is listed here:

All Chips

Since every chip must act as ChipP, ChipA and potentially ChipU, all chips require the following functions:
Random
ReplaceKey
Read
Write
WriteA
SetPermissions

ChipT

Chips that are to be used as ChipT also require:
Test

ChipS

Chips that are to be used as ChipS also require either or both of:
SignM
SignP

ChipF

Chips that are to be used as ChipF also require:
SetPartialKey
GetProgramKey

Remote Upgrades

Basic Remote Upgrades

Regardless of the number of keys and the number of memory vectors, the use of authenticated reads and writes, and of replacing a new key without revealing K_{new} or K_{old} allows the possibility of remote upgrades of ChipU and ChipP. The upgrade typically involves a remote server and follows two basic steps:
a. During the first stage of the upgrade, the remote system authenticates the user's system to ensure the user's system has the setup that it claims to have.
b. During the second stage of the upgrade, the user's system authenticates the remote system to ensure that the upgrade is from a trusted source.

User Requests Upgrade

The user requests that he wants to upgrade. This can be done by running a specific upgrade application on the user's computer, or by visiting a specific website.

Remote System Gathers Info Securely about User's Current Setup

In this step, the remote system determines the current setup for the user. The current setup must be authenticated, to ensure that the user truly has the setup that is claimed. Traditionally, this has been by checking the existence of files, generating checksums from those files, or by getting a serial number from a hardware dongle, although these traditional methods have difficulties since they can be generated locally by “hacked” software.

The authenticated read protocol can be used to accomplish this step. The use of random numbers has the advantage that the local user cannot capture a successful transaction and play it back on another computer system to fool the remote system.

Remote System Gives User Choice of Upgrade Possibilities & User Chooses

If there is more than one upgrade possibility, the various upgrade options are now presented to the user. The upgrade options could vary based on a number of factors, including, but not limited to:
current user setup
user's preference for payment schemes (e.g. single payment vs. multiple payment)
number of other products owned by user

The user selects an appropriate upgrade and pays if necessary (by some scheme such as via a secure web site). What is important to note here is that the user chooses a specific upgrade and commences the upgrade operation.

Remote System Sends Upgrade Request to Local System

The remote system now instructs the local system to perform the upgrade. However, the local system can only accept an upgrade from the remote system if the remote system is also authenticated. This is effectively an authenticated write. The use of R_{U} in the signature prevents the upgrade message from being replayed on another ChipU.

If multiple keys are used, and each chip has a unique key, the remote system can use a serial number obtained from the current setup (authenticated by a common key) to lookup the unique key for use in the upgrade. Although the random number provides time varying messages, use of an unknown K that is different for each chip means that collection and examination of messages and their signatures is made even more difficult.

OEM Upgrades

OEM upgrades are effectively the same as remote upgrades, except that the user interacts with an OEM server for upgrade selection. The OEM server may send sub-requests to the manufacturer's remote server to provide authentication, upgrade availability lists, and base-level pricing information.

An additional level of authentication may be incorporated into the protocol to ensure that upgrade requests are coming from the OEM server, and not from a 3rd party. This can readily be incorporated into both authentication steps.

Choice of Signature Function

Given that all protocols make use of keyed signature functions, the choice of function is examined here.

Table 5 outlines the attributes of the applicable choices. The attributes are phrased so that the attribute is seen as an advantage.

TABLE 5
Attributes of Applicable Signature Functions

| | Triple | Blow | | | Random | HMAC- | HMAC- | HMAC- |
|---|---|---|---|---|---|---|---|---|
| | DES | fish | RC5 | IDEA | Sequences | MD5 | SHA1 | RIPEMD160 |
| Free of patents | • | • | | | • | • | • | • |
| Random key | | | | | | • | • | • |
| generation | | | | | | | | |
| Can be exported from | | | | | • | • | • | • |
| the USA | | | | | | | | |
| Fast | | • | | | | • | • | • |
| Preferred Key Size | 168 | 128 | 128 | 128 | 512 | 128 | 160 | 160 |
| (bits) for use in this | | | | | | | | |
| application | | | | | | | | |
| Block size (bits) | 64 | 64 | 64 | 64 | 256 | 512 | 512 | 512 |
| Cryptanalysis Attack- | • | • | | | • | | • | • |
| Free | | | | | | | | |
| (apart from weak | | | | | | | | |
| keys) | | | | | | | | |
| Output size given | ≧N | ≧N | ≧N | ≧N | 128 | 128 | 160 | 160 |
| input size N | | | | | | | | |
| Low storage | | | | | • | • | • | • |
| requirements | | | | | | | | |
| Low silicon complexity | | | | | • | • | • | • |
| NSA designed | • | | | | | | • | |

An examination of Table 5 shows that the choice is effectively between the 3 HMAC constructs and the Random Sequence. The problem of key size and key generation eliminates the Random Sequence. Given that a number of attacks have already been carried out on MD5 and since the hash result is only 128 bits, HMAC-MD5 is also eliminated. The choice is therefore between HMAC-SHA1 and HMAC-RIPEMD160. Of these, SHA-1 is the preferred function, since:
SHA-1 has been more extensively cryptanalyzed without being broken;
SHA-1 requires slightly less intermediate storage than RIPE-MD-160;
SHA-1 is algorithmically less complex than RIPE-MD-160;

Although SHA-1 is slightly faster than RIPE-MD-160, this was not a reason for choosing SHA-1.

HMAC-SHA1

The mechanism for authentication is the HMAC-SHA1 algorithm. This section examines the HMAC-SHA1 algorithm in greater detail than covered so far, and describes an optimization of the algorithm that requires fewer memory resources than the original definition.

HMAC

Given the following definitions:
H=the hash function (e.g. MD5 or SHA-1)
n=number of bits output from H (e.g. 160 for SHA-1, 128 bits for MD5)
M=the data to which the MAC function is to be applied
K=the secret key shared by the two parties
ipad=0x36 repeated 64 times
opad =0x5C repeated 64 times

The HMAC algorithm is as follows:
a. Extend K to 64 bytes by appending 0x00 bytes to the end of K
b. XOR the 64 byte string created in (1) with ipad
c. append data stream M to the 64 byte string created in (2)
d. Apply H to the stream generated in (3)
e. XOR the 64 byte string created in (1) with opad
f. Append the H result from (4) to the 64 byte string resulting from (5)
g. Apply H to the output of (6) and output the result

Thus:
HMAC[M]=H[(K\textcircled{+}opad)|H[(K\textcircled{+}ipad)|M]]
The HMAC-SHA1 algorithm is simply HMAC with H=SHA-1.

SHA-1

Nine 32-bit constants are defined in Table 6. There are 5 constants used to initialize the chaining variables, and there are 4 additive constants.

TABLE 6
Constants used in SHA-1

| | |
|---|---|
| Initial Chaining Values | Additive Constants |

| | | | |
|---|---|---|---|
| h₁ | 0x67452301 | y₁ | 0x5A827999 |
| h₂ | 0xEFCDAB89 | y₂ | 0x6ED9EBA1 |
| h₃ | 0x98BADCFE | y₃ | 0x8F1BBCDC |
| h₄ | 0x10325476 | y₄ | 0xCA62C1D6 |
| h₅ | 0xC3D2E1F0 | | |

Non-optimized SHA-1 requires a total of 2912 bits of data storage:
Five 32-bit chaining variables are defined: H₁, H₂, H₃, H₄ and H₅.
Five 32-bit working variables are defined: A, B, C, D, and E.
One 32-bit temporary variable is defined: t.
Eighty 32-bit temporary registers are defined: X₀₋₇₉.

The following functions are defined for SHA-1:

TABLE 7
Functions used in SHA-1

| Symbolic | |
|---|---|
| Nomenclature | Description |
| + | Addition modulo 2³² |
| X << Y | Result of rotating X left through Y bit |
| | positions |
| f(X, Y, Z) | (X [symbol] Y) [symbol] ( [symbol] X [symbol] Z) |
| g(X, Y, Z) | (X [symbol] Y) [symbol] (X [symbol] Z) [symbol] (Y [symbol] Z) |
| h(X, Y, Z) | X ⊕ Y ⊕Z |

The hashing algorithm consists of firstly padding the input message to be a multiple of 512 bits and initializing the chaining variables H₁₋₅ with h₁₋₅. The padded message is then processed in 512-bit chunks, with the output hash value being the final 160-bit value given by the concatenation of the chaining variables: H₁|H₂|H₃|H₄|H₅.

The steps of the SHA-1 algorithm are now examined in greater detail.

Step 1. Preprocessing

The first step of SHA-1 is to pad the input message to be a multiple of 512 bits as follows and to initialize the chaining variables.

TABLE 8
Steps to follow to preprocess the input message

| | |
|---|---|
| Pad the input | Append a 1 bit to the message |
| message | |
| | Append 0 bits such that the length of |
| | the padded message is 64-bits short of |
| | a multiple of 512 bits. |
| | Append a 64-bit value containing the |
| | length in bits of the original input |
| | message. Store the length as most |
| | significant bit through to least |
| | significant bit. |
| Initialize the | H₁ ←h₁, H₂ ←h₂, H₃ ←h₃, H₄ ←h₄, H₅ |
| chaining variables | ←h₅ |

Step 2. Processing

The padded input message is processed in 512-bit blocks. Each 512-bit block is in the form of 16×32-bit words, referred to as InputWord₀₋₁₅.

TABLE 9
Steps to follow for each 512 bit block (InputWord₀₋₁₅)

| | |
|---|---|
| Copy the 512 input | For j = 0 to 15 |
| bits into X₀₋₁₅ | Xⱼ = InputWordⱼ |
| Expand X₀₋₁₅ into | For j = 16 to 79 |
| X₁₆₋₇₉ | Xⱼ ←((Xⱼ₋₃ ⊕ Xⱼ₋₈ ⊕ Xⱼ₋₁₄ ⊕ Xⱼ₋₁₆) << 1) |
| Initialize working | A ←H₁, B ←H₂, C ←H₃, D ←H₄, E ←H₅ |
| variables | |
| Round 1 | For j = 0 to 19 |
| | t ←((A << 5) + f(B, C, D) + E + Xj + y1) |
| | E ←D, D ←C, C ←(B << 30), B ←A, A ← t |
| Round 2 | For j = 20 to 39 |
| | t ←((A << 5) + h(B, C, D) + E + Xj + y2) |
| | E ←D, D ←C, C ←(B << 30), B ←A, A ← t |
| Round 3 | For j = 40 to 59 |
| | t ←((A << 5) + g(B, C, D) + E + Xj + y3) |
| | E ←D, D ←C, C ←(B << 30), B ←A, A ← t |
| Round 4 | For j = 60 to 79 |
| | t ←((A << 5) + h(B, C, D) + E + Xj + y4) |
| | E ←D, D ←C, C ←(B << 30), B ←A, A ← t |
| Update chaining | H₁ ←H₁ + A, H₂ ←H₂ + B, |
| variables | H₃ ←H₃ + C, H₄ ←H₄ + D, |
| | H₅ ←H₅ + E |

The bold text is to emphasize the differences between each round.

Step 3. Completion

After all the 512-bit blocks of the padded input message have been processed, the output hash value is the final 160-bit value given by: H₁|H₂|H₃|H₄|H₅.

Optimization for Hardware Implementation

The SHA-1 Step 2 procedure is not optimized for hardware. In particular, the 80 temporary 32-bit registers use up valuable silicon on a hardware implementation. This section describes an optimization to the SHA-1 algorithm that only uses 16 temporary registers. The reduction in silicon is from 2560 bits down to 512 bits, a saving of over 2000 bits. It may not be important in some applications, but in the QA Chip storage space must be reduced where possible.

The optimization is based on the fact that although the original 16-word message block is expanded into an 80-word message block, the 80 words are not updated during the algorithm. In addition, the words rely on the previous 16 words only, and hence the expanded words can be calculated on-the-fly during processing, as long as we keep 16 words for the backward references. We require rotating counters to keep track of which register we are up to using, but the effect is to save a large amount of storage.

Rather than index X by a single value j, we use a 5 bit counter to count through the iterations. This can be achieved by initializing a 5-bit register with either 16 or 20, and decrementing it until it reaches 0. In order to update the 16 temporary variables as if they were 80, we require 4 indexes, each a 4-bit register. All 4 indexes increment (with wraparound) during the course of the algorithm.

TABLE 10
Optimised Steps to follow for each 512 bit block (InputWord₀₋₁₅)

| | |
|---|---|
| Initialize working | A ←H₁, B ←H₂, C ←H₃, D ←H₄, E ←H₅ |
| variables | N1 ←13, N2 ←8, N3 ←2, N4 ←0 |
| Round 0 | Do 16 times |
| Copy the 512 input bits | X_{N4} = InputWord_{N4} |
| into X₀₋₁₅ | [ [symbol] N₁, [symbol] N₂, [symbol] N₃]ₒₚₜᵢₒₙₐₗ [symbol] N₄ |
| Round 1A | Do 16 times |
| | t ←((A << 5) + f(B, C, D) + E + X_{N4} + y₁) |
| | [ [symbol] N₁, [symbol] N₂, [symbol] N₃]ₒₚₜᵢₒₙₐₗ [symbol] N₄ |
| | E ←D, D ←C, C ←(B << 30), B ←A, A ←t |
| Round 1B | Do 4 times |
| | X_{N4} ←((X_{N1} ⊕ X_{N2} ⊕ X_{N3} ⊕ X_{N4}) << 1) |
| | t ←((A << 5) + f(B, C, D) + E + X_{N4} + y₁) |
| | [symbol] N₁, [symbol] N₂, [symbol] N₃, [symbol] N₄ |
| | E ←D, D ←C, C ←(B << 30), B ←A, A ←t |
| Round 2 | Do 20 times |
| | X_{N4} ←((X_{N1} ⊕ X_{N2} ⊕ X_{N3} ⊕ X_{N4}) << 1) |
| | t ←((A << 5) + h(B, C, D) + E + X_{N4} + y₂) |
| | [symbol] N₁, [symbol] N₂, [symbol] N₃, [symbol] N₄ |
| | E ←D, D ←C, C ←(B << 30), B ←A, A ←t |
| Round 3 | Do 20 times |
| | X_{N4} ←((X_{N1} ⊕ X_{N2} ⊕ X_{N3} ⊕ X_{N4}) << 1) |
| | t ←((A << 5) + g(B, C, D) + E + X_{N4} + y₃) |
| | [symbol] N₁, [symbol] N₂, [symbol] N₃, [symbol] N₄ |
| | E ←D, D ←C, C ←(B << 30), B ←A, A ←t |
| Round 4 | Do 20 times |
| | X_{N4} ←((X_{N1} ⊕ X_{N2} ⊕ X_{N3} ⊕ X_{N4}) << 1) |
| | t ←((A << 5) + h(B, C, D) + E + X_{N4} + y₄) |
| | [symbol] N₁, [symbol] N₂, [symbol] N₃, [symbol] N₄ |
| | E ←D, D ←C, C ←(B << 30), B ←A, A ←t |
| Update chaining | H₁ ←H₁ + A, H₂ ←H₂ + B, |
| variables | H₃ ←H₃ + C, H₄ ←H₄ + D, |
| | H₅ ←H₅ + E |

The bold text is to emphasize the differences between each round.

The incrementing of N₁, N₂, and N₃ during Rounds 0 and 1A is optional. A software implementation would not increment them, since it takes time, and at the end of the 16 times through the loop, all 4 counters will be their original values. Designers of hardware may wish to increment all 4 counters together to save on control logic. Round 0 can be completely omitted if the caller loads the 512 bits of X₀₋₁₅.

Logical Interface

Introduction

The QA Chip has a physical and a logical external interface. The physical interface defines how the QA Chip can be connected to a physical System, while the logical interface determines how that System can communicate with the QA Chip. This section deals with the logical interface.

Operating Modes

The QA Chip has four operating modes—Idle Mode, Program Mode, Trim Mode and Active Mode.
Idle Mode is used to allow the chip to wait for the next instruction from the System.
Trim Mode is used to determine the clock speed of the chip and to trim the frequency during the initial programming stage of the chip (when Flash memory is garbage). The clock frequency must be trimmed via Trim Mode before Program Mode is used to store the program code.
Program Mode is used to load up the operating program code, and is required because the operating program code is stored in Flash memory instead of ROM (for security reasons).
Active Mode is used to execute the specific authentication command specified by the System. Program code is executed in Active Mode. When the results of the command have been returned to the System, the chip enters Idle Mode to wait for the next instruction.

Idle Mode

The QA Chip starts up in Idle Mode. When the Chip is in Idle Mode, it waits for a command from the master by watching the primary id on the serial line.
If the primary id matches the global id (0x00, common to all QA Chips), and the following byte from the master is the Trim Mode id byte, the QA Chip enters Trim Mode and starts counting the number of internal clock cycles until the next byte is received.
If the primary id matches the global id (0x00, common to all QA Chips), and the following byte from the master is the Program Mode id byte, the QA Chip enters Program Mode.
If the primary id matches the global id (0x00, common to all QA Chips), and the following byte from the master is the Active Mode id byte, the QA Chip enters Active Mode and executes startup code, allowing the chip to set itself into a state to receive authentication commands (includes setting a local id).
If the primary id matches the chip's local id, and the following byte is a valid command code, the QA Chip enters Active Mode, allowing the command to be executed.

The valid 8-bit serial mode values sent after a global id are as shown in Table 11. They are specified to minimize the chances of them occurring by error after a global id (e.g. 0xFF and 0x00 are not used):

TABLE 11
Id byte values to place chip in specific mode

| Value | Interpretation |
|---|---|
| 10100101 | Trim Mode |
| (0xA5) | |
| 10001110 | Program Mode |
| (0x8E) | |
| 01111000 | Active Mode |
| (0x78) | |

Trim Mode

Trim Mode is enabled by sending a global id byte (0x00) followed by the Trim Mode command byte.

The purpose of Trim Mode is to set the trim value (an internal register setting) of the internal ring oscillator so that Flash erasures and writes are of the correct duration. This is necessary due to the variation of the clock speed due to process variations. If writes an erasures are too long, the Flash memory will wear out faster than desired, and in some cases can even be damaged.

Trim Mode works by measuring the number of system clock cycles that occur inside the chip from the receipt of the Trim Mode command byte until the receipt of a data byte. When the data byte is received, the data byte is copied to the trim register and the current value of the count is transmitted to the outside world.

Once the count has been transmitted, the QA Chip returns to Idle Mode.

At reset, the internal trim register setting is set to a known value r. The external user can now perform the following operations:
send the global id+write followed by the Trim Mode command byte
send the 8-bit value v over a specified time t
send a stop bit to signify no more data
send the global id+read followed by the Trim Mode command byte
receive the count c
send a stop bit to signify no more data

At the end of this procedure, the trim register will be v, and the external user will know the relationship between external time t and internal time c. Therefore a new value for v can be calculated.

The Trim Mode procedure can be repeated a number of times, varying both t and v in known ways, measuring the resultant c. At the end of the process, the final value for v is established (and stored in the trim register for subsequent use in Program Mode). This value v must also be written to the flash for later use (every time the chip is placed in Active Mode for the first time after power-up).

Program Mode

Program Mode is enabled by sending a global id byte (0x00) followed by the Program Mode command byte.

The QA Chip determines whether or not the internal fuse has been blown (by reading 32-bit word 0 of the information block of flash memory).

If the fuse has been blown the Program Mode command is ignored, and the QA Chip returns to Idle Mode.

If the fuse is still intact, the chip enters Program Mode and erases the entire contents of Flash memory. The QA Chip then validates the erasure. If the erasure was successful, the QA Chip receives up to 4096 bytes of data corresponding to the new program code and variable data. The bytes are transferred in order byte₀ to byte₄₀₉₅.

Once all bytes of data have been loaded into Flash, the QA Chip returns to Idle Mode.

Note that Trim Mode functionality must be performed before a chip enters Program Mode for the first time.

Once the desired number of bytes have been downloaded in Program Mode, the LSS Master must wait for 80 μs (the time taken to write two bytes to flash at nybble rates) before sending the new transaction (eg Active Mode). Otherwise the last nybbles may not be written to flash.

Active Mode

Active Mode is entered either by receiving a global id byte (0x00) followed by the Active Mode command byte, or by sending a local id byte followed by a command opcode byte and an appropriate number of data bytes representing the required input parameters for that opcode.

In both cases, Active Mode causes execution of program code previously stored in the flash memory via Program Mode. As a result, we never enter Active Mode after Trim Mode, without a Program Mode in between. However once programmed via Program Mode, a chip is allowed to enter Active Mode after power-up, since valid data will be in flash.

If Active Mode is entered by the global id mechanism, the QA Chip executes specific reset startup code, typically setting up the local id and other IO specific data.

If Active Mode is entered by the local id mechanism, the QA Chip executes specific code depending on the following byte, which functions as an opcode. The opcode command byte format is shown in Table 12:

TABLE 12
Command byte

| bits | Description |
|---|---|
| 2-0 | Opcode |
| 5-3 | [symbol] opcode |
| 7-6 | count of number of bits set in opcode (0 to 3) |

The interpretation of the 3-bit opcode is shown in Table 13:

TABLE 13
QA Chip opcodes

| Opcode | Mnemonic | Description |
|---|---|---|
| 000 | RST | Reset |
| 001 | RND | Random |
| 010 | RDM | Read M |
| 011 | TST | Test |
| 100 | WRM | Write M with no authentication |
| 101 | WRA | Write with Authentication (to M, P, or K) |

| | |
|---|---|
| 110 | chip specific - reserved for ChipF, ChipS etc |
| 111 | chip specific - reserved for ChipF, ChipS etc |

The command byte is designed to ensure that errors in transmission are detected. Regular QA Chip commands are therefore comprised of an opcode plus any associated parameters. The commands are listed in Table 14:

TABLE 14
QA Chip commands

| | Input | | Output |
|---|---|---|---|
| Command | opcode | Additional parms | Return value |
| Reset | RST | — | — |
| Random | RND | — | [20] |
| Read | RDM | [1, 1, 20] | [20, 64, 20] |
| Test | TST | [1, 20, 64, 20] | 89 if successful, 76 if |
| | | | not |
| Write | WRM | [1, 64, 20] | 89 if successful, 76 if |
| | | | not |
| WriteAuth | WRA | 76 [20, 64, 20] | 89 if successful, 76 if |
| | | | not |
| ReplaceKey | WRA | 89 76 [1, 20, 20, | 89 if successful, 76 if |
| | | 20] | not |
| SetPermissions | WRA | 89 89 [1, 1, 20, 4, | [4] |
| | | 20] | |
| SignM | ChipS | [1, 20, 20, 64, 20, | [20, 64, 20] |
| | only | 64] | |
| SignP | ChipS | [1, 20, 20, 4, 20, 4] | [20, 64, 20] |
| | only | | |
| GetProgKey | ChipF | [1, 20] | [20, 20, 20] |
| | only | | |
| SetPartialKey | ChipF | [1, 4] | 89 if successful, 76 if |
| | only | | not |

Apart from the Reset command, the next four commands are the commands most likely to be used during regular operation. The next three commands are used to provide authenticated writes (which are expected to be uncommon). The final set of commands (including SignM), are expected to be specially implemented on ChipS and ChipF QA Chips only.

The input parameters are sent in the specified order, with each parameter being sent least significant byte first and most significant byte last.

Return (output) values are read in the same way—least significant byte first and most significant byte last. The client must know how many bytes to retrieve. The QA Chip will time out and return to Idle Mode if an incorrect number of bytes is provided or read. In most cases, the output bytes from one chip's command (the return values) can be fed directly as the input bytes to another chip's command. An example of this is the RND and RD commands. The output data from a call to RND on a trusted QA Chip does not have to be kept by the System. Instead, the System can transfer the output bytes directly to the input of the non-trusted QA Chip's RD command. The description of each command points out where this is so.

Each of the commands is examined in detail in the subsequent sections. Note that some algorithms are specifically designed because flash memory is assumed for the implementation of non-volatile variables.

Non Volatile Variables

The memory within the QA Chip contains some non-volatile (Flash) memory to store the variables required by the authentication protocol. Table 15 summarizes the variables.

TABLE 15
Non volatile variables required by the authentication protocol

| | Size | |
|---|---|---|
| Name | (bits) | Description |
| N | 8 | Number of keys known to the chip |
| T | 8 | Number of vectors M is broken into |
| Kₙ | 160 per | Array of N secret keys used for calculating |
| R_{K} | key, 160 | F_{Kn}[X] where Kₙ is the nth element of the |
| | for R_{K} | array. Each Kₙ must not be stored directly |
| | | in the QA Chip. Instead, each chip needs |
| | | to store a single random number R_{K} |
| | | (different for each chip), Kₙ⊕R_{K}, and |
| | | [symbol] Kₙ⊕R_{K}. The stored Kₙ⊕R_{K} can be |
| | | XORed with R_{K} to obtain the real Kₙ. |
| | | Although [symbol] Kₙ⊕R_{K} must be stored to protect |
| | | against differential attacks, it is not |
| | | used. |
| R | 160 | Current random number used to ensure |
| | | time varying messages. Each chip |
| | | instance must be seeded with a different |
| | | initial value. Changes for each signature |
| | | generation. |
| M_{T} | 512 per M | Array of T memory vectors. Only M₀ can |
| | | be written to with an authorized write, |
| | | while all Ms can be written to in an |
| | | unauthorized write. Writes to M₀ are |
| | | optimized for Flash usage, while updates |
| | | to any other Mₙ are expensive with |
| | | regards to Flash utilization, and are |
| | | expected to be only performed once per |
| | | section of Mₙ. M₁ contains T and N in |
| | | ReadOnly form so users of the chip can |
| | | know these two values. |
| P_{T+N} | 32 per P | T + N element array of access permissions |
| | | for each part of M. Entries n = {0 . . . T − 1} |
| | | hold access permissions for non-authenticated |
| | | writes to Mₙ (no key required). Entries |
| | | n = {T to T + N − 1}hold access permissions |
| | | for authenticated writes to M₀ for Kₙ. |
| | | Permission choices for each part of M are |
| | | Read Only, Read/Write, and Decrement |
| | | Only |
| MinTicks | 32 | The minimum number of clock ticks |
| | | between calls to key-based functions. |

Note that since these variables are in Flash memory, writes should be minimized. The it is not a simple matter to write a new value to replace the old. Care must be taken with flash endurance, and speed of access. This has an effect on the algorithms used to change Flash memory based registers. For example, Flash memory should not be used as a shift register.

A reset of the QA Chip has no effect on the non-volatile variables.

M and P

Mₙ contains application specific state data, such as serial numbers, batch numbers, and amount of consumable remaining. Mₙ can be read using the Read command and written to via the Write and WriteA commands.

M₀ is expected to be updated frequently, while each part of M₁₋ₙ should only be written to once. Only M₀ can be written to via the WriteA command.

M₁ contains the operating parameters of the chip as shown in Table 243, and M₂₋ₙ are application specific.

TABLE 16
Interpretation of M₁

| Length | Bits | interpretation |
|---|---|---|
| 8 | 7-0 | Number of available keys |
| 8 | 15-8 | Number of available M vectors |
| 16 | 31-16 | Revision of chip |
| 96 | 127-32 | Manufacture id information |
| 128 | 255-128 | Serial number |
| 8 | 263-256 | Local id of chip |
| 248 | 511-264 | reserved |

Each Mₙ is 512 bits in length, and is interpreted as a set of 16×32-bit words. Although Mₙ may contain a number of different elements, each 32-bit word differs only in write permissions. Each 32-bit word can always be read. Once in client memory, the 512 bits can be interpreted in any way chosen by the client. The different write permissions for each P are outlined in Table 17:

TABLE 17
Write permissions

| Data type | permission description |
|---|---|
| Read Only | Can never be written to |
| ReadWrite | Can always be written to |
| Decrement | Can only be written to if the new value is less than |
| Only | the old value. Decrement Only values can be any |
| | multiple of 32 bits. |

To accomplish the protection required for writing, a 2-bit permission value P is defined for each of the 32-bit words. Table 18 defines the interpretation of the 2-bit permission bit-pattern:

TABLE 18
Permission bit interpretation

| | | | Action taken during Write |
|---|---|---|---|
| Bits | Op | Interpretation | command |
| 00 | RW | ReadWrite | The new 32-bit value is always |
| | | | written to M[n]. |
| 01 | MSR | Decrement Only | The new 32-bit value is only |
| | | (Most Significant | written to M[n] if it is less than the |
| | | Region) | value currently in M[n]. This is |
| | | | used for access to the Most |
| | | | Significant 16 bits of a Decrement |
| | | | Only number. |
| 10 | NMSR | Decrement Only | The new 32-bit value is only |
| | | (Not the Most | written to M[n] if M[n − 1] could |
| | | Significant | also be written. The NMSR access |
| | | Region) | mode allows multiple precision |
| | | | values of 32 bits and more |
| | | | (multiples of 32 bits) to |
| | | | decrement. |
| 11 | RO | Read Only | The new 32-bit value is ignored. |
| | | | M[n] is left unchanged. |

The 16 sets of permission bits for each 512 bits of M are gathered together in a single 32-bit variable P, where bits 2n and 2n+1 of P correspond to word n of M as follows:

Each 2-bit value is stored as a pair with the msb in bit 1, and the lsb in bit 0. Consequently, if words 0 to 5 of M had permission MSR, with words 6-15 of M permission RO, the 32-bit P variable would be 0xFFFFF555:

11-11-11-11-11-11-11-11-11-11-01-01-01-01-01-01

During execution of a Write and WriteA command, the appropriate Permissions[n] is examined for each M[n] starting from n=15 (msw of M) to n=0 (lsw of M), and a decision made as to whether the new M[n] value will replace the old. Note that it is important to process the M[n] from msw to lsw to correctly interpret the access permissions.

Permissions are set and read using the QA Chip's SetPermissions command. The default for P is all 0s (RW) with the exception of certain parts of M₁.

Note that the Decrement Only comparison is unsigned, so any Decrement Only values that require negative ranges must be shifted into a positive range. For example, a consumable with a Decrement Only data item range of −50 to 50 must have the range shifted to be 0 to 100. The System must then interpret the range 0 to 100 as being −50 to 50. Note that most instances of Decrement Only ranges are N to 0, so there is no range shift required.

For Decrement Only data items, arrange the data in order from most significant to least significant 32-bit quantities from M[n] onward. The access mode for the most significant 32 bits (stored in M[n]) should be set to MSR. The remaining 32-bit entries for the data should have their permissions set to NMSR.

If erroneously set to NMSR, with no associated MSR region, each NMSR region will be considered independently instead of being a multi-precision comparison.

K and R_{K}

K is the 160-bit secret key used to protect M and to ensure that the contents of M are valid (when M is read from a non trusted chip). K is initially programmed after manufacture, and from that point on, K can only be updated to a new value if the old K is known. Since K must be kept secret, there is no command to directly read it.

K is used in the keyed one-way hash function HMAC-SHA1. As such it should be programmed with a physically generated random number, gathered from a physically random phenomenon. K must NOT be generated with a computer-run random number generator. The security of the QA Chips depends on K being generated in a way that is not deterministic.

Each Kₙ must not be stored directly in the QA Chip. Instead, each chip needs to store a single random number R_{K} (different for each chip), Kₙ\textcircled{+}R_{K}, and [symbol] Kₙ\textcircled{+}R_{K}. The stored Kₙ\textcircled{+}R_{K} can be XORed with R_{K} to obtain the real Kₙ. Although [symbol] Kₙ\textcircled{+}R_{K} must be stored to protect against differential attacks, it is not used.

R

R is a 160-bit random number seed that is set up after manufacture (when the chip is programmed) and from that point on, cannot be changed. R is used to ensure that each signed item contains time varying information (not chosen by an attacker), and each chip's R is unrelated from one chip to the next.

R is used during the Test command to ensure that the R from the previous call to Random was used as the session key in generating the signature during Read. Likewise, R is used during the WriteAuth command to ensure that the R from the previous call to Read was used as the session key during generation of the signature in the remote Authenticated chip.

The only invalid value for R is 0. This is because R is changed via a 160-bit maximal period LFSR (Linear Feedback Shift Register) with taps on bits 0, 2, 3, and 5, and is changed only by a successful call to a signature generating function (e.g. Test, WriteAuth).

The logical security of the QA Chip relies not only upon the randomness of K and the strength of the HMAC-SHA1 algorithm. To prevent an attacker from building a sparse lookup table, the security of the QA Chip also depends on the range of R over the lifetime of all Systems. What this means is that an attacker must not be able to deduce what values of R there are in produced and future Systems. Ideally, R should be programmed with a physically generated random number, gathered from a physically random phenomenon (must not be deterministic). R must NOT be generated with a computer-run random number generator.

MinTicks

There are two mechanisms for preventing an attacker from generating multiple calls to key-based functions in a short period of time. The first is an internal ring oscillator that is temperature-filtered. The second mechanism is the 32-bit MinTicks variable, which is used to specify the minimum number of QA Chip clock ticks that must elapse between calls to key-based functions.

The MinTicks variable is set to a fixed value when the QA Chip is programmed. It could possibly be stored in M₁.

The effective value of MinTicks depends on the operating clock speed and the notion of what constitutes a reasonable time between key-based function calls (application specific). The duration of a single tick depends on the operating clock speed. This is the fastest speed of the ring oscillator generated clock (i.e. at the lowest valid operating temperature).

Once the duration of a tick is known, the MinTicks value can to be set. The value for MinTicks will be the minimum number of ticks required to pass between calls to the key-based functions (there is no need to protect Random as this produces the same output each time it is called multiple times in a row). The value is a real-time number, and divided by the length of an operating tick.

It should be noted that the MinTicks variable only slows down an attacker and causes the attack to cost more since it does not stop an attacker using multiple System chips in parallel.

GetProgramKey

| | |
|---|---|
| Input: | n, R_{E} = [1 byte, 20 bytes] |
| Output: | R_{L}, E_{Kx}[S_{Kn}[R_{E}\|R_{L}\|C₃]], S_{Kx}[R_{L}\|E_{Kx}[S_{Kn}[R_{E}\|R_{L}\|C₃]\|C₃] = |
| | [20, 20, 20] |
| Changes: | R_{L} |

Note:
The GetProgramKey command is only implemented in ChipF, and not in all QA Chips.

The GetProgramKey command is used to produce the bytestream required for updating a specified key in ChipP. Only an QA Chip programmed with the correct values of the old Kₙ can respond correctly to the GetProgramKey request. The output bytestream from the Random command can be fed as the input bytestream to the ReplaceKey command on the QA Chip being programmed (ChipP).

The input bytestream consists of the appropriate opcode followed by the desired key to generate the signature, followed by 20 bytes of R_{E}(representing the random number read in from ChipP).

The local random number R_{L} is advanced, and signed in combination with R_{E} and C₃ by the chosen key to generate a time varying secret number known to both ChipF and ChipP. This signature is then XORed with the new key Kₓ (this encrypts the new key). The first two output parameters are signed with the old key to ensure that ChipP knows it decoded Kₓ correctly.

This whole procedure should only be allowed a given number of times. The actual number can conveniently be stored in the local M₀[0] (eg word 0 of M₀) with ReadOnly permission. Of course another chip could perform an Authorised write to update the number (via a ChipS) should it be desired.

The GetProgramKey command is implemented by the following steps:

Loop through all of Flash, reading each word (will trigger checks)
Accept n
Restrict n to N
Accept R_{E}
If (M₀[0] = 0)

Output 60 bytes of 0x00# no more keys allowed to be generated

from this chipF

Done

EndIf
Advance R_{L}
SIG ← S_{Kn}[R_{L}|R_{E}|C₃] # calculation must take constant time
Tmp ← SIG ⊕ K_{X}
Output R_{L}
Output Tmp
Decrement M₀[0] # reduce the number of allowable key generations by 1
SIG ← S_{KX}[R_{L}|Tmp|C₃] # calculation must take constant time
Output SIG

Random

| | |
|---|---|
| Input: | None |
| Output: | R_{L} = [20 bytes] |
| Changes: | None |

The Random command is used by a client to obtain an input for use in a subsequent authentication procedure. Since the Random command requires no input parameters, it is therefore simply 1 byte containing the RND opcode.

The output of the Random command from a trusted QA Chip can be fed straight into the non-trusted chip's Read command as part of the input parameters. There is no need for the client to store them at all, since they are not required again. However the Test command will only succeed if the data passed to the Read command was obtained first from the Random command.

If a caller only calls the Random function multiple times, the same output will be returned each time. R will only advance to the next random number in the sequence after a successful call to a function that returns or tests a signature.

The Random command is implemented by the following steps:

Loop through all of Flash, reading each word (will trigger checks)
Output R_{L}

Read

| | |
|---|---|
| Input: | n, t, R_{E} = [1 byte, 1 byte, 20 bytes] |
| Output: | R_{L}, M_{Lt}, S_{Kn}[R_{E}\|R_{L}\|C₁\|M_{Lt}] = [20 bytes, 64 bytes, 20 bytes] |
| Changes: | R_{L} |

The Read command is used to read the entire state data (Mₜ) from an QA Chip. Only an QA Chip programmed with the correct value of Kₙ can respond correctly to the Read request. The output bytestream from the Read command can be fed as the input bytestream to the Test command on a trusted QA Chip for verification, with Mₜ stored for later use if Test returns success.

The input bytestream consists of the RD opcode followed by the key number to use for the signature, which M to read, and the bytes 0-19 of R_{E}. 23 bytes are transferred in total. R_{E} is obtained by calling the trusted QA Chip's Random command. The 20 bytes output by the trusted chip's Random command can therefore be fed directly into the non-trusted chip's Read command, with no need for these bits to be stored by System.

Calls to Read must wait for MinTicksRemaining to reach 0 to ensure that a minimum time will elapse between calls to Read.

The output values are calculated, MinTicksRemaining is updated, and the signature is returned. The contents of M_{Lt} are transferred least significant byte to most significant byte. The signature S_{Kn}[R_{E}|R_{L}|C₁|M_{Lt}] must be calculated in constant time.

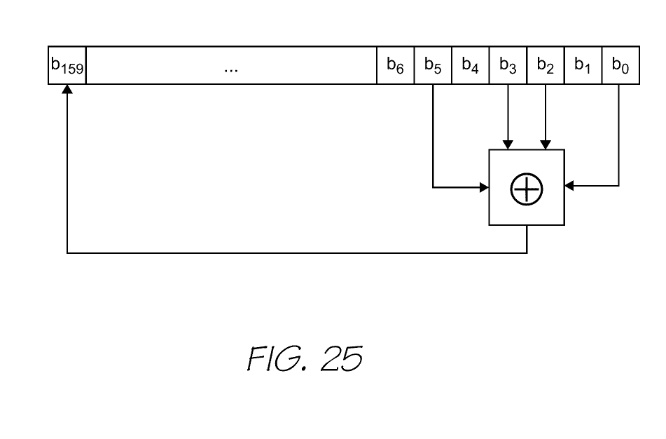

The next random number is generated from R using a 160-bit maximal period LFSR (tap selections on bits 5, 3, 2, and 0). The initial 160-bit value for R is set up when the chip is programmed, and can be any random number except 0 (an LFSR filled with 0s will produce a never-ending stream of 0s). R is transformed by XORing bits 0, 2, 3, and 5 together, and shifting all 160 bits right 1 bit using the XOR result as the input bit to b₁₅₉. The process is shown in FIG. 25.

Care should be taken when updating R since it lives in Flash. Program code must assume power could be removed at any time.

The Read command is implemented with the following steps:

Wait for MinTicksRemaining to become 0
Loop through all of Flash, reading each word (will trigger checks)
Accept n
Accept t
Restrict n to N
Restrict t to T
Accept R_{E}
Advance R_{L}
Output R_{L}
Output M_{Lt}
Sig ← S_{Kn}[R_{E}|R_{L}|C₁|M_{Lt}] # calculation must take constant time
MinTicksRemaining ← MinTicks
Output Sig
Wait for MinTicksRemaining to become 0

Set Permissions

| | |
|---|---|
| Input: | n, p, R_{E}, P_{E}, SIG_{E} = [1 byte, 1 byte, 20 bytes, 4 bytes, 20 |
| | bytes] |
| Output: | Pₚ |
| Changes: | Pₚ, R_{L} |

The SetPermissions command is used to securely update the contents of Pₚ (containing QA Chip permissions). The WriteAuth command only attempts to replace Pₚ if the new value is signed combined with our local R.

It is only possible to sign messages by knowing Kₙ. This can be achieved by a call to the SignP command (because only a ChipS can know Kₙ). It means that without a chip that can be used to produce the required signature, a write of any value to Pₚ is not possible.

The process is very similar to Test, except that if the validation succeeds, the P_{E} input parameter is additionally ORed with the current value for Pₚ. Note that this is an OR, and not a replace. Since the SetParms command only sets bits in Pₚ. the effect is to allow the permission bits corresponding to M[n] to progress from RW to either MSR, NMSR, or RO.

The SetPermissions command is implemented with the following steps:

```
Wait for MinTicksRemaining to become 0
Loop through all of Flash, reading each word (will trigger checks)
Accept n
Restrict n to N
Accept p
Restrict p to T+N
Accept R_{E}
Accept P_{E}
SIG_{L} ← S_{Kn}[R_{L}|R_{E}|P_{E}|C₂] # calculation must take constant time
Accept SIG_{E}
If (SIG_{E} = SIG_{L})
  Update R_{L}
  P_{P} ← P_{P} $$ P_{E}
EndIf
Output P_{P} # success or failure will be determined by receiver
MinTicksRemaining ← MinTicks
```

ReplaceKey

| | |
|---|---|
| Input: | n, R_{E}, V, SIG_{E} = [1 byte, 20 bytes, 20 bytes, 20 bytes] |
| Output: | Boolean (0x76 = failure, 0x89 = success) |
| Changes: | Kₙ, M_{L}, R_{L} |

The ReplaceKey command is used to replace the specified key in the QA Chip flash memory. However Kₙ can only be replaced if the previous value is known. A return byte of 0x89 is produced if the key was successfully updated, while 0x76 is returned for failure.

A ReplaceKey command consists of the WRA command opcode followed by 0x89, 0x76, and then the appropriate parameters. Note that the new key is not sent in the clear, it is sent encrypted with the signature of R_{L}, R_{E} and C₃ (signed with the old key). The first two input parameters must be verified by generating a signature using the old key.

The ReplaceKey command is implemented with the following steps:

```
Loop through all of Flash, reading each word (will trigger checks)
Accept n
Restrict n to N
Accept R_{E}# session key from ChipF
Accept V # encrypted key
SIG_{L} ← S_{Kn}[R_{E}|V|C₃] # calculation must take constant time
Accept SIG_{E}
If (SIG_{L} = SIG_{E2}) # comparison must take constant time
  SIG_{L} ← S_{Kn}[R_{L}|R_{E}|C₃]# calculation must take constant time
  Advance R_{L}
  K_{E} ← SIG_{L} ⊕ V
  Kₙ ← K_{E}  # involves storing (K_{E} ⊕ R_{K}) and ( [symbol] K_{E} ⊕ R_{K})
  Output 0x89 # success
Else
  Output 0x76 # failure
EndIf
```

SignM

| | |
|---|---|
| Input: | n, R_{X}, R_{E}, M_{E}, SIG_{E}, M_{desired} = [1 byte, 20 bytes, 20 bytes, 64 |
| | bytes, 32 bytes] |
| Output: | R_{L}, M_{new}, S_{Kn}[R_{E}\|R_{L}\|C₁\|M_{new}] = [20 bytes, 64 bytes, |
| | 20 bytes] |
| Changes: | R_{L} |

Note:
The SignM command is only implemented in ChipS, and not in all QA Chips.

The SignM command is used to produce a valid signed M for use in an authenticated write transaction. Only an QA Chip programmed with correct value of Kₙ can respond correctly to the SignM request. The output bytestream from the SignM command can be fed as the input bytestream to the WriteA command on a different QA Chip.

The input bytestream consists of the SMR opcode followed by 1 byte containing the key number to use for generating the signature, 20 bytes of R_{X} (representing the number passed in as R to ChipU's READ command, i.e. typically 0), the output from the READ command (namely R_{E}, M_{E}, and SIG_{E}), and finally the desired M to write to ChipU. The SignM command only succeeds when SIG_{E}=S_{K}[R_{X}|R_{E}|C₁|M_{E}], indicating that the request was generated from a chip that knows K. This generation and comparison must take the same amount of time regardless of whether the input parameters are correct or not. If the times are not the same, an attacker can gain information about which bits of the supplied signature are incorrect. If the signatures match, then R_{L} is updated to be the next random number in the sequence.

Since the SignM function generates signatures, the function must wait for the MinTicksRemaining register to reach 0 before processing takes place.

Once all the inputs have been verified, a new memory vector is produced by applying a specially stored P value (eg word 1 of M₀) and M_{desired} against M_{E}. Effectively, it is performing a regular Write, but with separate P against someone else's M. The M_{new} is signed with an updated R_{L} (and the passed in R_{E}), and all three values are output (the random number R_{L}, M_{new}, and the signature). The time taken to generate this signature must be the same regardless of the inputs.

Typically, the SignM command will be acting as a form of consumable command, so that a given ChipS can only generate a given number of signatures. The actual number can conveniently be stored in M₀ (eg word 0 of M₀) with ReadOnly permissions. Of course another chip could perform an Authorised write to update the number (using another ChipS) should it be desired.

The SignM command is implemented with the following steps:

Wait for MinTicksRemaining to become 0
Loop through all of Flash, reading each word (will trigger checks)
Accept n
Restrict n to N

| | |
|---|---|
| Accept R_{X} | # don't care what this number is |
| Accept R_{E} | |
| Accept M_{E} | |
| SIG_{L} ← S_{Kn}[R_{X}\|R_{E}\|C₁\|M_{E}] | # calculation must take constant time |

```
Accept SIG_{E}
Accept M_{desired}
If ((SIG_{E} ≠ SIG_{L}) OR (M_{L}[0] = 0)) # fail if bad signature or if allowed
sigs = 0
  Output appropriate number of 0  # report failure
  Done
EndIf
Update R_{L}
# Create the new version of M in ram from W and Permissions
# This is the same as the core process of Write function
# except that we don't write the results back to M
DecEncountered ← 0
EqEncountered ← 0
Permissions = M_{L}[1]  #  assuming  M₀  contains
appropriate permissions
For n ← msw to lsw #(word 15 to 0)
  AM ← Permissions[n]
  LT ← (M_{desired}[n] < M_{E}[n]) # comparison is unsigned
  EQ ← (M_{desired}[n] = M_{E}[n])
  WE ← (AM = RW) [symbol]  ((AM = MSR) [symbol]  LT) [symbol]  ((AM = NMSR) [symbol]
(DecEncountered [symbol]  LT))
  DecEncountered ← ((AM = MSR) [symbol]  LT) [symbol]
          ((AM = NMSR) [symbol]  DecEncountered) [symbol]
          ((AM = NMSR) [symbol]  EqEncountered [symbol]  LT)
  EqEncountered ← ((AM = MSR) [symbol]  EQ) [symbol]  ((AM =
NMSR) [symbol]  EqEncountered [symbol]  EQ)
  If ( [symbol] WE) [symbol]  (M_{E}[n] ≠ M_{desired}[n])
    Output appropriate number of 0  # report failure
  EndIf
EndFor
# At this point, M_{desired} is correct
Output R_{L}
Output M_{desired}  # M_{desired} is now effectively M_{new}
Sig ← S_{Kn}[R_{E}|R_{L}|C₁|M_{desired}] # calculation must take constant time
MinTicksRemaining ← MinTicks
Decrement M_{L}[0] # reduce the number of allowable signatures by 1
Output Sig
```

SignP

| | |
|---|---|
| Input: | n, R_{E}, P_{desired} = [1 byte, 20 bytes, 4 bytes] |
| Output: | R_{L}, S_{Kn}[R_{E}\|R_{L}\|P_{desired}\|C₂] = [20 bytes, 20 bytes] |
| Changes: | R_{L} |

Note:
The SignP command is only implemented in ChipS, and not in all QA Chips.

The SignP command is used to produce a valid signed P for use in a SetPermissions transaction. Only an QA Chip programmed with correct value of Kₙ can respond correctly to the SignP request. The output bytestream from the SignP command can be fed as the input bytestream to the SetPermissions command on a different QA Chip.

The input bytestream consists of the SMP opcode followed by 1 byte containing the key number to use for generating the signature, 20 bytes of R_{E} (representing the number obtained from ChipU's RND command, and finally the desired P to write to ChipU.

Since the SignP function generates signatures, the function must wait for the MinTicksRemaining register to reach 0 before processing takes place.

Once all the inputs have been verified, the P_{desired} is signed with an updated R_{L} (and the passed in R_{E}), and both values are output (the random number R_{L} and the signature). The time taken to generate this signature must be the same regardless of the inputs.

Typically, the SignP command will be acting as a form of consumable command, so that a given ChipS can only generate a given number of signatures. The actual number can conveniently be stored in M₀ (eg word 0 of M₀) with ReadOnly permissions. Of course another chip could perform an Authorised write to update the number (using another ChipS) should it be desired.

The SignM command is implemented with the following steps:

```
Wait for MinTicksRemaining to become 0
Loop through all of Flash, reading each word (will trigger checks)
Accept n
Restrict n to N
Accept R_{E}
Accept P_{desired}
If (M_{L}[0] = 0) # fail if allowed sigs = 0
  Output appropriate number of 0  # report failure
  Done
EndIf
Update R_{L}
Output R_{L}
Sig ← S_{Kn}[R_{E}|R_{L}|P_{desired}|C₂] # calculation must take constant time
MinTicksRemaining ← MinTicks
Decrement M_{L}[0] # reduce the number of allowable signatures by 1
Output Sig
```

Test

| | |
|---|---|
| Input: | n, R_{E}, M_{E}, SIG_{E} = [1 byte, 20 bytes, 64 bytes, 20 bytes] |
| Output: | Boolean (0x76 = failure, 0x89 = success) |
| Changes: | R_{L} |

The Test command is used to authenticate a read of an M from a non-trusted QA Chip.

The Test command consists of the TST command opcode followed by input parameters: n, R_{E}, M_{E}, and SIG_{E}. The byte order is least significant byte to most significant byte for each command component. All but the first input parameter bytes are obtained as the output bytes from a Read command to a non-trusted QA Chip. The entire data does not have to be stored by the client. Instead, the bytes can be passed directly to the trusted QA Chip's Test command, and only M should be kept from the Read.

Calls to Test must wait for the MinTicksRemaining register to reach 0.

S_{Kn}[R_{L}|R_{E}|C₁|M_{E}] is then calculated, and compared against the input signature SIG_{E}. If they are different, R_{L} is not changed, and 0x76 is returned to indicate failure. If they are the same, then R_{L} is updated to be the next random number in the sequence and 0x89 is returned to indicate success. Updating R_{L} only after success forces the caller to use a new random number (via the Random command) each time a successful authentication is performed.

The calculation of S_{Kn}[R_{L}|R_{E}|C₁|M_{E}] and the comparison against SIG_{E} must take identical time so that the time to evaluate the comparison in the TST function is always the same. Thus no attacker can compare execution times or number of bits processed before an output is given.

The Test command is implemented with the following steps:

```
Wait for MinTicksRemaining to become 0
Loop through all of Flash, reading each word (will trigger checks)
Accept n
Restrict n to N
Accept R_{E}
Accept M_{E}
SIG_{L} ← S_{Kn}[R_{L}|R_{E}|C₁|M_{E}] # calculation must take constant time
Accept SIG_{E}
If (SIG_{E} = SIG_{L})
  Update R_{L}
  Output 0x89 # success
Else
  Output 0x76  # report failure
EndIf
MinTicksRemaining ← MinTicks
```

Write

| | |
|---|---|
| Input: | t, M_{new}, SIG_{E} = [1 byte, 64 bytes, 20 bytes] |
| Output: | Boolean (0x76 = failure, 0x89 = success) |
| Changes: | Mₜ |

The Write command is used to update Mₜ according to the permissions in Pₜ. The WR command by itself is not secure, since a clone QA Chip may simply return success every time. Therefore a Write command should be followed by an authenticated read of Mₜ (e.g. via a Read command) to ensure that the change was actually made. The Write command is called by passing the WR command opcode followed by which M to be updated, the new data to be written to M, and a digital signature of M. The data is sent least significant byte to most significant byte.

The ability to write to a specific 32-bit word within Mₜ is governed by the corresponding Permissions bits as stored in Pₜ. Pₜ can be set using the SetPermissions command. The fact that Mₜ is Flash memory must be taken into account when writing the new value to M. It is possible for an attacker to remove power at any time. In addition, only the changes to M should be stored for maximum utilization. In addition, the longevity of M will need to be taken into account. This may result in the location of M being updated. The signature is not keyed, since it must be generated by the consumable user.

The Write command is implemented with the following steps:

```
Loop through all of Flash, reading each word (will trigger checks)
Accept t
Restrict t to T
Accept M_{E} # new M
Accept SIG_{E}
SIG_{L} = Generate SHA1[M_{E}]
If (SIG_{L} = SIG_{E})
  output 0x76 # failure due to invalid signature
  exit
EndIf
DecEncountered ← 0
EqEncountered ← 0
For i ← msw to lsw #(word 15 to 0)
  P ← Pₜ[i]
  LT ← (M_{E}[i] < Mₜ[i]) # comparison is unsigned
  EQ ← (M_{E}[i] = Mₜ[i])
  WE ← (P = RW) [symbol]  ((P = MSR) [symbol]  LT) [symbol]  ((P = NMSR) [symbol]
(DecEncountered [symbol]  LT))
  DecEncountered ← ((P = MSR) [symbol]  LT) [symbol]
        ((P = NMSR) [symbol]  DecEncountered) [symbol]
        ((P = NMSR) [symbol]  EqEncountered [symbol]  LT)
  EqEncountered ← ((P = MSR) [symbol]  EQ) [symbol]  ((P = NMSR) [symbol]
EqEncountered [symbol]  EQ)
  If ( [symbol]  WE) [symbol]  (M_{E}[i] ≠ Mₜ[i])
    output 0x76 # failure due to wanting a change but not allowed it
  EndIf
EndFor
# At this point, M_{E} (desired) is correct to be written to the flash
Mₜ ← M_{E}  # update flash
output 0x89  # success
```

WriteAuth

| | |
|---|---|
| Input: | n, R_{E}, M_{E}, SIG_{E} = [1 byte, 20 bytes, 64 bytes, 20 bytes] |
| Output: | Boolean (0x76 = failure, 0x89 = success) |
| Changes: | M₀, R_{L} |

The WriteAuth command is used to securely replace the entire contents of M₀ (containing QA Chip application specific data) according to the P_{T+n}. The WriteAuth command only attempts to replace M₀ if the new value is signed combined with our local R.

It is only possible to sign messages by knowing Kₙ. This can be achieved by a call to the SignM command (because only a ChipS can know Kₙ). It means that without a chip that can be used to produce the required signature, a write of any value to M₀ is not possible.

The process is very similar to Write, except that if the validation succeeds, the M_{E} input parameter is processed against M₀ using permissions P_{T+n}.

The WriteAuth command is implemented with the following steps:

```
Wait for MinTicksRemaining to become 0
Loop through all of Flash, reading each word (will trigger checks)
Accept n
Restrict n to N
Accept R_{E}
Accept M_{E}
SIG_{L} ← S_{Kn}[R_{L}|R_{E}|C₁|M_{E}] # calculation must take constant time
Accept SIG_{E}
If (SIG_{E} = SIG_{L})
  Update R_{L}
  DecEncountered ← 0
  EqEncountered ← 0
  For i ← msw to lsw #(word 15 to 0)
    P ← P_{T+n}[i]
    LT ← (M_{E}[i] < M₀[i])  # comparison is unsigned
    EQ ← (M_{E}[i] = M₀[i])
    WE ← (P = RW) [symbol]  ((P = MSR) [symbol]  LT) [symbol]  ((P = NMSR) [symbol]
    (DecEncountered [symbol]  LT))
    DecEncountered ← ((P = MSR) [symbol]  LT) [symbol]
          ((P = NMSR) [symbol]  DecEncountered) [symbol]
          ((P = NMSR) [symbol]  EqEncountered [symbol] LT)
    EqEncountered ← ((P = MSR) [symbol]  EQ) [symbol]  ((P = NMSR) [symbol]
    EqEncountered [symbol]  EQ)
    If (( [symbol]  WE) [symbol]  (M_{E}[i] ≠ M₀[i]))
      output 0x76 # failure due to wanting a change but not allowed it
    EndIf
  EndFor
  # At this point, M_{E} (desired) is correct to be written to the flash
  M₀ ← M_{E}  # update flash
  output 0x89  # success
EndIf
MinTicksRemaining ← MinTicks
```

Logical Interface Specification for Preferred Form of QA Chip

The QA Chip Logical Interface provides authenticated manipulation of specific printer and consumable parameters. The interface is described in terms of data structures and the functions that manipulate them, together with examples of use. While the descriptions and examples are targetted towards the printer application, they are equally applicable in other domains.

An instance of a QA Chip Logical Interface (on any platform) is a QA Device.

QA Devices cannot talk directly to each other. A System is a logical entity which has one or more QA Devices connected logically (or physically) to it, and calls the functions on the QA Devices. The system is considered secure and the program running on the system is considered to be trusted.

Types of QA Devices

Trusted QA Device

The Trusted QA Device forms an integral part of the system itself and resides within the trusted environment of the system. It enables the system to extend trust to external QA Device s. The Trusted QA Device is only trusted because the system itself is trusted.

External Untrusted QA Device

The External untrusted QA Device is a QA Device that resides external to the trusted environment of the system and is therefore untrusted. The purpose of the QA Chip Logical Interface is to allow the external untrusted QA Devices to become effectively trusted. This is accomplished when a Trusted QA Device shares a secret key with the external untrusted QA Device, or with a Translation QA Device (see below).

In a printing application external untrusted QA Devices would typically be instances of SBR4320 implementations located in a consumable or the printer.

Translation QA Device

A Translation QA Device is used to translate signatures between QA Devices and extend effective trust when secret keys are not directly shared between QA Devices. The Translation QA Device must share a secret key with the Trusted QA Device that allows the Translation QA Device to effectively become trusted by the Trusted QA Device and hence trusted by the system. The Translation QA Device shares a different secret key with another external untrusted QA Device (which may in fact be a Translation QA Device etc). Although the Trusted QA Device doesn't share (know) the key of the external untrusted QA Device, signatures generated by that untrusted device can be translated by the Translation QA Device into signatures based on the key that the Trusted QA Device does know, and thus extend trust to the otherwise untrusted external QA Device.

In a SoPEC-based printing application, the Printer QA Device acts as a Translation QA Device since it shares a secret key with the SoPEC, and a different secret key with the ink carridges.

Consumable QA Device

A Consumable QA Device is an external untrusted QA Device located in a consumable. It typically contains details about the consumable, including how much of the consumable remains.

In a printing application the consumable QA Device is typically found in an ink cartridge and is referred to as an Ink QA Device, or simply Ink QA since ink is the most common consumable for printing applications. However, other consumables in printing applications include media and impression counts, so consumable QA Device is more generic.

Printer QA Device

A Printer QA Device is an external untrusted device located in the printer. It contains details about the operating parameters for the printer, and is often referred to as a Printer QA.

Value Upgrader QA Device

A Value Upgrader QA Device contains the necessary functions to allow a system to write an initial value (e.g. an ink amount) into another QA Device, typically a consumable QA Device. It also allows a system to refill/replenish a value in a consumable QA Device after use.

Whenever a value upgrader QA Device increases the amount of value in another QA Device, the value in the value upgrader QA Device is correspondingly decreased. This means the value upgrader QA Device cannot create value—it can only pass on whatever value it itself has been issued with. Thus a value upgrader QA Device can itself be replenished or topped up by another value upgrader QA Device.

An example of a value upgrader is an Ink Refill QA Device, which is used to fill/refill ink amount in an Ink QA Device.

Parameter Upgrader QA Device

A Parameter Upgrader QA Device contains the necessary functions to allow a system to write an initial parameter value (e.g. a print speed) into another QA Device, typically a printer QA Device. It also allows a system to change that parameter value at some later date.

A parameter upgrader QA Device is able to perform a fixed number of upgrades, and this number is effectively a consumable value. Thus the number of available upgrades decreases by 1 with each upgrade, and can be replenished by a value upgrader QA Device.

Key Programmer QA Device

Secret batch keys are inserted into QA Devices during instantiation (e.g. manufacture). These keys must be replaced by the final secret keys when the purpose of the QA Device is known. The Key Programmer QA Device implements all necessary functions for replacing keys in other QA Devices.

Signature

Digital signatures are used throughout the authentication protocols of the QA Chip Logical Interface. A signature is produced by passing data plus a secret key through a keyed hash function. The signature proves that the data was signed by someone who knew the secret key.

The signature function used throughout the QA Chip Logical Interface is HMAC-SHA1.

Authenticated Read

This is a read of data from a non-trusted QA Device that also includes a check of the signature. When the System determines that the signature is correct for the returned data (e.g. by asking a trusted QA Device to test the signature) then the System is able to trust that the data has not been tampered en route from the read, and was actually stored on the non-trusted QA Device.

Authenticated Write

An authenticated write is a write to the data storage area in a QA Device where the write request includes both the new data and a signature. The signature is based on a key that has write access permissions to the region of data in the QA Device, and proves to the receiving QA Device that the writer has the authority to perform the write. For example, a Value Upgrader Refilling Device is able to authorize a system to perform an authenticated write to upgrade a Consumable QA Device (e.g. to increase the amount of ink in an Ink QA Device).

The QA Device that receives the write request checks that the signature matches the data (so that it hasn't been tampered with en route) and also that the signature is based on the correct authorization key.

An authenticated write can be followed by an authenticated read to ensure (from the system's point of view) that the write was successful.

Non-Authenticated Write

A non-authenticated write is a write to the data storage area in a QA Device where the write request includes only the new data (and no signature). This kind of write is used when the system wants to update areas of the QA Device that have no access-protection.

The QA Device verifies that the destination of the write request has access permissions that permit anyone to write to it. If access is permitted, the QA Device simply performs the write as requested.

A non-authenticated write can be followed by an authenticated read to ensure (from the system's point of view) that the write was successful.

Authorized Modification of Data

Authorized modification of data refers to modification of data via authenticated writes.

Data Structures

Table 2 provides a summary of the data structures used in the QA Chip Logical Interface

TABLE 2
List of data structures

| Group | | Represented | | |
|---|---|---|---|---|
| description | Name | by | Size | Description |
| QA Device | Chip Identifier | ChipId | 48 bits | Unique identifier for this QA Device. |
| instance | | | | |
| identifier | | | | |
| Key and key | Number of Keys | NumKeys | 8 | Number of key slots available in this QA Device. |
| related data | Key | K | 160 bits per key | K is the secret key used for calculating signatures. |
| | | | | Kⁿ is the key stored in the nth key slot. |
| | Key Identifier | KeyId | 31 bits per key | Unique identifier for each key |
| | | | | KeyIdⁿ is the key identifier for the key stored in slot n. |
| | KeyLock | KeyLock | 1 bit per key | Flag indicates whether the key is locked in the corresponding. |
| | | | | slot or not. |
| | | | | KeyLockⁿ is the key lock flag for slot n. |
| Operating and | Number of Memory | NumVectors | 4 | Number of 512 bit memory vectors in this QA Device. |
| state data | Vectors | | | |
| | Memory Vector | M | 512 bits per Mⁱ | M is a 512 bit memory vector. |
| | | | | The 512-bit vector is divided into 16 × 32 bit words. |
| | | M⁰ | | M⁰ stores application specific data that is protected by access |
| | | | | permissions for key-based and non-key based writes. |
| | | M¹ | | M¹ stores the attributes for M⁰, and is write-once-only. |
| | | M²⁺ | | M²⁺ stores application specific data that is protected only by |
| | | | | non key-based access permissions. |
| | Permissions | Pⁿ | 16 bits per P | Access permissions for each word of M¹⁺. n = number of M¹⁺ |
| | | | | vectors |
| Session data | Random Number | R | 160 bits | Current random number used to ensure time varying |
| | | | | messages. Changes after each successful authentication or |
| | | | | signature generation. |

Instance/Device Identifier

Each QA Device requires an identifier that allows unique identification of that QA Device by external systems, ensures that messages are received by the correct QA Device, and ensures that the same device can be used across multiple transactions.

Strictly speaking, the identifier only needs to be unique within the context of a key, since QA Devices only accept messages that are appropriately signed. However it is more convenient to have the instance identifier completely unique, as is the case with this design.

The identifier functionality is provided by ChipID.

ChipID

ChipId is the unique 64-bit QA Device identifier. The ChipId is set when the QA Device is instantiated, and cannot be changed during the lifetime of the QA Device. A 64-bit ChipID gives a maximum of 1844674 trillion unique QA Devices.

Key and Key Related Data

Numkeys, K, KeyID, and KeyLock

Each QA Device contains a number of secret keys that are used for signature generation and verification. These keys serve two basic functions:
For reading, where they are used to verify that the read data came from the particular QA Device and was not altered en route.
For writing, where they are used to ensure only authorised modification of data.

Both of these functions are achieved by signature generation; a key is used to generate a signature for subsequent transmission from the device, and to generate a signature to compare against a received signature.

The number of secret keys in a QA Device is given by NumKeys. For this version of the QA Chip Logical Interface, NumKeys has a maximum value of 8. Each key is referred to as K, and the subscripted form Kₙ refers to the nth key where n has the range 0 to NumKeys-1 (i.e. 0 to 7). For convenience we also refer to the nth key as being the key in the nth keyslot.

The length of each key is 160-bits. 160-bits was chosen because the output signature length from the signature generation function (HMAC-SHA1) is 160 bits, and a key longer than 160-bits does not add to the security of the function.

The security of the digital signatures relies upon keys being kept secret. To safeguard the security of each key, keys should be generated in a way that is not deterministic. Ideally each key should be programmed with a physically generated random number, gathered from a physically random phenomenon. Each key is initially programmed during QA Device instantiation.

Since all keys must be kept secret and must never leave the QA Device, each key has a corresponding 31-bit KeyID which can be read to determine the identity or label of the key without revealing the value of the key itself. Since the relationship between keys and KeyIds is 1:1, a system can read all the KeyIds from a QA Device and know which keys are stored in each of the keyslots.

Finally, each keyslot has a corresponding 1-bit KeyLock status indicating whether the key in that slot/position is allowed to be replaced (securely replaced, and only if the old key is known). Once a key has been locked into a slot, it cannot be unlocked i.e. it is the final key for that slot. A key can only be used to perform authenticated writes of data when it has been locked into its keyslot (i.e. its KeyLock status=1).

Thus each of the NumKeys keyslots contains a 160-bit key, a 31-bit KeyId, and a 1-bit KeyLock.

Common and Variant Signature Generation

To create a digital signature, we pass the data to be signed together with a secret key through a key dependent one-way hash function. The key dependent one-way hash function used throughout the QA Chip Logical Interface is HMAC-SHA1.

Signatures are only of use if they can be validated i.e. QA Device A produces a signature for data and QA Device B can check if the signature was valid for that particular data. This implies that A and B must share some secret information so that they can generate equivalent signatures.

Common key signature generation is when QA Device A and QA Device B share the exact same key i.e. key K_{A}=key K_{B}. Thus the signature for a message produced by A using K_{A} can be equivalently produced by B using K_{B}. In other words SIG_{KA}(message)=SIG_{KB}(message) because key K_{A}=key K_{B}.

Variant key signature generation is when QA Device B holds a base key, and QA Device A holds a variant of that key such that K_{A}=owf(K_{B},U_{A}) where owf is a one-way function based upon the base key (K_{B}) and a unique number in A (U_{A}). Thus A can produce SlG_{KA}(message), but for B to produce an equivalent signature it must produce K_{A} by reading U_{A} from A and using its base key K_{B}. K_{A} is referred to as a variant key and K_{B} is referred to as the base/common key. Therefore, B can produce equivalent signatures from many QA Devices, each of which has its own unique variant of K_{B}. Since ChipId is unique to a given QA Device, we use that as U_{A}. A one-way function is required to create K_{A} from K_{B} or it would be possible to derive K_{B} if K_{A} were exposed. Common key signature generation is used when A and B are equally available to an attacker. For example, Printer QA Devices and Ink QA Devices are equally available to attackers (both are commonly available to an attacker), so shared keys between these two devices should be common keys.

Variant key signature generation is used when B is not readily available to an attacker, and A is readily available to an attacker. If an attacker is able to determine K_{A}, they will not know K_{A} for any other QA Device of class A, and they will not be able to determine K_{B}.

The QA Device producing or testing a signature needs to know if it must use the common or variant means of signature generation. Likewise, when a key is stored in a QA Device, the status of the key (whether it is a base or variant key) must be stored along with it for future reference. Both of these requirements are met using the KeyId as follows:

The 31-bit KeyId is broken into two parts:
A 30-bit unique identifier for the key. Bits 30-1 represents the Id.
A 1-bit Variant Flag, which represents whether the key is a base key or a variant key. Bit 0 represents the Variant Flag.

Table 19 describes the relationship of the Variant Flag with the key.

TABLE 19
Variant Flag representation

| | Key |
|---|---|
| value | represented |
| 0 | Base key |
| 1 | Variant key |

Equivalent Signature Generation Between QA Devices

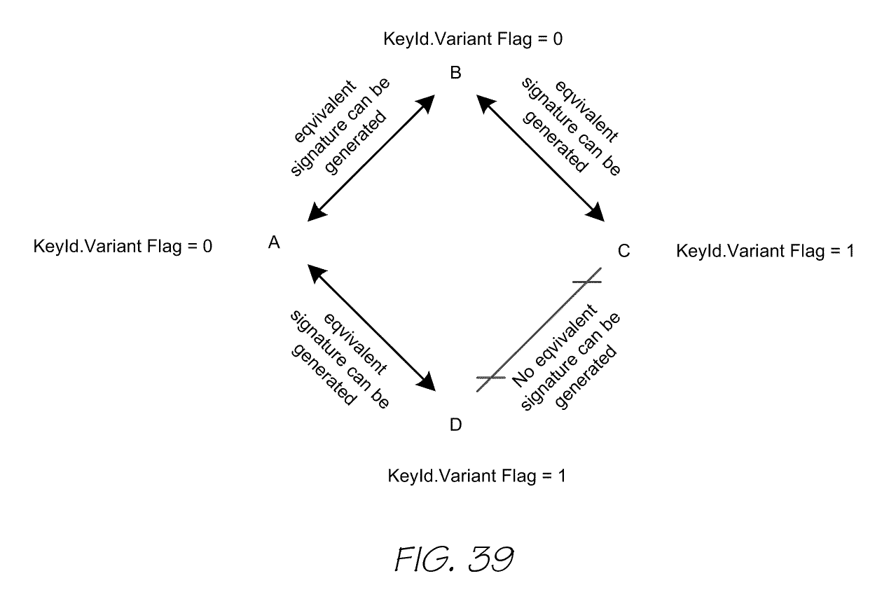

Equivalent signature generation between 4 QA Devices A, B, C and D is shown in FIG. 39. Each device has a single key. KeyId.Id of all four keys are the same i.e KeyId_{A}.Id=KeyId_{B}.Id=KeyId_{C}.Id=KeyId_{D}.Id.

If KeyId_{A}.VariantFlag=0 and KeyId_{B}.VariantFlag=0, then a signature produced by A, can be equivalently produced by B because K_{A}=K_{B}.

If KeyId_{B}.VariantFlag=0 and KeyId_{C}.VariantFlag=1, then a signature produced by C, is equivalently produced by B because K_{C}=f (K_{B}, ChipId_{C}).

If KeyId_{C}.VariantFlag=1 and KeyId_{D}.VariantFlag=1, then a signature produced by C, cannot be equivalently produced by D because there is no common base key between the two devices.

If KeyId_{D}.VariantFlag=1 and KeyId_{A}.VariantFlag=0, then a signature produced by D, can be equivalently produced by A because K_{D}=f (K_{A}, ChipId_{D}).

Operating and State Data

The primary purpose of a QA Device is to securely hold application-specific data. For example if the QA Device is an Ink QA Device it may store ink characteristics and the amount of ink-remaining. If the QA Device is a Printer QA Device it may store the maximum speed and width of printing.

For secure manipulation of data:
Data must be clearly identified (includes typing of data).
Data must have clearly defined access criteria and permissions.

The QA Chip Logical Interface contains structures to permit these activities.

The QA Device contains a number of kinds of data with differing access requirements:
Data that can be decremented by anyone, but only increased in an authorised fashion e.g. the amount of ink-remaining in an ink cartridge.
Data that can only be decremented in an authorised fashion e.g. the number of times a Parameter Upgrader QA Device has upgraded another QA Device.
Data that is normally read-only, but can be written to (changed) in an authorised fashion e.g. the operating parameters of a printer.
Data that is always read-only and doesn't ever need to be changed e.g. ink attributes or the serial number of an ink cartridge or printer.
Data that is written by QACo/Silverbrook, and must not be changed by the OEM or end user e.g. a licence number containing the OEM's identification that must match the software in the printer.
Data that is written by the OEM and must not be changed by the end-user e.g. the machine number that filled the ink cartridge with ink (for problem tracking).

M

M is the general term for all of the memory (or data) in a QA Device. M is further subscripted to refer to those different parts of M that have different access requirements as follows:
M₀ contains all of the data that is protected by access permissions for key-based (authenticated) and non-key-based (non-authenticated) writes.
M₁ contains the type information and access permissions for the M₀ data, and has write-once permissions (each sub-part of M₁ can only be written to once) to avoid the possibility of changing the type or access permissions of something after it has been defined.
M₂, M₃ etc., referred to as M₂₊, contains all the data that can be updated by anyone until the permissions for those sub-parts of M₂₊ have changed from read/write to read-only.
While all QA Devices must have at least M₀ and M₁, the exact number of memory vectors (Mₙs) available in a particular QA Device is given by NumVectors. In this version of the QA Chip Logical Interface there are exactly 4 memory vectors, so NumVectors=4.
Each Mₙ is 512 bits in length, and is further broken into 16×32 bit words. The ith word of Mₙ is referred to as Mₙ[i]. Mₙ[0] is the least significant word of Mₙ, and Mₙ[15] is the most significant word of Mₙ.

M₀ and M₁

In the general case of data storage, it is up to the external accessor to interpret the bits in any way it wants. Data structures can be arbitrarily arranged as long as the various pieces of software and hardware that interpret those bits do so consistently. However if those bits have value, as in the case of a consumable, it is vital that the value cannot be increased without appropriate authorisation, or one type of value cannot be added to another incompatible kind e.g. dollars should never be added to yen.

Therefore M₀ is divided into a number of fields, where each field has a size, a position, a type and a set of permissions. M₀ contains all of the data that requires authenticated write access (one data element per field), and M₁ contains the field information i.e. the size, type and access permissions for the data stored in M₀.

Each 32-bit word of M₁ defines a field. Therefore there is a maximum of 16 defined fields. M₁[0] defines field 0, M₁[1] defines field 1 and so on. Each field is defined in terms of:
size and position, to permit external accessors determine where a data item is
type, to permit external accessors determine what the data represents
permissions, to ensure approriate access to the field by external accessors.

The 32-bit value M₁[n] defines the conceptual field attributes for field n as follows:

With regards to consistency of interpretation, the type, size and position information stored in the various words of M₁ allows a system to determine the contents of the corresponding fields (in M₀) held in the QA Device. For example, a 3-color ink cartridge may have an Ink QA Device that holds the amount of cyan ink in field 0, the amount of magenta ink in field 1, and the amount of yellow ink in field 2, while another single-color Ink QA Device may hold the amount of yellow ink in field 0, where the size of the fields in the two Ink QA Devices are different.

A field must be defined (in M₁) before it can be written to (in M₀). At QA Device instantiation, the whole of M₀ is 0 and no fields are defined (all of M₁ is 0). The first field (field 0) can only be created by writing an appropriate value to M₁[0]. Once field 0 has been defined, the words of M₀ corresponding to field 0 can be written to (via the appropriate permissions within the field definition M₁[0]).

Once a field has been defined (i.e. M₁[n] has been written to), the size, type and permissions for that field cannot be changed i.e. M₁ is write-once. Otherwise, for example, a field could be defined to be lira and given an initial value, then the type changed to dollars.

The size of a field is measured in terms of the number of consecutive 32-bit words it occupies. Since there are only 16×32-bit words in M₀, there can only be 16 fields when all 16 fields are defined to be 1 word sized each. Likewise, the maximum size of a field is 512 bits when only a single field is defined, and it is possible to define two fields of 256-bits each.

Once field 0 has been created, field 1 can be created, and so on. When enough fields have been created to allocate all of M₀, the remaining words in M₁ are available for write-once general data storage purposes.

It must be emphasised that when a field is created the permissions for that field are final and cannot be changed. This also means that any keys referred to by the field permissions must be already locked into their keyslots. Otherwise someone could set up a field's permissions that the key in a particular keyslot has write access to that field without any guarantee that the desired key will be ever stored in that slot (thus allowing potential mis-use of the field's value).

Field Size and Position

A field's size and position are defined by means of 4 bits (referred to as EndPos) that point to the least significant word of the field, with an implied position of the field's most significant word. The implied position of field 0's most significant word is M₀[15]. The positions and sizes of all fields can therefore be calculated by starting from field 0 and working upwards until all the words of M₀ have been accounted for.

The default value of M₁[0] is 0, which means field0.endPos=0. Since field0.startPos=15, field 0 is the only field and is 16 words long.

Example

Suppose for example, we want to allocate 4 fields as follows:
field 0:128 bits (4×32-bit words)
field 1:32 bits (1×32-bit word)
field 2:160 bits (5×32-bit words)
field 3:192 bits (6×32-bit words)

Field 0's position and size is defined by M₁[0], and has an assumed start position of 15, which means the most significant word of field 0 must be in M₀[15]. Field 0 therefore occupies M₀[12] through to M₀[15], and has an endPos value of 12.

Field 1's position and size is defined by M₁[1], and has an assumed start position of 11 (i.e. M₁[0].endPos−1). Since it has a length of 1 word, field 1 therefore occupies only M₀[11] and its end position is the same as its start position i.e. its endPos value is 11. Likewise field 2's position and size is defined by M₁[2], and has an assumed start position of 10 (i.e. M₁[1].endPos−1). Since it has a length of 5 words, field 2 therefore occupies M₀[6] through to M₀[10] and and has an endPos value of 6.

Finally, field 3's position and size is defined by M₁[3], and has an assumed start position of 5 (i.e. M₁[2].endPos−1). Since it has a length of 6 words, field 3 therefore occupies M₀[5] through to M₀[0] and and has an endPos value of 0.

Since all 16 words of M₀ are now accounted for in the 4 fields, the remaining words of M₁ (i.e. M₁[4] though to M₁[15]) are ignored, and can be used for any write-once (and thence read-only) data.

Determining the Number of Fields

The following pseudocode illustrates a means of determining the number of fields:

```
fieldNum FindNumFields(M1)
startPos ← 15
fieldNum ← 0
While (fieldNum < 16)
  endPos ← M1[fieldNum].endPos
  If (endPos > startPos)
    # error in this field... so must be an attack
    attackDetected( )  # most likely clears all keys and data
  EndIf
  fieldNum++
  If (endPos = 0)
    return fieldNum # is already incremented
  Else
    startPos ← endPos − 1 # endpos must be > 0
  EndIf
EndWhile
# error if get here since 16 fields are consumed in 16 words at most
attackDetected( )  # most likely clears all keys and data
```

Determining the Sizes of All Fields

The following pseudocode illustrates a means of determing the sizes of all valid fields:

```
FindFieldSizes(M1, fieldSize[ ])
numFields ← FindNumFields(M1) # assumes that FindNumFields does all
checking
ntartPos ← 15
fieldNum ← 0
While (fieldNum < numFields)
  EndPos ← M1[fieldNum].endPos
  fieldSize[fieldNum] = startPos − endPos + 1
  startPos ← endPos − 1 # endpos must be > 0
  fieldNum++
EndWhile
While (fieldNum < 16)
  fieldSize[fieldNum] ← 0
  fieldNum++
EndWhile
```

Field Type

The system must be able to identify the type of data stored in a field so that it can perform operations using the correct data. For example, a printer system must be able identify which of a consumable's fields are ink fields (and which field is which ink) so that the ink usage can be correctly applied during printing. A field's type is defined by 15 bits.

The default value of M₁[0] is 0, which means field0.type=0 (i.e. non-initialised). Strictly speaking, the type need only be interpreted by all who can securely read and write to that field i.e. within the context of one or more keys. However it is convenient if possible to keep all types unique for simplistic identification of data across all applications.

In the general case, an external system communicating with a QA Device can identify the data stored in M₀ in the following way:
Read the KeyId of the key that has permission to write to the field. This will a give broad identification of the data type, which may be sufficient for certain applications.
Read the type attribute for the field to narrow down the identity within the broader context of the KeyId.

For example, the printer system can read the KeyId to deduce that the data stored in a field can be written to via the HP_Network_InkRefill key, which means that any data is of the general ink category known to HP Network printers. By further reading the type attribute for the field the system can determine that the ink is Black ink.

Field Permissions

All fields can be ready by everyone. However writes to fields are governed by 13-bits of permissions that are present in each field's attribute definition. The permissions describe who can do what to a specific field.

Writes to fields can either be authenticated (i.e. the data to be written is signed by a key and this signature must be checked by the receiving device before write access is given) or non-authenticated (i.e. the data is not signed by a key). Therefore we define a single bit (AuthRW) that specifies whether authenticated writes are permitted, and a single bit (NonAuthRW) specifying whether non-authenticated writes are permitted. Since it is pointless to permit both authenticated and non-authenticated writes to write any value (the authentciated writes are pointless), we further define the case when both bits are set to be interpreted as authenticated writes are permitted, but non-authenticated writes only succeed when the new value is less than the previous value i.e. the permission is decrement-only. The interpretation of these two bits is shown in Table 20.

TABLE 20
Interpretation of AuthRW and NonAuthRW

| NonAuthRW | AuthRW | Interpretation |
|---|---|---|
| 0 | 0 | Read-only access (no-one can write to this |
| | | field). This is the initial state for each field. |
| | | At instantiation all of M₁ is 0 which means |
| | | AuthRW and NonAuthRW are 0 for each |
| | | field, and hence none of M₀ can be written |
| | | to until a field is defined. |
| 0 | 1 | Authenticated write access is permitted |
| | | Non-authenticated write acecss is not permitted |
| 1 | 0 | Authenticated write access is not permitted |
| | | Non-authenticated write access is permitted |
| | | (i.e. anyone can write to this field) |
| 1 | 1 | Authenticated write access is permitted |
| | | Non-authenticated write access is |
| | | decrement-only. |

If authenticated write access is permitted, there are 11 additional bits (bringing the total number of permission bits to 13) to more fully describe the kind of write access for each key. We only permit a single key to have the ability to write any value to the field, and the remaining keys are defined as being either not permitted to write, or as having decrement-only write access. A 3-bit KeyNum represents the slot number of the key that has the ability to write any value to the field (as long as the key is locked into its key slot), and an 8-bit KeyPerms defines the write permissions for the (maximum of) 8 keys as follows:
KeyPerms[n]=0: The key in slot n (i.e. Kₙ) has no write access to this field (except when n=KeyNum). Setting KeyPerms to 0 prohibits a key from transferring value (when an amount is deducted from field in one QA Device and transferred to another field in a different QA Device)
KeyPerms[n]=1: The key in slot n (i.e. Kₙ) is permitted to perform decrement-only writes to this field (as long as Kₙ is locked in its key slot). Setting KeyPerms to 1 allows a key to transfer value (when an amount is deducted from field in one QA Device and transferred to another field in a different QA Device).

Summary of Field Attributes

TABLE 21
Attributes for a field

| | | Size | |
|---|---|---|---|
| | Sub-attribute | in | |
| Attribute | name | bits | Interpretation |
| Type | Type | 15 | Gives additional identification of the |
| | | | data stored in the field within the |
| | | | context of the accessors of that |
| | | | field. |
| Permissions | KeyNum | 3 | The slot number of the key that has |
| | | | authenticated write access to the |
| | | | field. |
| | NonAuthRW | 1 | 0 = non-authenticated writes are |
| | | | not permitted to this field. |
| | | | 1 = non-authenticated writes are |
| | | | permitted to this field (see Table |
| | | | 249). |
| | AuthRW | 1 | 0 = authenticated writes are not |
| | | | permitted to this field. |
| | | | 1 = authenticated writes are |
| | | | permitted to this field. |
| | KeyPerms | 8 | Bitmap representing the write |
| | | | permissions for each of the keys |
| | | | when AuthRW = 1. For each bit: |
| | | | 0 = no write access for this key |
| | | | (except for key KeyNum) |
| | | | 1 = decrement-only access is |
| | | | permitted for this key. |
| Size and | EndPos | 4 | The word number in M₀ that holds |
| Position | | | the lsw of the field. The msw is held |
| | | | in M1[fieldNum − 1], where msw of |
| | | | field 0 is 15. |

Permissions of M₁

M₁ holds the field attributes for data stored in M₀, and each word of M₁ can be written to once only. It is important that a system can determine which words are available for writing. While this can be determined by reading M₁ and determining which of the words is non-zero, a 16-bit permissions value P₁ is available, with each bit indicating whether or not a given word in M₁ has been written to. Bit n of P₁ represents the permissions for M₁[n] as follows:

TABLE 22
Interpretation of P₁[n] i.e. bit n of M₁'s permission

| | Description |
|---|---|
| 0 | writes to M₁[n] are not permitted i.e. this word is now |
| | read-only |
| 1 | writes to M₁[n] are permitted |

Since M₁ is write-once, whenever a word is written to in M₁, the corresponding bit of P₁ is also cleared, i.e. writing to M₁[n] clears P₁[n].

Writes to M₁[n] only succeed when all of M₁[0 . . . n−1] have already written to (i.e. previous fields are defined) i.e.
M₁[0 . . . n−1] must have already been written to (i.e. P₁[0 . . . n−1] are 0)
P₁[n]=1 (i.e. it has not yet been written to)

In addition, if M₁[n−1].endPos≠0, the new M₁[n] word will define the attributes of field n, so must be further checked as follows:
The new M₁[n].endPos must be valid (i.e. must be less than M₁[n−1].endPos)
If the new M₁[n].authRW is set, K_{keyNum} must be locked, and all keys referred to by the new M₁[n].keyPerms must also be locked.

However if M₁[n−1].endPos=0, then all of M₀ has been defined in terms of fields. Since enough fields have been created to allocate all of M₀, any remaining words in M₁ are available for write-once general data storage purposes, and are not checked any further.

M2+

M₂, M₃ etc., referred to as M₂₊, contains all the data that can be updated by anyone (i.e. no authenticated write is required) until the permissions for those sub-parts of M₂+have changed from read/write to read-only.

The same permissions representation as used for M₁ is also used for M₂₊.

Consequently Pₙ is a 16-bit value that contains the permissions for Mₙ (where n>0). The permissions for word w of Mₙ is given by a single bit Pₙ[w]. However, unlike writes to M₁, writes to M₂₊ do not automatically clear bits in P. Only when the bits in P₂₊ are explictly cleared (by anyone) do those corresponding words become read-only and final.

Session Data

Data that is valid only for the duration of a particular communication session is referred to as session data. Session data ensures that every signature contains different data (sometimes referred to as a nonce) and this prevents replay attacks.

R

R is a 160-bit random number seed that is set up (when the QA Device is instantiated) and from that point on it is internally managed and updated by the QA Device. R is used to ensure that each signed item contains time varying information (not chosen by an attacker), and each QA Device's R is unrelated from one QA Device to the next.

This R is used in the generation and testing of signatures.

An attacker must not be able to deduce the values of R in present and future devices. Therefore, R should be programmed with a cryptographically strong random number, gathered from a physically random phenomenon (must not be deterministic).

Advancing R

The session component of the message must only last for a single session (challenge and response).

The rules for updating R are as follows:
Reads of R do not advance R.
Everytime a signature is produced with R, R is advanced to a new random number.
Everytime a signature including R is tested and is found to be correct, R is advanced to a new random number.

R_{L} AND R_{E}

Each signature contains 2 pieces of session data i.e. 2 Rs:
One R comes from the QA Device issuing the challenge i.e. the challenger. This is so the challenger can ensure that the challenged QA Device isn't simply replaying an old signature i.e. the challenger is protecting itself against the challenged.
One R comes from the device responding to the challenge i.e. the challenged. This is so the challenged never signs anything that is given to it without inserting some time varying change i.e. protects the challenged from the challenger in case the challenger is actually an attacker performing a chosen text attack

Since there are two Rs, we need to distinguish between them. We do so by defining each R as external (R_{E}) or local (R_{L}) depending on its use in a given function. For example, the challenger sends out its local R, referred to as R_{L}. The device being challenged receives the challenger's R as an external R, i.e R_{E}. It then generates a signature using its R_{L} and the challenger's R_{E}. The resultant signature and R_{L} are sent to the challenger as the response. The challenger receives the signature and R_{E} (signature and R_{L} produced by the device being challenged), produces its own signature using R_{L} (sent to the device being challenged earlier) and R_{E} received, and compares that signature to the signature received as response.

Signature Functions

Objects

KeyRef

Instead of passing keys directly into a function, a KeyRef (i.e. key reference) object is passed instead. A KeyRef object encapsulates the process by which a key is formed for common and variant forms of signature generation (based on the setting of the variables within the object). A KeyRef defines which key to use, whether it is a common or variant form of that key, and, if it is a variant form, the Chip Id to use to create the variant.

Users pass KeyRef objects in as input parameters to public functions of the QA Chip Logical Interface , and these KeyRefs are subsequently passed to the signature function (called within the interface function). Note, however, that the method functions for KeyRef objects are not available outside the QA Chip Logical Interface.

Table 23 describes each of the variables within a KeyRef object.

TABLE 23
Description of object variables for KeyRef object

| Parameter | Description |
|---|---|
| keyNum | Slot number of the key to use as the basis for key formation |
| useChipId | 0 = the key to be formed is a common key (i.e. is the same as |
| | K_{keyNum}) |
| | 1 = the key to be formed is a variant key based on K_{keyNum} |
| ChipId | When useChipId = 1, this is the ChipId to be used to form the |
| | variant key (this will be the ChipId of the QA Device which |
| | stores the variant of K_{keyNum}) |
| | When useChipId = 0, chipId is not used |

Object Methods

getKey

Public Key getKey (Void)

This method is a public method (public in object oriented terms, not public to users of the QA Chip Logical Interface) and is called by the GenerateSignature function to return the key for use in signature generation.

If useChipId is true, the formKeyVariant method is called to form the key using chipId and then return the variant key. If useChipId is false, the key stored in slot keyNum is returned.

Method Sequence

The getkey method is illustrated by the following pseudocode:

```
If (useChipId = 0)
  key ←K_{keyNum}
Else
  key ←formKeyVariant( )
EndIf
Return key
```

formKeyVariant

private key formKeyVariant (Void)

This method produces the variant form of a key, based on the K_{keyNum} and chipId. The variant form of key K_{keyNum} is generated by owf (K_{keyNum}, chipId) where owf is a one-way function.

In addition, the time taken by owf must not depend on the value of the key i.e. the timing should be effectively constant. This prevents timing attacks on the key.

At present, owf is SHA1, although this still needs to be verified. Thus the variant key is defined to be SHA1 (K_{keyNum}|chipId).

Method Sequence

The formKeyVariant method is illustrated by the following pseudocode:

key ←SHA1(K_{keyNum} | chipId) # Calculation must take constant time
Return key

Functions

Digital signatures form the basis of all authentication protocols within the QA Chip Logical Interface. The signature functions are not directly available to users of the QA Chip Logical Interface, since a golden rule of digital signatures is never to sign anything exactly as it has been given to you. Instead, these signature functions are internally available to the functions that comprise the public interface, and are used by those functions for the formation of keys and the generation of signatures.

GenerateSignature

| | |
|---|---|
| Input: | KeyRef, Data, Random1, Random2 |
| Output: | SIG |
| Changes: | None |
| Availability: | All devices |

Function Description

This function uses KeyRef to obtain the actual key required for signature generation, appends Random1 and Random2 to Data, and performs HMAC_SHA1[key, Data] to output a signature.

In addition, this operation must take constant time irrespective of the value of the key.

Input Parameter Description

Table 24 describes each of the input parameters:

TABLE 24
Description of input parameters for GenerateSignature

| Parameter | Description |
|---|---|
| KeyRef | This is an instance of the KeyRef object for use by the |
| | GenerateSignature function. For common key signature |
| | generation: KeyRef.keyNum = Slot number of the key to |
| | be used to produce the signature. KeyRef.useChipId = 0 |
| | For variant key signature generation: KeyRef.keyNum = Slot |
| | number of the key to be used for generating the variant key, |
| | where the variant key is to be used to produce the signature |
| | KeyRef.useChipId = 1 KeyRef.ChipId = ChipId of the QA |
| | Device which stores the variant of K_{KeyRef.keyNum}, and uses |
| | the variant key for signature generation. |
| Data | Preformatted data to be signed. |
| | Random1 and Random2 are appended to Data before the |
| | signature is generated to ensure that the signature is session |
| | based (applicable only to a single session). |
| Random 1 | This is the session component from the QA Device that is |
| | responding to the challenge. |
| Random 2 | This is the session component from the QA Device that |
| | issued the challenge. |

Output Parameter Description

Table 25 describes each of the output parameters.

TABLE 25
Description of output parameters for GenerateSignature

| Parameter | Description |
|---|---|
| SIG | SIG = SIG_{key}(Data \| Random1 \| Random2) where |
| | key = KeyRef.getKey( ) |

Function Sequence

The GenerateSignature function is illustrated by the following pseudocode:

key ← KeyRef.getKey( )
dataToBeSigned ←Data|Random1|Random2
SIG ← HMAC_SHA1(key, dataToBeSigned) # Calculation must
take constant time
Output SIG
Return

Basic Functions

This section defines return codes and constants referred to by functions and pseudocode.

ResultFlag

The ResultFlag is a byte that indicates the return status from a function. Callers can use the value of ResultFlag to determine whether a call to a function succeeded or failed, and if the call failed, the specific error condition.

Table 26 describes the ResultFlag values and the mnemonics used in the pseudocode.

TABLE 26
ResultFlag value description

| Mnemonic | Description | Possible causes |
|---|---|---|
| Pass | Function completed | Function successfully completed requested |
| | sucessfully | task. |
| Fail | General Failure | An error occurred during function processing. |
| BadSig | Signature mismatch | Input signature didn't match the generated |
| | | signature. |
| InvalidKey | KeyRef incorrect | Input KeyRef.keyNum > 3. |
| InvalidVector | VectNum incorrect | Input M_{VectNum} > 3. |
| InvalidPermission | Permission not | Trying to perform a Write or WriteAuth with |
| | adqeuate to per form | incorrect permissions. |
| | operation. | |
| KeyAlreadyLocked | Key already locked. | Key cannot be changed because it has |
| | | already been locked. |

Constants

Table 27 describes the constants referred to by functions and pseudocode.

TABLE 27
Constants

| Definition | Value |
|---|---|
| MaxKey | NumKeys − 1 |
| | (typically 7) |
| MaxM | NumVectors − 1 |
| | (typically 3) |
| MaxWordInM | 16 − 1 = 15 |

GetInfo

| | |
|---|---|
| Input: | None |
| Output: | ResultFlag, SoftwareReleaseIdMajor, |
| | SoftwareReleaseIdMinor, |
| | NumVectors, NumKeys, ChipId |
| | DepthOfRollBackCache (for an upgrade device only) |
| Changes: | None |
| Availability: | All devices |

Function Description

Users of QA Devices must call the GetInfo function on each QA Device before calling any other functions on that device.

The GetInfo function tells the caller what kind of QA Device this is, what functions are available and what properties this QA Device has. The caller can use this information to correctly call functions with appropriately formatted parameters.

The first value returned, SoftwareReleaseIdMajor, effectively identifies what kind of QA Device this is, and therefore what functions are available to callers.

SoftwareReleaseIdMinor tells the caller which version of the specific type of QA Device this is. The mapping between the SoftwareReleaseIdMajor and type of device and their different functions is described in Table 29

Every QA Device also returns NumVectors, NumKeys and ChipId which are required to set input parameter values for commands to the device.

Additional information may be returned depending on the type of QA Device. The VarDataLen and VarData fields of the output hold this additional information.

Output Parameters

Table 28 describes each of the output parameters.

TABLE 28
Description of output parameters for GetInfo function

| Parameter | #bytes | Description |
|---|---|---|
| ResultFlag | | Indicates whether the function completed |
| | | successfully or not. If it did not complete |
| | | successfully, the reason for the failure is returned here. |
| SoftwareReleaseIdMajor | 1 | This defines the function set that is available on |
| | | this QA Device. |
| SoftwareReleaseIdMinor | 1 | This defines minor software releases within a |
| | | major release, and are incremental changes to |
| | | the software mainly to deal with bug fixes. |
| NumVectors | 1 | Total number of memory vectors in this QA |
| | | Device. |
| NumKeys | 1 | Total number of keys in this QA Device. |
| ChipId | 6 | This QA Device's ChipId |
| VarDataLen | 1 | Length of bytes to follow. |
| VarData | (VarDataLen | This is additional application specific data, and will |
| | bytes) | be of length VarDataLen (i.e. may be 0). |

Table 29 shows the mapping between the SoftwareReleaseIdMajor, the type of QA Device and the available device functions.

TABLE 29
Mapping between SoftwareReleaseIdMajor and available device
functions

| SoftwareReleaseId- | | |
|---|---|---|
| Major | Device description | Functions available |
| 1 | Ink or Printer QA Device | GetInfo |
| | | Random |
| | | Read |
| | | Test |
| | | Translate |
| | | WriteM1+ |
| | | WriteFields |
| | | WriteFieldsAuth |
| | | SetPerm |
| | | ReplaceKey |
| 2 | Value Upgrader QA | All functions in the Ink |
| | Device (e.g. Ink Refill | or Printer Device, plus: |
| | QA Device) | StartXfer |
| | | XferAmount |
| | | StartRollBack |
| | | RollBackAmount |
| 3 | Parameter Upgrader QA | All functions in the Ink |
| | Device | or Printer device, plus: |
| | | StartXfer |
| | | XferField |
| | | StartRollBack |
| | | RollBackField |
| 4 | Key Replacement device | All functions in the Ink |
| | | or Printer Device, plus: |
| | | GetProgramKey |
| | | ReplaceKey - is different |
| | | from the Ink or Printer |
| | | device |
| 5 | Trusted device | All functions in the Ink |
| | | or Printer Device, plus: |
| | | SignM |

Table 30 shows the VarData components for Value Upgrader and Parameter Upgrader QA Devices.

TABLE 30
VarData for Value and Parameter Upgrader QA Devices

| | Length | |
|---|---|---|
| VarData | in | |
| Components | bytes | Description |
| DepthOfRollBackCache | 1 | The number of datasets that can be |
| | | accommodated |
| | | in the Xfer Entry cache of the device. |

Function Sequence

The GetInfo command is illustrated by the following pseudocode:

Output SoftwareReleaseIdMajor
Output SoftwareReleaseIdMinor
Output NumVectors
Output NumKeys
Output ChipId
VarDataLen ← 1 # In case of an upgrade device
Output DepthOfRollBackCache
Return

Random

| | |
|---|---|
| Input: | None |
| Output: | R_{L} |
| Changes: | None |
| Availability: | All devices |

The Random command is used by the caller to obtain a session component (challenge) for use in subsequent signature generation.

If a caller calls the Random function multiple times, the same output will be returned each time. R_{L} (i.e. this QA Device's R) will only advance to the next random number in the sequence after a successful test of a signature or after producing a new signature. The same R_{L} can never be used to produce two signatures from the same QA Device. The Random command is illustrated by the following pseudocode:

Output R_{L}
Return

Read

| | |
|---|---|
| Input: | KeyRef, SigOnly, MSelect, KeyIdSelect, WordSelect, R_{E} |
| Output: | ResultFlag, SelectedWordsOfSelectedMs, SelectedKeyIds, |
| | R_{L}, SIGₒᵤₜ |
| Changes: | R_{L} |
| Availability: | All devices |

Function Description

The Read command is used to read data and keyIds from a QA Device. The caller can specify which words from M and which KeyIds are read.

The Read command can return both data and signature, or just the signature of the requested data. Since the return of data is based on the caller's input request, it prevents unnecessary information from being sent back to the caller. Callers typically request only the signature in order to confirm that locally cached values match the values on the QA Device.

The data read from an untrusted QA Device (A) using a Read command is validated by a trusted QA Device (B) using the Test command. The R_{L} and SIG_{OUT} produced as output from the Read command are input (along with correctly formatted data) to the Test command on a trusted QA Device for validation of the signature and hence the data. SIG_{OUT} can also optionally be passed through the Translate command on a number of QA Devices between Read and Test if the QA Devices A and B do not share keys.

Input Parameters

Table 31 describes each of the input parameters:

TABLE 31
Description of input parameters for Read

| Parameter | Description |
|---|---|
| KeyRef | For common key signature generation: |
| | KeyRef.keyNum = Slot number of the key to be used |
| | for producing the output signature. KeyRef.useChipId = 0 |
| | No variant key signature generation required |
| SigOnly | Flag indicating return of signature and data. 0 - indicates |
| | both the signature and data are to be returned. 1 - |
| | indicates only the signature is to be returned. |
| Mselect | Selection of memory vectors to be read - each bit |
| | corresponding to a given memory vector (a maximum |
| | of NumVector bits) 0 - indicates the memory vector must |
| | not be read. 1 - indicates memory vector must be read. |
| KeyIdSelect | Selection of KeyIds to be read - each bit corresponds to |
| | a given KeyId (a maximum of NumKey bits). 0 - |
| | indicates KeyId must not be read. 1 - indicates KeyId |
| | must be read. |
| WordSelect | Selection of words read from a desired M as requested |
| | in MSelect. Each WordSelect is 16 bits corresponding |
| | to each bit in MSelect. Each bit in the WordSelect |
| | indicates whether or not to read the corresponding word |
| | for the particular M. 0 - indicates word must not be read. |
| | 1 - indicates word must be read. |
| R_{E} | External random value required for output signature |
| | generation (i.e the challenge). R_{E} is obtained by calling |
| | the Random function on the device which will receive |
| | the SIGₒᵤₜ from the Read function. |

Output Parameters

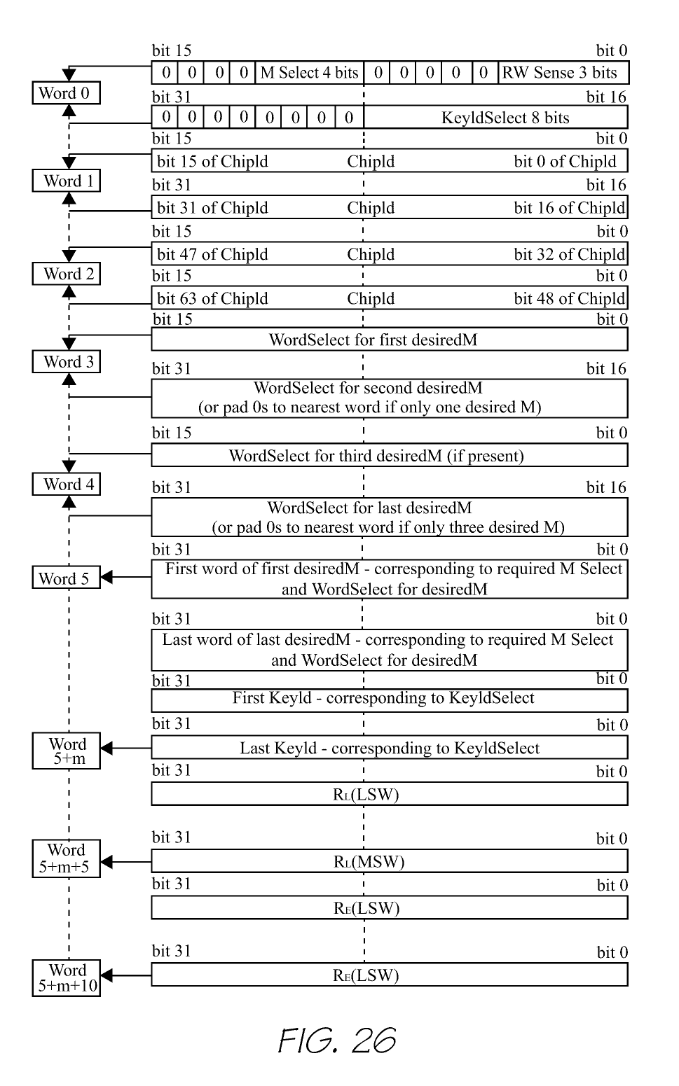

Table 32 describes each of the output parameters.

| Parameter | Description |
|---|---|
| ResultFlag | Indicates whether the function completed |
| | successfully or not. If it did not complete |
| | successfully, the reason for the failure |
| | is returned here. |
| SelectedWordsOfSelectedMs | Selected words from selected memory |
| | vectors as requested by MSelect |
| | and WordSelect. |
| SelectedKeyIds | Selected KeyIds as requested by |
| | KeyIdSelect. |
| R_{L} | Local random value added to the output |
| | signature (i.e SIGₒᵤₜ). Refer to FIG. 26. |
| SIGₒᵤₜ | SIGₒᵤₜ = SIG_{KeyRef}(data \| R_{L}\| R_{E}). |

SIG_{OUT}

FIG. 26 shows the formatting of data for output signature generation.

Table 33 gives the parameters included in SIGₒᵤₜ

| | Length in | | Value set |
|---|---|---|---|
| Parameter | bits | Value set internally | from Input |
| RWSense | 3 | read constant = 000 | |
| MSelect | 4 | | |
| KeyIdSelect | 8 | | |
| ChipId | 48 | This QA Device's ChipId | |
| WordSelect | 16 per M | | |
| SelectedWordsOfSelectedMs | 32 per word | The appropriate words | |
| | | from the various Ms as | |
| | | selected by the caller | |
| R_{L} | 160 | This QA Device's current R | |
| R_{E} | 160 | | |

RWSense

An RWSense value is present in the signed data to distinguish whether a signature was produced from a Read or produced for a WriteAuth.

The RWSense is set to a read constant (000) for producing a signature from a read function. The RWSense is set to a write constant (001) for producing a signature for a write function.

The RWSense prevents signatures produced by Read to be subsequently sent into a WriteAuth function. Only signatures produced with RWSense set to write (001), are accepted by a write function.

Function Sequence

The Read command is illustrated by the following pseudocode:

```
Accept input parameters- KeyRef, SigOnly, MSelect, KeyIdSelect
# Accept input parameter WordSelect based on MSelect
For i ←0 to MaxM
  If(MSelect[i] = 1)
    Accept next WordSelect
    WordSelectTemp[i] ←WordSelect
  EndIf
EndFor
Accept R_{E}
Check range of KeyRef.keyNum
If invalid
  ResultFlag ←InvalidKey
  Output ResultFlag
  Return
EndIf
#Build SelectedWordsOfSelectedMs
k \tilde{←}# k stores the word count for SelectedWordsOfSelectedMs
SelectedWordsOfSelectedMs[k] \tilde{←}
For i←0 to 3
  If(MSelect[i] = 1)
    For j ←0 to MaxWordInM
      If(WordSelectTemp[i][j] = 1)
      SelectedWordsOfSelectedMs[k] ←(Mᵢ[j])
      k++
      EndIf
    EndFor
  EndIf
EndFor
#Build SelectedKeyIds
l \tilde{←}# l stores the word count for SelectedKeyIds
SelectedKeyIds[l] \tilde{←}
For i ←0 to MaxKey
  If(KeyIdSelect[i] = 1)
    SelectedKeyIds[l] ←KeyId[i]
    l++
  EndIf
EndFor
#Generate message for passing into the GenerateSignature function
data ←RWSense|MSelect|KeyIdSelect|ChipId|WordSelect
      |SelectedWordsOfSelectedMs|SelectedKeyIds) # Refer to
      Figure 26.
#Generate Signature function
SIG_{L} ←GenerateSignature(KeyRef,data,R_{L},R_{E})
Update R_{L} to R_{L2}
ResultFlag ←Pass
Output ResultFlag
If(SigOnly = 0)
  Output SelectedWordsOfSelectedMs, SelectedKeyIds
EndIf
Output R_{L}, SIG_{L}
Return
```

Test

| | |
|---|---|
| Input: | KeyRef, DataLength, Data, R_{E}, SIG_{E} |
| Output: | ResultFlag |
| Changes: | R_{L} |
| Availability: | All devices except ink device |

Function Description

The Test command is used to validate data that has been read from an untrusted QA Device according to a digital signature SIG_{E}. The data will typically be memory vector and KeyId data. SIG_{E} (and its related R_{E}) is the most recent signature—this will be the signature produced by Read if Translate was not used, or will be the output from the most recent Translate if Translate was used.

The Test function produces a local signature (SIG_{L}=SlG_{key}(Data|R_{E}|R_{L}) and compares it to the input signature (SIG_{E}). If the two signatures match the function returns ‘Pass’, and the caller knows that the data read can be trusted.

The key used to produce SIG_{L} depends on whether SIG_{E} was produced by a QA Device sharing a common key or a variant key. The KeyRef object passed into the interface must be set appropriately to reflect this.

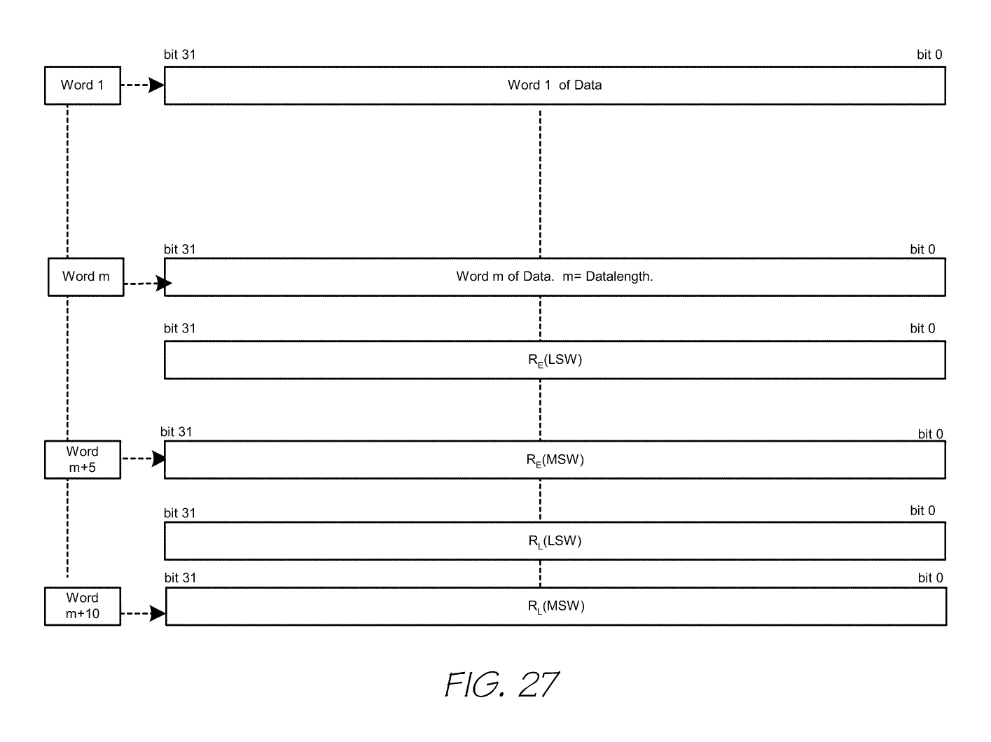

The Test function accepts preformatted data (as DataLength number of words), and appends the external R_{E} and local R_{L} to the preformatted data to generate the signature as shown in FIG. 27.

Input Parameters

Table 34 describes each of the input parameters.

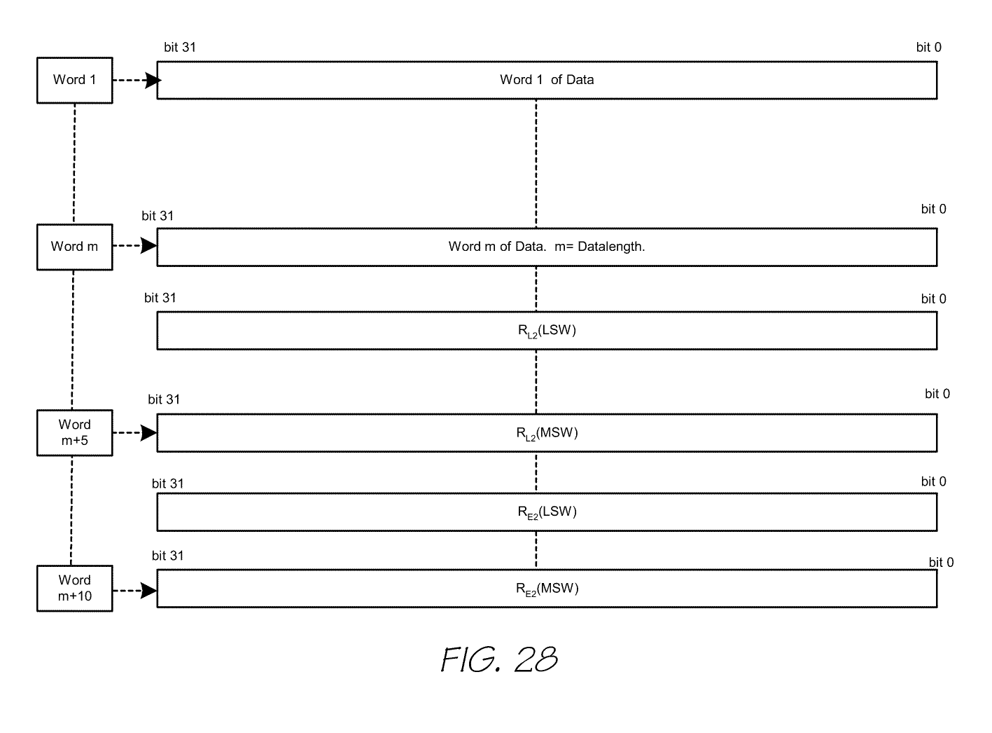

TABLE 34
Description of input parameters for Test

| Parameter | Description |
|---|---|
| KeyRef | For testing common key signature: KeyRef.keyNum = Slot |
| | number of the key to be used for testing the signature. |
| | SIG_{E} produced using K_{KeyRef.keyNum} by the external |
| | device. KeyRef.useChipId = 0 |
| | For testing variant key signature: KeyRef.keyNum = Slot |
| | number of the key to be used for generating the variant key. |
| | SIG_{E} produced using a variant of K_{KeyRef.keyNum} |
| | by the external device. |
| | KeyRef.useChipId = 1 KeyRef.chipId = ChipId of the |
| | device which generated SIG_{E} using a variant of |
| | K_{KeyRef.keyNum}. |
| DataLength | Length of preformatted data in words. Must be non zero. |
| Data | Preformatted data to be used for producing the signature. |
| R_{E} | External random value required for verifying the input |
| | signature. This will be the R from the input signature |
| | generator (i.e the device generating SIG_{E}). |
| SIG_{E} | External signature required for authenticating input data as |
| | shown in FIG. 28. The external signature is generated either |
| | by a Read function or a Translate function. A correct |
| | SIG_{E} = SIG_{KeyRef}(Data\|R_{E}\|R_{L}). |

Input Signature Verification Data Format

FIG. 27 shows the formatting of data for input signature verification.

The data in FIG. 27 (i.e. not R_{E} or R_{L}) is typically output from a Read function (formatted as per FIG. 26). The data may also be generated in the same format by the system from its cache as will be the case when it performs a Read using SigOnly=1.

Output Parameters

Table 35 describes each of the output parameters.

TABLE 35
Description of output parameters for Test

| Parameter | Description |
|---|---|
| ResultFlag | Indicates whether the function completed successfully or |
| | not. If it did not complete successfully, the reason for the |
| | failure is returned here. |

Function Sequence

The Test command is illustrated by the following pseudocode:

Accept input parameters- KeyRef, DataLength
# Accept input parameter- Data based on DataLength
For i ←0 to (DataLength − 1)

Accept next word of Data

EndFor
Accept input parameters - R_{E}, SIG_{E}
Check range of KeyRef.keyNum
If invalid

ResultFlag ←InvalidKey
Output ResultFlag
Return

EndIf
#Generate signature
SIG_{L} ←GenerateSignature(KeyRef,Data,R_{E},R_{L}) # Refer to Figure 27.
#Check signature
If(SIG_{L} = SIG_{E})

Update R_{L} to R_{L2}
ResultFlag ←Pass

Else

ResultFlag ←BadSig

EndIf
Output ResultFlag
Return

Translate

| | |
|---|---|
| Input: | InputKeyRef, DataLength, Data, R_{E}, SIG_{E,} OutputKeyRef, |
| | R_{E2} |
| Output: | ResultFlag, R_{L2}, SIG_{Out} |
| Changes: | R_{L} |
| Availability: | Printer device, and possibly on other devices |

Function Description

It is possible for a system to call the Read function on QA Device A to obtain data and signature, and then call the Test function on QA Device B to validate the data and signature. In the same way it is possible for a system to call the SignM function on a trusted QA Device B and then call the WriteAuth function on QA Device B to actually store data on B. Both of these actions are only possible when QA Devices A and B share secret key information.

If however, A and B do not share secret keys, we can create a validation chain (and hence extension of trust) by means of translation of signatures. A given QA Device can only translate signatures if it knows the key of the previous stage in the chain as well as the key of the next stage in the chain. The Translate function provides this functionality. The Translate function translates a signature from one based on one key to one based another key. The Translate function first performs a test of the input signature using the InputKeyRef, and if the test succeeds produces an output signature using the OutputKeyRef. The Translate function can therefore in some ways be considered to be a combination of the Test and Read function, except that the data is input into the QA Device instead of being read from it.

The InputKeyRef object passed into Translate must be set appropriately to reflect whether SIG_{E} was produced by a QA Device sharing a common key or a variant key. The key used to produce output signature SIGₒᵤₜ depends on whether the translating device shares a common key or a variant key with the QA Device receiving the signature. The OutputKeyRef object passed into Translate must be set appropriately to reflect this.

Since the Translate function does not interpret or generate the data in any way, only preformatted data can be passed in. The Translate function does however append the external R_{E} and local R_{L} to the preformatted data for verifying the input signature, then advances R_{L} to R_{L2}, and appends R_{L2} and R_{E2} to the preformatted data to produce the output signature. This is done to protect the keys and prevent replay attacks.

The Translate functions translates:
signatures for subsequent use in Test, typically originating from Read
signatures for subsequent use in WriteAuth, typically originating from SignM

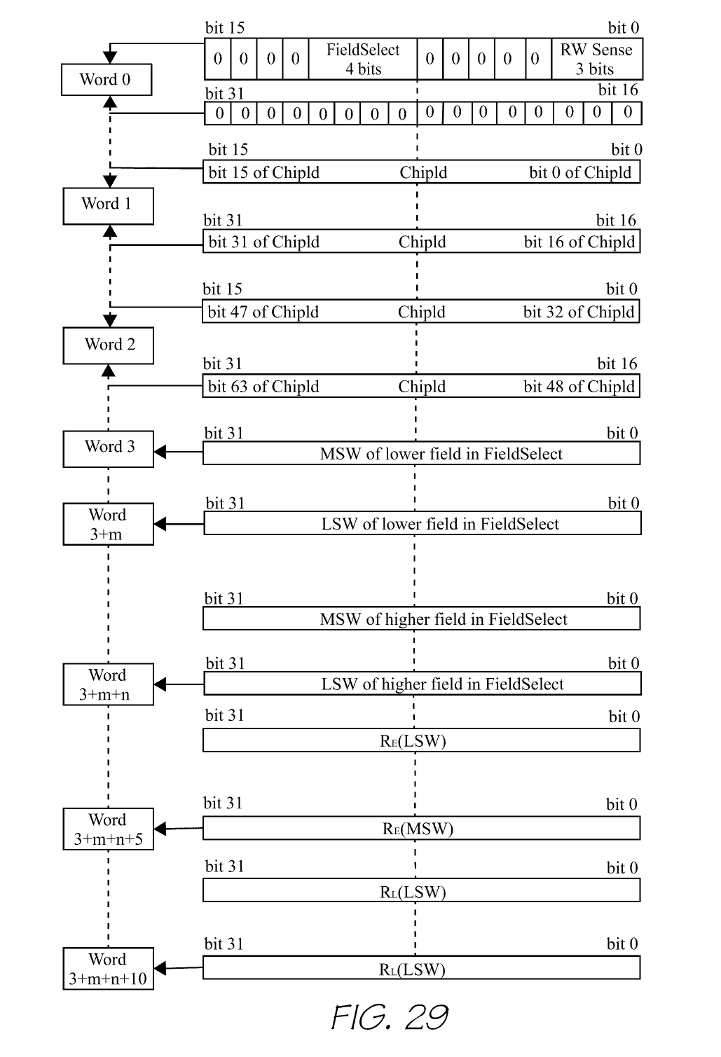

In both cases, preformatted data is passed into the Translate function by the system. For translation of data destined for Test, the data should be preformatted as per FIG. 26 (all words except the Rs). For translation of signatures for use in WriteAuth, the data should be preformatted as per FIG. 29 (all words except the Rs).

Input Parameters

Table 36 describes each of the input parameters.

TABLE 36
Description of input parameters for Translate

| Parameter | Description |
|---|---|
| InputKeyRef | For translating common key input signature: InputKeyRef.keyNum = |
| | Slot number of the key to be used for testing the signature. SIG_{E} |
| | produced using K_{InputKeyRef.keyNum} by the external device. |
| | InputKeyRef.useChipId = 0 |
| | For translating variant key input signatures: InputKeyRef.keyNum = |
| | Slot number of the key to be used for generating the variant key. |
| | SIG_{E} produced using a variant of K_{InputKeyRef.keyNum} by the external |
| | device. InputKeyRef.useChipId = 1 InputKeyRef.chipId = ChipId |
| | of the device which generated SIG_{E} using a variant of |
| | K_{InputKeyRef.keyNum}. |
| DataLength: | Length of data in words. |
| Data | Data used for testing the input signature and for producing the |
| | output signature. |
| R_{E} | External random value required for verifying input signature. This |
| | will be the R from the input signature generator (i.e device generating SIG_{E}). |
| SIG_{E} | External signature required for authenticating input data. The |
| | external signature is either generated by a Read function, a |
| | Xfer/Rollback function or a Translate function. A correct SIG_{E} = |
| | SIG_{KeyRef}(Data\|R_{E}\|R_{L}). |
| OutputKeyRef | For generating common key output signature: |
| | OutputKeyRef.keyNum = Slot number of the key for producing the |
| | output signature. SIGout produced using K_{OutputKeyRef.keyNum} because |
| | the device receiving SIGout shares K_{OutputKeyRef.keyNum} with the |
| | translating device. OutputKeyRef.useChipId = 0 |
| | For generating variant key output signature: |
| | OutputKeyRef.keyNum = Slot number of the key to be used for |
| | generating the variant key. SIGout produced using a variant of |
| | K_{OutputKeyRef.keyNum} because the device receiving SIGout shares a |
| | variant of K_{OutputKeyRef.keyNum} with the translating device. |
| | OutputKeyRef.useChipId = 1 OutputKeyRef.chipId = ChipId of |
| | the device which receives SIGₒᵤₜ produced by a variant of |
| | K_{OutputKeyRef.keyNum}. |
| R_{E2} | External random value required for output signature generation. |
| | This will be the R from the destination of SIGₒᵤₜ. R_{E2} is obtained by |
| | calling the Random function on the device which will receive the |
| | SIGₒᵤₜ from the Translate function. |

Output Parameters

Table 37 describes each of the output parameters.

TABLE 37
Description of output parameters for Translate

| Parameter | Description |
|---|---|
| ResultFlag | Indicates whether the function completed successfully or not. |
| | If it did not complete successfully, the reason for the failure |
| | is returned here. |
| R_{L2} | Local random value used in output signature (i.e SIG_{Out}). |
| SIG_{Out} | Output signature produced using OutputKeyRef.keyNum |
| | using the data format described in FIG. 28. |
| | SIG_{Out} = SIG_{OutKeyRef}(Data\|R_{L2}\|R_{E2}). |

SIGₒᵤₜ

FIG. 28 shows the data format for output signature generation from the Translate function.

Function Sequence

The Translate command is illustrated by the following pseudocode:

```
Accept input parameters-InputKeyRef, DataLength
# Accept input parameter- Data based on DataLength
For i ←0 to (DataLength − 1)
  Accept next Data
EndFor
Accept input parameters - R_{E}, SIG_{E,}OutputKeyRef, R_{E2}
Check range of InputKeyRef.keyNum and OutputKeyRef.keyNum
If invalid
  ResultFlag ←Invalidkey
  Output ResultFlag
  Return
EndIf
#Generate Signature
SIG_{L} ←GenerateSignature(InputKeyRef,Data,R_{E},R_{L}) # Refer to Figure 27.
#Validate input signature
If(SIG_{L} = SIG_{E})
  Update R_{L} to R_{L2}
Else
  ResultFlag ←BadSig
  Output ResultFlag
  Return
EndIf
#Generate output signature
SIG_{Out} ←GenerateSignature(OutputKeyRef,Data,R_{E},R_{L}) # Refer to
Figure 28.
Update R_{L2} to R_{L3}
ResultFlag ←Pass
Output ResultFlag, R_{L2}, SIG_{Out}
Return
```

WriteM1+

| | |
|---|---|
| Input: | VectNum, WordSelect, MVal |
| Output: | ResultFlag |
| Changes: | M_{VectNum} |
| Availability: | All devices |

Function Description

The WriteM1+ function is used to update selected words of M1+, subject to the permissions corresponding to those words stored in P_{VectNum}.

Note: Unlike WriteAuth, a signature is not required as an input to this function.

Input Parameters

Table 38 describes each of the input parameters.

TABLE 38
Description of input parameters for WriteM1+

| Parameter | Description |
|---|---|
| VectNum | Number of the memory vector to be written. |
| | Must be in range 1 to (NumVectors - 1) |
| WordSelect | Selection of words to be written. |
| | 0 - indicates corresponding word is not written. |
| | 1 - indicates corresponding word is to be written as |
| | per input. |
| | If WordSelect[N bit] is set, then write to M_{VectNum} |
| | word N. |
| MVal | Multiple of words corresponding to the number of |
| | words selected for write. |
| | Starts with LSW of M_{VectNum}. |

Note:
Since this function has no accompanying signatures, additional input parameter error checking is required.

Output Parameters

Table 39 describes each of the output parameters.

TABLE 39
Description of output parameters for WriteM1+

| Parameter | Description |
|---|---|
| ResultFlag | Indicates whether the function completed successfully or |
| | not. If it did not complete successfully, the reason for the |
| | failure is returned here. |

Function Sequence

The WriteM1+ command is illustrated by the following pseudocode:

```
Accept input parameters VectNum, WordSelect
#Accept MVal as per WordSelect
MValTemp[16] ←0 # Temporary buffer to hold MVal after being read
For i ←0 to MaxWordInM # word 0 to word 15
  If(WordSelect[i] = 1)
    Accept next MVal
    MValTemp[i] ←MVal # Store MVal in temporary buffer
  EndIf
EndFor
Check range of VectNum
If invalid
  ResultFlag ←InvalidVector
  Output ResultFlag
  Return
EndIf
#Checking non authenticated write permission for M1+
PermOK ←CheckM1+Perm(VectNum,WordSelect)
#Writing M with MVal
If(PermOK =1)
  WriteM(VectNum,MValTemp[ ])
  ResultFlag ←Pass
Else
  ResultFlag ←InvalidPermission
EndIf
Output ResultFlag
Return
```

PermOK CheckM1+Perm (VectNum, WordSelect)

This function checks WordSelect against permission P_{VectNum} for the selected word.

```
For i ←0 to MaxWordInM # word 0 to word 15
  If(WordSelect[i] = 1) [symbol]  (P_{VectNum}[i] = 0) # Trying to write
  a ReadOnly word
    Return PermOK← 0
  EndIf
EndFor
Return PermOK← 1
```

WriteM(VectNum, MValTemp[ ])

This function copies MValTemp to M_{VectNum}.

```
For i ←0 to MaxWordInM # Copying word from temp buff to M
    If(VectNum = 1) # If M1
      P_{VectNum}[i]← 0 # Set permission to ReadOnly before writing
    EndIf
    M_{VectNum}[i] ←MValTemp[i] # copy word buffer to M
word
  EndIf
EndFor
```

Write Fields

| | |
|---|---|
| Input: | FieldSelect, FieldVal |
| Output: | ResultFlag |
| Changes: | M_{VectNum} |
| Availability: | All devices |

Function Description

The WriteFields function is used to write new data to selected fields (stored in M₀). The write is carried out subject to the non-authenticated write access permissions of the fields as stored in the appropriate words of M1.

The WriteFields function is used whenever authorization for a write (i.e. a valid signature) is not required. The WriteFieldsAuth function is used to perform authenticated writes to fields. For example, decrementing the amount of ink in an ink cartridge field is permitted by anyone via the WriteFields, but incrementing it during a refill operation is only permitted using WriteFieldsAuth.

Therefore WriteFields does not require a signature as one of its inputs.

Input Parameters

Table 40 describes each of the input parameters.

TABLE 40
Description of input parameters for WriteFields

| Parameter | Description |
|---|---|
| FieldSelect | Selection of fields to be written. |
| | 0 - indicates corresponding field is not written. |
| | 1 - indicates corresponding field is to be written as per |
| | input. |
| | If FieldSelect [N bit] is set, then write to Field N of M0. |
| FieldVal | Multiple of words corresponding to the words for all |
| | selected fields. |
| | Since Field0 starts at M0[15], FieldVal words starts with |
| | MSW of lower field. |

Note: Since this function has no accompanying signatures, additional input parameter error checking is required especially if the QA Device communication channel has potential for error.

Output Parameters

Table 41 describes each of the output parameters.

TABLE 41
Description of output parameters for WriteFields

| Parameter | Description |
|---|---|
| ResultFlag | Indicates whether the function completed successfully or |
| | not. If it did not complete successfully, the reason for the |
| | failure is returned here. |

Function Sequence

The WriteFields command is illustrated by the following pseudocode:

```
Accept input parameters FieldSelect
#Accept FieldVal as per FieldSelect into a temporary buffer MValTemp
#Find the size of each FieldNum to accept FieldData
FieldSize[16] ←0 # Array to hold FieldSize assuming there are 16 fields
NumFields← FindNumberOfFieldsInM0(M1,FieldSize)
MValTemp[16] ←0 # Temporary buffer to hold FieldVal after being read
For i ←0 to NumFields
  If FieldSelect[i] = 1
    If i = 0 # Check if field number is 0
      PreviousFieldEndPos ←MaxWordInM
    Else
      PreviousFieldEndPos ←M1[i−1].EndPos # position of the last
word for the
                          # previous field
    EndIf
    For j ←(PreviousFieldEndPos −1) to M1[FieldNum].EndPos( )
      MValTemp[j] = Next FieldVal word #Store FieldVal in
      MValTemp.
    EndFor
  EndIf
EndFor
#Check non-authenticated write permissions for all fields in FieldSelect
PermOK ←CheckM0NonAuthPerm(FieldSelect,MValTemp,M0,M1)
#Writing M0 with MValTemp if permissions allow writing
If(PermOK =1)
  WriteM(0,MValTemp)
  ResultFlag ←Pass
Else
  ResultFlag ←InvalidPermission
EndIf
Output ResultFlag
Return
```

NumFields FindNumOfFieldsInM0(M1,FieldSize[ ])

This function returns the number of fields in M₀ and an array FieldSize which stores the size of each field.

```
CurrPos ←0
NumFields ←0
FieldSize[16] ←0 # Array storing field sizes
For FieldNum ←0 to MaxWordInM
  If(CurrPos = 0) # check if last field has reached
    Return FieldNum #FieldNum indicates number of fields in M0
  EndIf
  FieldSize[FieldNum]← CurrPos − M1[FieldNum].EndPos
  If(FieldSize[FieldNum] < 0)
    Error # Integrity problem with field attributes
    Return FieldNum # Lower M0 fields are still valid but higher M0
                # fields are ignored
  Else
    CurrPos← M1[FieldNum].EndPos
  EndIf
EndFor
```

WordBitMapForField GetWordMapForField(FieldNum,M1)

This function returns the word bitmap corresponding to a field i.e the field consists of which consecutive words.

```
WordBitMapForField←0
WordMapTemp \tilde{←}
PreviousFieldEndPos ←M1[FieldNum −1].EndPos # position of the last
word for the
                  # previous field
For j ←(PreviousFieldEndPos +1) to M1[FieldNum].EndPos( )
  # Set bit corresponding to the word position
  WordMapTemp ←SHIFTLEFT(1,j)
  WordBitMapForField ←WordMapTemp [symbol] WordBitMapForField
EndFor
Return WordBitMapForField
```

PermOK CheckM0NonAuthPerm(FieldSelect,MValTemp[ ],M0,M1)

This functions checks non-authenticated write permissions for all fields in FieldSelect.

```
PermOK CheckM0NonAuthPerm( )
FieldSize[16] ←0
NumFields ←FindNumOfFieldsInM0(FieldSize)
# Loop through all fields in FieldSelect and check their
# non-authenticated permission
For i ←0 to NumFields
  If FieldSelect[i] = 1 # check selected
    WordBitMapForField← GetWordMapForField(i,M1) #get word
bitmap for field
    PermOK
←CheckFieldNonAuthPerm(i,WordBitMapForField,MValTemp,M0,)
            # Check permission for field i in FieldSelect
    If(PermOK = 0)  #Writing is not allowed, return if permissions
for field
            # doesn't allow writing
      Return PermOK
    EndIf
  EndIf
EndFor
Return PermOK
```

PermOK

CheckFieldNonAuthPerm(FieldNum,WordBitMapForField, MValTemp[ ],M0)

This function checks non authenticated write permissions for the field.

```
DecrementOnly \tilde{←}
AuthRW ←M1[FieldNum].AuthRW
NonAuthRW ←M1[FieldNum].AuthRW
If(NonAuthRW = 0) # No NonAuth write allowed
  Return PermOK← 0
EndIf
If((AuthRW = 0) [symbol]  (NonAuthRW = 1))# NonAuthRW allowed
  Return PermOK←1
ElseIf(AuthRW = 1) [symbol]  (NonAuthRW = 1)# NonAuth
DecrementOnly allowed
  PermOK
←CheckInputDataForDecrementOnly(M0,MValTemp,
WordBitMapForField)
  Return PermOK
EndIf
```

PermOK CheckInputDataForDecrementOnly(M0,MValTemp[ ],WordBitMapForField)

This function checks the data to be written to the field is less than the current value.

```
DecEncountered ← 0
LessThanFlag \tilde{←}
EqualToFlag \tilde{←}
For i = MaxWordInM to 0
  If(WordBitMapForField[i] = 1) # starting word of the field − starting
  at MSW
  # comparing the word of temp buffer with M0 current value
  LessThanFlag ←M0[i] < MValTemp[i]
  EqualToFlag←M0[i] = MValTemp[i]
  # current value is less or previous value has been decremented
  If(LessThanFlag =1) [symbol]  (DecEncountered = 1)
    DecEncountered [symbol]
    PermOK← 1
    Return PermOK
  ElseIf(EqualToFlag≠1)  # Only if the value is greater than current and
  decrement not encountered in previous words
      PermOK← 0
      Return PermOK
    EndIf
  EndIf
EndFor
```

WriteM(VectNum, MValTemp[ ])

WriteFieldsAuth

| | |
|---|---|
| Input: | KeyRef, FieldSelect, FieldVal, R_{E}, SIG_{E} |
| Output: | ResultFlag |
| Changes: | _{M0} and R_{L} |
| Availability: | All devices |

Function Description

The WriteFieldsAuth command is used to securely update a number of fields (in _{M0}). The write is carried out subject to the authenticated write access permissions of the fields as stored in the appropriate words of M1. WriteFieldsAuth will either update all of the requested fields or none of them; the write only succeeds when all of the requested fields can be written to.

The WriteFieldsAuth function requires the data to be accompanied by an appropriate signature based on a key that has appropriate write permissions to the field, and the signature must also include the local R (i.e. nonce/challenge) as previously read from this QA Device via the Random function.

The appropriate signature can only be produced by knowing K_{KeyRef}. This can be achieved by a call to an appropriate command on a QA Device that holds a key matching K_{KeyRef}. Appropriate commands include SignM, XferAmount, XferField, StartXfer, and StartRollBack.

Input Parameters

Table 42 describes each of the input parameters for WriteAuth.

| Parameter | Description |
|---|---|
| KeyRef | For common key signature generation: KeyRef.keyNum = |
| | Slot number of the key to be used for testing the input |
| | signature. KeyRef.useChipId = 0 |
| | No variant key signature generation required |
| FieldSelect | Selection of fields to be written. 0—indicates |
| | corresponding field is not written. 1—indicates |
| | corresponding field is to be written as per input. If |
| | FieldSelect [N bit] is set, then write to Field N of M0. |
| FieldVal | Multiple of words corresponding to the total number of |
| | words for all selected fields. Since Field0 starts at |
| | M0[15], FieldVal words starts with MSW of lower field. |
| RE | External random value used to verify input signature. |
| | This will be the R from the input signature generator (i.e |
| | device generating SIG_{E}). |
| SIGE | External signature required for authenticating input data. |
| | The external signature is either generated by a |
| | Translate or one of the Xfer functions. A correct SIG_{E} = |
| | SIG_{KeyRef}(data\|R_{E}\|R_{L}). |

Input Signature Verification Data Format

FIG. 29 shows the input signature verification data format for the WriteAuth function.

Table 43 gives the parameters included in SIG_{E for write Auth}

| | Length in | | Value set |
|---|---|---|---|
| Parameter | bits | Value set internally | from Input |
| RWSense | 3 | write constant = 001 | |
| FieldNum | 4 | | |
| ChipID | 48 | This QA Device's | |
| | | ChipId | |
| FieldData | 32 per word | | |
| R_{E} | 160 | | |
| R_{L} | 160 | random value from | |
| | | device | |

Output Parameters

Table 44 describes each of the output parameters.

TABLE 44
Description of output parameters for WriteAuth

| Parameter | Description |
|---|---|
| ResultFlag | Indicates whether the function completed successfully or not. |
| | If it did not complete successfully, the reason for the failure |
| | is returned here. |

Function Sequence

The WriteAuth command is illustrated by the following pseudocode:

```
Accept input parameters-KeyRef, FieldSelect,
#Accept FieldVal as per FieldSelect into a temporary buffer MValTemp
#Find the size of each FieldNum to accept FieldData
FieldSize[16] ←0 # Array to hold FieldSize assuming there are 16 fields
NumFields← FindNumberOfFieldsInM0(M1,FieldSize)
MValTemp[16] ←0 # Temporary buffer to hold FieldVal after being read
For i ←0 to NumFields
  If i = 0 # Check if field number is 0
    PreviousFieldEndPos ←MaxWordInM
  Else
    PreviousFieldEndPos ←M1[i−1].EndPos # position of the last word
for the previous field
  EndIf
  For j ←(PreviousFieldEndPos −1) to M1[FieldNum].EndPos( )
    MValTemp[j] = Next FieldVal word #Store FieldVal in MValTemp.
  EndFor
  EndIf
EndFor
Accept R_{E}, SIG_{E}
Check range of KeyRef.keyNum
If invalid range
  ResultFlag ←InvalidKey
  Output ResultFlag
  Return
EndIf
#Generate message for passing to GenerateSignature function
data ←(RWSense|FieldSelect|ChipId|FieldVal
#Generate Signature
SIG_{L} ←GenerateSignature(KeyRef,data,R_{E},R_{L}) # Refer to Figure 29.
#Check signature
If(SIG_{L} = SIG_{E})
  Update R_{L} to R_{L2}
Else
  ResultFlag ←BadSig
  Output ResultFlag
  Return
EndIf
#Check authenticated write permission for all fields in FieldSelect using
KeyRef
PermOK← CheckM0AuthPerm(FieldSelect,MValTemp,M0,M1,KeyRef)
If(PermOK = 1)
  WriteM(0,MValTemp[ ])# Copy temp buffer to M0
  ResultFlag ←Pass
Else
  ResultFlag ←InvalidPermission
EndIf
Output ResultFlag
Return
```

PermOK CheckM0AuthPerm(FieldSelect,MValTemp[ ],M0, M1, KeyRef)

This functions checks non-authenticated write permissions for all fields in FieldSelect using KeyRef.

```
PermOK CheckM0NonAuthPerm( )
FieldSize[16] ←0
NumFields ←FindNumOfFieldsInM0(FieldSize)
# Loop through fields
For i ←0 to NumFields
  If FieldSelect[i] = 1 # check selected
    WordBitMapForField← GetWordMapForField(i,M1) #get word
bitmap for field
    PermOK ←CheckAuthFieldPerm(i,WordBitMapForField,
MValTemp,M0,KeyRef)
        # Check permission for field i in FieldSelect
    If(PermOK = 0)  #Writing is not allowed, return if #permissions
          for field doesn't allow writing
      Return PermOK
    EndIf
  EndIf
EndFor
Return PermOK
```

PermOK CheckAuthFieldPerm(FieldNum, WordMapForField,MValTemp[ ], M0, KeyRef)
This function checks authenticated permissions for an M0 field using KeyRef (whether KeyRef has write permissions to the field).

```
AuthRW ←M1[FieldNum].AuthRW
KeyNumAtt ←M1[FieldNum].KeyNum
If(AuthRW = 0) # Check whether any key has write permissions
  Return PermOK←0 # No authenticated write permissions
EndIf
# Check KeyRef has ReadWrite Permission to the field and it is locked
If(KeyLock_{KeyNum} = locked) [symbol] (KeyNumAtt = KeyRef.keyNum)
  Return PermOK← 1
Else # KeyNum is not a ReadWrite Key
  KeyPerms ←M1[FieldNum].DOForKeys # Isolate KeyPerms for
  FieldNum
  # Check Decrement Only Permission for Key
  If(KeyPerms[KeyRef.keyNum] = 1) # Key is allowed to Decrement
  field
      PermOK
←CheckInputDataForDecrementOnly(M0,MValTemp,WordMapForField)
    Else # Key is a ReadOnly key
      PermOK←0
  EndIf
EndIf
Return PermOK
```

WordBitMapField GetWordMapForField(FieldNum,M1)

PermOK CheckInputDataForDecrementOnly(M0,MValTemp[ ],WordMapForField) WriteM(VectNum, MValTemp[ ])

SetPerm

| | |
|---|---|
| Input: | VectNum, PermVal |
| Output: | ResultFlag, NewPerm |
| Changes: | Pₙ |
| Availability: | All devices |

Function Description

The SetPerm command is used to update the contents of P_{VectNum} (which stores the permission for M_{VectNum}).

The new value for P_{VectNum} is a combination of the old and new permissions in such a way that the more restrictive permission for each part of P_{VectNum} is kept.

M0's permissions are set by M1 therefore they can't be changed.

M1's permissions cannot be changed by SetPerm. M1 is a write-once memory vector and its permissions are set by writing to it.

Input Parameters

Table 45 describes each of the input parameters for SetPerm.

| Parameter | Description |
|---|---|
| VectNum | Number of the memory vector whose permission is |
| | being changed. |
| PermVal | Bitmap of permission for the corresponding Memory |
| | Vector. |

Note: Since this function has no accompanying signatures, additional input parameter error checking is required.

Output Parameters

Table 46 describes each of the output parameters for SetPerm.

| Parameter | Description |
|---|---|
| ResultFlag | Indicates whether the function completed successfully or |
| | not. If it did not complete successfully, the reason for the |
| | failure is returned here. |
| Perm | If VectNum = 0, then no Perm is returned. |
| | If VectNum = 1, then old Perm is returned. |
| | If VectNum > 1, then new Perm is returned after P_{VectNum} |
| | has been changed based on PermVal. |

Function Sequence

The SetPerm command is illustrated by the following pseudocode:

```
Accept input parameters- VectNum, PermVal
Check range of VectNum
If invalid
  ResultFlag ←InvalidVector
  Output ResultFlag
  Return
EndIf
If(VectNum = 0) # No permssions for M0
  ResultFlag ←Pass
  Output ResultFlag
  Return
ElseIf(VectNum = 1)
    ResultFlag ←Pass
    Output ResultFlag
    Output P₁
    Return
ElseIf(VectNum >1)
  # Check that only ‘RW’ parts are being changed
  # RW(1)→ RO(0), RO(0) →RO(0), RW(1) → RW(1) - valid change
  # RO(0) →RW(1) - Invalid change
  # checking for change from ReadOnly to ReadWrite
  temp← ~P_{VectNum} [symbol] PermVal
  If(temp 1) # If invalid change is 1
    ResultFlag ← InvalidPermission
    Output ResultFlag
  Else
    P_{VectNum} ←PermVal
    ResultFlag ← Pass
    Output ResultFlag
    Output P_{VectNum}
  EndIf
  Return
EndIf
```

ReplaceKey

| | |
|---|---|
| Input: | KeyRef, KeyId, KeyLock, EncryptedKey, R_{E}, SIG_{E} |
| Output: | ResultFlag |
| Changes: | K_{KeyRef.keyNum} and R_{L} |
| Availability: | All devices |

Function Description

The ReplaceKey command is used to replace the contents of a non-locked keyslot, which means replacing the key, its associated keyId, and the lock status bit for the keyslot. A key can only be replaced if the slot has not been locked i.e. the KeyLock for the slot is 0. The procedure for replacing a key also requires knowledge of the value of the current key in the keyslot i.e. you can only replace a key if you know the current key. Whenever the ReplaceKey function is called, the caller has the ability to make this new key the final key for the slot. This is accomplished by passing in a new value for the KeyLock flag. A new KeyLock flag of 0 keeps the slot unlocked, and permits further replacements. A new KeyLock flag of 1 means the slot is now locked, with the new key as the final key for the slot i.e. no further key replacement is permitted for that slot.

Input Parameters

Table 47 describes each of the input parameters for Replacekey.

| Parameter | Description |
|---|---|
| KeyRef | For common key signature generation: KeyRef.keyNum = |
| | Slot number of the key to be used for testing the input |
| | signature, and will be replaced by the new key. |
| | KeyRef.useChipId = 0 No variant key signature |
| | generation required |
| KeyId | KeyId of the new key. The LSB represents whether the new |
| | key is a variant or a common key. |
| KeyLock | Flag indicating whether the new key should be the final key |
| | for the slot or not. (1 = final key, 0 = not final key) |
| Encrypted | SIG_{Kold}(R_{E}\|R_{L}) ⊕K_{new} where K_{old} = KeyRef.getkey( ). |
| Key | |
| RE | External random value required for verifying input signature. |
| | This will be the R from the input signature generator |
| | (device generating SIG_{E}). In this case the input signature |
| | is a generated by calling the GetProgramKey function on a |
| | Key Programming device. |
| SIGE | External signature required for authenticating input data and |
| | determining the new key from the EncryptedKey. |

Input Signature Generation Data Format

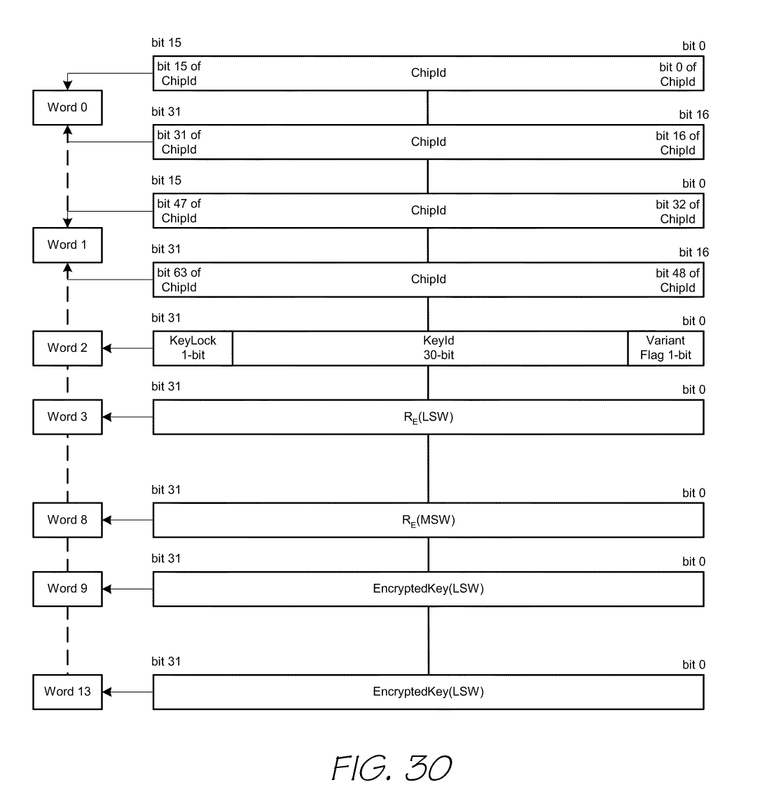

FIG. 30 shows the input signature generation data format for the ReplaceKey function.

Table 48 gives the parameters included in SIG_{E for ReplaceKey}.

| | Length in | Value set | Value set |
|---|---|---|---|
| Parameter | bits | internally | from Input |
| ChipId | 48 | This QA | |
| | | Device's ChipId | |
| KeyId | 32 | | |
| R_{E} | 160 | | |
| EncryptedKey | 160 | | |

Output Parameters

Table 49 describes each of the output parameters for ReplaceKey.

| Parameter | Description |
|---|---|
| ResultFlag | Indicates whether the function completed successfully or |
| | not. If it did not complete successfully, the reason for the |
| | failure is returned here. |

Function Sequence

The ReplaceKey command is illustrated by the following pseudocode:

```
Accept input parameters - KeyRef, KeyId, KeyLock, EncryptedKey,R_{E},
SIG_{E}
Check KeyRef.keyNum range
If invalid
  ResultFlag ←InvalidKey
  Output ResultFlag
  Return
EndIf
#Generate message for passing to GenerateSignature function
data ←(ChipId|KeyId|KeyLock|R_{E}|EncryptedKey)
#Generate Signature
SIG_{L} ←GenerateSignature(KeyRef,data,Null,Null) # Refer to Figure 30.
# Check if the key slot is unlocked
If(KeyLock # unlock)
  ResultFlag ←KeyAlreadyLocked
  Output ResultFlag
  Return
EndIf
#Test SIG_{E}
If (SIG_{L} # SIG_{E})
  ResultFlag ←BadSig
  Output ResultFlag
  Return
EndIf
SIG_{L} ←GenerateSignature(Key,null,R_{E},R_{L})
  Advance R_{L}
  # Must be atomic - must not be possible to remove power and have
KeyId and KeyNum mismatched. Also preferable for KeyLock, although
  not strictly required.
  K_{KeyNum} ← SIG_{L} ⊕ EncryptedKey
  KeyId_{KeyNum} [symbol] KeyId
  KeyLock_{KeyNum} ←KeyLock
  ResultFlag ←Pass
  Output ResultFlag
Return
```

SignM

| | |
|---|---|
| Input: | KeyRef, FieldSelect, FieldValLength, FieldVal, |
| | ChipId, R_{E} |
| Output: | ResultFlag, R_{L}, SIGₒᵤₜ |
| Changes: | R_{L} |
| Availabllity: | Trusted device only |

Function Description

The SignM function is used to generate the appropriate digital signature required for the authenticated write function WriteFieldsAuth. The SignM function is used whenever the caller wants to write a new value to a field that requires key-based write access. The caller typically passes the new field value as input to the SignM function, together with the nonce (R_{E}) from the QA Device who will receive the generated signature. The SignM function then produces the appropriate signature SIGₒᵤₜ. Note that SIGₒᵤₜ may need to be translated via the Translate function on its way to the final WriteFieldsAuth QA Device.

The SignM function is typically used by the system to update preauthorisation fields. The key used to produce output signature SIGₒᵤₜ depends on whether the trusted device shares a common key or a variant key with the QA Device directly receiving the signature. The KeyRef object passed into the interface must be set appropriately to reflect this.

Input Parameters

Table 50 describes each of the input parameters for SignM.

| Parameter | Description |
|---|---|
| KeyRef | For generating common key output signature: |
| | Ref.keyNum = Slot number of the key for producing the output |
| | signature. |
| | SIGₒᵤₜ produced using K_{KeyRef.keyNum} because the device receiving |
| | SIGₒᵤₜ shares K_{KeyRef.keyNum} with the trusted device. |
| | KeyRef.useChipId = 0 |
| | For generating variant key output signature: |
| | KeyRef.keyNum = Slot number of the key to be used for |
| | generating the variant key. |
| | SIGₒᵤₜ produced using a variant of K_{KeyRef.keyNum} because the device |
| | receiving SIGₒᵤₜ shares a variant of K_{KeyRef.keyNum} with the trusted |
| | device. |
| | KeyRef.useChipId = 1 |
| | KeyRef.chipId = ChipId of the device which receives SIGₒᵤₜ. |
| FieldNum | Field number of the field that will be written to. |
| FieldDataLength | The length of the FieldData in words. |
| FieldData | The value that will be written to the field selected by FieldNum. |
| R_{E} | External random value used in the output signature generation. |
| | R_{E} is obtained by calling the Random function on the device, which |
| | will receive the SIGₒᵤₜ from the SignM function, which in this case is |
| | the WriteAuth function or the Translate function. |
| ChipId | Chip identifier of the device whose WriteAuth function will be called |
| | subsequently to perform an authenticated write to its FieldNum of |
| | M0. |

Output Parameters

Table 51 describes each of the output parameters.

TABLE 51
Description of output parameters for SignM

| Parameter | Description |
|---|---|
| ResultFlag | Indicates whether the function completed successfully or |
| | not. If it did not complete successfully, the reason for the |
| | failure is returned here. |
| R_{L} | Internal random value used in the output signature. |
| SIGₒᵤₜ | SIG_{Out} = SIG_{KeyRef}(data\|R_{L}\|R_{E}) as shown in FIG. 29. |
| | As per FIG. 29, R_{E} is actually R_{L} and R_{L} is R_{E} with |
| | respect to device producing SIGₒᵤₜ to be applied to |
| | WriteAuth function. |

Function Sequence

The SignM command is illustrated by the following pseudocode:

```
Accept input parameters - KeyRef, FieldNum, FieldDataLength
# Accept FieldData words
For i = 0 to FieldValLength
  Accept next FieldData
EndFor
Accept ChipId, R_{E}
Check KeyRef.keyNum range
If invalid
  ResultFlag ←InvalidKey
  Output ResultFlag
  Return
EndIf
#Generate message for passing into the GenerateSignature function
data ←(RWSense|FieldSelect|ChipId|FieldVal)
#Generate Signature
SIGₒᵤₜ ←GenerateSignature(KeyRef,data,R_{L},R_{E})
Advance R_{L}to R_{L2}
ResultFlag ←Pass
Output parameters ResultFlag, R_{L},SIGₒᵤₜ
Return
```

Functions on a Key Programming QA Device

The key programming device is used to replace keys in other devices.

The key programming device stores both the old key which will be replaced in the device being programmed, and the new key which will replace the old key in the device being programmed. The keys reside in normal key slots of the key programming device. Any key stored in the key programming device can be used as an old key or a new key for the device being programmed, provided it is permitted by the key replacement map stored within the key programming device.

FIG. 31 is representation of a key replacement map. The 1s indicates that the new key is permitted to replace the old key. The 0s indicates that key replacement is not permitted for those positions. The positions in FIG. 31 which are blank indicate a 0. According to the key replacement map in FIG. 31, K₅ can replace K₁, K₆ can replace K₃, K₄, K₅, K₇, K₃ can replace K₂, K₀ can replace K₂, and K₂ can replace K₆. No key can replace itself.

The key replacement map must be readable from an external system and must be updateable by an authenticated write. Therefore, the key replacement map must be stored in an M0 field. This requires one of the keys residing in the key programming device to be have ReadWrite access to the key replacement map. This key is referred to as the key replacement map key and is used to update the key replacement map. There will one key replacement map field in a key programming device.

No key replacement mappings are allowed to the key replacement map key because it should not be used in another device being programmed. To prevent the key replacement map key from being used in key replacement, in case the mapping has been accidentally changed, the key replacement map key is allocated a fixed key slot of 0 in all key programming devices. If a GetProgram function is invoked on the key programming device with the key replacement map key slot number 0 it immediately returns an error, even before the key replacement map is checked.

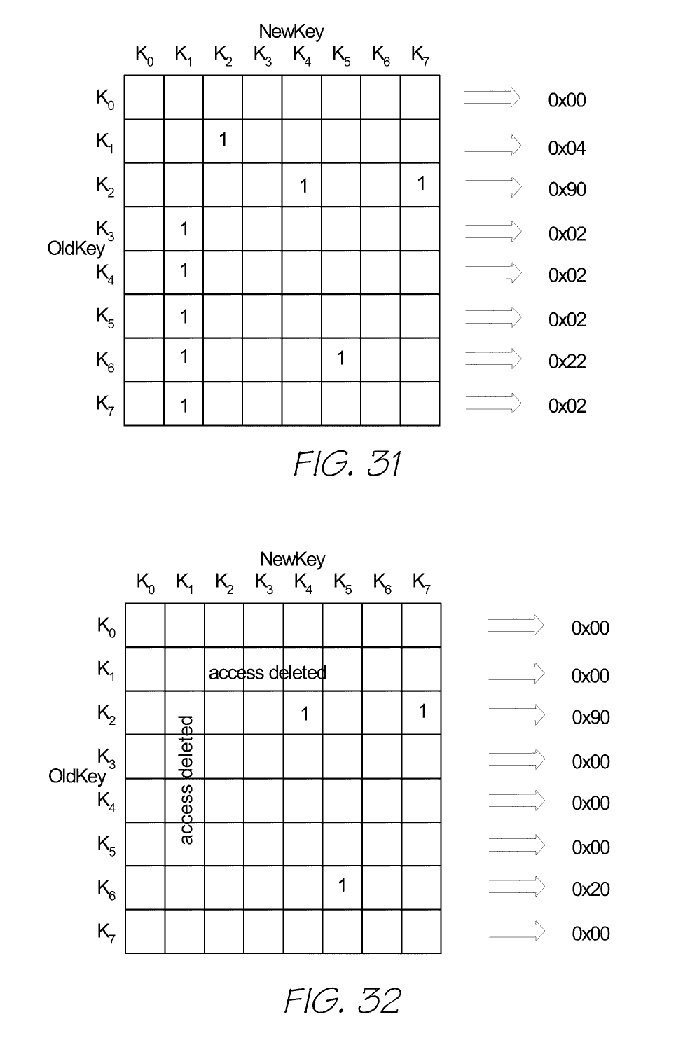

The keys K₀ to K₇ in the key programming device are initially set during the instantiation of the key programming device. Thereafter, any key can be replaced on the key programming device by another key programming device If a key in a key slot of the key programming device is being replaced, the key replacement map for the old key must be invalidated automatically. This is done by setting the row and column for the corresponding key slot to 0 For example, if K₁ is replaced, then column 1 and row 1 are set to 0, as indicated in FIG. 32.

The new mapping information for K₁ is then entered by performing an authenticated write of the key replacement map field using the key replacement map key.

Key Replacement Map Data Structure

The key replacement map must be readable by external systems and must be updateable using an authenticated write by the key replacement map key. Therefore, the key replacement map is stored in an M0 field of the key programming device. The map is 8×8 bits in size and therefore can be stored in a two word field. The LSW of key replacement map stores the mappings for K₀-K₃. The MSW of key replacement map stores the mappings for K₄-K₇. Referring to FIG. 31, key replacement map LSW is 0x40092000 and MSW is 0x40224040. Referring to FIG. 32, after K₁ is replaced in the key programming device, the value of the key replacement map LSW is 0x40090000 and MSW is 0x40224040.

The key replacement map field has an M1 word representing its attributes. The attribute setting for this field is specified in Table 52.

TABLE 52
Key replacement map attribute setting

| Attribute | | |
|---|---|---|
| name | Value | Explanation |
| Type | TYPE_KEY_MAP | Indicates that the field value |
| | Refer to Appendix A. | represents a key replacement |
| | | map. |
| | | Only one such field per key |
| | | programming QA Device. |
| KeyNum | 0 | Slot number of the key |
| | | replacement map key. |
| NonAuthRW | 0 | No non authenticated writes |
| | | is permitted. |
| AuthRW | 1 | Authenticated write is |
| | | permitted. |
| KeyPerms | 0 | No Decrement Only |
| | | permission for any key. |
| EndPos | Value such that field size | |
| | is 2 words | |

Basic Scheme

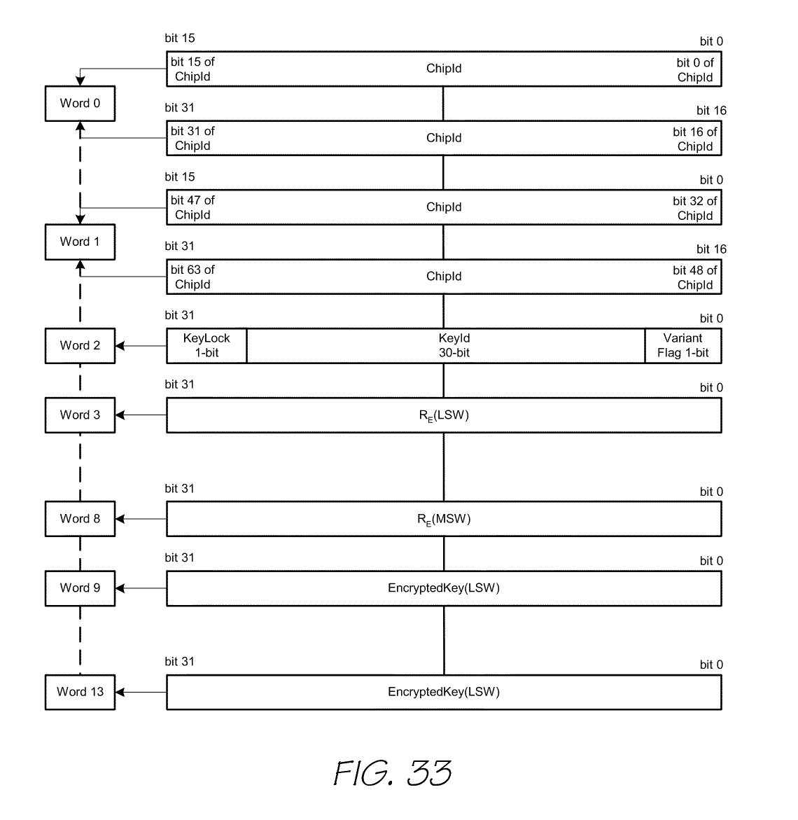

The Key Replacement sequence is shown FIG. 33.

Following is a sequential description of the transfer and rollback process:

1. The System gets a Random number from the QA Device whose keys are going to be replaced.

2. The System makes a GetProgramKey Request to the Key Programming QA Device. The Key Programming QA Device must contain both keys for QA Device whose keys are being replaced—Old Keys which are the keys that exist currently (before key replacement), and the New Keys which are the keys which the QA Device will have after a successful processing of the ReplaceKey Request. The GetProgramKey Request is called with the Key number of the Old Key (in the Key Programming QA Device) and the Key Number of the New Key (in the Key Programming QA Device), and the Random number from (1). The Key Programming QA Device validates the GetProgramKey Request based on the KeyReplacement map, and then produces the necessary GetProgramKey Output. The GetProgramKey Output consists of the encrypted New Key (encryption done using the Old Key), along with a signature using the Old Key.

3. The System then applies GetProgramKey Output to the QA Device whose key is being replaced, by calling the ReplaceKey function on it, passing in the GetProgramKey Output. The ReplaceKey function will decrypt the encrypted New Key using the Old Key, and then replace its Old Key with the decrypted New Key.

Functions

GetProgamKey

| | |
|---|---|
| Input: | OldKeyRef, ChipId, R_{E}, KeyLock, NewKeyRef |
| Output: | ResultFlag, R_{L}, EncryptedKey, KeyIdOfNewKey, |
| | SIGₒᵤₜ |
| Changes: | R_{L} |
| Availability: | Key programming device |

Function Description

The GetProgramKey works in conjunction with the ReplaceKey command, and is used to replace the specified key and its KeyId. This function is available on a key programming device and produces the necessary inputs for the ReplaceKey function. The ReplaceKey command is then run on the device whose key is being replaced. The key programming device must have both the old key and the new key programmed as its keys, and the key replacement map stored in one of its M0 field, before GetProgramKey can be called on the device.

Depending on the OldKeyRef object and the NewKeyRef object passed in, the GetProgramKey will produce a signature to replace a common key by a common key, a variant key by a common key, a common key by a variant key or a variant key by a variant key.

Input Parameters

Table 53 describes each of the input parameters for GetProgramKey.

| Parameter | Description |
|---|---|
| OldKeyRef | Old key is a common key: OldKeyRef.keyNum = Slot number of the old |
| | key in the Key Programming QA Device. The device whose key is being |
| | replaced, shares a common key K_{OldKeyRef.keyNum}with the key |
| | programming device. OldKeyRef.useChipId = 0 |
| | Old key is a variant key KeyRef.keyNum = Slot number of the old keyin |
| | the Key Programming QA Device. that will be used to generate the |
| | variant key. The device whose key is being replaced, shares a variant of |
| | K_{OldKeyRef.keyNum} with the key programming device. OldKeyRef.useChipId = |
| | 1 OldKeyRef.chipId = ChipId of the device whose variant of |
| | K_{OldKeyRef.keyNum} key is being replaced. |
| ChipId | Chip identifier of the device whose key is being replaced. |
| RE | External random value which will be used in output signature generation. |
| | R_{E} is obtained by calling the Random function on the device being |
| | programmed. This will also receive the SIGout from the GetProgramKey |
| | function. SIGout is passed in to ReplaceKey function. |
| KeyLock | Flag indicating whether the new key should be unlocked/locked into its |
| | slot. |
| NewKeyRef | New key is a common key: NewKeyRef.keyNum = Slot number of the |
| | new keyin the Key Programming QA Device. The device whose key is |
| | being replaced, will receive a common key K_{NewKeyRef.keyNum} from the key |
| | programming device. NewKeyRef.useChipId = 0 |
| | NewKey is a variant key: NewKeyRef.keyNum = Slot number of the |
| | new key in the Key Programming QA Device. that will be used to |
| | generate the new variant key. The device whose key is being replaced, |
| | will receive a new key which is a variant of K_{NewKeyRef.keyNum} from the key |
| | programming device. NewKeyRef.useChipId = 1 NewKeyRef.chipId = |
| | ChipId of the device receiving a new key, the new key is a variant of the |
| | K_{NewKeyRef.keyNum}. |

Output Parameters

Table 54 describes each of the output parameters for GetProgramKey.

| Parameter | Description |
|---|---|
| ResultFlag | Indicates whether the function completed successfully |
| | or not. If it did not complete successfully, the reason |
| | for the failure is returned here. |
| R_{L} | Internal random value used in the output signature. |
| EncryptedKey | SIG_{Kold}(R_{L}\|R_{E}) ⊕K_{new} |
| KeyIdOfNewKey | KeyId of the new key. The LSB represents whether the |
| | new key is a variant or a common key. |
| SIGₒᵤₜ | SIGₒᵤₜ = SIG_{Kold}(data\|R_{L}\|R_{E}) |

TABLE 55
ResultFlag definitions for GetProgramKey

| Result Flag | Description |
|---|---|
| InvalidKeyReplacementMap | Key replacement map field invalid or |
| | doesn't exist. |
| KeyReplacementNotAllowed | Key replacement not allowed as per key |
| | replacement map. |

SIGₒᵤₜ

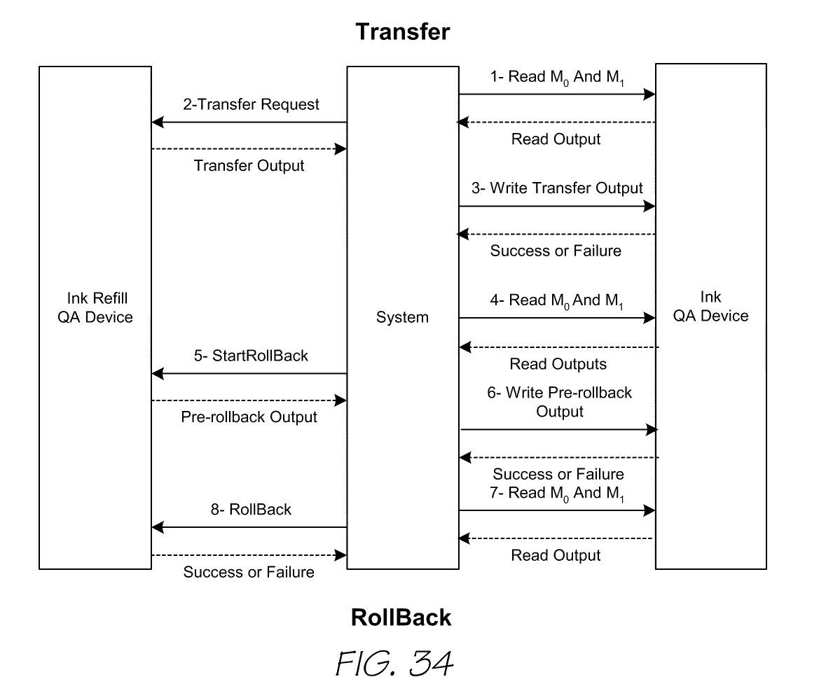

FIG. 34 shows the output signature generation data format for the GetProgramKey function.

Function Sequence

The GetProgramKey command is illustrated by the following pseudocode:

```
Accept input parameters - OldKeyRef, ChipId, R_{E}, KeyLock, NewKeyRef
# key replacement map key stored in K0, must not be used for key
replacement
If(OldKeyRef.keyNum = 0) [symbol] (NewKeyRef.keyNum = 0)
  ResultFlag ←Fail
  Output ResultFlag
  Return
EndIf
CheckRange(OldKeyRef.keyNum)
If invalid
  ResultFlag ←InvalidKey
  Output ResultFlag
  Return
EndIf
CheckRange(NewKeyRef.keyNum)
If invalid
  ResultFlag ←InvalidKey
  Output ResultFlag
  Return
EndIf
# Find M0 words that represent the key replacement map
WordSelectForKeyMapField ←GetWordSelectForKeyMapField(M1)
If(WordSelectForKeyMapField \tilde{ }.
  ResultFlag ←InvalidKeyReplacementMap
  Output ResultFlag
  Return
EndIf
#CheckMapPermits key replacement
ReplaceOK
←CheckMapPermits(WordSelectForKeyMapField,OldKeyNum,
NewKeyNum)
If(ReplaceOK = 0)
  ResultFlag ←KeyReplacementNotAllowed
  Output ResultFlag
  Return
EndIf
#All checks are OK, now generate Signature with OldKey
SIG_{L} ←GenerateSignature(OldKeyRef,null,R_{L},R_{E})
#Get new key
K_{NewKey}← NewKeyRef.getKey( )
#Generate Encrypted Key
EncryptedKey ← SIG_{L} ⊕K_{NewKey}
#Set base key or variant key - bit 0 of KeyId
If(NewKeyRef.useChipId = 1)
  KeyId←0x0001 [symbol]  0x0001
Else
  KeyId ←0x0001 [symbol]  0x0000
EndIf
#Set the new key KeyId to the KeyId - bits 1-30 of KeyId
KeyIdOfNewKey←SHIFTLEFT(KeyIdOfNewKey,1)
KeyId← KeyId [symbol] KeyIdOfNewKey
#Set the KeyLock as per input - bit 31 of KeyId
KeyLock← SHIFTLEFT(KeyLock,31)
#KeyId← KeyId [symbol] KeyLock
#Generate message for passing in to the GenerateSignature function
data ←ChipId|KeyId|R_{L}|EncryptedKey
#Generate output signature
SIGₒᵤₜ ←GenerateSignature(OldKeyRef,data,null,null)
# Refer to Figure 34
Advance R_{L}to R_{L2}
ResultFlag ←Pass
Output ResultFlag, R_{L},SIGₒᵤₜ,KeyId, EncryptedKey
Return
```

WordSelectForField GetWordSelectForKeyMapField(M1)

This function gets the words corresponding to the key replacement map in M0.

```
FieldSize[16] ←0 # Array to hold FieldSize assuming there are 16 fields
NumFields ←FindNumberOfFieldsInM0(M1,FieldSize)
#Find the key replacement map field
For i ←0 to NumFields
  If(TYPE_KEY_MAP = M1[i].Type) # Field is key map field
    MapFieldNum [symbol]
    Return
  Endif
EndFor
#Get the words corresponding to the key replacement map
WordMapForField← GetWordMapForField(MapFieldNum,M1)
Return WordSelectForField
```

NumFields FindNum OfFieldsInM0(M1, FieldSize[ ])

WordMapForField GetWordMapForField(FieldNum, M1)

Replace OK CheckMapPermits(WordSelectForKeyMapField, OldKeyNum, NewKeyNum, M0)

This function checks whether key replacement map permits key replacement.

```
#Isolate KeyReplacementMap based on WordSelectForKeyMapField and
M0
  KeyReplacementMap[64 bit]
  #Isolate permission bit corresponding for NewKeyNum in the map for
  OldKeyNm
  ReplaceOK ←KeyReplacementMap[(OldKeyNum × . NewKeyNum)
  bit]
  Return ReplaceOK
```

Replace Key

| | |
|---|---|
| Input: | KeyRef, KeyId, KeyLock, EncryptedKey, R_{E}, SIG_{E} |
| Output: | ResultFlag |
| Changes: | K_{KeyNum} and R_{L} |
| Availability: | Key programming device |

Function Description

This function is used for replacing a key in a key programming device and is similar to the generic ReplaceKey function, with an additional step of setting the KeyRef.keyNum column and KeyRef.keyNum row key replacement map to 0.

Function Sequence

The ReplaceKey command is illustrated by the following pseudocode:

```
Accept input parameters - KeyRef, KeyId, EncryptedKey,R_{E}, SIG_{E}
#Generate message for passing into GenerateSignature function
data ←(ChipId|KeyId|R_{E}|EncryptedKey)# Refer to Figure 30.
----------------------------------------------------------------
# Validate KeyRef, and then verify signature
ResultFlag = ValidateKeyRefAndSignature(KeyRef,data,R_{E},R_{L})
If (ResultFlag ≠ Pass)
  Output ResultFlag
  Return
EndIf
----------------------------------------------------------------
# Check if the key slot is unlocked
Isolate KeyLock for KeyRef
If(KeyLock = lock)
  ResultFlag ←KeyAlreadyLocked
  Output ResultFlag
  Return
EndIf
SIG_{L} ←GenerateSignature(Key,Null,R_{E},R_{L})
Advance R_{L}
# Find M0 words that represent the key replacement map
WordSelectForKeyMapField ←GetWordSelectForKeyMapField(M1)
# Set the bits corresponding to the keyRef.keyNum row and column to 0
# i.e invalidate the key replacement map for KeyRef.keyNum.
#Must be done before the key is replaced and must be atomic with key
replacement.
SetFlag
←SetKeyMapForKeyNum(WordSelectForKeyMapField,KeyRef.-
keyNum,M0)
If(SetFlag = 1)
  # Must be atomic - must not be possible to remove power and have
KeyId and
  KeyNum mismatched
  K_{KeyNum} ← SIG_{L} ⊕ EncryptedKey
  KeyId_{KeyNum} ←KeyId
  KeyLock_{KeyNum} ←KeyLock
  ResultFlag ←Pass
Else
  ResultFlag ←Fail
EndIf
Output ResultFlag
Return
```

WordSelectForField GetWordSelectForKeyMapField(M1)

SetFlag SetKeyMapForKeyNum(WordSelectForKeyMapField,KeyNum, M0)

This function invalidates the key replacement map for KeyNum.

```
#Isolate KeyReplacementMap based on WordSelectForKeyMapField
and M0
KeyReplacementMap[64 bit]
# Set KeyNum row (all bits) to 0 in the KeyReplacementMap
For i = 0 to 7
  KeyReplacementMap[(KeyNum × . i)bit] ←0
EndFor
# Set KeyNum column to 0 in the KeyReplacementMap
For i = 0 to 7
  KeyReplacementMap[(i×. KeyNum)bit] ←0
EndFor
SetFlag [symbol]
Return SetFlag
```

Functions Upgrade Device (Ink Re/Fill)

In a printing application, an ink cartridge contains an Ink QA Device storing the ink-remaining values for that ink cartridge. The ink-remaining values decrement as the ink cartridge is used to print. When an ink cartridge is physically re/filled, the Ink QA Device needs to be logically re/filled as well. Therefore, the main purpose of an upgrade is to re/fill the ink-remaining values of an Ink QA Device in an authorised manner.

The authorisation for a re/fill is achieved by using a Value Upgrader QA Device which contains all the necessary functions to re/write to the Ink QA Device. In this case, the value upgrader is called an Ink Refill QA Device, which is used to fill/refill ink amount in an Ink QA Device.

When an Ink Refill QA Device increases (additive) the amount of ink-remaining in an Ink QA Device, the amount of ink-remaining in the Ink Refill QA Device is correspondingly decreased. This means that the Ink Refill QA Device can only pass on whatever ink-remaining value it itself has been issued with. Thus an Ink Refill QA Device can itself be replenished or topped up by another Ink Refill QA Device.

The Ink Refill QA Device can also be referred to as the Upgrading QA Device, and the Ink QA Device can also be referred to as the QA Device being upgraded.

The refill of ink can also be referred to as a transfer of ink, or transfer of amount/valu, or an upgrade.

Typically, the logical transfer of ink is done only after a physical transfer of ink is successful.

The transfer process has two basic requirements:
The transfer can only be performed if the transfer request is valid. The validity of the transfer request must be completely checked by the Ink Refill QA Device, before it produces the required output for the transfer. It must not be possible to apply the transfer output to the Ink QA Device, if the Ink Refill QA Device has been already been rolled back for that particular transfer.
A process of rollback is available if the transfer was not received by the Ink QA Device. A rollback is performed only if the rollback request is valid. The validity of the rollback request must be completely checked by the Ink Refill QA Device, before it adjusts its value to a previous value before the transfer request was issued. It must not be possible to rollback an Ink Refill QA Device for a transfer which has already been applied to the Ink QA Device i.e the Ink Refill QA Device must only be rolled back for transfers that have actually failed.

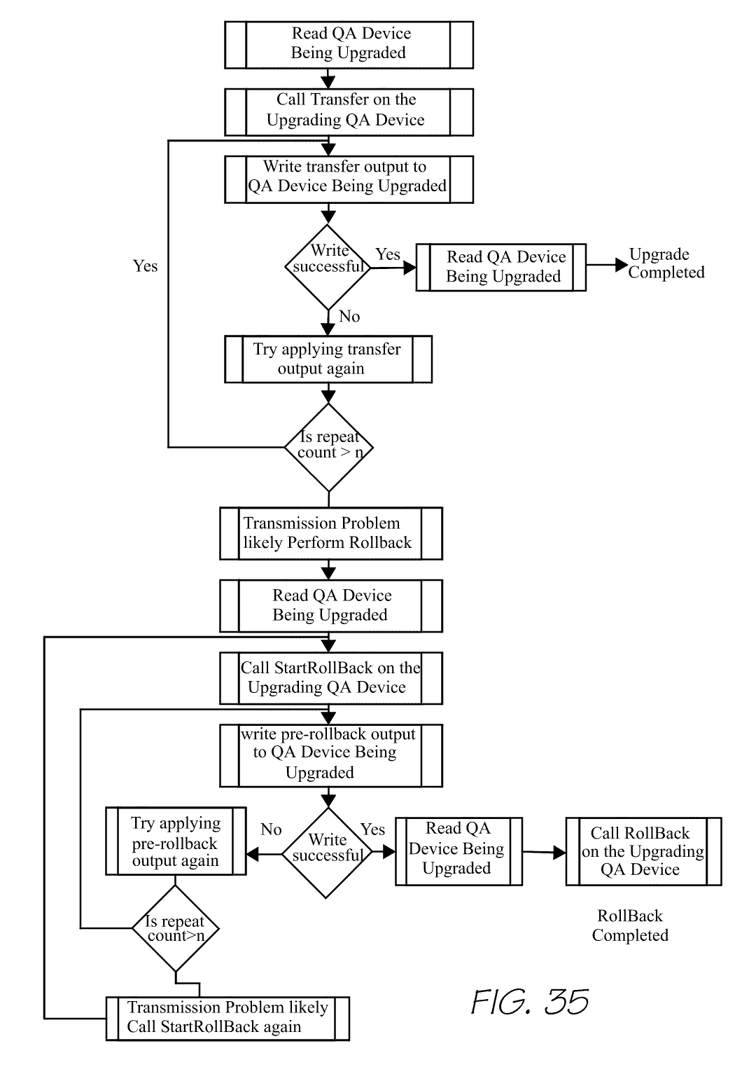

The transfer and rollback process is shown in FIG. 35.

Following is a sequential description of the transfer and rollback process:

1. The System Reads the memory vectors M0and M1 of the Ink QA Device. The output from the read which includes the M0 and M1 words of the Ink QA Device, and a signature, is passed as an input to the Transfer Request. It is essential that M0 and M1 l are read together. This ensures that the field information for M0 fields are correct, and have not been modified, or substituted from another device. Entire M0 and M1 must be read to verify the correctness of the subsequent Transfer Request by the Ink Refill QA Device.

2. The System makes a Transfer Request to the Ink Refill QA Device with the amount that must be transferred, the field in the Ink Refill QA Device the amount must be transferred from, and the field in Ink QA Device the amount must be transferred to. The Transfer Request also includes the output from Read of the Ink QA Device. The Ink Refill QA Device validates the Transfer Request based on the Read output, checks that it has enough value for a successful transfer, and then produces the necessary Transfer Output. The Transfer Output typically consists of new field data for the field being refilled or upgraded, additional field data required to ensure the correctness of the transfer/rollback, along with a signature.

3. The System then applies the Transfer Output to the Ink QA Device, by calling an authenticated Write function on it, passing in the Transfer Output. The Write is either successful or not. If the Write is not successful, then the System will repeat calling the Write function using the same transfer output, which may be successful or not. If unsuccesful the System will initiate a rollback of the transfer. The rollback must be performed on the Ink Refill QA Device, so that it can adjust its value to a previous value before the current Transfer Request was initiated. It is not necessary to perform a rollback immediately after a failed Transfer. The Ink QA Device can still be used to print, if there is any ink remaining in it.

4. The System starts a rollback by Reading the memory vectors M0 and M1 of the Ink QA Device.

5. The System makes a StartRollBack Request to the Ink Refill QA Device with same input parameters as the Transfer Request, and the output from Read in (4). The Ink Refill QA Device validates the StartRollBack Request based on the Read output, and then produces the necessary Pre-rollback output. The Pre-rollback output consists only of additional field data along with a signature.

6. The System then applies the Pre-rollback Output to the Ink QA Device, by calling an authenticated Write function on it, passing in the Pre-rollback output. The Write is either successful or not. If the Write is not successful, then either (6), or (5) and (6) must be repeated.

7. The System then Reads the memory vectors M0 and M1 of the Ink QA Device.

8. The System makes a RollBack Request to the Ink Refill QA Device with same input parameters as the Transfer Request, and the output from Read (7). The Ink Refill QA Device validates the RollBack Request based on the Read output, and then rolls back its field corresponding to the transfer.

Transfer

The Ink QA Device stores ink-remaining values in its M0 fields, and its corresponding M₁ words contains field information for its ink-remaining fields. The field information consists of the size of the field, the type of data stored in field and the access permission to the field.

The Ink Refill QA Device also stores its ink-remaining values in its M0 fields, and its corresponding M₁ words contains field information for its ink-remaining fields.

Authorisation

The basic authorisation for a transfer comes from a key, which has authenticated ReadWrite permission (stored in field information as KeyNum) to the ink-remaining field (to which ink will be transferred) in the Ink QA Device. We will refer to this key as the refill key. The refill key must also have authenticated decrement-only permission for the ink-remaining field (from which ink will be transferred) in the Ink Refill QA Device. After validating the input transfer request, the Ink Refill QA Device will decrement the amount to be transferred from its ink-remaining field, and produce a transfer amount (previous ink-remaining amount in the Ink QA Device+transfer amount), additional field data, and a signature using the refill key. Note that the Ink Refill QA Device can decrement its ink-remaining field only if the refill key has the permission to decrement it. The signature produced by the Ink Refill QA Device is subsequently applied to the Ink QA Device. The Ink QA Device will accept the transfer amount only if the signature is valid. Note that the signature will only be valid if it was produced using the refill key which has write permission to the ink-remaining field being written.

Data Type Matching

The Ink Refill QA Device validates the transfer request by matching the Type of the data in ink-remaining information field of Ink QA Device to the Type of data in ink-remaining information field of the Ink Refill QA Device. This ensures that equivalent data Types are transferred i.e Network_OEM1_infrared ink is not transferred to Network_OEM1_cyan ink.

Addition Validation

Additional validation of the transfer request must also be performed before a transfer output is generated by the Ink Refill QA Device. These are as follows:

For the Ink Refill QA Device:

1. Whether the field being upgraded is actually present.

2. Whether the field being upgraded can hold the upgraded amount.

For the Ink QA Device:

1. Whether the field from which the amount is transferred is actually present.

2. Whether the field has sufficient amount required for the transfer.

Rollback Facilitation

To facilitate a rollback, the Ink Refill QA Device will store a list of transfer requests processed by it. This list is referred to as the Xfer Entry cache. Each record in the list consists of the transfer parameters corresponding to the transfer request.

Rollback

A rollback request is validated by looking through the Xfer Entry of the Ink Refill QA Device and finding the request that should be rolled back. After the right transfer request is found the Ink Refill QA Device checks that the output from the transfer request was not applied to the Ink QA Device by comparing the current Read of the Ink QA Device to the values in the Xfer Entry cache, and finally rolls back its ink-remaining field (from which the ink was transferred) to a previous value before the transfer request was issued.

The Ink Refill QA Device must be absolutely sure that the Ink QA Device didn't receive the transfer. This factor determines the additional fields that must be written along with transfer amount, and also the parameters of the transfer request that must be stored in the Xfer Entry cache to facilitate a rollback, to prove that the Printer QA Device didn't actually receive the transfer.

Sequence Fields

The rollback process must ensure that the transfer output (which was previously produced) for which the rollback is being performed, cannot be applied after the rollback has been performed.

How do we achieve this? There are two separate decrement-only sequence fields (SEQ_{—}1 and SEQ_{—}2) in the Ink QA Device which can only be decremented by the Ink Refill QA Device using the refill key. The nature of data to be written to the sequence fields is such that either the transfer output or the pre-rollback output can be applied to the Ink QA Device, but not both i.e they must be mutually exclusive. Refer to Table 56 for details.

TABLE 56
Sequence field data for Transfer and Pre-rollback

| | Sequence Field data | | |
|---|---|---|---|
| | written to Ink QA Device | | |
| Function | SEQ_1 | SEQ_2 | Explanation |
| Initialised | 0xFFFFFFFF | 0xFFFFFFFF | Written using the sequence |
| | | | key |
| | | | which is different from the |
| | | | refill key |
| Write using | (Previous Value − 2) | (Previous Value − | Written using the refill key |
| Transfer | If Previous Value = | 1) | using |
| Output | intialised value then | If Previous Value = | the refill key which has |
| | 0xFFFFFFFD | intialised value | decrement-only |
| | | then | permission on the fields. |
| | | 0xFFFFFFFE | Value cannot be written if |
| | | | pre-rollback |
| | | | output is already written. |
| Write usiing | (Previous Value − 1) | (Previous Value − | Written using the refill key |
| Pre- | If Previous Value = | 2) | using |
| rollback | intialised value | If Previous Value = | the refill key which has |
| | then 0xFFFFFFFE | intialised value | decrement-only |
| | | then | permissionon the fields. |
| | | 0xFFFFFFFD | Value can be written only if |
| | | | Transfer |
| | | | Output has not been |
| | | | written. |

The two sequence fields are initialised to 0xFFFFFFFF using sequence key. The sequence key is different to the refill key, and has authenticated ReadWrite permission to both the sequence fields.

The transfer output consists of the new data for the field being upgraded, field data of the two sequence fields, and a signature using the refill key. The field data for SEQ_{—}1 is decremented by 2 from the original value that was passed in with the transfer request. The field data for SEQ_{—}2 is decremented by 1 from the original value that was passed in with the transfer request.

The pre-rollback output consists only of the field data of the two sequence fields, and a signature using the refill key. The field data for SEQ_{—}1 is decremented by 1 from the original value that was passed in with the transfer request. The field data for SEQ_{—}2 is decremented by 2 from the original value that was passed in with the transfer request. Since the two sequence fields are decrement-only fields, the writing of the transfer output to QA Device being upgraded will prevent the writing of the pre-rollback output to QA Device being upgraded. If the writing of the transfer output fails, then pre-rollback can be written. However, the transfer output cannot be written after the pre-rollback has been written.

Before a rollback is performed, the Ink Refill QA Device must confirm that the sequence fields was successfully written to the pre-rollback values in the Ink QA Device. Because the sequence fields are Decrement-Only fields, the Ink QA Device will allow pre-rollback output to be written only if the upgrade output has not been written. It also means that the transfer output cannot be written after the pre-rollback values have been written.

Field Information of the Sequence Data Field

For a device to be upgradeable the device must have two sequence fields SEQ_{—}1 and SEQ_{—}2 which are written with sequence data during the transfer sequence. Thus all upgrading QA devices, ink QA Devices and printer QA Devices must have two sequence fields. The upgrading QA Devices must also have these fields because they can be upgraded as well.

The sequence field information is defined in Table 57.

TABLE 57
Sequence field information

| Attribute Name | Value | Explanation |
|---|---|---|
| Type | TYPE_SEQ_1 or | |
| | TYPE_SEQ_2. | |
| KeyNum | Slot number of the sequence | Only the sequence key has |
| | key. | authenticated |
| | | ReadWrite access to this field. |
| Non Auth RW | 0 | Non authenticated ReadWrite |
| Perm | | is not allowed to the field. |
| Auth RW Perm | 1 | Authenticated (key based) |
| | | ReadWrite access |
| | | is allowed to the field. |
| KeyPerm | KeyPerms[KeyNum] = 0 | KeyNum is the slot number of the |
| | | sequence key, |
| | | which has ReadWrite permission |
| | | to the field. |
| | KeyPerms[Slot number of the | Refill key can decrement the |
| | refill key] = 1 | sequence field. |
| | KeyPerms[others = 0 . . . 7 | All other keys have ReadOnly access. |
| | (except refill key)] = 0 | |
| End Pos | | Set as required. Size is typically 1 |
| | | word. |

Upgrade States

There are three states in an transfer sequence, the first state is initiated for every transfer, while the next two states are initiated only when the transfer fails. The states are—Xfer, StartRollback, and Rollback.

Upgrade Flow

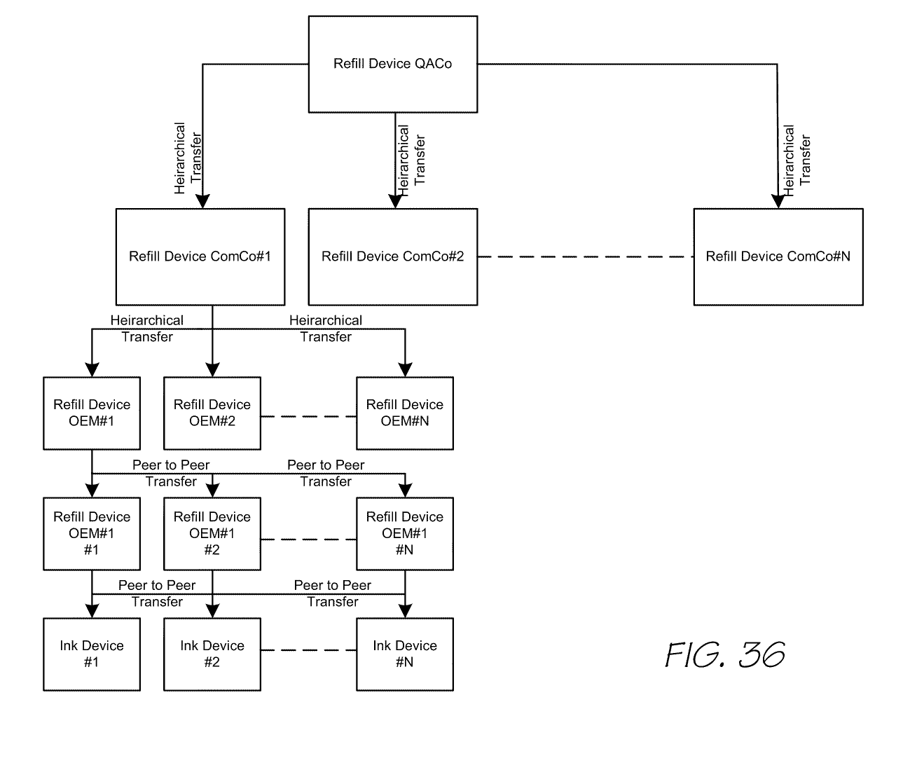

FIG. 36 shows a typical upgrade flow.

Xfer

This state indicates the start of the transfer process, and is the only state required if the transfer is successful. During this state, the Ink Refill QA Device adds a new record to its Xfer Entry cache, decrements its amount, produces new amount, new sequence data and a signature based on the refill key.

The Ink QA Device will subsequently write the new amount and new sequence data, after verifying the signature. If the new amount can be successfully written to the Ink QA Device, then this will finish a successful transfer.

If the writing of the new amount is unsuccessful (result returned is BAD SIG ), the System will re-transmit the transfer output to the Ink QA Device, by calling the authenticated Write function on it again, using the same transfer output.

If retrying to write the same transfer output fails repeatedly, the System will start the rollback process on Ink Refill QA Device, by calling the Read function on the Ink QA Device, and subsequently calling the StartRollBack function on the Ink Refill QA Device. After a successful rollback is performed, the System will invoke the transfer sequence again.

StartRollBack

This state indicates the start of the rollback process. During this state, the Ink Refill QA Device produces the next sequence data and a signature based on the refill key. This is also called a pre-rollback.

The pre-rollback output can only be written to the Ink QA Device, if the previous transfer output has not been written. The writing of the pre-rollback sequence data also ensures, that if the previous transfer output was captured and not applied, then it cannot be applied to the Ink QA Device in the future.

If the writing of the pre-rollback output is unsuccessful (result returned is BAD SIG), the System will re-transmit the pre-rollback output to the Ink QA Device, by calling the authenticated Write function on it again, using the same pre-rollback output.

If retrying to write the same pre-rollback output fails repeatedly, the System will call the StartRollback on the Ink Refill QA Device again, and subsequently calling the authenticated Write function on the Ink QA Device using this output.

Rollback

This state indicates a successful deletion (completion) of a transfer sequence. During this state, the Ink Refill QA Device verifies the sequence data produced from StartRollBack has been correctly written to Ink Refill QA Device, then rolls its ink-remaining field to a previous value before the transfer request was issued.

Xfer Entry Cache

The Xfer Entry data structure must allow for the following:
Stores the transfer state and sequence data for a given transfer sequence.
Store all data corresponding to a given transfer, to facilitate a rollback to the previous value before the transfer output was generated.

The Xfer Entry cache depth will depend on the QA Chip Logical Interface implementation. For some implementations a single Xfer Entry value will be saved. If the Ink Refill QA Device has no powersafe storage of Xfer Entry cache, a power down will cause the erasure of the Xfer Entry cache and the Ink Refill QA Device will not be able to rollback to a pre-power-down value.

A dataset in the Xfer Entry cache will consist of the following:

Information about the QA Device being upgraded:

a. ChipId of the device.

b. FieldNum of the M0 field (i.e what was being upgraded).

Information about the upgrading QA Device:

a. FieldNum of the M0 field used to transfer the amount from.

XferVal—the transfer amount.

Xfer State—indicating at which state the transfer sequence is. This will consist of:

a. State definition which could be one of the following: -Xfer, StartRollBack and complete/deleted.

b. The value of sequence data fields SEQ_{—}1 and SEQ_{—}2.

Adding New Dataset

A new dataset is added to Xfer Entry cache by the Xfer function.

There are three methods which can be used to add new dataset to the Xfer Entry cache. The methods have been listed below in the order of their priority:
1. Replacing existing dataset in Xfer Entry cache with new dataset based on ChipId and FieldNum of the Ink QA Device in the new dataset. A matching ChipId and FieldNum could be found because a previous transfer output corresponding to the dataset stored in the Xfer Entry cache has been correctly received and processed by the Ink Refill QA Device, and a new transfer request for the same Ink QA Device, same field, has come through to the Ink Refill QA Device.
2. Replace existing dataset cache with new dataset based on the Xfer State. If the Xfer State for a dataset indicates deleted (complete), then such a dataset will not be used for any further functions, and can be overwritten by a new dataset.
3. Add new dataset to the end of the cache. This will automatically delete the oldest dataset from the cache regardless of the Xfer State.

Different Types of Transfer

There can be three types of transfer:

Peer to Peer Transfer—This transfer could be one of the 2 types described below:
a. From an Ink Refill QA Device to a Ink QA Device. This is performed when the Ink QA Device is refilled by the Ink Refill QA Device.
b. From one Ink Refill QA Device to another Ink Refill QA Device, where both QA Devices belong to the same OEM. This is typically performed when OEM divides ink from one Ink Refill QA Device to another Ink Refill QA Device, where both devices belong to the same OEM

Heirachical Transfer—This is a transfer from one Ink Refill QA Device to another Ink Refill QA Device, where the QA Devices belong to different organisation, say ComCo and OEM. This is typically performed when ComCo divides ink from its refill device to several refill devices belonging to several OEMs.

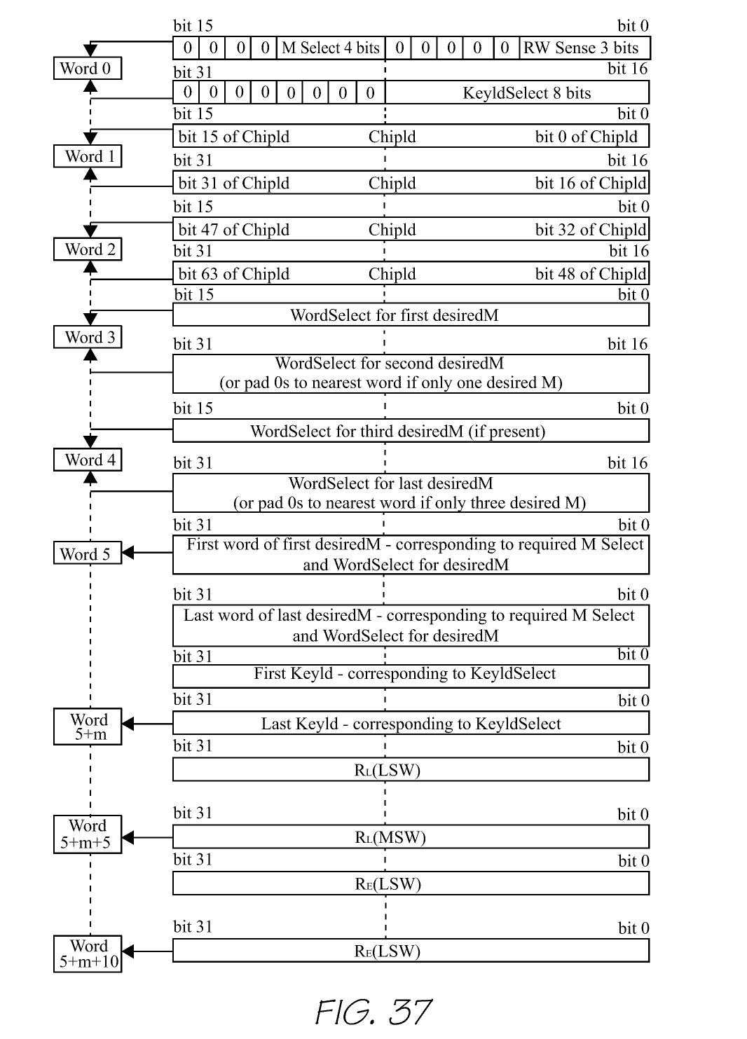

FIG. 37 is a representation of various authorised ink refill paths in the printing system.

Hierarchical Transfer

Referring to FIG. 37, this transfer is typically performed when ink is transferred from ComCo's Ink Refill QA Device to OEM's Ink Refill QA Device, or from QACo's Ink Refill QA Device to ComCo's Ink Refill QA Device.

Keys and Access Permission

We will explain this using a transfer from ComCo to OEM.

There is an ink-remaining field associated with the ComCo's Ink Refill QA Device. This ink-remaining field has two keys associated with:
The first key transfers ink to the device from another refill device (which is higher in the heirachy), fills/refills (upgrades) the device itself. This key has authenticated ReadWrite permission to the field.
The second key transfers ink from it to other devices (which are lower in the heirachy), fills/refills (upgrades) other devices from it. This key has authenticated decrement-only permission to the field.

There is an ink-remaining field associated with the OEM's Ink refill device. This ink-remaining field has a single key associated with:
This key transfers ink to the device from another refill device (which is higher or at the same level in the hierarchy), fills/refills (upgrades) the device itself, and additionally transfers ink from it to other devices (which are lower in the heirachy), fills/refills (upgrades) other devices from it. Therefore, this key has both authenticated ReadWrite and decrement-only permission to the field.

For a successful transfer ink from ComCo's refill device to an OEM's refill device, the ComCo's refill device and the OEM's refill device must share a common key or a variant key. This key is fill/refill key with respect to the OEM's refill device and it is the transfer key with respect to the ComCo's refill device.

For a ComCo to successfully fill/refill its refill device from another refill device (which is higher in the heirachy possibly belonging to the QA Co), the ComCo's refill device and the QACo's refill device must share a common key or a variant key. This key is fill/refill key with respect to the ComCo's refill device and it is the transfer key with respect to the QACo's refill device.

Ink—Remaining Field Information

Table 58 shows the field information for an _{M0} field storing logical ink-remaining amounts in the refill device and which has the ability to transfer down the heirachy.

| Attribute Name | Value | Explanation |
|---|---|---|
| Type | For e.g - TYPE_HIGHQUALITY_BLACK_INK^{a} | Type describing the logical ink |
| | | stored in the ink-remaining field in |
| | | the refill device. |
| KeyNum | Slot number of the refill key. | Only the refill key has |
| | | authenticated |
| | | ReadWrite access to this field. |
| Non Auth RW | 0 | Non authenticated ReadWrite |
| Perm^{b} | | is not allowed to the field. |
| Auth RW Perm^{c} | 1 | Authenticated (key based) |
| | | ReadWrite access is allowed to |
| | | the field. |
| KeyPerm | KeyPerms[KeyNum] = 0 | KeyNum is the slot number of the |
| | | refill key, which has ReadWrite |
| | | permission to the field. |
| | KeyPerms[Slot Num of transfer | Transfer key can decrement the |
| | key] = 1 | field. |
| | KeyPerms[others = 0 . . . 7(except | All other keys have ReadOnly |
| | transfer key)] = 0 | access. |
| End Pos | Set as required. | Depends on the amount of logical |
| | | ink the device can store and |
| | | storage resolution - i.e in picolitres |
| | | or in microlitres. |

^{a}This is a sample type only and is not included in the Type Map.
^{b}Non authenticated Read Write permission.
^{c}Authenticated Read Write permission.

Peer to Peer Transfer

Referring to FIG. 37, this transfer is typically performed when ink is transferred from OEM's Ink Refill Device to another Ink Refill Device belonging to the same OEM, or OEM's Ink Refill Device to Ink Device belonging to the same OEM.

Keys and Access Permission

There is an ink-remaining field associated with the refill device which transfers ink amounts to other refill devices (peer devices), or to other ink devices. This ink-remaining field has a single key associated with:
This key transfers ink to the device from another refill device (which is higher or at the same level in the heirachy), fills/refills (upgrades) the device itself, and additionally transfers ink from it to other devices (which are lower in the heirachy), fills/refills (upgrades) other devices from it.

This key is referred to as the fill/refill key and is used for both fill/refill and transfer. Hence, this key has both ReadWrite and Decrement-Only permission to the ink-remaining field in the refill device.

Ink-Remaining Field Information

Table 59 shows the field information for an _{M0} field storing logical ink-remaining amounts in the refill device with the ability to transfer between peers.

| Attribute Name | Value | Explanation |
|---|---|---|
| Type | For e.g - | Type describing the logical ink stored in the |
| | TYPE_HIGHQUALITY_BLACK_INK^{a} | ink-remaining field |
| | | in the refill device. |
| KeyNum | Slot number of the | Only the refill key has authenticated |
| | refill key. | ReadWrite access to this field. |
| Non Auth RW | 0 | Non authenticated ReadWrite |
| Perm^{b} | | is not allowed to the field. |
| Auth RW Perm^{c} | 1 | Authenticated (key based) ReadWrite |
| | | access |
| | | is allowed to the field. |
| KeyPerm | KeyPerms[KeyNum] = 1 | KeyNum is the slot number of the refill |
| | | key, |
| | | which has ReadWrite and Decrement |
| | | permission to the field. |
| | KeyPerms[others = 0 . . . 7 | All other keys have ReadOnly access. |
| | (except KeyNum)] = 0 | |
| End Pos | Set as required. | Depends on the amount of logical ink the |
| | | device can store |
| | | and storage resolution - i.e in picolitres or |
| | | in microlitres. |

^{a}This is a sample type only.
^{b}Non authenticated Read Write permission.
^{c}Authenticated Read Write permission.

Functions

XferAmount

| | |
|---|---|
| Input: | KeyRef, _{M0}OfExternal, _{M1}OfExternal, ChipId, |
| | FieldNumL, FieldNumE, XferValLength, XferVal, |
| | InputParameterCheck (optional), R_{E}, SIG_{E}, R_{E2} |
| Output: | ResultFlag, FieldSelect, FieldVal, R_{L2}, SIGₒᵤₜ |
| Changes: | _{M0} and R_{L} |
| Availability | Ink refill QA Device |

Function Description

The XferAmount function produces data and signature for updating a given _{M0} field. This data and signature when applied to the appropriate device through the WriteFieldsAuth function, will update the _{M0} field of the device.

The system calls the XferAmount function on the upgrade device with a certain XferVal, this XferVal is validated by the XferAmount function for various rules, the function then produces the data and signature for the passing into the WriteFieldsAuth function for the device being upgraded.

The transfer amount output consists of the new data for the field being upgraded, field data of the two sequence fields, and a signature using the refill key. When a transfer output is produced, the sequence field data in SEQ_{—}1 is decremented by 2 from the previous value(as passed in with the input), and the sequence field data in SEQ_{—}2 is decremented by 1 from the previous value (as passed in with the input).

Additional InputParameterCheck value must be provided for the parameters not included in the SIG_{E}, if the transmission between the System and Ink Refill QA Device is error prone, and these errors are not corrected by the transimission protocol itself. InputParameterCheck is SHA-1[FieldNumL|FieldNumE|XferValLength|XferVal], and is required to ensure the integrity of these parameters, when these inputs are received by the Ink Refill QA Device. This will prevent an incorrect transfer amount being deducted.

The XferAmount function must first calculate the SHA-1[FieldNumL|FieldNumE|XferValLength|XferVal], compare the calculated value to the value received (InputParameterCheck) and only if the values match act upon the inputs.

Input Parameters

Table 60 describes each of the input parameters for XferAmount function.

| Parameter | Description |
|---|---|
| KeyRef | For comsmon key input and output signature: KeyRef.keyNum = |
| | Slot number of the key to be used for testing input signature and |
| | producing the output signature. SIG_{E} produced using K_{KeyRef.keyNum} |
| | by the QA Device being upgraded. SIGout produced using |
| | K_{KeyRef.keyNum} for delivery to the QA Device being upgraded. |
| | KeyRef.useChipId = 0 |
| | For variant key input and output signatures: KeyRef.keyNum = |
| | Slot number of the key to be used for generating the variant key. |
| | SIG_{E} produced using a variant of K_{KeyRef.keyNum} by the QA Device |
| | being upgraded. SIGout produced using a variant of K_{KeyRef.keyNum} |
| | for delivery to the QA Device being upgraded. KeyRef.useChipId = |
| | 1 KeyRef.chipId = ChipId of the device which generated SIG_{E} and |
| | will receive SIGout. |
| _{M0}OfExternal | All 16 words of _{M0} of the QA Device being upgraded. |
| _{M1}OfExternal | All 16 words of _{M1} of the QA Device being upgraded. |
| ChipId | ChipId of the QA Device being upgraded. |
| FieldNumL | _{M0} field number of the local (refill) device from which the value will |
| | be transferred. |
| FieldNumE | _{M0} field number of the QA Device being upgraded to which the |
| | value will be transferred. |
| XferValLength | XferVal length in words. Non zero length required. |
| XferVal | The logical amount that will be transferred from the local device to |
| | the external device. |
| R_{E} | External random value used to verify input signature. This will be |
| | the R from the input signature generator (i.e device generating |
| | SIG_{E}). The input signal generator in this case, is the device |
| | being upgraded or a translation device. |
| R_{E2} | External random value used to produce output signature. This will |
| | be R obtained by calling the Random function on the device which |
| | will receive the SIGₒᵤₜ from the XferAmount function. The device |
| | receiving the SIGₒᵤₜ in this case, is the device being upgraded or a |
| | translation device. |
| SIG_{E} | External signature required for authenticating input data. The input |
| | data in this case, is the output from the Read function performed on the |
| | device being upgraded. |
| | A correct SIG_{E} = SIG_{KeyRef}(Data \| R_{E} \| R_{L}). |

Input Signature Verification Data Format

The input signature passed in to the XferAmount function is the output signature from the Read function of the Ink QA Device.

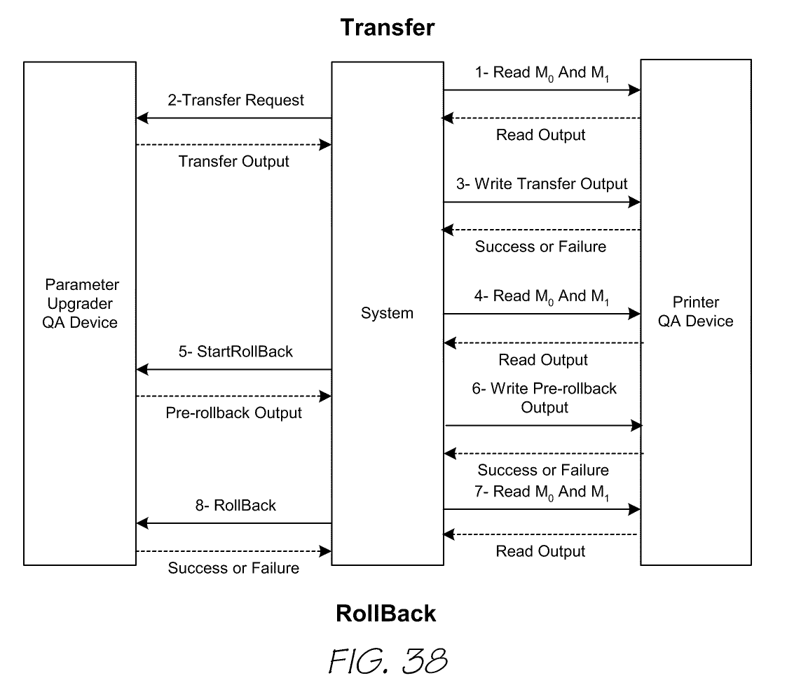

FIG. 38 shows the input signature verification data format for the XferAmount function. Table 61 gives the parameters included in SIG_{E for XferAmount.}

| | Length in | | Value set from |
|---|---|---|---|
| Parameter | bits | Value set internally | Input |
| RWSense | 3 | 000 | |
| MSelect | 4 | 0011 | |
| KeyIdSelect | 8 | 00000000 | |
| ChipId | 48 | | ChipId of the QA |
| | | | Device being |
| | | | upgraded |
| WordSelect for M₀ | 16 | All bits set to 1 | |
| WordSelect for M₁ | 16 | All bits set to 1 | |
| M0 | 512 | | |
| M1 | 512 | | |
| R_{E} | 160 | | |
| R_{L} | 160 | Based on the | |
| | | internal R | |

The XferAmount function is not passed all the parameters required to generate SIG_{E}.

For producing SIG_{L} which is used to test SIG_{E}, the function uses the expected values of some the parameters.

Output Parameters

Table 62 describes each of the output parameters for XferAmount.

| Parameter | Description |
|---|---|
| ResultFlag | Indicates whether the function completed successfully or |
| | not. If it did not complete successfully, the reason for the |
| | failure is returned here. |
| FieldSelect | Selection of fields to be written |
| | In this case the bit corresponding to SEQ_1, SEQ_2 and to |
| | FieldNumE are set to 1. |
| | All other bits are set to 0. |
| FieldVal | Updated data words for Sequence data field and |
| | FieldNumE for QA Device being upgraded. |
| | Starts with LSW of lower field. |
| | This must be passed as input to the WriteFieldsAuth |
| | function of the QA Device being upgraded. |
| R_{L2} | Internal random value required to generate output signature. |
| | This must be passed as input to the WriteFieldsAuth |
| | function or Translate function of the QA Device being |
| | upgraded. |
| SIGₒᵤₜ | Output signature which must be passed as an input to the |
| | WriteFieldsAuth function of the QA Device being |
| | upgraded. SIGₒᵤₜ = SIG_{KeyRef}(data \| R_{L2} \| R_{E2}). |

TABLE 63
Result Flag definitions for XferAmount

| ResultFlag Definition | Description |
|---|---|
| FieldNumEInvalid | FieldNum to which the amount is being transferred, or |
| | which is being upgraded in the QA Device being upgraded |
| | is invalid. |
| SeqFieldInvalid | The sequence field for the QA Device being upgraded is |
| | invalid. |
| FieldNumEWritePermInvalid | FieldNum to which the amount is being transferred, or |
| | which is being upgraded in the QA Device being upgraded |
| | has no authenticated write permission. |
| FieldNumLInvalid | FieldNum from which the amount is being transferred, or |
| | from which the value is being copied in the Upgrading QA |
| | Device is invalid. |
| FieldNumLWritePermInvalid | FieldNum from which the amount is being transferred in |
| | the Upgrading QA Device has no authenticated |
| | permission, or no authenticated permission with the |
| | KeyRef. |
| TypeMismatch | Type of the data from which the amount is being |
| | transferred in the Upgrading QA Device, doesn't match the |
| | Type of data to which the amount in being transferred in |
| | the Device being upgraded. |
| UpgradeFieldEInvalid | Only applicable for transferring count-remaining values. |
| | The upgrade field associated with the count-remaining field |
| | in the QA Device being upgraded is invalid. |
| UpgradeFieldLInvalid | Only applicable for transferring count-remaining values. |
| | The upgrade field associated with the count-remaining field |
| | in the Upgrading QA Device is invalid. |
| UpgradeFieldMismatch | Only applicable for transferring count-remaining values. |
| | Type of the data in the upgrade field in the Upgrading QA |
| | Device, doesn't match the Type of data in the upgrade field |
| | in the Device being upgraded. |
| FieldNumESizeInsufficient | FieldNum to which the amount is being transferred, or |
| | which is being upgraded in the QA Device is not big |
| | enough to store the transferred data. |
| FieldNumLAmountInsufficient | FieldNum in the Upgrading QA Device from which the |
| | amount is being transferred doesn't have the amount |
| | required for the transfer. |

Function Sequence

The XferAmount command is illustrated by the following pseudocode:

```
  Accept input parameters-KeyRef, M0OfExternal, M1OfExternal,
  ChipId, FieldNumL, FieldNumE, XferValLength
  # Accept XferVal words
  For i ←0 to XferValLength
    Accept next XferVal
  EndFor
  Accept R_{E}, SIG_{E}, R_{E2}
  #Generate message for passing into ValidateKeyRefAndSignature
  function
  data ←(RWSense|MSelect|KeyIdSelect|ChipId|WordSelect|M0|M1)
      # Refer to Figure 38.
  ----------------------------------------------------------------
  # Validate keyRef, and then verify signature
  ResultFlag = ValidateKeyRefAndSignature(KeyRef,data,R_{E},R_{L})
  If (ResultFlag ≠ Pass)
    Output ResultFlag
    Return
  EndIf
  ----------------------------------------------------------------
  #Validate FieldNumE
  # FieldNumE is present in the device being upgraded
  PresentFlagFieldNumE ←GetFieldPresent(M1OfExternal,FieldNumE)
  # Check FieldNumE present flag
  If(PresentFlagFieldNumE ≠ 1)
    ResultFlag ←FieldNumEInvalid
    Output ResultFlag
    Return
  EndIf
  ---------------------------------------------------------------------------------
  # Check Seq Fields Exist and get their Field Num
  # Get Seqdata field SEQ_1 num for the device being upgraded
  XferSEQ_1FieldNum←GetFieldNum(M1OfExternal, SEQ_1)
  # Check if the Seqdata field SEQ_1 is valid
  If(XferSEQ_1FieldNum invalid)
    ResultFlag ←SeqFieldInvalid
    Output ResultFlag
    Return
  EndIf
  # Get Seqdata field SEQ_2 num for the device being upgraded
  XferSEQ_2FieldNum←GetFieldNum(M1OfExternal, SEQ_2)
  # Check if the Seqdata field SEQ_2 is valid
  If(XferSEQ_2FieldNum invalid)
    ResultFlag ←SeqFieldInvalid
    Output ResultFlag
    Return
  EndIf
  ----------------------------------------------------------------
#Check write permission for FieldNumE
  PermOKFieldNumE
  ←CheckFieldNumEPerm(M1OfExternal,FieldNumE)
  If(PermOKFieldNumE ≠1)
    ResultFlag ←FieldNumEWritePermInvalid
    Output ResultFlag
    Return
  EndIf
  ----------------------------------------------------------------#Check that both
  SeqData
  fields have Decrement-Only permission with the same key
  #that has write permission on FieldNumE
  PermOKXferSeqData ←CheckSeqDataFieldPerms(M1OfExternal,
          XferSEQ_1FieldNum, XferSEQ_2FieldNum,FieldNumE)
  If(PermOKXferSeqData ≠1)
    ResultFlag ←SeqWritePermInvalid
    Output ResultFlag
    Return
  EndIf
  ----------------------------------------------------------------
  # Get SeqData SEQ_1 data from device being upgraded
  GetFieldDataWords(XferSEQ_1FieldNum,
          XferSEQ_1DataFromDevice,M0OfExternal,M1OfExternal)
  # Get SeqData SEQ_2 data from device being upgraded
  GetFieldDataWords(XferSEQ_2FieldNum,
          XferSEQ_2DataFromDevice, M0OfExternal,M1OfExternal)
  ----------------------------------------------------------------
  # FieldNumL is a present in the refill device
  PresentFlagFieldNumL ←GetFieldPresent(M1,FieldNumL)
  If(PresentFlagFieldNumL ≠ 1)
    ResultFlag ←FieldNumLInvalid
    Output ResultFlag
    Return
  EndIf
  #Check permission for FieldNumL
  PermOKFieldNumL ←CheckFieldNumLPerm(M1,FieldNumL,KeyRef)
  If(PermOKFieldNumL ≠ 1)
    ResultFlag ←FieldNumLWritePermInvalid
    Output ResultFlag
    Return
  EndIf
  ----------------------------------------------------------------
  #Find the type attribute for FieldNumE
  TypeFieldNumE ←FindFieldNumType(M1OfExternal,FieldNumE)
  #Find the type attribute for FieldNumL
  TypeFieldNumL ←FindFieldNumType(M1,FieldNumL)
  # Check type attribute for both fields match
  If(TypeFieldNumE ≠TypeFieldNumL)
    ResultFlag ←TypeMismatch
    Output ResultFlag
    Return
  EndIf
  ----------------------------------------------------------------
----------------------------------------------------------------------- Do this if the
Refill Device is tranferring Count-remaining for Printer upgrades
  # If the Type is count remaining, check that upgrade values associated
  with # the count remaining are valid.
  If(TypeFieldNumL =
  TYPE_COUNT_REMAINING) [symbol] (TypeFieldNumE =
  TYPE_COUNT_REMAINING)
  #Upgrade value field is lower adjoining field
  UpgradeValueFieldNumE = FieldNumE −1
  If(UpgradeValueFieldNumE < 0) # upgrade field doesn't exist for
QA Device being upgraded
    ResultFlag ←UpgradeFieldEInvalid
    Output ResultFlag
    Return
  EndIf
  UpgradeValueFieldNumL = FieldNumL − 1
  If(UpgradeValueFieldNumL < 0) # upgrade field doesn't exist for
  local device
    ResultFlag ←UpgradeFieldLInvalid
    Output ResultFlag
    Return
  EndIf
  UpgradeValueCheckOK ←
UpgradeValCheck(UpgradeValueFieldNumL,M0,M1,
  UpgradeValueFieldNumL,M0OfExternal,M1OfExternal,KeyRef)
  If(UpgradeValueCheckOK = 0)
    ResultFlag ←UpgradeFieldMismatch
    Output ResultFlag
    Return
  EndIf
EndIf
# Do this if Field Type is Count Remaining........end
----------------------------------------------------------------
#Check whether the device being upgraded can hold the transfer amount
#(XferVal + AmountLeft
OverFlow ←CanHold(FieldNumE,M0OfExternal,XferVal)
If OverFlow error
  ResultFlag ←FieldNumESizeInsufficient
  Output ResultFlag
  Return
EndIf
----------------------------------------------------------------
#Check the refill device has the desired amount
(XferVal < = AmountLeft)
UnderFlow ←HasAmount(FieldNumL,M0,XferVal)
If UnderFlow error
  ResultFlow ←FieldNumLAmountInsufficient
  Output ResultFlag
  Return
EndIf
----------------------------------------------------------------
# All checks complete .....
# Generate Seqdata for SEQ_1 and SEQ_2 fields
XferSEQ_1DataToDevice = XferSEQ_1DataFromDevice − 2
XferSEQ_2DataToDevice = XferSEQ_2DataFromDevice − 1
# Add DataSet to Xfer Entry Cache
AddDataSetToXferEntryCache(ChipId,FieldNumE, FieldNumL,
XferLength, XferVal, XferSEQ_1DataFromDevice,
XferSEQ_2DataFromDevice)
# Get current FieldDataE field data words to write to Xfer Entry cache
GetFieldDataWords(FieldNumE,FieldDataE,M0OfExternal,
M1OfExternal)
#Deduct XferVal from FieldNumL and Write new value
DeductAndWriteValToFieldNumL(XferVal,FieldNumL,M0)
#Generate new field data words for FieldNumE. The current FieldDataE is
added to
# XferVal to generate new FieldDataE
GenerateNewFieldData(FieldNumE,XferVal,FieldDataE)
# Generate FieldSelect and FieldVal for SeqData field SEQ_1, SEQ_2
and
# FieldDataE...
CurrentFieldSelect← 0
FieldVal ← 0
GenerateFieldSelectAndFieldVal(FieldNumE, FieldDataE,
XferSEQ_1FieldNum, XferSEQ_1DataToDevice,XferSEQ_2FieldNum,
XferSEQ_2DataToDevice,
FieldSelect,FieldVal)
#Generate message for passing into GenerateSignature function
data ←(RWSense|FieldSelect|ChipId|FieldVal)
#Create output signature for FieldNumE
SIGₒᵤₜ←GenerateSignature(KeyRef,data,R_{L2},R_{E2})
Update R_{L2} to R_{L3}
ResultFlag ←Pass
Output ResultFlag, FieldData, R_{L2},SIGₒᵤₜ
Return
EndIf
```

ResultFlag ValidateKeyRefAndSignature(KeyRef, data, R_{E}, R_{L})

This function checks KeyRef is valid, and if KeyRef is valid, then input signature is verified using KeyRef.

```
CheckRange(KeyRef.keyNum)
If invalid
  ResultFlag ←InValidKey
  Output ResultFlag
  Return
EndIf
#Generate message for passing into GenerateSignature function
data ←(RWSense|MSelect|KeyIdSelect|ChipId|WordSelect|M0|M1)
#Generate Signature
SIG_{L} ←GenerateSignature(KeyRef,data,R_{E},R_{L})
# Check input signature SIG_{E}
If(SIG_{L} = SIG_{E})
  Update R_{L} to R_{L2}
Else
  ResultFlag ←Bad Signature
  Output ResultFlag
  Return
EndIf
```

GenerateFieldSelectAndFieldVal (FieldNumE, FieldDataE, XferSEQ_{—}1FieldNum, XferSEQ_{—}1DataToDevice, XferSEQ_{—}2FieldNum, XferSEQ_{—}2DataToDevice, FieldSelect, FieldVal)

This functions generates the FieldSelect and FieldVal for output from FieldNumE and its final data, and data to be written to Seq fields SEQ_{—}1 and SEQ_{—}2.

PresentFlagGetFieldPresent(M1, FieldNum)

This function checks whether FieldNum is a valid.

```
FieldSize[16] ←0 # Array to hold FieldSize assuming there are 16 fields
NumFields← FindNumberOfFieldsInM0(M1,FieldSize)
If(FieldNum< NumFields)
  PresentFlag← 1
Else
  PresentFlag← 0
EndIf
Return PresentFlag
```

FieldNum GetFieldNum(M1, Type)

This function returns the field number based on the Type.

```
FieldSize[16] ←0 # Array to hold FieldSize assuming there are 16 fields
NumFields← FindNumberOfFieldsInM0(M1,FieldSize)
For i = 0 to NumFields
  If(M1[i].Type = Type)
    Return i # This is field Num for matching field
EndFor
i = 255 # If XferSession field was not found then return an invalid value
Return i
```

PermOK CheckFieldNumEPerm(M1, FieldNumE)

This function checks authenticated write permission for FieldNum which holds the upgraded value.

```
AuthRW ←M1[FieldNum].AuthRW
NonAuthRW ←M1[FieldNum].NonAuthRW
If(AuthRW = 1) [symbol] NonAuthRW = 0)
  PermOK ← 1
Else
  PermOK ← 0
EndIf
Return PermOK
```

PermOK CheckSeqDataFieldPerms(M1, XferSEQ_{—}1FieldNum, XferSEQ_{—}2FieldNum, FieldNumE)

This function checks that both SeqData fields have Decrement-Only permission with the same key that has write permission on FieldNumE.

```
KeyNumForFieldNumE ←M1[FieldNumE].KeyNum # Isolate KeyNum
for the field that
# will be upgraded
# Isolate KeyNum for both SeqData fields and check that they can be
written using the same key
KeyNumForSEQ_1 ←M1[XferSEQ_1FieldNum].KeyNum
KeyNumForSEQ_2 ←M1[XferSEQ_2FieldNum].KeyNum
If(KeyNumForSEQ_1 ≠KeyNumForSEQ_2)
  PermOK ← 0
  Return PermOK
EndIf
# Check that the write key for FieldNumE and SeqData field is not the
same
If (KeyNumForSEQ_1 = KeyNumForFieldNumE)
  PermOK ← 0
  Return PermOK
EndIf
#Isolate Decrement-Only permissions with the write key of FieldNumE
KeyPermsSEQ_1
←M1[XferSEQ_1FieldNum].KeyPerms[KeyNumForFieldNumE]
KeyPermsSEQ_2
←M1[XferSEQ_2FieldNum].KeyPerms[KeyNumForFieldNumE]
# Check that both sequence fields have Decrement-Only permission for
this key
If(KeyPermsSEQ_1 0) [symbol] (KeyPermsSEQ_2 0)
  PermOK ← 0
  Return PermOK
EndIf
PermOK ← 1
Return PermOK
```

AddDataSetToXferEntryCache (ChipId, FieldNumE, FieldNumL, XferVal, SEQ_{—}1Data, SEQ_{—}2Data)

This function adds a new dataset to the Xfer Entry cache. Dataset is a single record in the Xfer Entrycache.

```
# Search for matching ChipId FieldNumE is Cache
DataSet ←SearchDataSetInCache (ChipId, FieldNumE)
# If found
If(DataSet is valid)
  DeleteDataSetInCache(DataSet) # This creates a vacant dataset
  AddRecordToCache(ChipId, FieldNumE,FieldDataL,XferVal,
SEQ_1Data, SEQ_2Data)
EndIf
# Searches the cache for XferState complete/deleted
Found←SearchRecordsInCache(complete/deleted)
If(Found =1)
  AddRecordToCache(ChipId, FieldNumE,FieldDataL,XferVal,
SEQ_1Data, SEQ_2Data)
Else
  # This will overwrite the oldest DataSet in cache
  AddRecordToCache(ChipId, FieldNumE,FieldDataL,XferVal,
SEQ_1Data, SEQ_2Data)
  Return
Endif
Set XferState in record to Xfer
Return
```

Field Type FindFieldNumType (M1, FieldNum)

This function gets the Type attribute for a given field.

FieldType ←M1[FieldNum].Type
Return FieldType

PermOK CheckFieldNumLPerm(M1, FieldNumL, KeyRef)

This function checks authenticated write permissions using KeyRef for FieldNumL in the refill device.

```
AuthRW ←_{M1}[FieldNumL].AuthRW
KeyNumAtt ←_{M1}[FieldNumL].KeyNum
DOForKeys ←_{M1}[FieldNumL].DOForKeys[KeyNum]
# Authenticated write allowed
# ReadWrite key for field is the same as Input KeyRef.keyNum
# Key has both ReadWrite and DecrementOnly Permission
If(AuthRW = 1) [symbol] (KeyRef.keyNum = KeyNumAtt) [symbol]
(DOForKeys = 1
  PermOK← 1
Else
  PermOK← 0
EndIf
Return PermOK
```

CheckOK Upgrade ValCheck(FieldNum 1, M0OfFieldNum1, M1OfFieldNum1, FieldNum2, M0OfFieldNum2, M1OfFieldNum2,KeyRef)

This function checks the upgrade value corresponding to the count remaining. The upgrade value corresponding to the count remaining field is stored in the lower adjoining field. To upgrade the count remaining field, the upgrade value in refill device and the device being upgraded must match.

```
#Check authenticated write permissions is allowed to the field
#Check that only one key has ReadWrite access,
#and all other keys are ReadOnly access
PermCheckOKFieldNum1
←CheckUpgradeKeyForField(FieldNum1,M1OfFieldNum1,KeyRef)
If(PermCheckOKFieldNum1 ≠ 1)
  CheckOK ←0
  Return CheckOK
EndIf
PermCheckOKFieldNum2
←CheckUpgradeKeyForField(FieldNum2,M1OfFieldNum2,KeyRef)
If(PermCheckOKFieldNum2 ≠ 1)
  CheckOK ←0
  Return CheckOK
EndIf
#Get the upgrade value associated with field
GetFieldDataWords(FieldNum1,UpgradeValueFieldNum1,
M0OfFieldNum1,M1 OfFieldNum1)
#Get the upgrade value associated with field
GetFieldDataWords(FieldNum2,UpgradeValueFieldNum2,
M0OfFieldNum2,M1 OfFieldNum2)
If(UpgradeValueFieldNum1 ≠ UpgradeValueFieldNum2)
  CheckOK ←0
  Return CheckOK
EndIf
# Get the type attribute for the field
UpgradeTypeFieldNum1←GetUpgradeType(FieldNum1,
M1OfFieldNum1)
UpgradeTypeFieldNum2←GetUpgradeType(FieldNum2,
M1OfFieldNum2)
If(UpgradeTypeFieldNum1 ≠ UpgradeTypeFieldNum2)
  CheckOK ←0
  Return CheckOK
EndIf
CheckOK ←1
Return CheckOK
```

CheckOK CheckUpgradeKeyForField(FieldNum, M1, KeyRef)

This function checks that authenticated write permissions is allowed to the field. It also checks that only one key has ReadWrite access and all other keys have ReadOnly access. KeyRef which updates count remaining must not have write access to the upgrade value field.

```
KeyNum ←M1[FieldNum].KeyNum
AuthRW ←M1[FieldNum].AuthRW
NonAuthRW ←M1[FieldNum].NonAuthRW
DOForKeys←M1[FieldNum].DOForKeys
#Check that KeyRef doesn't have write permissions to the field
If(KeyRef.keyNum = KeyNum)
  CheckOK \tilde{←}
  Return CheckOK
EndIf
#AuthRW access allowed or NonAuthRW not allowed
If(AuthRW = 0) [symbol] (NonAuthRW =1)
  CheckOK \tilde{←}
  Return CheckOK
EndIf
For i ←0 to 7
  # Keys other than KeyNum are allowed ReadOnly access,
  # DecrementOnly access not allowed for other keys(not KeyNum)
  If (i ≠KeyNum) [symbol] (DOForKeys[i] = 1)
    CheckOK ←
    Return CheckOK
  EndIf
  #ReadWrite access allowed for KeyNum,
  #ReadWrite and DecrementOnly access not allowed for KeyNum.
  If (i = KeyNum) [symbol] (DOForKeys[i] = 1)
    CheckOK \tilde{←}
    Return CheckOK
  EndIf
EndFor
CheckOK [symbol]
Return CheckOK
```

UpgradeType GetUpgradeType(FieldNum, M1)

This function gets the type attribute for the upgrade field.

UpgradeType GetUpgradeType(FieldNum)
UpgradeType←M1[FieldNum].Type
Return UpgradeType

GetFieldDataWords(FieldNum, FieldData[ ], M0, M1)

This function gets the words corresponding to a given field.

CurrPos ← MaxWordInM
If FieldNum = 0

CurrPos ← MaxWordInM

Else

CurrPos ← (M1[FieldNum −1].EndPos) −1 # Next lower word after

last word of the

# previous field

EndIf
EndPos ← (M1[FieldNum].EndPos)
For i ←EndPos to CurrPos j \tilde{←}

FieldData[j] ←M0[i] #Copy M0 word to FieldData array

EndFor

StartRollBack

| | |
|---|---|
| Input: | KeyRef, _{M0}OfExternal, _{M1}OfExternal, ChipId, |
| | FieldNumL, FieldNumE, InputParameterCheck (optional), |
| | R_{E}, SIG_{E}, R_{E2} |
| Output: | ResultFlag, FieldSelect, FieldVal, R_{L2}, SIGₒᵤₜ |
| Changes: | _{M0} and R_{L} |
| Availability | Ink refill QA Device and Parameter Upgrader QA Device |

Function Description

StartRollBack function is used to start a rollback sequence if the QA Device being upgraded didn't receive the transfer message correctly and hence didn't receive the transfer.

The system calls the function on the upgrading QA Device, passing in FieldNumE and ChipId of the QA Device being upgraded, and FieldNumL of the upgrading QA Device. The upgrading QA Device checks that the QA Device being upgraded didn't actually receive the message correctly, by comparing the values read from the device with the values stored in the Xfer Entry cache. The values compared is the value of the sequence fields. After all checks are fulfilled, the upgrading QA Device produces the new data for the sequence fields and a signature. This is subsequently applied to the QA Device being upgraded (using the WriteFieldAuth function), which updates the sequence fields SEQ_{—}1 and SEQ_{—}2 to the pre-rollback values. However, the new data for the sequence fields and signature can only be applied if the previous data for the sequence fields produced by Xfer function has not been written.

The output from the StartRollBack function consists only of the field data of the two sequence fields, and a signature using the refill key. When a pre-rollback output is produced, then sequence field data in SEQ_{—}1 (as stored in the Xfer Entry cache, which is what is passed in to the XferAmount function) is decremented by 1 and the sequence field data in SEQ_{—}2 (as stored in the Xfer Entry cache, which is what is passed in to the XferAmount function) is decremented by 2.

Additional InputParameterCheck value must be provided for the parameters not included in the SIG_{E}, if the transmission between the System and Ink Refill QA Device is error prone, and these errors are not corrected by the transimission protocol itself. InputParameterCheck is SHA-1[FieldNumL|FieldNumE], and is required to ensure the integrity of these parameters, when these inputs are received by the Ink Refill QA Device.

The StartRollBack function must first calculate the SHA-1[FieldNumL|FieldNumE], compare the calculated value to the value received (InputParameterCheck) and only if the values match act upon the inputs.

Input Parameters

Table 64 describes each of the input parameters for StartRollback function.

| Parameter | Description |
|---|---|
| KeyRef | For common key input signature: KeyRef.keyNum = Slot number |
| | of the key to be used for testing input signature. SIG_{E} produced |
| | using K_{KeyRef.keyNum} by the QA Device being upgraded. |
| | KeyRef.useChipId = 0 |
| | For variant key input signature: KeyRef.keyNum = Slot number of |
| | the key to be used for generating the variant key for testing input |
| | signature. SIG_{E} produced using a variant of K_{KeyRef.keyNum} by the QA |
| | Device being upgraded. KeyRef.useChipId = 1 KeyRef.chipId = |
| | ChipId of the device which generated SIG_{E}. |
| _{M0}OfExternal | All 16 words of _{M0} of the QA Device being upgraded which failed to |
| | upgrade. |
| _{M1}OfExternal | All 16 words of _{M1} of the QA Device being upgraded which failed to |
| | upgrade. |
| ChipId | ChipId of the QA Device being upgraded which failed to upgrade. |
| FieldNumL | _{M0} field number of the local (refill) device from which the value was |
| | supposed to transferred. |
| FieldNumE | _{M0} field number of the QA Device being upgraded to which the |
| | value couldn't be transferred. |
| R_{E} | External random value used to verify input signature. This will be |
| | the R from the input signature generator (i.e device generating |
| | SIG_{E}). The input signal generator in this case, is the device which |
| | failed to upgrade or a translation device. |
| SIG_{E} | External signature required for authenticating input data. The input |
| | data in this case, is the output from the Read function performed on |
| | the device which failed to upgrade. A correct SIG_{E} = SIG_{KeyRef}(Data |
| | \| R_{E} \| R_{L}). |

Output Parameters

Table 65 describes each of the output parameters for StartRollback function.

| Parameter | Description |
|---|---|
| ResultFlag | Indicates whether the function completed successfully |
| | or not. If it did not complete successfully, the reason |
| | for the failure is returned here. |
| FieldSelect | Selection of fields to be written |
| | In this case the bits corresponding to SEQ_1 and |
| | SEQ_2 are set to 1. |
| | All other bits are set to 0. |
| FieldVal | Updated data for sequence datat field for QA Device |
| | being upgraded. This must be passed as input to the |
| | WriteFieldsAuth function of the QA Device being |
| | upgraded. |
| R_{L2} | Internal random value required to generate output |
| | signature. This must be passed as input to the |
| | WriteFieldsAuth function or Translate function of the |
| | QA Device being upgraded. |
| SIGₒᵤₜ | Output signature which must be passed as an input |
| | to the WriteFieldsAuth function of the QA Device |
| | being upgraded. SIGₒᵤₜ = SIG_{KeyRef}(data \| R_{L2} \| R_{E2}). |

TABLE 66
Result definition for StartRollBack

| ResultFlag Definition | Description |
|---|---|
| RollBackInvalid | RollBack cannot be performed on the request |
| | because parameters for rollback is incorrect. |

Function Sequence

The StartRollBack command is illustrated by the following pseudocode: Accept input parameters-KeyRef, M0OfExternal, M1OfExternal, ChipId, FieldNumL, FieldNumE, R_{E}, SIG_{E}, R_{E2}

Accept R_{E}, SIG_{E}, R_{E2}
#Generate message for passing into ValidateKeyRefAndSignature function
data ←(RWSense|MSelect|KeyIdSelect|ChipId|WordSelect|M0|M1)
----------------------------------------------------------------
# Validate KeyRef, and then verify signature
ResultFlag = ValidateKeyRefAndSignature(KeyRef,data,R_{E},R_{L})
If (ResultFlag ≠ Pass)

Output ResultFlag
Return

EndIf
----------------------------------------------------------------# Check Seq Fields Exist and
get their Field Num
# Get Seqdata field SEQ_1 num for the device being upgraded
XferSEQ_1FieldNum←GetFieldNum(M1OfExternal, SEQ_1)
# Check if the Seqdata field SEQ_1 is valid
If(XferSEQ_1FieldNum invalid)

ResultFlag ←SeqFieldInvalid
Output ResultFlag
Return

EndIf
# Get Seqdata field SEQ_2 num for the device being upgraded
XferSEQ_2FieldNum←GetFieldNum(M1OfExternal, SEQ_2)
# Check if the Seqdata field SEQ_2 is valid
If(XferSEQ_2FieldNum invalid)

ResultFlag ←SeqFieldInvalid
Output ResultFlag
Return

EndIf
----------------------------------------------------------------
# Get SeqData SEQ_1 data from device being upgraded
GetFieldDataWords(XferSEQ_1FieldNum,

XferSEQ_1DataFromDevice,M0OfExternal,M1OfExternal)

# Get SeqData SEQ_2 data from device being upgraded
GetFieldDataWords(XferSEQ_2FieldNum,

XferSEQ_2DataFromDevice, M0OfExternal,M1OfExternal)

----------------------------------------------------------------
# Check Xfer Entry in cache is correct - dataset exists, Field data
# and sequence field data matches and Xfer State is correct
XferEntryOK ←CheckEntry(ChipId, FieldNumE, FieldNumL,

XferSEQ_1DataFromDevice, XferSEQ_2DataFromDevice)

If( XferEntryOK= 0)

ResultFlag ←RollBackInvalid
Output ResultFlag
Return

EndIf
# Generate Seqdata for SEQ_1 and SEQ_2 fields
XferSEQ_1DataToDevice = XferSEQ_1DataFromDevice − 1
XferSEQ_2DataToDevice = XferSEQ_2DataFromDevice − 2
# Generate FieldSelect and FieldVal for sequence fields SEQ_1 and SEQ_2
CurrentFieldSelect← 0
FieldVal ← 0
GenerateFieldSelectAndFieldVal(XferSEQ_1FieldNum,
XferSEQ_1DataToDevice, XferSEQ_2FieldNum, XferSEQ_2DataToDevice,
FieldSelect, FieldVal)
#Generate message for passing into GenerateSignature function
data ←(RWSense|FieldSelect|ChipId|FieldVal)
#Create output signature for FieldNumE
SIGₒᵤₜ←GenerateSignature(KeyRef,data,R_{L2},R_{E2})
Update R_{L2} to R_{L3}
ResultFlag ←Pass
Output ResultFlag, FieldData, R_{L2,}SIGₒᵤₜ
Return
EndIf

RollBackAmount

| | |
|---|---|
| Input: | KeyRef, _{M0}OfExternal, _{M1}OfExternal, ChipId, FieldNumL, |
| | FieldNumE, InputParameterCheck (optional), R_{E}, SIG_{E} |
| Output: | ResultFlag |
| Changes: | _{M0} and R_{L} |
| Availablity: | Ink refill QA Device |

Function Description

RollBackAmount function finally adjusts the value of the FieldNumL of the upgrading QA Device to a previous value before the transfer request, if the QA Device being upgraded didn't receive the transfer message correctly (and hence was not upgraded). The upgrading QA Device checks that the QA Device being upgraded didn't actually receive the transfer message correctly, by comparing the sequence data field values read from the device with the values stored in the Xfer Entry cache. The sequence data field values read must match what was previously written using the StartRollBack function. After all checks are fulfilled, the upgrading QA Device adjusts its FieldNumL. Additional InputParameterCheck value must be provided for the parameters not included in the SIG_{E}, if the transmission between the System and Ink Refill QA Device is error prone, and these errors are not corrected by the transimission protocol itself. InputParameterCheck is SHA-1[FieldNumL|FieldNumE], and is required to ensure the integrity of these parameters, when these inputs are received by the Ink Refill QA Device.

The RollBackAmount function must first calculate the SHA-1[FieldNumL|FieldNumE], compare the calculated value to the value received (InputParameterCheck) and only if the values match act upon the inputs.

Input Parameters

Table 67 describes each of the input parameters for RollbackAmount function.

| Parameter | Description |
|---|---|
| KeyRef | For common key input signature: KeyRef.keyNum = Slot number |
| | of the key to be used for testing input signature. SIG_{E} produced |
| | using K_{KeyRef.keyNum} by the QA Device being upgraded. |
| | KeyRef.useChipId = 0 |
| | For variant key input signature: KeyRef.keyNum = Slot number of |
| | the key to be used for generating the variant key for testing input |
| | signature. SIG_{E} produced using a variant of K_{KeyRef.keyNum} by the QA |
| | Device being upgraded. KeyRef.useChipId = 1 KeyRef.chipId = |
| | ChipId of the device which generated SIG_{E}. |
| _{M0}OfExternal | All 16 words of _{M0} of the QA Device being upgraded which failed to |
| | upgrade. |
| _{M1}OfExternal | All 16 words of _{M1} of the QA Device being upgraded which failed to |
| | upgrade. |
| ChipId | ChipId of the QA Device being upgraded which failed to upgrade. |
| FieldNumL | _{M0} field number of the local (refill) device from which the value was |
| | supposed to transferred. |
| FieldNumE | _{M0} field number of the QA Device being upgraded to which the |
| | value was not transferred. |
| R_{E} | External random value used to verify input signature. This will be |
| | the R from the input signature generator (i.e device generating |
| | SIG_{E}). The input signal generator in this case, is the device which |
| | failed to upgrade or a translation device. |
| SIG_{E} | External signature required for authenticating input data. The input |
| | data in this case, is the output from the Read function performed on |
| | the device which failed to upgrade. A correct SIG_{E} = SIG_{KeyRef}(Data |
| | \| R_{E} \| R_{L}). |

Output Parameters

Table 68 describes each of the output parameters for RollbackAmount.

| Parameter | Description |
|---|---|
| ResultFlag | Indicates whether the function completed successfully |
| | or not. If it did not complete successfully, the reason |
| | for the failure is returned here. |

Function Sequence

The RollBackAmount command is illustrated by the following pseudocode:

Accept input parameters-KeyRef, M0OfExternal, M1OfExternal, ChipId,
FieldNumL, FieldNumE, R_{E},SIG_{E}
#Generate message for passing into ValidateKeyRefAndSignature function
data ←(RWSense|MSelect|KeyIdSelect|ChipId|WordSelect|M0|M1)
----------------------------------------------------------------
# Validate KeyRef, and then verify signature
ResultFlag = ValidateKeyRefAndSignature(KeyRef,data,R_{E},R_{L})
If (ResultFlag ≠ Pass)

Output ResultFlag
Return

EndIf
----------------------------------------------------------------
# Check Seq Fields Exist and get their Field Num
# Get Seqdata field SEQ_1 num for the device being upgraded
XferSEQ_1FieldNum←GetFieldNum(M1OfExternal, SEQ_1)
# Check if the Seqdata field SEQ_1 is valid
If(XferSEQ_1FieldNum invalid)

ResultFlag ←SeqFieldInvalid
Output ResultFlag
Return

EndIf
# Get Seqdata field SEQ_2 num for the device being upgraded
XferSEQ_2FieldNum←GetFieldNum(M1OfExternal, SEQ_2)
# Check if the Seqdata field SEQ_2 is valid
If(XferSEQ_2FieldNum invalid)

ResultFlag ←SeqFieldInvalid
Output ResultFlag
Return

EndIf
----------------------------------------------------------------
# Get SeqData SEQ_1 data from device being upgraded
GetFieldDataWords(XferSEQ_1FieldNum,

XferSEQ_1DataFromDevice,M0OfExternal,M1OfExternal)

# Get SeqData SEQ_2 data from device being upgraded
GetFieldDataWords(XferSEQ_2FieldNum,

XferSEQ_2DataFromDevice, M0OfExternal,M1OfExternal)

----------------------------------------------------------------
# Generate Seqdata for SEQ_1 and SEQ_2 fields with the data that is read
XferSEQ_1Data = XferSEQ_1DataFromDevice + 1
XferSEQ_2Data = XferSEQ_2DataFromDevice + 2
# Check Xfer Entry in cache is correct - dataset exists, Field data
# and sequence field data matches and Xfer State is correct
XferEntryOK ←CheckEntry(ChipId, FieldNumE, FieldNumL,

XferSEQ_1Data, XferSEQ_2Data)

If( XferEntryOK= 0)

ResultFlag ←RollBackInvalid
Output ResultFlag
Return

EndIf
# Get FieldDataL from DataSet
GetVal(ChipId, FieldNumE, FieldDataL)
# Add FieldDataL to FieldNumL
AddValToField(FieldNumL, FieldDataL)
# Update XferState in DataSet to complete/deleted
UpdateXferStateToComplete(ChipId,FieldNumE)
ResultFlag ←Pass
Output ResultFlag
Return

The above describes the secure communication between the SoPEC and QA devices, allowing system authentication and ink usage accounting. Modifications and/or changes can be made thereto without departing from the scope and spirit of the invention, the embodiments being illustrative and not restrictive.

1. A method of providing integrated circuits with keys for use in secure communication, the method including the steps of:
determining a unique identifier for each integrated circuit in the series;
permanently storing the identifiers in the respective integrated circuits;
in each integrated circuit, mapping the identifier into a key;
wherein the key of one of the integrated circuits is designated as a base key, and the key of at least one other integrated circuit is derived from the base key by applying a one-way function to the base key.

2. A method according to claim 1, wherein the identifier for each integrated circuit is determined using a stochastic mechanism.

3. A method according to claim 1, wherein the key of the at least one other integrated circuit is derived from the base key by applying a one-way function to the base key and the identifier of the at least one other integrated circuit.

4. A method according to claim 1, comprising the further steps of:
generating, in at least one integrated circuit, a signature using the key of that integrated circuit;
signing a communication to at least one other integrated circuit with the signature; and
authenticating the communication by the other integrated circuit using the base key and the unique identifier of the integrated circuit that signed the communication.

5. A method according to claim 1, wherein the one-way function is HMAC-SHA1.

6. A method according to claim 1, wherein the one or more of the integrated circuits is in a device holding a consumable, and communication is between a system dispensing the consumable and the integrated circuit.

7. A method according to claim 6, wherein the consumable is ink and communication is used to authenticate the integrated circuit.

8. A method according to claim 7, wherein communication is further used for ink usage accounting.
